(19) United States
(12) Patent Application Publication
(10) Pub. No.: US 2026/0180092 A1
(43) Pub. Date: Jun. 25, 2026

(54) BATTERY PACK

(71) Applicant: Black & Decker Inc., New Britain, CT (US)

(72) Inventors: Jackson Stefancik, Pasadena, MD (US); Franklin Regan, Columbia, MD (US); Michael W. Roberts, Red Lion, PA (US); Mark Cherry, White Marsh, MD (US); Kurt Munich, Forest Hill, MD (US)

(21) Appl. No.: 19/539,687

(22) Filed: Feb. 13, 2026

Related U.S. Application Data
(63) Continuation of application No. PCT/US2024/042984, filed on Aug. 19, 2024.
(60) Provisional application No. 63/520,315, filed on Aug. 17, 2023.
(60) Provisional application No. 63/584,755, filed on Sep. 22, 2023.
(60) Provisional application No. 63/520,316, filed on Oct. 24, 2023.
(60) Provisional application No. 63/520,317, filed on Oct. 24, 2023.
(60) Provisional application No. 63/622,460, filed on Jan. 18, 2024.

(51) Int. Cl. H01M 50/204; H01M 50/244

(52) U.S. Cl. CPC H01M 50/204; H01M 50/244

(57) ABSTRACT

A battery pack comprises a housing forming an internal cavity and an electronics subassembly. The electronics subassembly includes a terminal block and a set of battery pack terminals fixedly held in place to the terminal block. The set of battery pack terminals is configured to mate with a corresponding set of terminals of an electrical device. The electrical device terminals are received in a mating direction. A first terminal of the set of battery pack terminals includes a first portion for contacting a first electrical device contact and a second portion for contacting the first electrical device contact. The first portion and the second portion are nested together.

### CROSS-REFERENCE TO RELATED APPLICATION(S)

This application is a continuation of Patent Cooperation Treaty Application No. PCT/US2024/042984, filed on Aug. 19, 2024, entitled “Battery Pack”, and claims the benefit of priority thereof under 35 U.S.C. § 120, and which claims the benefit of priority to each of: U.S. Provisional Patent Application Ser. No. 63/520,315, filed Aug. 17, 2023, titled “Battery Pack”; U.S. Provisional Patent Application Ser. No. 63/520,316 filed Aug. 17, 2023, titled “Battery Pack Charger”; U.S. Provisional Patent Application Ser. No. 63/520,317 filed Aug. 17, 2023, titled “Battery Pack Adaptor”; U.S. Provisional Patent Application Ser. No. 63/584,755 filed Sep. 22, 2023, titled “Battery Pack Interface”; and U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”.

### INCORPORATION BY REFERENCE

Patent Cooperation Treaty Application No. PCT/US2024/042984, filed on Aug. 19, 2024, entitled “Battery Pack”, is incorporated herein in its entirety by reference.

U.S. Provisional Patent Application Ser. No. 63/520,315, filed Aug. 17, 2023, titled “Battery Pack”, is incorporated herein in its entirety by reference.

U.S. Provisional Patent Application Ser. No. 63/520,316, filed Aug. 17, 2023, titled “Battery Pack Charger”, is incorporated herein in its entirety by reference.

U.S. Provisional Patent Application Ser. No. 63/520,317, filed Aug. 17, 2023, titled “Battery Pack Adaptor”, is incorporated herein in its entirety by reference.

U.S. Provisional Patent Application Ser. No. 63/584,755 filed Sep. 22, 2023, titled “Battery Pack Interface”, is incorporated herein in its entirety by reference.

U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”, is incorporated herein in its entirety by reference.

This application is related to U.S. patent application Ser. No. 18/114,121, filed on Feb. 24, 2023, titled “Cordless Power Tool System”, which in turn claims the benefit of priority from U.S. Provisional Patent Application Ser. No. 63/268,451, filed on Feb. 24, 2022, titled “Cordless Power Tool System”, the contents all of which are incorporated herein in their entireties by reference.

This application also is related to Patent Cooperation Treaty Application No. PCT/US2024/042983, filed on Aug. 19, 2024, titled “Battery Packs, Battery Pack Chargers, Battery Pack Interfaces and Adaptors of a Cordless Power Tool System”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042979, filed on Aug. 19, 2024, entitled “Battery Pack Charger”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042976, filed on Aug. 19, 2024, titled “Battery Pack-Power Tool Interface”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042973, filed on Aug. 19, 2024, titled “Battery Pack Adaptor”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042820, filed on Aug. 16, 2024, titled “Cordless Power Tool System”, which in turn claims the benefit of priority from U.S. Provisional Patent Application Ser. No. 63/622,475, filed Jan. 18, 2024, the contents all of which are incorporated herein in their entireties by reference.

### FIELD

The patent application relates to a battery pack of a cordless power tool system and a method for manufacturing a battery pack of a cordless power tool system.

### BACKGROUND

Removable, rechargeable battery packs are becoming ubiquitous as more and more devices become cordless to take advantage of the advances in battery technology.

Such battery packs are commonly part of cordless power tool systems and are designed and configured to operate with a variety of cordless power tools.

Conventional rechargeable battery packs may include Li-Ion battery cells. Due to the nature of the chemistry of these battery packs, the United States and many other countries and international bodies, including the United Nations, have implemented special rules directed to the shipping of Li-Ion batteries. If a battery or battery pack exceeds these rules/limits, there are additional fees and shipping costs for shipping the battery pack. As such, there is an interest in keeping the Watt-hour levels below the 100 Wh limits. Today, it is common for Li-Ion batteries to exceed these limits. As battery power and capacity increases it will become more common for batteries to exceed these limits. As such, there is a great desire to keep address this issue.

Typically, shipping regulations impose limitations upon how much energy is disposed in a battery pack. For example, some regulations require that each cell have an energy equal to or less than 20 Watt-hours, and that each battery pack has an energy limit equal to or less than 100 Watt-hours. It is preferable to provide a solution that can maximize the energy available to the end user while complying with shipping regulations. Preferably, a switching system could be used to separate components of the battery pack, thus opening the battery pack circuit, limiting the energy output.

While, for ground service (highway and rail), United States Department of Transportation (USDOT) regulations allow for certain packaging and shipment exceptions for batteries below 300 watt-hours, USDOT regulations for batteries above 300 watt-hours require special packaging (e.g., “Class 9” packaging) around the battery packs for shipment to be permissible.

The present patent application describes an example battery pack for use with a power tool system utilizing pouch battery cells and an example method of manufacturing such a battery pack.

Typically, rechargeable battery packs are charged using battery pack chargers that are designed and configured to charge specific battery packs. These chargers are designed and configured to plug into a wall outlet for access to alternating current (AC) mains line (utility) power or some other source of AC power, such as a generator. The battery packs, the power tools, and the chargers generally include an interface system that enables the battery pack to couple to the power tool and the charger, as is well known in the art. Various interfaces are known for electrically and physically coupling the battery pack with an electrical apparatus such as a power tool or a battery pack charge.

While prior art power tool systems including a set of cordless power tools, a set of releasably attachable battery packs and a set of battery pack chargers all designed and configured to operate with each other by an original equipment manufacturer have proven to be more than suitable for their intended purposes, each battery pack in the set of battery packs is limited for use with an associated tool of the set of cordless power tools and an associated charger of the set of battery pack chargers. Thus, it remains desirable in the art to provide an adaptor for a first battery pack having a first configuration specifically designed and configured to operate with a first type of power tool system that enables use of the first battery pack as a substitute for a second battery pack having a second configuration specifically designed and configured to operate with a second type of power tool system. Further, the cordless power tools and the battery packs may be used in heavy contamination environments. This type of environment may expose the cordless power tools and the battery packs to water and particulate ingress that may reduce the performance and warranty life expectancy. The present patent application provides improvements in the battery pack adaptors.

### SUMMARY

One aspect of the present patent application provides a battery pack. The battery pack comprises a housing and an electronics subassembly. The battery pack housing forms a cavity. The electronics subassembly may include a terminal block and a set of battery pack terminals fixedly held in place. The set of battery pack terminals may be configured to mate with a corresponding set of terminals of an electrical device. The electrical device terminals may be received in a mating direction. A first terminal of the set of battery pack terminals may include a first portion for contacting a first electrical device contact and a second portion for contacting the first electrical device contact. The first portion and the second portion may be nested together.

Implementations of the foregoing aspects may include one or more of the following features.

In an aspect of the present patent application, a second terminal of the set of battery pack terminals may include a first portion for contacting a second electrical device contact and a second portion for contacting the second electrical device contact. The first portion and the second portion of the second terminal may be nested together.

In an aspect of the present patent application, one of the first terminal and the second terminal may be a positive terminal and the other of the first terminal and the second terminal may be a negative terminal. The first terminal and the second terminal may be parallel to each other and extend along the mating direction.

In an aspect of the present patent application, each of the first portion and the second portion of the first terminal and each of the first portion and the second portion of the second terminal may include (a) a base portion, (b) opposing side walls that are spaced apart from each other and extend perpendicular to the base portion, and (c) terminal contacts that extend, along the mating direction.

In an aspect of the present patent application, for each of the first terminal and the second terminal, the terminal contacts of the first portion may be configured to be received between the opposing side walls of the second portion.

In an aspect of the present patent application, for each of the first terminal and the second terminal, the first portion may include a first length dimension measured along the mating direction, from a first end of the first portion to a second end of the first portion. The second portion may include a second length dimension measured along the mating direction, from a first end of the second portion to a second end of the second portion. When the first portion and the second portion are nested together, a nested length dimension may be measured along the mating direction, from the first end of the first portion to the second end of the second portion. The nested length dimension may be less than a sum of the first length dimension of the first portion and the second length dimension of the second portion.

In an aspect of the present patent application, the first length dimension of the first portion may be the same as the second length dimension of the second portion.

In an aspect of the present patent application, the first length dimension of the first portion may be different from the second length dimension of the second portion.

In an aspect of the present patent application, the base portion of the first portion of the first terminal may be configured to connect the first portion of the first terminal to a first contact portion of the terminal block. The base portion of the second portion of the first terminal may be configured to connect the second portion of the first terminal to the first contact portion of the terminal block.

In an aspect of the present patent application, the base portion of the first portion of the second terminal may be configured to connect the first portion of the second terminal to a second contact portion of the terminal block. The base portion of the second portion of the second terminal may be configured to connect the second portion of the second terminal to the second contact portion of the terminal block.

In an aspect of the present patent application, the terminal contacts of the first portion and the second portion of the first terminal may be configured to engage with the first electrical device contact.

In an aspect of the present patent application, the terminal contacts of the first portion and the second portion of the second terminal may be configured to engage with the second electrical device contact.

In an aspect of the present patent application, the terminal contacts of the first portion and the second portion of the first terminal may include tulip terminal contacts that are configured to be separated from each other to receive portions of the first electrical device contact therebetween. The terminal contacts of the first portion and the second portion of the second terminal may include tulip terminals that are configured to be separated from each other to receive portions of the second electrical device contact therebetween.

In an aspect of the present patent application, the opposing side walls of the second portion of the first terminal may be separated from each other by a first width dimension. The first width dimension may allow for separation of the tulip terminal contacts of the first portion of the first terminal to receive the portions of the first electrical device contact therebetween. The opposing side walls of the second portion of the second terminal may be separated from each other by a second width dimension. The second width dimension may allow for separation of the tulips terminal contacts of the first portion of the second terminal to receive the portions of the second electrical device contact therebetween.

In an aspect of the present patent application, the first width dimension of the second portion of the first terminal may be the same as the second width dimension of the second portion of the second terminal.

In an aspect of the present patent application, the first width dimension of the second portion of the first terminal may be different from the second width dimension of the second portion of the second terminal.

In an aspect of the present patent application, the electrical device may be a power tool.

In an aspect of the present patent application, the electrical device may be a charger.

In an aspect of the present patent application, the first portion and the second portion of the first terminal may be at the same potential.

In an aspect of the present patent application, the first portion and the second portion of the second terminal may be at the same potential.

In an aspect of the present patent application, for each of the first terminal and the second terminal, the terminal contacts at the second end of the first portion may be configured to overlap with the base portion at the first end of the second portion when the first portion and the second portion are nested together.

In an aspect of the present patent application, for each of the first terminal and the second terminal, portions of the first portion may be configured to overlap, along the mating direction, with portions of the second portion when the first portion and the second portion are nested together.

In another aspect of the present patent application a battery pack is provided. The battery pack comprises a housing and a cell holder subassembly. The cell holder subassembly includes a set of battery cell modules.

Implementations of the foregoing aspects may include one or more of the following features.

In an aspect of the present patent application, the housing may include a first housing portion and a second housing portion together forming an internal cavity. The cell holder subassembly may be received in the internal cavity of the housing.

In an aspect of the present patent application, the cell holder subassembly may include a module holder. The module holder may include a base and two opposing side walls that form an interior storage space that is configured to receive the set of battery cell modules. The module holder has a longitudinal axis along a length of the module holder and a transverse axis that is perpendicular to the longitudinal axis. The transverse axis may be along a width of the modular holder. The two side walls may extend along the longitudinal axis of the module holder.

In an aspect of the present patent application, the base and the two side walls of the module holder may be integrally formed.

In an aspect of the present patent application, the cell holder subassembly may include two opposing end walls that extend perpendicular to the base and the two side walls and that extend along the transverse axis of the module holder. The two end walls may be configured to be removably connected to the two side walls.

In an aspect of the present patent application, the battery pack may further comprise a subassembly support that is configured to support an electronics module subassembly. The subassembly support may be configured to be positioned parallel to the base of the module holder to form a top of the module holder. The subassembly support may be configured to be removably connected to the two side walls and the two end walls of the cell holder subassembly.

In an aspect of the present patent application, the cell holder subassembly may include one or more partition walls that extend parallel to the two end walls and along the transverse axis of the module holder. The one or more partition walls may be configured to be removably connected to the two side walls. When installed, the one or more partition walls may be configured to divide the interior storage space of the module holder into two or more storage spaces. Each of the two or more storage spaces is configured to receive one or more of the set of battery cell modules.

In an aspect of the present patent application, the base of the module holder may include a plurality of airflow openings that are configured to allow airflow between the interior storage space of the module holder and the internal cavity of the housing.

In an aspect of the present patent application, the set of battery cell modules may include three battery cell modules.

In an aspect of the present patent application, each battery cell module may include a plurality of battery cells that are stacked in the battery cell module along the longitudinal axis of the module holder. Each battery cell of the battery cell module is in a plane that is parallel to the transverse axis of the module holder.

In an aspect of the present patent application, the cell holder subassembly may be configured to receive three battery cell modules therein. Each battery cell module may be configured to be positioned to be parallel to the transverse axis of the cell holder subassembly. Battery cell tabs of each battery cell module may be disposed to be offset by 180 degrees with respect to its adjacent battery cell modules. The battery cell tabs of each battery cell module may be configured to face away from the base and are disposed in a plane that is parallel to the base of the cell holder subassembly.

In an aspect of the present patent application, each battery cell module may include five battery cells.

In an aspect of the present patent application, the battery cells in the battery cell module are pouch battery cells.

In an aspect of the present patent application, the battery pack may include a capacity of 10 Ah and a nominal voltage of 54V.

In an aspect of the present patent application, the housing may include an upper housing portion. The cell holder subassembly may be configured to be removably connected to the upper housing portion.

Another aspect of the present patent application provides a battery pack. The battery pack includes a housing forming an internal cavity and a shipping subassembly. The shipping subassembly includes a handle having a recess forming a cavity. The cavity includes an opening to the internal cavity and an actuation component received in the handle cavity.

Implementations of the foregoing aspects may include one or more of the following features.

In an aspect of the present patent application, the shipping subassembly may include a plurality of moveable contacts and a contact holding member configured to house the moveable contacts. The contact holding member may be configured to be translated along a longitudinal axis of the battery pack between a first position and a second position. When the contact holding member is in the first position, the contacts may be configured to engage with contact pads of the battery pack to complete a power path (e.g., circuit) between battery cells of the battery pack and to connect the battery cells of the battery pack together in series. The contact pads of the battery pack may be configured to be connected to cell taps of the battery pack. When the contact holding member is in the second position, the contacts may be configured to be disengaged from the contact pads of the battery pack to break the power path between battery cells of the battery pack and to disconnect the battery cells of the battery pack.

In an aspect of the present patent application, the contacts may include leaf spring style contacts.

In an aspect of the present patent application, the first position may be a use configuration of the battery pack and the second position may be a shipping configuration for transportation of the battery pack.

In an aspect of the present patent application, the contact holding member may include a body portion configured to be connected with the contacts and configured to retain the contacts in place, a handle portion having a first cam surface, and connector portions configured to connect the handle portion and the body position. The handle portion may be configured to engage with the actuation component.

In an aspect of the present patent application, the shipping subassembly may further include a shipping subassembly base member, and a contact pad member that may include a plurality of fixed contact pads. The fixed contact pads may be insert molded within the shipping subassembly base member such that the fixed contact pads are exposed for contact with the movable contacts.

In an aspect of the present patent application, the shipping subassembly may further include a shipping subassembly cover member configured to connect with the shipping subassembly base member, and at least one spring configured to be connected between the contact holding member and the shipping subassembly base member. The shipping subassembly base member may be configured to receive the contact holding member along with the moveable contacts therein.

In an aspect of the present patent application, the shipping subassembly base member may include grooves configured to receive the connector portions of the contact holding member to allow the contact holding member to translate along the longitudinal axis of the battery pack and with respect to the shipping subassembly base member; and seal members configured to be positioned adjacent the grooves of the shipping subassembly base member and the connector portions of the contact holding member so as to seal the internal cavity of the battery pack. The shipping subassembly cover member and shipping subassembly base member may be configured to enclose the at least one spring, the seal members, and portions of the contact holding member along with the moveable contacts.

In an aspect of the present patent application, the at least one spring may be configured to bias the contact holding member in a first direction along the longitudinal direction of the battery pack and with respect to the shipping subassembly base member so as to position the contact holding member in the first position.

In an aspect of the present patent application, the actuation component may be configured to engage with the contact holding member to translate the contact holding member from the first position to the second configuration against the bias of the at least one spring and in an opposing second direction along the longitudinal axis of the battery pack.

In an aspect of the present patent application, the actuation component may include an actuation component body sized and configured to be received in the cavity of the handle of the shipping subassembly and an actuation element having a first end and second end, the actuation element configured to be connected to the actuation component body at the first end and the actuation element comprises a second cam surface at the second end.

In an aspect of the present patent application, portions of the actuation element are configured to extend into an opening to the internal cavity when the actuation component body is received in the cavity of the handle of the shipping subassembly, such that the second cam surfaces at the second end of the actuation element engage with the first cam surface of the handle portion of the contact holding member. Surface interactions between the second cam surfaces of the actuation element and the first cam surfaces of the handle portion of the contact holding member causes the contact holding member to translate from the first position to the second position against the bias of the springs and in an opposing second direction along the longitudinal axis of the battery pack.

In an aspect of the present patent application, the handle of the shipping subassembly may be integrally formed in the housing of the battery pack. The handle may be used by a user to carry the battery pack from one location to another location between use.

In an aspect of the present patent application, the battery pack may further include a subassembly support that is configured to support an electronics module subassembly and a terminal block on a top surface thereof and is configured to be connected with the shipping subassembly base member on a bottom surface thereof. The shipping subassembly base member may be connected to the shipping subassembly cover member on a top surface thereof to enclose the at least one spring, the seal members, and the contact holding member along with the moveable contacts between the shipping subassembly base member and the shipping subassembly cover member.

Another aspect of the present patent application provides a battery pack latching system for latching a battery pack to a device upon mating the battery pack to the device along a mating direction. The battery pack latching system comprises a first component with a first end for user engagement and a second end for rotation about a first rotation axis, and a second component with a first end for engagement with a portion of the device and a second end for rotation about a second rotation axis. The second rotation axis is generally parallel to the first rotation axis. The first component includes at least one shoulder between the first end and the second end and the second component includes at least one shoulder between the first end and the second end. The first component shoulder positioned to engage the second component shoulder upon rotation of the first component about the first rotation axis forcing the second component to rotate about the second rotation axis.

Implementations of the foregoing aspects may include one or more of the following features.

In an aspect of the present patent application, the first component may include a user actuation element for user engagement. The second component may include a latching element configured to engage with the portion of the device. The first end of the second component may include a latching element latching end. The second end of the second component may include a latching element rotating end. The first component shoulder engages the second component shoulder in an area, the latching element rotating end and the latching element latching end may be on opposite sides of a plane that is generally perpendicular to the mating direction and passes through the area.

In an aspect of the present patent application, the first end of the first component may include a user actuation element user end. The second end of the first component may include a user actuation element rotating end. The first component shoulder engages the second component shoulder in an area, the user actuation element rotating end and the user actuation element user end may be on opposite sides of a plane that is generally perpendicular to the mating direction and passes through the area.

In an aspect of the present patent application, the device is a charger.

In an aspect of the present patent application, the device is a cordless power tool.

In an aspect of the present patent application, the battery pack latching system may further include a spring assembly. The spring assembly having a first end and a second end. The first end of the spring assembly may be configured to be operatively connected to the second component and the second end of the spring assembly may be configured to be operatively connected to a housing of the battery pack. The spring assembly may be configured to bias the second component away from the housing.

In an aspect of the present patent application, when the first component shoulder engages the second component shoulder in an area, the second component may be forced to rotate about the second rotation axis against the bias of the spring assembly.

In an aspect of the present patent application, when the user actuation element is actuated by the user, the first component shoulder engages the second component shoulder upon rotation of the first component about the first rotation axis forcing the second component to rotate about the second rotation axis against the bias of the spring assembly. The rotation of the second component about the second rotation axis causes the latching element of the second component to disengage from the portion of the device.

A battery pack includes a set of discharge FETs. As a default, the discharge FETs are in an open state (when the battery pack is not connected to a power tool or a battery charger or when in an inactive or sleep state when connected to a power tool or a battery charger. As such, in the default state the Batt+/Batt− terminals are an open circuit (no potential). In this condition, when a tool (or a charger) is coupled to the pack, the tool (or the charger) will not receive any current (power) from the pack. In our present system, the tool (or the charger) and the battery pack includes a wake up circuit to wake up the battery pack and to close the discharge FETs and enable discharging and charging of the battery pack. The wake up circuit includes three parts: a battery pack wake up circuit, a first tool wake up circuit—for pack insertion (part of tool terminal block) and a second tool wake up circuit—for tool trigger pull (part of tool controller). In a default state, a signal from the pack microcontroller to the discharge FETs is in a first state which keeps the discharge FETs in an open state. The signal from the pack microcontroller to the discharge FETs is in the first state because a signal from the pack wake up circuit is in a first state. When the pack is fully inserted into the tool (or the charger) the first tool wake up circuit is activated and a signal in a first state is presented at the tool wake terminal (WK_{T}) which is coupled to the pack wake terminal (WK_{B}). The signal presented at the WK_{B} terminal changes the signal from the pack wake up circuit to the pack microcontroller to a second state. When the signal to the pack microcontroller changes to the second state, the pack microcontroller changes the signal to the discharge FETs to a second state. When the signal from the pack microcontroller to the discharge FETs is in the second state the discharge FETs are closed. As such, high current (power) is presented at the Batt+/Batt− terminals.

In order to ensure that that pack does not inadvertently discharge or present a safety issue when not being used, the wake up circuit as discussed above includes a timer. If a user does not activate the tool (trigger pull) before the timer expires, the wake up circuit will change the signal presented at the WK_{B}-WK_{T} terminals to a second state to open the discharge FETs. As such, the tool includes the second tool wake up circuit which is activated during a trigger pull. Upon trigger pull, the signal presented at the WK_{B}-WK_{T} terminals is the first state. As such, the pack will respond as noted above and close the discharge FETs. The second tool wake up circuit does not include a timer. As such, as long as the trigger is pulled, the signal in the first state will be presented to the WK_{B}-WK_{T} terminals. When the trigger is released, the signal presented at the WK_{B}-WK_{T} terminals will change to the second state and the discharge FETs will open, as described above.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

Each of the aspects described above and in the following description can be used in any combination of one or more of these aspects, as will be understood to one of ordinary skill in the art.

### BRIEF DESCRIPTION OF THE DRAWINGS

FIGS. 1 and 2 show an example power tool system in accordance with an embodiment of the present patent application;

FIG. 3 shows a rear end view of a battery pack in accordance with an embodiment of the present patent application;

FIG. 4 shows a left side view of the battery pack;

FIG. 5 shows a front end view of the battery pack;

FIG. 6 shows a right side view of the battery pack;

FIG. 7 shows a top plan view of the battery pack;

FIG. 8 shows a bottom plan view of the battery pack;

FIGS. 9-18 show various perspective views of the battery pack;

FIG. 19 shows a perspective view of the battery pack along with its dimensions in accordance with an embodiment of the present patent application;

FIG. 20 shows an exploded view of an upper housing portion and a latch system that is configured to latch the battery pack with an electrical device;

FIGS. 21-24 show perspective views of the upper housing portion and steps for assembling the latch system;

FIG. 25 shows a rear view of the upper housing portion showing portions of the latch system and a State of Charge (SOC) indicator and a cover of a battery pack latching system;

FIGS. 26-30 show cross-sectional views of the latch system, wherein FIGS. 26 and 28A show the latch system in its latch configuration, wherein FIGS. 27, and 28B-29 show the latch system in its unlatched configuration, wherein FIGS. 26-27 show the cross-sectional views of the latch system taken along an axis C-C in FIG. 25, wherein FIGS. 28A-28B show the cross-sectional views of the latch system taken along an axis D-D in FIG. 25, wherein FIG. 29 show the cross-sectional views of the latch system taken along an axis C-C in FIG. 25, and wherein, FIG. 30 shows a cross-sectional view of the latch system, in its unlatched configuration, taken along an axis E-E in FIG. 25;

FIGS. 31 and 32 show a perspective view and a front view, respectively, of the battery cell holder collection straps of a battery cell module;

FIGS. 33 and 34 show a front view and a perspective view, respectively, of a battery cell holder of the battery cell module, wherein the battery cell holder is injection molded around the battery cell holder collection straps of FIGS. 31 and 32;

FIGS. 35 and 36 show perspective views of the battery cell holder, wherein FIG. 35 shows the battery cell holder before gap pads are installed/disposed in the battery cell holder and FIG. 36 shows the battery cell holder after the gap pads are installed/disposed in the battery cell holder;

FIG. 37 shows an exploded view of the battery cell holder, battery cells, and gap pads of the battery cell module, wherein FIG. 37 shows the battery cell holder before the battery cells and the gap pads are installed/disposed in the battery cell holder;

FIG. 38 shows a front view of the battery cell holder with the battery cells and the gap pads installed/disposed therein;

FIG. 39 shows a perspective view of the battery cell holder with the battery cells and the gap pads installed/disposed therein and an end gap pad and an end insulated layer before the end gap pad and the end insulating layer are installed/disposed at the ends of the battery cell holder;

FIG. 40 shows a front view of a battery cell module of the battery pack;

FIG. 41 shows a perspective view of a module holder of the battery pack and a first battery cell module before that battery cell module is installed/disposed in the module holder;

FIG. 42 shows a perspective view of the module holder with the first battery cell module installed/disposed therein and a first end member of the module holder before the first end member is attached to the module holder;

FIG. 43 shows a perspective view of the module holder with the first battery cell module installed/disposed therein and a second battery cell module and a third battery cell module before they are installed/disposed in the module holder;

FIGS. 44 and 45 show a front view and a perspective view of the module holder with the three battery cell modules installed/disposed therein;

FIGS. 46-47 show a side view and a perspective view of a cell holder subassembly;

FIG. 48 shows a (top down) cross-sectional view of the cell holder subassembly of FIGS. 46-47;

FIG. 49 shows a perspective view of a (metal) contact stamped pattern of a shipping system subassembly of the battery pack;

FIG. 50 shows a perspective view of the stamped pattern of FIG. 49 and a base member of the shipping system subassembly;

FIG. 51 shows the stamped pattern and the base member wherein portions of the stamped pattern have been removed;

FIG. 52 shows a perspective view of contacts of the shipping system subassembly;

FIG. 53 shows a perspective view of the contacts of FIG. 52 insert molded into a contact holding member of the shipping system subassembly;

FIG. 54 shows a perspective view of the contact holding member of FIG. 53 placed in the base member of FIG. 51;

FIG. 55 shows a top plan view of the contact holding member placed in the base member of FIG. 54, wherein the contact holding member is in a use position;

FIGS. 56 and 57 show perspective views of the shipping system subassembly of a shipping system of the battery pack, wherein the contact holding member is in the use position and the shipping system subassembly is in a use mode;

FIG. 58 shows a top plan view of the shipping system subassembly of FIG. 57;

FIG. 59 shows a top plan view of the shipping system subassembly of FIG. 58, wherein a cover is removed and the base member is transparent;

FIG. 60 shows a top plan view of the base member of FIG. 51 and the contacts of FIG. 52, wherein the base member is transparent and the contacts are in the use position;

FIG. 61 shows a cross-sectional view of the battery pack and a shipping mode actuator;

FIG. 62 shows a detail cross-sectional view of the battery pack, wherein the shipping system is in the use mode;

FIG. 63 shows a top perspective view of the lower housing with the cell holder subassembly and the shipping system subassembly (with the cover removed) received therein, wherein the shipping system subassembly is in the use mode;

FIGS. 64 and 65 show top plan views of FIG. 63, wherein the contact holding member and the contacts are removed and wherein FIG. 65 shows the base member as transparent;

FIGS. 66 and 67 show top plan views of FIG. 63, wherein FIG. 67 shows the base member as transparent;

FIGS. 68 and 69 top plan views of FIG. 63, wherein the contact holding member is removed and wherein FIG. 69 shows the base member as transparent;

FIG. 70 shows a partial side cross-sectional view of the battery pack with the shipping mode actuator being partially inserted therein, wherein the shipping system is in an intermediate position/configuration between the use mode and the shipping mode;

FIG. 71 shows a cross-sectional view of the battery pack with the shipping mode actuator inserted therein, wherein the shipping system is in the shipping mode;

FIG. 72 shows a detail cross-sectional view of FIG. 71;

FIG. 73 shows a top plan view of the battery pack, wherein the upper portion of the battery pack is not shown to better illustrate other portions of the battery pack;

FIG. 74 shows a top perspective view of the lower housing with the cell holder subassembly and the shipping system subassembly (with the cover removed) received therein, wherein the shipping system subassembly is in the shipping mode;

FIGS. 75 and 76 show top plan views of FIG. 74, wherein FIG. 76 shows the base member as transparent;

FIGS. 77 and 78 show top plan views of FIG. 74, wherein the contact holding member is removed and wherein FIG. 78 shows the base member as transparent;

FIGS. 79 and 80 show top plan views of the shipping system subassembly (with the cover removed), wherein the contact holding member is in the shipping position and wherein FIG. 80 shows the base member as transparent;

FIG. 81 shows a top plan view of FIG. 80, wherein the contact holding member is removed;

FIGS. 82-85 show perspective views of nested terminal portions of a power terminal of the battery pack;

FIGS. 86-91 show a top plan view, a bottom plan view, a left side view, a right side view, a front view, and a rear view, respectively, of the nested terminal portions of FIGS. 82-85;

FIG. 92 shows a top perspective view of a battery pack terminal block housing of the battery pack;

FIG. 93 shows a bottom perspective view of the battery pack terminal block housing including metal, insert molded terminal bases;

FIG. 94 shows a top perspective view of the battery pack terminal block housing including a set of first terminals;

FIG. 95 shows a bottom perspective view of the battery pack terminal block housing of FIG. 94;

FIGS. 96-99 show top perspective views of the battery pack terminal block;

FIG. 100 shows a top plan view of the battery pack terminal block of FIGS. 96-99;

FIG. 101 shows a bottom perspective view of the battery pack terminal block;

FIGS. 102-103 show bottom perspective views of the battery pack terminal block, wherein the battery pack terminal block housing is shown as transparent in FIG. 103;

FIG. 104 shows a top perspective view of the battery pack terminal block of FIG. 102;

FIG. 105 shows a partial right side cross-sectional view of the battery pack terminal block;

FIGS. 106-108 show perspective views of an electronics module subassembly of the battery pack, wherein FIG. 106 shows a printed circuit board of the electronics module subassembly, FIG. 107 shows electronic components disposed on the printed circuit board, FIG. 108 shows flexible circuits, connectors and electronic components disposed on the printed circuit board;

FIGS. 109-110 show a perspective view and a bottom plan view of the electronics module subassembly of the battery pack and the terminal block connected thereto;

FIGS. 111-112 show a perspective view and a bottom plan view of a subassembly holder/platform/support/base of the battery pack;

FIG. 113 shows an exploded perspective view of the subassembly holder, the shipping system subassembly and the electronics module subassembly;

FIGS. 114-115 show a top perspective view and a bottom plan view of the subassembly holder and the shipping system subassembly, wherein the subassembly holder and the shipping system subassembly are aligned with each other and before being connected to each other;

FIG. 116 shows a bottom plan view of the subassembly holder and the shipping system subassembly after the subassembly holder and the shipping system are connected to each other;

FIG. 117 shows a perspective view of the subassembly holder and the shipping system subassembly of FIG. 114, wherein spacers have been added to the subassembly holder;

FIGS. 118-119 show a top plan view and a perspective view of the subassembly holder, the shipping system subassembly, the battery pack terminal block, the electronics module subassembly and a state of charger subassembly;

FIG. 120 shows a cross-sectional view of the battery pack terminal block along with portions of the assembled subassembly holder, shipping system subassembly and electronics module subassembly;

FIG. 121 shows a cross-sectional view of the battery pack terminal block along with portions of the assembled subassembly holder, shipping system subassembly and the electronics module subassembly;

FIG. 122 shows a perspective view of the subassembly holder, the shipping system subassembly, the battery pack terminal block, the electronics module subassembly, and the state of charge subassembly, wherein potting material is applied to the electronics module subassembly and is received in the subassembly;

FIGS. 123-124 show exploded perspective views of the cell holder subassembly (e.g., the module holder with the three battery cell modules) of FIG. 47 and the assembled subassembly holder, battery pack terminal block, shipping system subassembly, electronics module subassembly, and state of charger subassembly of FIG. 122 before they are connected to each other;

FIGS. 125-129 show perspective views, a top plan view and a rear view of a corepack of the battery pack including the cell holder subassembly and the assembled subassembly holder, battery pack terminal block, shipping system subassembly, electronics module subassembly, and state of charge subassembly wherein FIG. 125 shows them after they are aligned but before they are connected to each other, wherein FIGS. 126-129 show them after they are connected to each other;

FIGS. 130-134 show a bottom perspective view, a front view, two top perspective views, a side view, respectively, of the upper housing portion of the battery pack;

FIGS. 135-137 show perspective views and a plan view, respectively, of the corepack of FIG. 127 received in and aligned with the upper housing portion;

FIG. 138 shows a plan view of the corepack received in and connected to the upper housing portion and a gasket at a mating surface of the upper housing portion;

FIG. 139 shows a top perspective view of the lower housing portion of the battery pack;

FIG. 140 shows a top perspective view of the lower housing portion of the battery pack and a gasket at a mating surface of the lower housing portion;

FIG. 141 shows a perspective view of the battery pack;

FIG. 142 shows a front perspective, cross-sectional view of the battery pack;

FIG. 143 shows a detail view of FIG. 142;

FIG. 144 shows a front perspective view of the battery pack;

FIGS. 145-146 show perspective views of the corepack received in the lower housing portion and a gasket at a mating surface of the lower housing portion, wherein the upper housing is not shown to better illustrate other portions of the battery pack;

FIG. 147 shows a partial cross-sectional view of the battery pack showing a first gasket at the mating surface between the upper housing portion and the lower housing portion and a second gasket at a mating surface between the upper housing portion and the terminal block housing;

FIG. 148 shows an example battery adaptor;

FIG. 149 shows an example power tool interface;

FIG. 150 shows an example battery pack;

FIG. 151 shows an example battery pack charger;

FIGS. 152-153 show a perspective view and a top plan view, respectively, of an example power tool (rammer);

FIG. 154 shows another perspective view of the example power tool (rammer);

FIGS. 155-156 show perspective views of another example power tool (plate compactor);

FIGS. 157-159 show perspective views of the battery pack and an example battery pack charger;

FIG. 160 shows a perspective view of an actuation component prior to being received in a handle cavity;

FIG. 161 shows a perspective view of the actuation component received in the handle cavity;

FIGS. 162 and 163 show a top perspective view and a bottom perspective view, respectively, of a latching element of a battery pack latching system in accordance with an embodiment of the present patent application;

FIGS. 164-166 show a top perspective view, a bottom perspective view, and a side perspective view, respectively, of a user actuation element of the battery pack latching system in accordance with an embodiment of the present patent application;

FIG. 167 shows a side view of the latching element of FIG. 162 and the user actuation element of FIG. 164 engaged with each other;

FIG. 168 shows a top plan view of the latching element of FIG. 162 and the user actuation element of FIG. 164 engaged with each other;

FIGS. 169-171 show top perspective views of the latching element of FIG. 162 and the user actuation element of FIG. 164 engaged with each other;

FIGS. 172-173 show bottom perspective views of the latching element of FIG. 162 and the user actuation element of FIG. 164 engaged with each other;

FIG. 174 shows a partial top plan view of the battery pack showing a cavity in the upper housing portion for receiving portions of the battery pack latching system;

FIGS. 175 and 176 show perspective views of a spring system of the battery pack latching system received in the cavity of the upper housing portion;

FIGS. 177 and 178 shows perspective views of the user actuation element of the battery pack latching system received in the cavity of the upper housing portion;

FIG. 179 show a top plan view of FIG. 178;

FIG. 180 shows a cross-sectional view taken along section line A-A of FIG. 179;

FIGS. 181 and 182 show perspective views of the latch element of the battery pack latching system received in the cavity of the upper housing portion;

FIGS. 183-184 show a perspective view and a top plan view the user actuation element and the latch element of the battery pack latching system received in the cavity of the upper housing portion;

FIG. 185 a cross-sectional view taken along section line B-B of FIG. 184, wherein the latch system is in its latched position;

FIG. 185 a cross-sectional view taken along section line B-B of FIG. 184, wherein the latch system is in its unlatched position;

FIG. 186 shows a partial perspective view of the battery pack upper housing portion showing the user actuation element, the latch element, and a latch cover of the battery pack latch system;

FIG. 188 shows a bottom perspective view of the user actuation element, the latch element, the latch cover, and the spring system of the battery pack latch system;

FIGS. 189-191 show perspective views of the spring system of the battery pack latch system; and

FIGS. 192-194 show side views of another example embodiment of a battery pack latch system.

FIG. 195 shows a front, bottom, left side view of another example battery pack of the present application.

FIG. 196 shows a plan view of an example terminal block of the battery pack of FIG. 195.

FIGS. 197A and 197B show the terminal block of FIG. 196 coupled to an example printed circuit board of the battery pack of FIG. 195.

FIG. 198 shows an example schematic block diagram of the battery pack of FIG. 195.

FIG. 199 shows an example schematic diagram of a charge path and a discharge path of the battery pack of FIG. 195.

FIG. 200 shows a block diagram of an example controller of the battery pack of FIG. 195.

FIG. 201 shows a block diagram of another example controller of the battery pack of FIG. 195.

FIG. 202 shows a block diagram of another example controller of the battery pack of FIG. 195.

FIG. 203-209 show schematic diagrams of various example circuits of the battery pack of FIG. 195.

FIGS. 210 and 211 show various views of an example power tool of the present application.

FIG. 212 shows a plan view of an example terminal block of the power tool of FIG. 210.

FIG. 213 shows a schematic block diagram of the power tool of FIG. 210.

FIG. 214 shows a plan view of an example terminal block and circuit board of the power tool of FIG. 210.

FIG. 215 shows a schematic diagram of an example circuit of the power tool of FIG. 210.

FIG. 216 shows a schematic block diagram of an example control unit of the power tool of FIG. 210.

FIGS. 217 and 218 show schematic diagrams of example circuits of the power tool of FIG. 210.

FIG. 219 shows a schematic block diagram of the power tool of FIG. 210 coupled to the battery pack of FIG. 195.

FIGS. 220-226 show an insertion sequence of the battery pack of FIG. 195 mating with the power tool of FIG. 210.

FIG. 227 shows a top plan view of an example battery charger of the present application.

FIG. 228 shows an example terminal block of the battery charger of FIG. 227.

FIG. 229 shows an example schematic block diagram of the battery charger of FIG. 227.

FIG. 230 shows a block diagram of an example controller of the battery charger of FIG. 227.

FIG. 231 shows a block diagram of another example controller of the battery charger of FIG. 227.

FIGS. 232-234 show schematic diagrams of example circuits of the battery charger of FIG. 227.

FIG. 235 shows a schematic block diagram of the battery pack of FIG. 195 coupled to the battery charger of FIG. 227.

FIGS. 236 and 237 show graphs of the operation of the battery charger of FIG. 227.

FIGS. 238-243 show insertion sequence of the battery pack of FIG. 195 mating with the battery charger of FIG. 227.

FIG. 244 shows an isometric of an example adaptor of the present application prior to receiving an example battery pack of the present application.

FIGS. 245 and 246 show views of the adaptor of FIG. 244.

FIG. 247 shows an example terminal block of the adaptor of FIG. 245.

FIGS. 248 and 249 show views of an example set of terminals mated to an example printed circuit board of the adaptor of FIG. 245.

FIG. 250 shows a schematic block diagram of the adaptor of FIG. 245.

FIG. 251 shows a block diagram of an example controller of the adaptor of FIG. 245.

FIGS. 252-254 show schematic diagrams of example circuits of the adaptor of FIG. 245.

FIG. 255 shows a schematic block diagram of the adaptor and the battery pack of FIG. 244 coupled together.

FIGS. 256-259 show various views of the adaptor and the battery pack of FIG. 244 coupled to an example power tool of the present application.

FIG. 260 shows a schematic block diagram of the adaptor, the battery pack and the power tool of FIGS. 256-259.

FIGS. 261-267 shows an insertion sequence of the adaptor of FIG. 245 mating with the power tool of FIG. 256.

FIGS. 268-271 shows an insertion sequence of the adaptor of FIG. 245 mating with the battery charger of FIG. 227.

FIGS. 272-274 show various views of another example adaptor of the present application.

FIG. 275 shows an example schematic block diagram of the adaptor of FIG. 272.

FIG. 276 shows a block diagram of an example controller of the adaptor of FIG. 272.

FIGS. 277-279 show schematic diagrams of example circuits of the adaptor of FIG. 272.

FIGS. 280-282 show various views of an example power tool of the present application prior to mating with the adaptor of FIG. 256.

FIGS. 283-286 show various views of the adaptor of FIG. 256 mated with the power tool of FIG. 280.

FIG. 287 shows a schematic block diagram of the adaptor and power tool of FIG. 283.

FIG. 288 shows a schematic diagram of an example circuit of the power tool of FIG. 283.

FIGS. 289-291 show various views of the battery pack of FIG. 195 prior to mating with the adaptor and power tool of FIG. 283.

FIGS. 292-294 show various views of the battery pack of FIG. 195 mated with the adaptor and power tool of FIG. 283.

FIG. 295 shows a schematic block diagram of the battery pack, the adaptor and the power tool of FIG. 292.

FIG. 296 shows a schematic block diagram of the battery pack and adaptor of FIG. 255 mated to adaptor and power tool of FIG. 287.

### DETAILED DESCRIPTION

Additional details of embodiments of various battery packs and power tools considered within the scope of the present disclosure can be found in at least U.S. Provisional Patent Application Nos. 62/636,395, 62/853,694, 62/636,568, 63/359,940, 63/533,751, 63/533,754, 63/533,755, 63/533,758, 63/578,008; U.S. patent application Ser. No. 18/114,121; U.S. Pat. No. 9,406,915; European Patent Application Nos. EP22202110.7, EP22194105.7, EP23163288.6, and EP23192793.0; PCT Patent Application Nos. PCT/EP2022/074710, PCT/EP2023/072939, PCT/EP2023/072638, and PCT/EP2023/072679; and U.K. Patent Application Nos. GB2112789.9, GB2209009.6, and GB2218350.3. The disclosures of each of the above applications and patents are hereby incorporated by reference in their entirety.

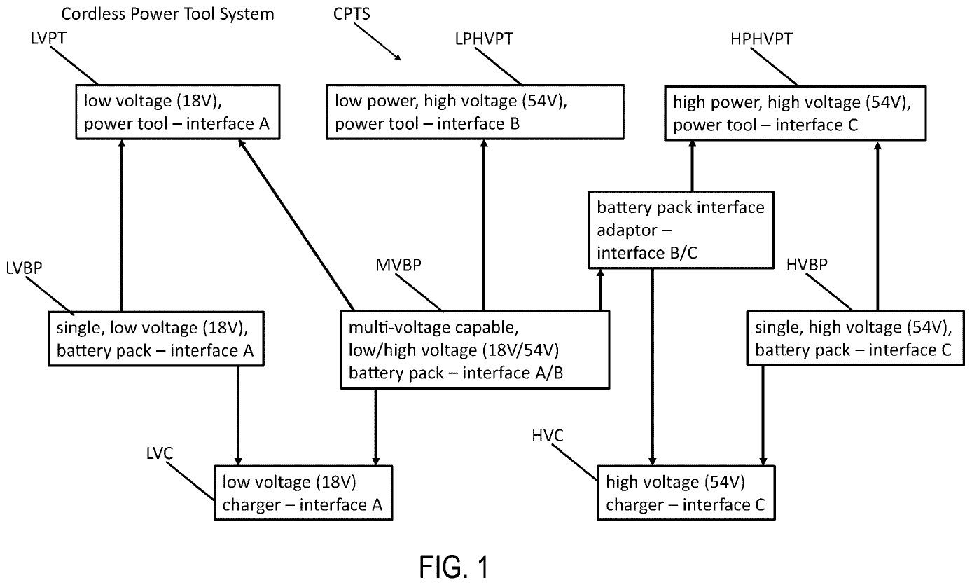

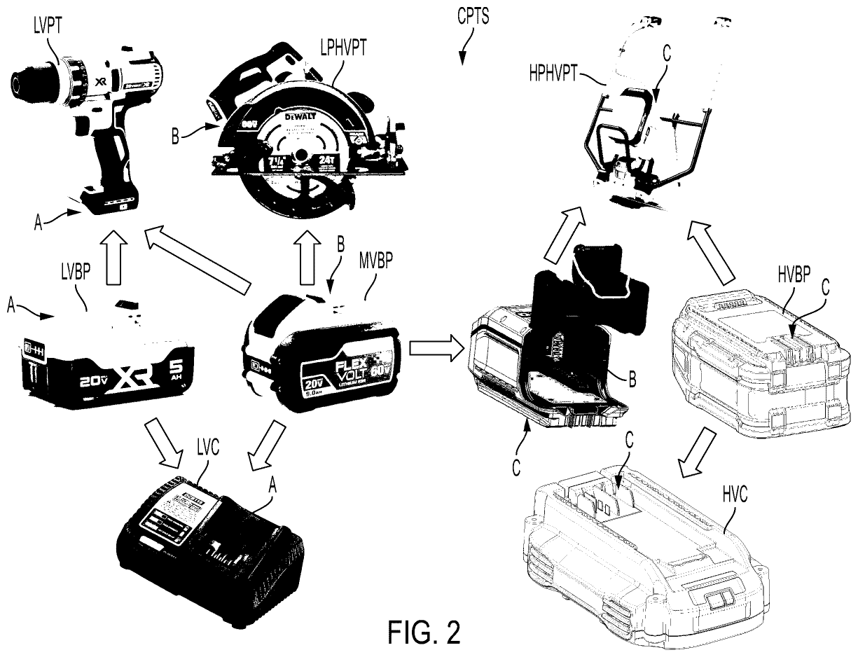

Referring to FIGS. 1-2, the present patent application provides a cordless power tool system (CPTS). The CPTS may include a first power tool, a second power tool, a third power tool, a first battery pack, and a second battery pack. The first power tool may include a high power, high voltage power tool (HPHVPT). The HPHVPT may have a first power tool rated voltage (e.g., 54 volts (V)). The HPHVPT may have a first power tool interface (e.g., interface C). The second power tool may include a low power, high voltage power tool (LPHVPT). The LPHVPT may have the second power tool rated voltage (e.g., 54V). The LPHVPT may have the second power tool interface (e.g., interface B) that is different from the first power tool interface (e.g., interface C). The third power tool may include a low voltage power tool (LVPT). The LVPT may have the third power tool rated voltage (e.g., 18V). The LVPT may have the third power tool interface (e.g., interface A) that is different from the first power tool interface (e.g., the interface C) and the second power tool interface (e.g., the interface B).

Referring to FIGS. 1-2, in one example embodiment, the CPTS may include a high voltage battery pack (HVBP) 100 and a set of cordless HPHVPT (one shown). The CPTS also may include a high voltage charger HVC. Each of the cordless power tools of the set of cordless power tools may be powered by the HVBP 100. The set of power tools may include, for example, a screed, a concrete plate compactor, a rammer, a concrete vibrator powerpack, a concrete vibrator backpack, and a concrete/core drill. It is understood that the HPHVPT illustrated in FIGS. 1-2 are examples and that other power devices are contemplated to be included as part of the CPTS, even though not illustrated. In one example implementation, the HPHVPT have an operating voltage of 54V. Each HPHVPT may include a receptacle for receiving the HVBP 100. The power tool receptacle may include an interface for mating with the HVBP 100. The battery pack receptacle may be configured with one interface for receiving one removable, rechargeable battery pack, for example, from the HVBP 100.

The first battery pack may be a single (fixed) voltage (high voltage) battery pack (HVBP). The HVBP may have a first nominal voltage (e.g., 54V) that is substantially the same as the first power tool rated voltage (e.g., 54V). The HVBP may have the first battery pack interface (e.g., the interface C) that is connectable to the first power tool interface (i.e., the interface C) to provide power to the HPHVPT. The first battery pack interface (e.g., the interface C) of the HVBP is not connectable to the second power tool interface (e.g., the interface B) or the third power tool interface (e.g., the interface A).

The second battery pack may be a multi-voltage capable, low voltage/high voltage battery pack (MVBP). The MVBP may have a second battery pack interface (e.g., the interface A/B) that is coupleable to the second power tool interface (e.g., the interface B) of the LPHVPT and that is coupleable to the third power tool interface (i.e., the interface A) of the LVPT.

The MVBP may have the first nominal voltage (e.g., 54V) that is substantially the same as the first power tool rated voltage (e.g., 54V) when the MVBP is coupled to the HPHVPT or connected to the LPHVPT and may have a second nominal voltage (e.g., of 18V) that is substantially the same as the third power tool rated voltage (e.g., 18V) when the MVBP is connected to the LVPT. The MVBP is configured to be coupled to the HPHVPT to provide power to the HPHVPT (e.g., it will require the adaptor to couple the MVBP and the HPHVPT). It is noted that, in the present patent application, the battery and the power tool may be “connected” when there is no adaptor, while the battery and the power tool may be “coupled” when there is an adaptor. The MVBP may also be configured to be connected to the LVPT to provide power to the LVPT.

The CPTS may further comprise an adaptor 3000 having a first adaptor interface (e.g., interface C) configured to be connected to the first power tool interface (e.g., the interface C) of the HPHVPT and a second adaptor interface (e.g., interface B) configured to be connected to the second battery pack interface (e.g., the interface A/B) of the MVBP to couple the MVBP to the HPHVPT.

The second battery pack interface (e.g., the interface A/B) of the MVBP is not able to be coupled to the first power tool interface (e.g., the interface C) of the HPHVPT without the adaptor 3000.

The rated voltage of the HPHVPT and the rated voltage of the LPHVPT are the same. The rated voltage of the HPHVPT and the rated voltage of the LPHVPT may be 54V.

The nominal voltage of the HVBP and the nominal voltage of the MVBP may be the same. The nominal voltage of the HVBP and the nominal voltage of the MVBP may be 54V.

The third battery pack may be a single (fixed) voltage (low voltage) battery pack (LVBP). The LVBP may have the second nominal voltage (e.g., 18V) that is substantially the same as the third power tool rated voltage (e.g., 18V). The LVBP may have a third battery pack interface (e.g., the interface A) that is connectable to the third power tool interface (e.g., the interface A) of the third power tool HPHVPT. The third battery pack LVBP may have a third battery pack interface (e.g., the interface A) that is not connectable to the first power tool interface (e.g., the interface C) of the HPHVPT or the second power tool interface (e.g., the interface B) of the LPHVPT.

As used in this application, rated voltage may refer to the advertised voltage, or the operating voltage, depending on the context. The rated voltage may also encompass a single (fixed) voltage, several discrete voltages, or one or more ranges of voltages. As used in the application, rated voltage may refer to any of these types of voltages or a range of any of these types of voltages.

Advertised Voltage: With respect to power tools, battery packs, and chargers, the advertised voltage generally refers to a voltage that is designated on labels, packaging, user manuals, instructions, advertising, marketing, or other supporting documents for these products by a manufacturer or seller so that a user is informed which power tools, battery packs, and chargers will operate with one another. The advertised voltage may include a numeric voltage value, or another word, phrase, alphanumeric character combination, icon, or logo that indicates to the user which power tools, battery packs, and chargers will work with one another. In some embodiments, as discussed below, a power tool, battery pack, or charger may have a single advertised voltage (e.g., 20V or 60V), a range of advertised voltages (e.g., 20V-60V), or a plurality of discrete advertised voltages (e.g., 20V/60V). As discussed further below, a power tool may also be advertised or labeled with a designation that indicates that it will operate with both a DC power supply and an AC power supply (e.g., AC/DC or AC/60V). An AC power supply may also be said to have an advertised voltage, which is the voltage that is generally known in common parlance to be the AC mains voltage in a given country (e.g., 120 VAC in the United States and 220 VAC-240 VAC in Europe).

Operating Voltage: For a power tool, the operating voltage generally refers to a voltage or a range of voltages of AC and/or DC power supply (ies) with which the power tool, its motor, and its electronic components are designed to operate. For example, a power tool advertised as a 120V AC/DC tool may have an operating voltage range of 92V-132V. The power tool operating voltage may also refer to the aggregate of the operating voltages of a plurality of power supplies that are coupled to the power tool (e.g., a 120V power tool may be operable using two 60V battery packs connected in series). For a battery pack and a charger, the operating voltage refers to the DC voltage or range of DC voltages at which the battery pack or charger is designed to operate. For example, a battery pack or charger advertised as a 60V battery pack or charger may have an operating voltage range of 51V-60V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS operating voltage of 120V and an average positive operating voltage of 108V.

Nominal Voltage: For a battery pack, the nominal voltage generally refers to the average DC voltage output from the battery pack. For example, a battery pack advertised as a 60V battery pack, with an operating voltage of 51V-60V, may have a nominal voltage of 54V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS nominal voltage of 120V and an average positive nominal voltage of 108V.

Maximum Voltage: For a battery pack, the maximum voltage may refer to the fully charged voltage of the battery pack. For example, a battery pack advertised as a 60V battery pack may have a maximum fully charged voltage of 60V. For a charger, the maximum voltage may refer to the maximum voltage to which a battery pack can be recharged by the charger. For example, a 60V charger may have a maximum charging voltage of 60V.

It should also be noted that certain components of the power tools, battery packs, and chargers may themselves be said to have a voltage rating, each of which may refer to one or more of the advertised voltage, the operating voltage, the nominal voltage, or the maximum voltage. The rated voltages for each of these components may encompass a single voltage, several discrete voltages, or one or more ranges of voltages. These voltage ratings may be the same as or different from the rated voltage of power tools, battery packs and chargers. For example, a power tool motor may be said to have its own an operating voltage or range of voltages at which the motor is designed to operate. The motor rated voltage may be the same as or different from the operating voltage or voltage range of the power tool. For example, a power tool having a voltage rating of 60V-120V may have a motor that has an operating voltage of 60V-120V or a motor that has an operating voltage of 90V-100V.

The power tools, power supplies, and chargers also may have ratings for features other than voltage. For example, the power tools may have ratings for motor performance, such as an output power (e.g., maximum watts out (MWO) as described in U.S. Pat. No. 7,497,275, which is incorporated by reference herein in its entirety-“the '275 patent”) or motor speed under a given load condition. In another example, the battery packs may have a rated capacity, which refers to the total energy stored in a battery pack. The battery pack rated capacity may depend on the rated capacity of the individual cells and the manner in which the cells are electrically connected.

This application also refers to the ratings for voltage (and other features) using relative terms such as low, medium, high, and very high. The terms low rated, medium rated, high rated, and very high rated are relative terms used to indicate relative relationships between the various ratings of the power tools, battery packs, AC power supplies, chargers, and components thereof, and are not intended to be limited to any particular numerical values or ranges. For example, it should be understood that a low rated voltage is generally lower than a medium rated voltage, which is generally lower than a high rated voltage, which is generally lower than a very high rated voltage.

Each of the power tools—LVPT, LPHVPT or HPHVPT—may include a housing. Each power tool housing may incorporate components/elements such as a motor and a working element of the power tool. Each of the power tools LVPT, LPHVPT or HPHVPT may also include a motor control circuit and a battery pack interface that are configured to enable operation from one or more DC battery pack power supplies that together have a rated voltage that corresponds to the rated voltage of the power tool. The motor may be any brushed or brushless DC electric motor, including, but is not limited to, a permanent magnet brushless DC motor (BLDC), a permanent magnet DC brushed motor (PMDC), an induction motor, a universal motor, etc. The motor control circuit may include a power unit having one or more power switches (not shown) disposed between the power supply and the motor. The power switch may be an electromechanical on/off switch, a power semiconductor device (e.g., diode, FET, BJT, IGBT, etc.), or a combination thereof. The motor control circuit may further include a control unit or controller. The control unit may be arranged to control a switching operation of the power switches in the power unit. The motor control circuit may control the motor in fixed or variable speed. The control unit may include a micro-controller or similar programmable module configured to control gates of power switches. Additionally or alternatively, the control unit may be configured to monitor and manage the operation of the DC battery pack power supplies. Additionally or alternatively, the control unit may be configured to monitor and manage various tool operations and conditions.

The LVPT may include, but is not limited to, at least one of the following power tools: a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger. The LVPT may be configured to operate at a rated voltage of 18 V.

The LVPT may be configured to be powered by a single LVBP, which may be charged using an LVC that is designed and configured to charge the LVBP. The LVPT, the LVBP, and the LVC may have the same interface (e.g., the interface A). The interfaces may be configured for electrically and physically coupling the LVBP with the LVPT and/or the LVC.

The LPHVPT may be configured to operate at a rated voltage of 54 V. The power tool interface of the LPHVPT may be referred to as interface B in this patent application. The LPHVPT may include, but is not limited to, at least one of the following power tools: a circular saw, a drill, a grinder, a miter saw, a reciprocating saw, a rotary hammer, or a table saw.

The LPHVPT may be configured to be powered by a MVBP, which may be charged using a LVC. The LVC may be designed and configured to charge either the LVBP or the MVBP. The MVBP may be configured to power either the LVPT or the LPHVPT. The MVBP is also described in detail in U.S. Pat. No. 9,406,915, which is incorporated herein in its entirety.

The MVBP interface may incorporate two interfaces (e.g., the interface A and the interface B). The LPHVPT and the MVBP may both include the same interface (e.g., the interface B). The LVPT and the MVBP may both include the same interface (e.g., the interface A). The interface A may be configured for electrically and physically coupling the MVBP with the LVPT and/or LVC and the interface B may be configured for electrically and physically coupling the MVBP with the LPHVPT using the adaptor 3000.

The HPHVPT may be configured to operate at a rated voltage of 54V or higher. The power tool interface of the HPHVPT may be referred to as the interface C in this patent application. The HPHVPT may include, but is not limited to, at least one of the following power tools: a jack hammer a concrete drill, a concrete saw, a 12 inch cut-off saw, a concrete vibrator, a plate/concrete plate compactor, a rammer, or a screed/concrete screed. Such HPHV power tools are also described in detail in U.S. Patent Application Publication Number 2023-0291049, which is incorporated herein in its entirety. These power tools may require a relatively high amount of power and/or runtime compared to the LPHVPT. The HPHVPT may also include, but is not limited to, a concrete mixer, a jobsite lift, a block saw, a concrete finisher, an early entry saw, and a jobsite buggy, they may be referred to as very high power tools. These power tools may have the relatively high operating voltage. These power tools may require a relatively high amount of power and/or runtime compared to the LPHVPT.

The HPHVPT may be configured to be powered by a HVBP, which may be charged using a HVC that is designed and configured to charge the HVBP. The HPHVPT, the HVBP, and the HVC may have the same interface (e.g., the interface C). The interfaces may be configured for electrically and physically connecting the HVBP with the HPHVPT and/or the HVC.

However, it will be understood by those skilled in the art that the teachings of the present patent application are not so limited.

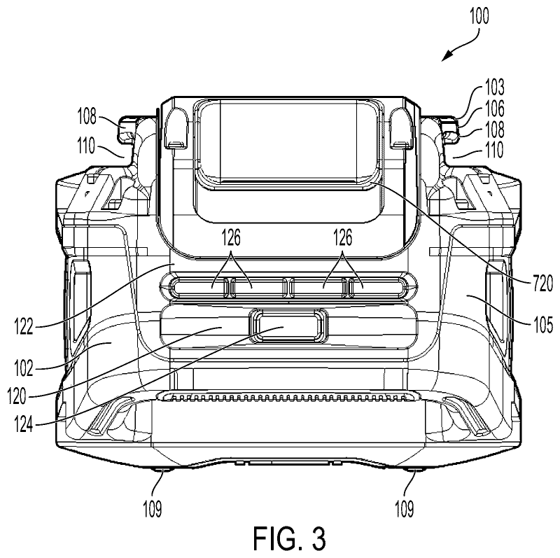

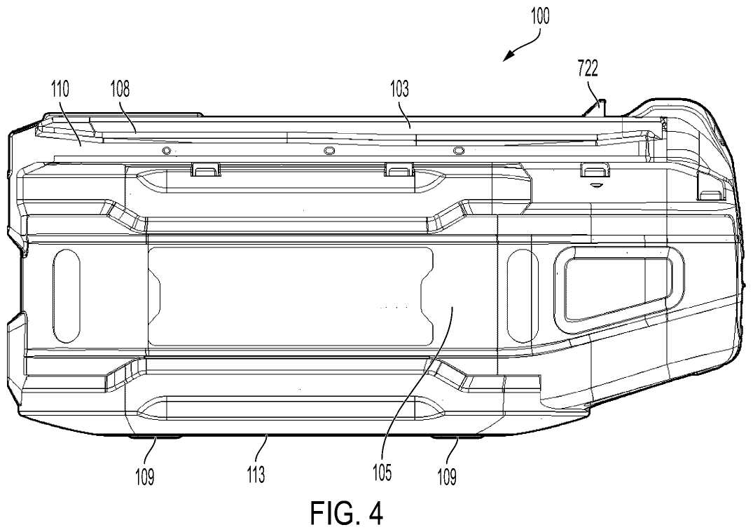

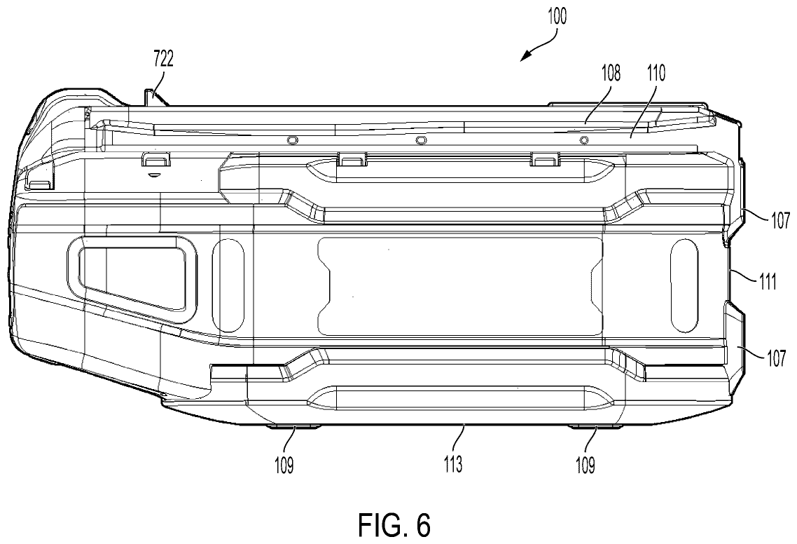

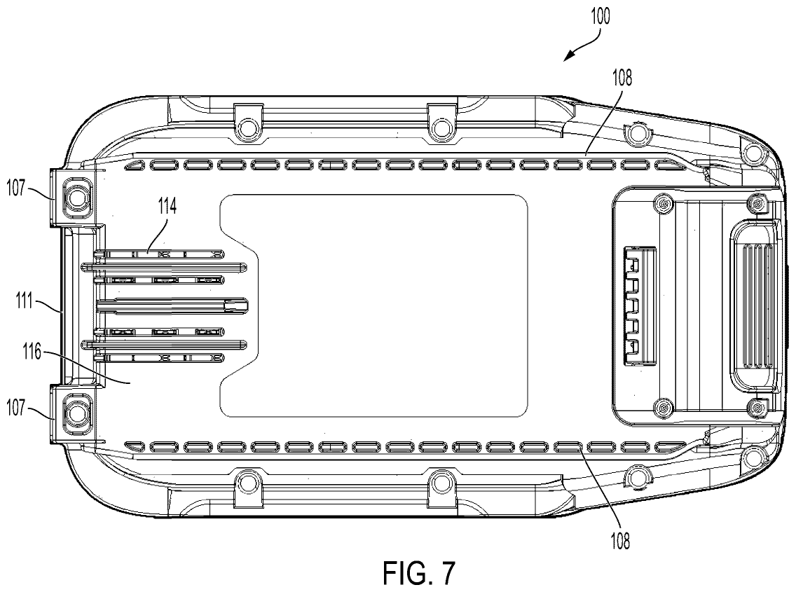

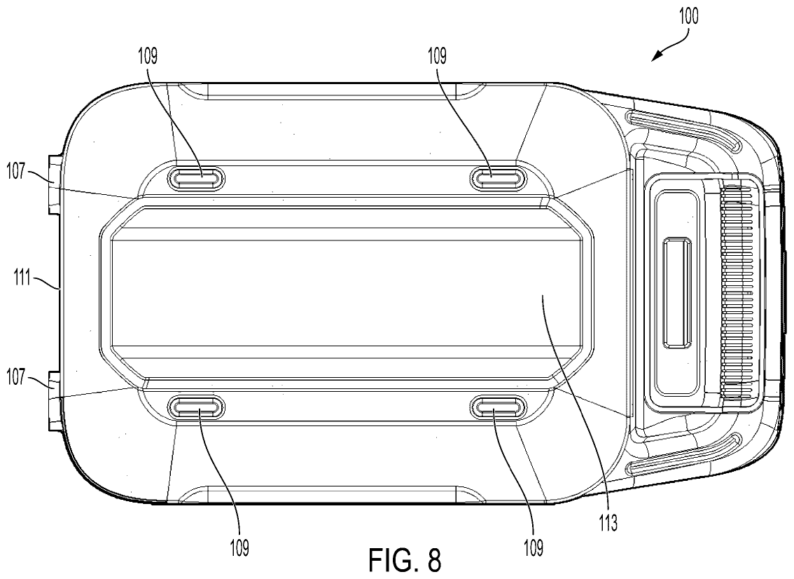

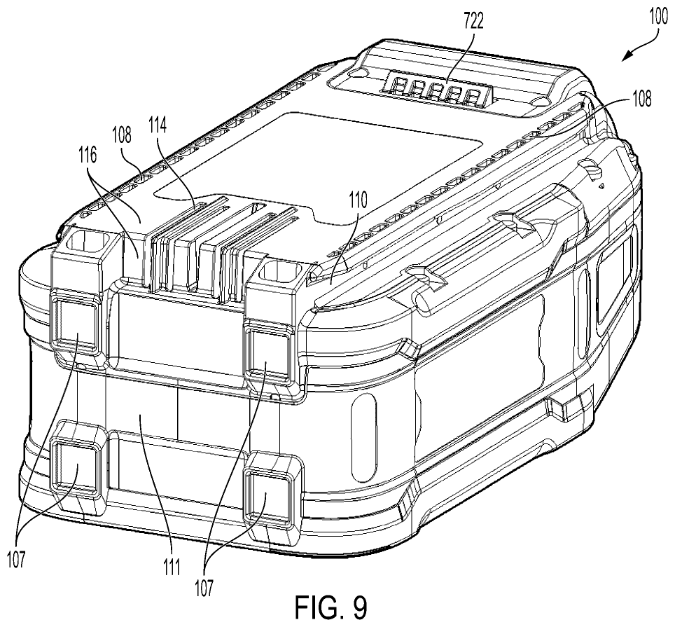

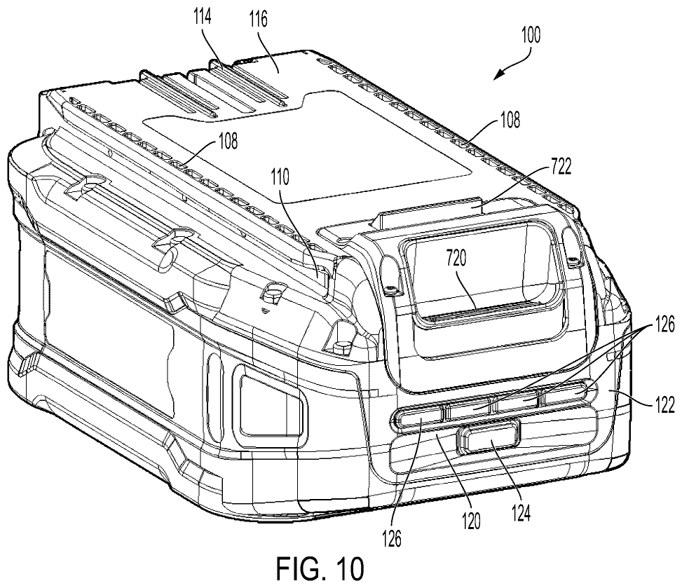

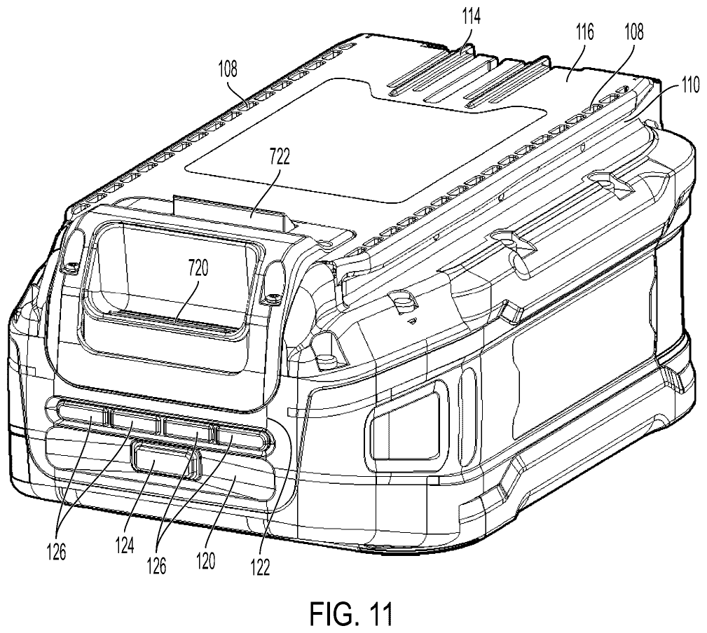

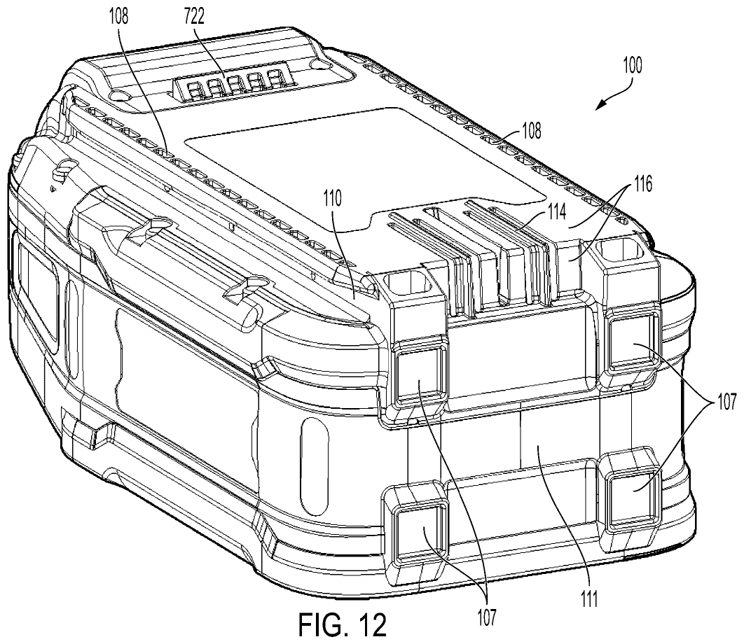

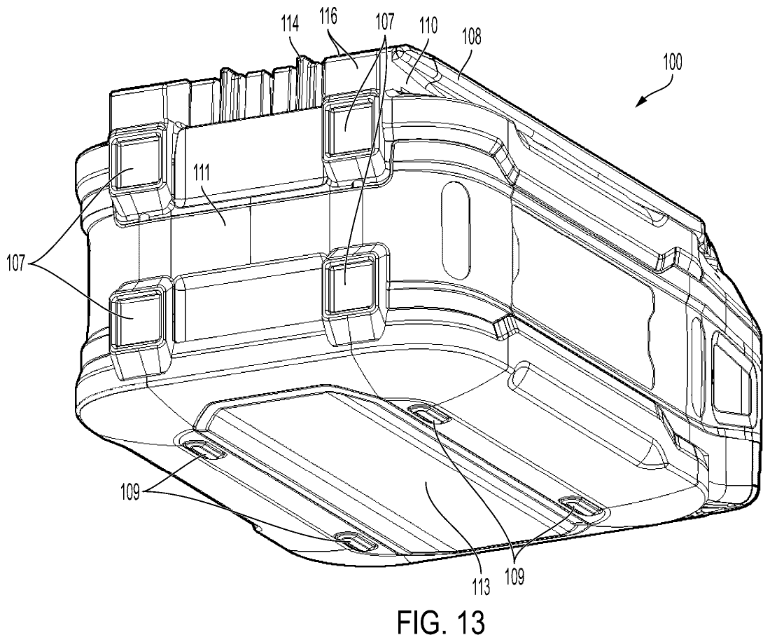

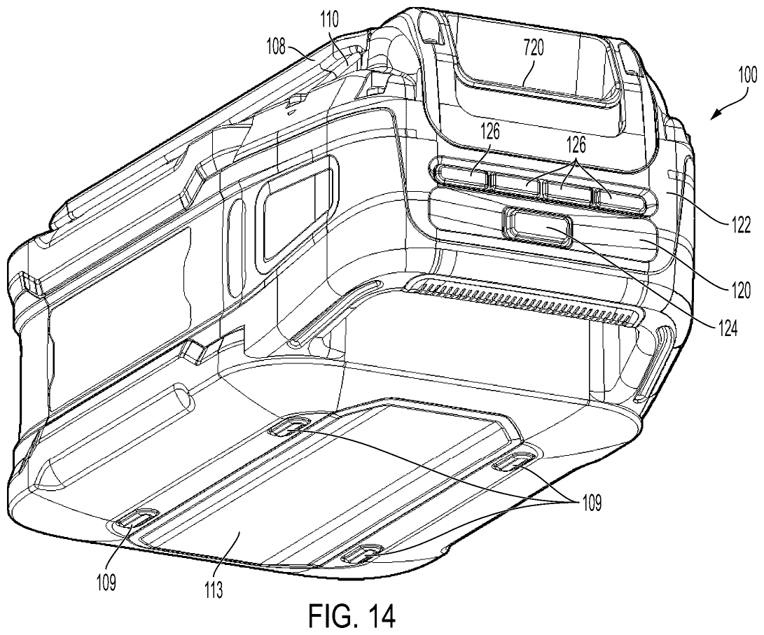

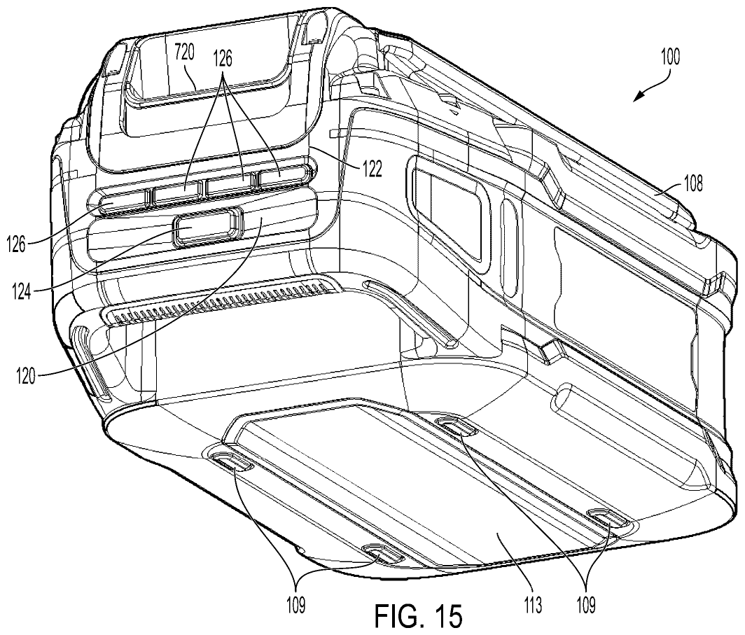

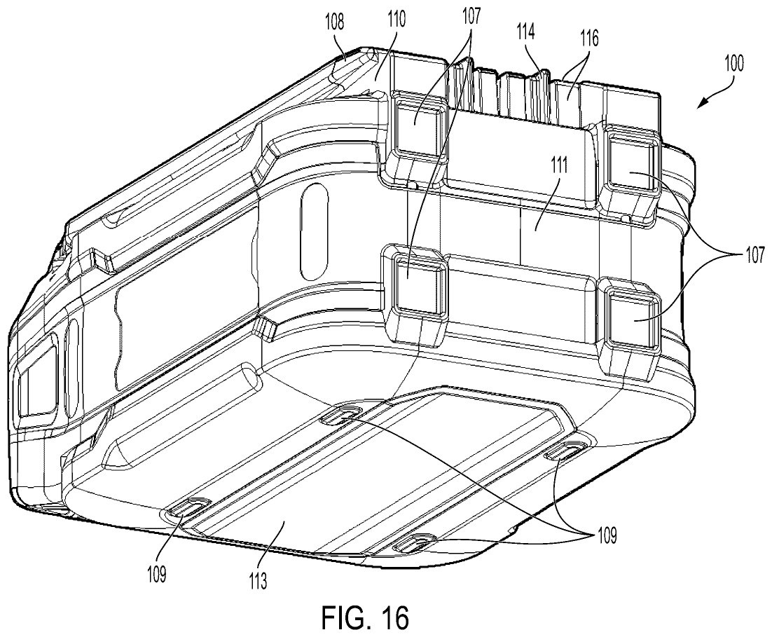

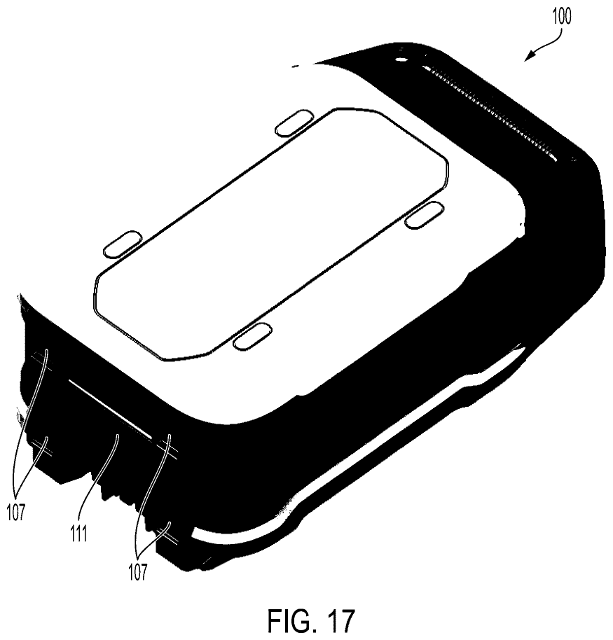

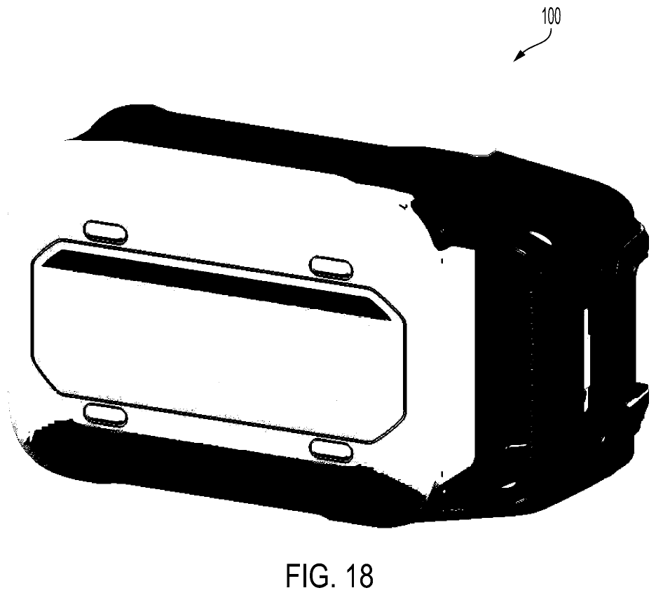

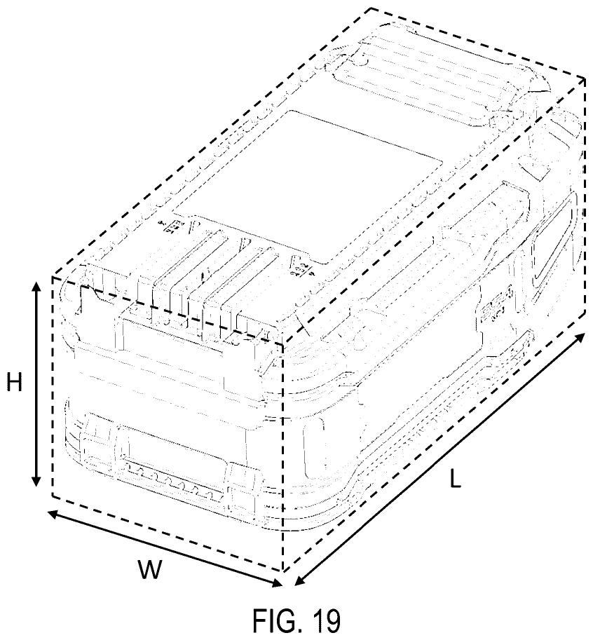

As shown in FIGS. 3-17, the battery pack 100 may include a housing 102. The housing 102 may provide a protective cover for the power source contained within the housing 102, such as one or more rechargeable battery cells, electronics and other components. The housing 102 may include alternate configurations for creating the housing. For example, a top/upper housing portion 103 and a bottom/lower housing portion 105 may be coupled/joined together at a horizontal parting line to form the housing 102. In another embodiment, two (left and right) side portions may be coupled/joined together at a vertical parting line to form the housing 102. The housing 102 may be constructed of plastic or other suitable material for the application. Along with the two sides, the housing 102 may also include a front and a back. Regardless of the structure, the housing 102 forms an interior/internal/inner cavity 104. Other configurations for forming the housing 102 are contemplated and encompassed by the present patent application. The battery pack 100 may include a capacity of 10 Ah and a nominal voltage of 54V.

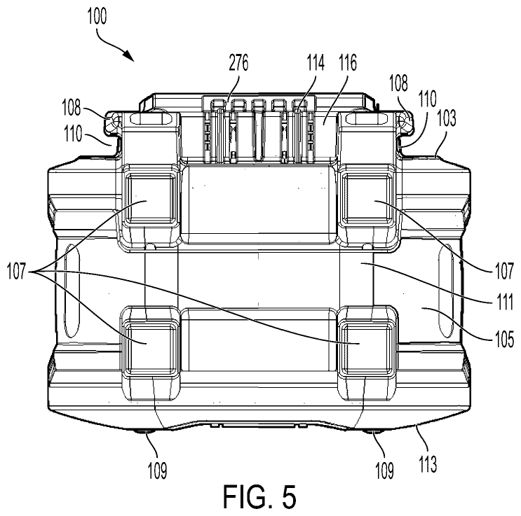

As shown in FIGS. 5-9, 12-13, and 16-17, the battery pack 100 may include a plurality of first feet portions 107 configured to provide stable support for the battery pack 100 on a surface/ground when the battery pack is in a first orientation (e.g., a vertical orientation). The feet portions 107 may extend outwardly away from a side wall/surface 111 of the housing 102 to provide stable support for the battery pack 100 when the battery pack 100 is in the first orientation. As shown in FIGS. 3-6, 8, and 13-16, the battery pack 100 may include a plurality of second feet portions 109 configured to provide stable support for the battery pack 100 on the surface/ground when the battery pack is in a second orientation (e.g., a horizontal orientation). The feet portions 109 may extend outwardly away from a bottom wall/surface 113 of the housing 102 to provide stable support for the battery pack 100 when the battery pack 100 is in the second orientation.

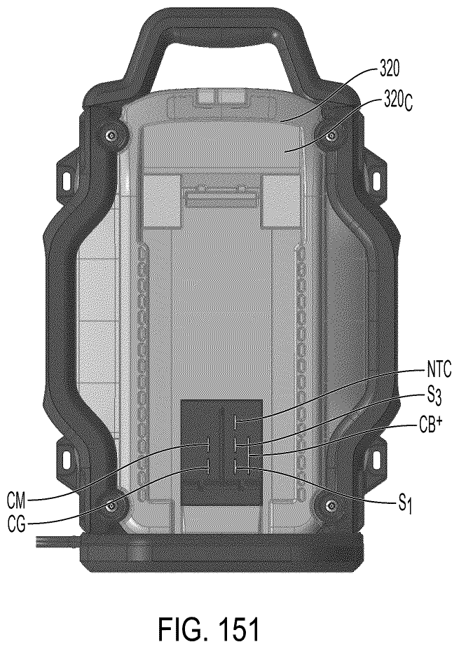

The battery pack 100 may be a rechargeable battery pack. The battery pack 100 may be generally configured to power the power tool. The battery pack 100 may be rechargeable using a battery charger (as shown in FIG. 151) after being used as a power source for the power tool (the battery pack interface of the power tool is shown in FIG. 149). Also, the present disclosure contemplates that other powered devices may be utilized with the disclosed battery pack, interfaces and may be considered other types of power tools. Examples of such powered devices that may be considered power tools can include lights, lasers, dust extractors, radios, speakers, heated garments, etc.

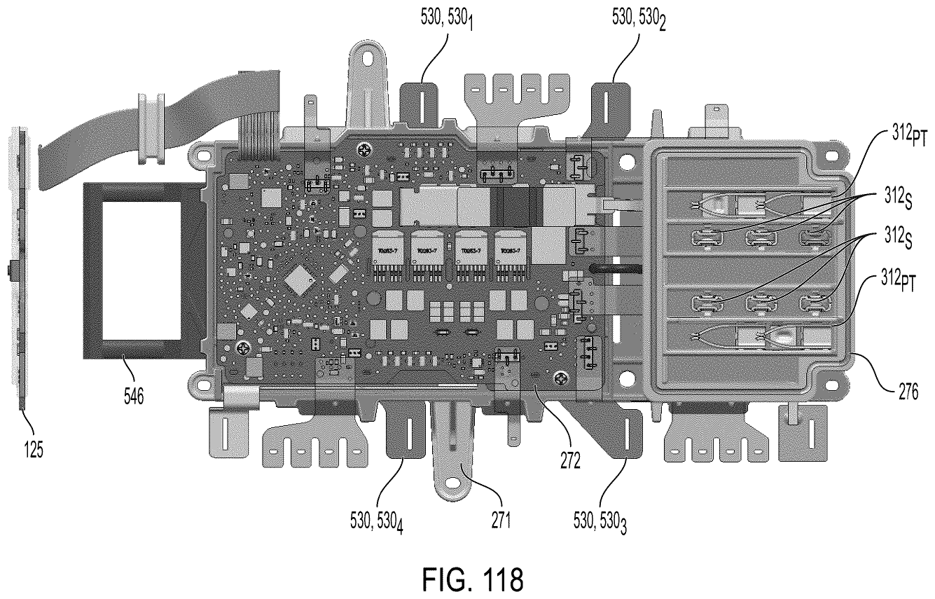

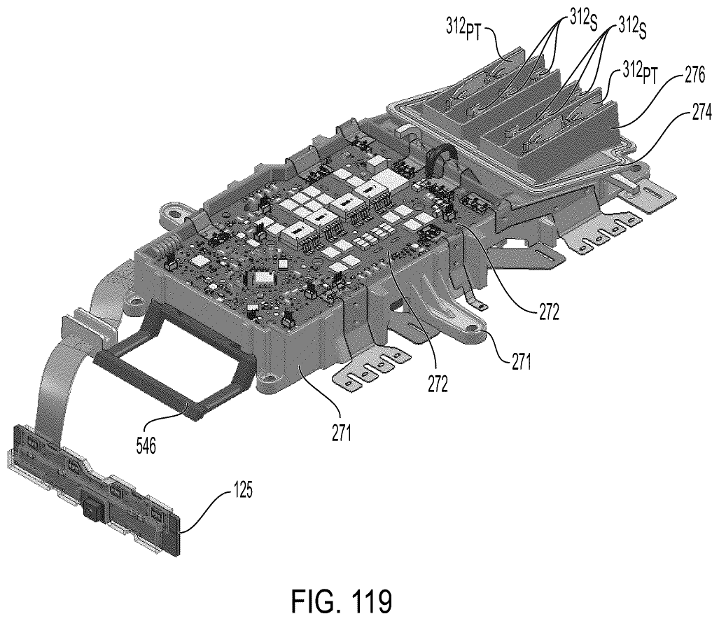

As shown in FIGS. 3, 10-11, and 15, the battery pack 100 may also include a state of charge (SOC) indicator 120 on a surface/side 122 of the housing 102. The SOC indicator 120 may include an activation button 124 and a plurality of LEDs/lights 126. The SOC indicator 120 may include or may be operatively connected to an SOC PCB 125 (as shown in FIGS. 118-119) and other components. As would be appreciated by a person of ordinary skill in the art, the SOC PCB 125 may be connected to a main PCB by a pair of wires.

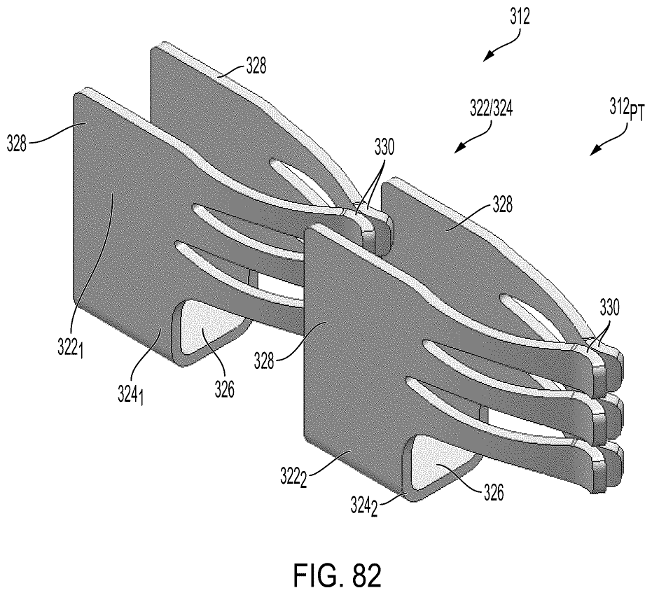

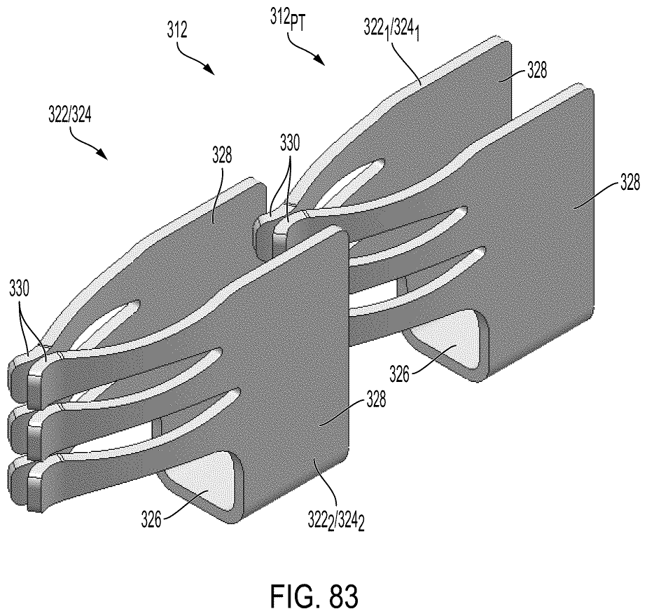

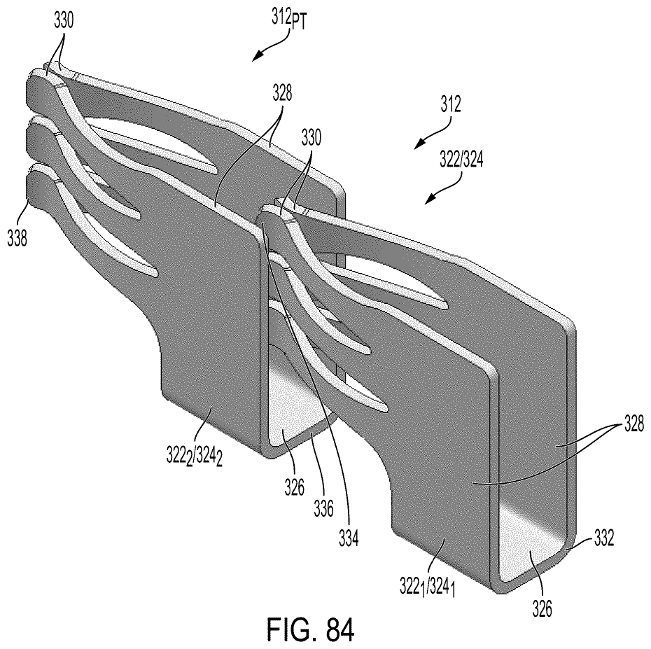

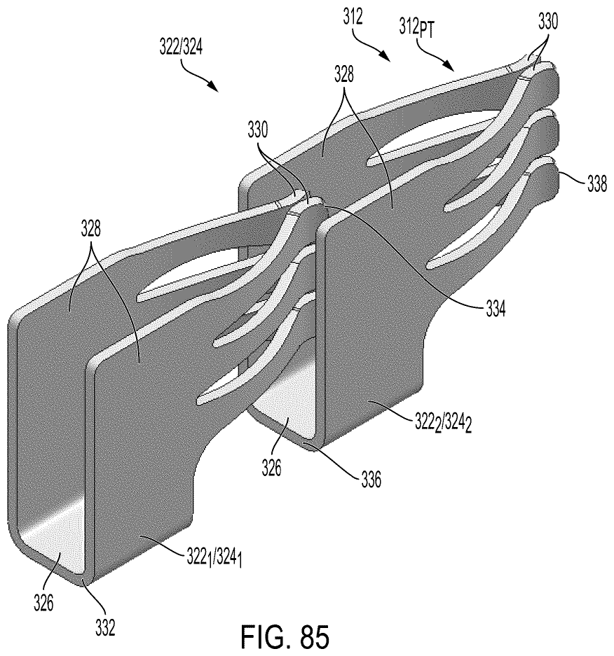

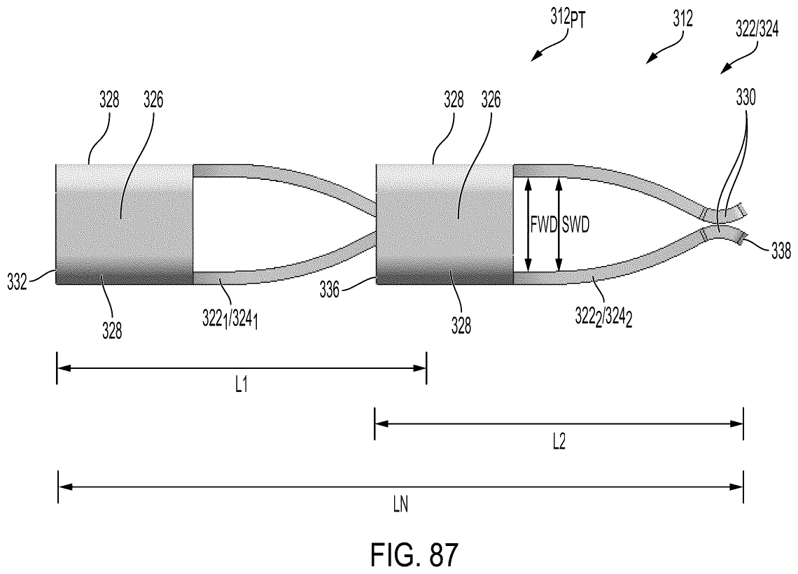

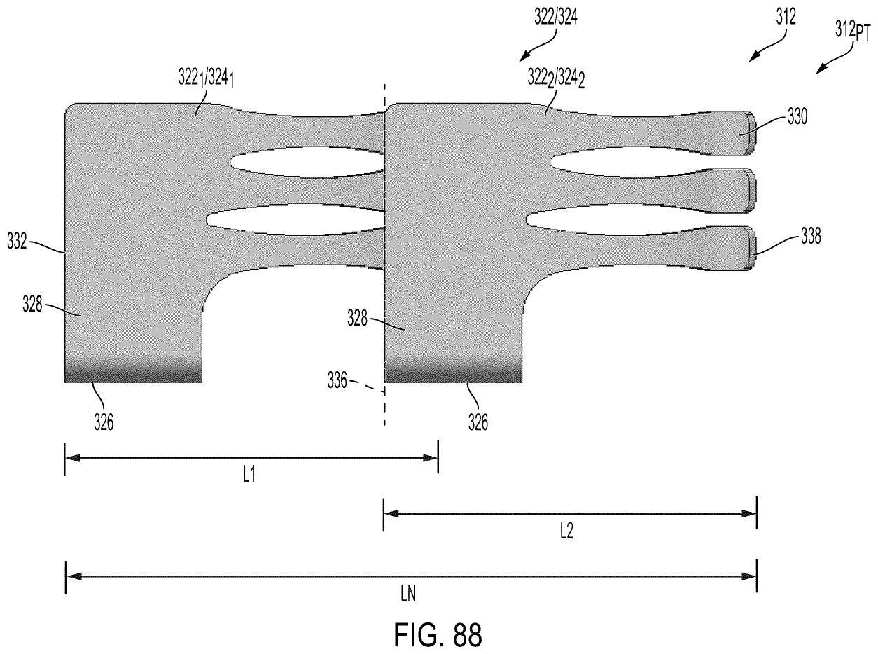

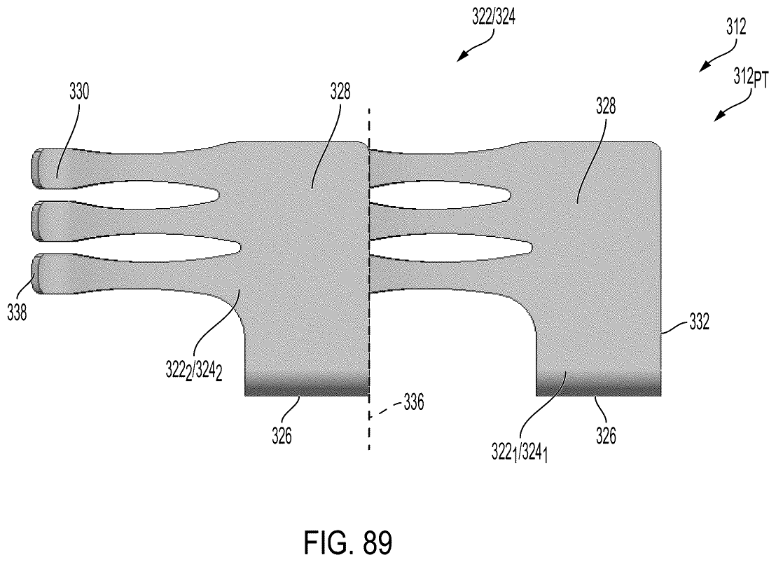

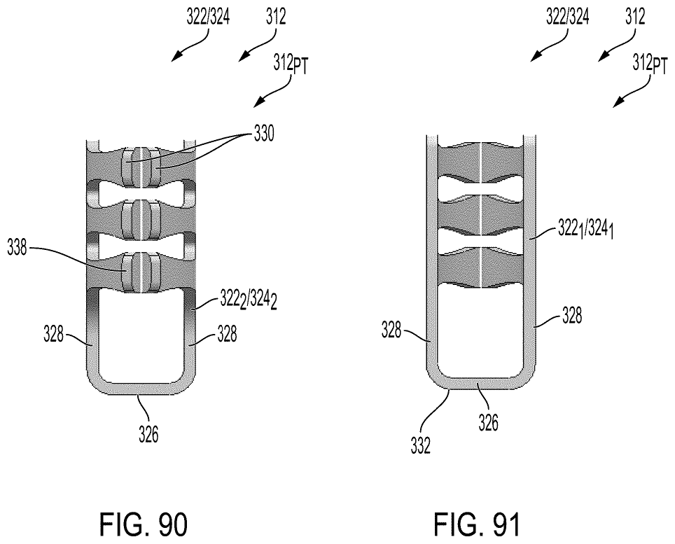

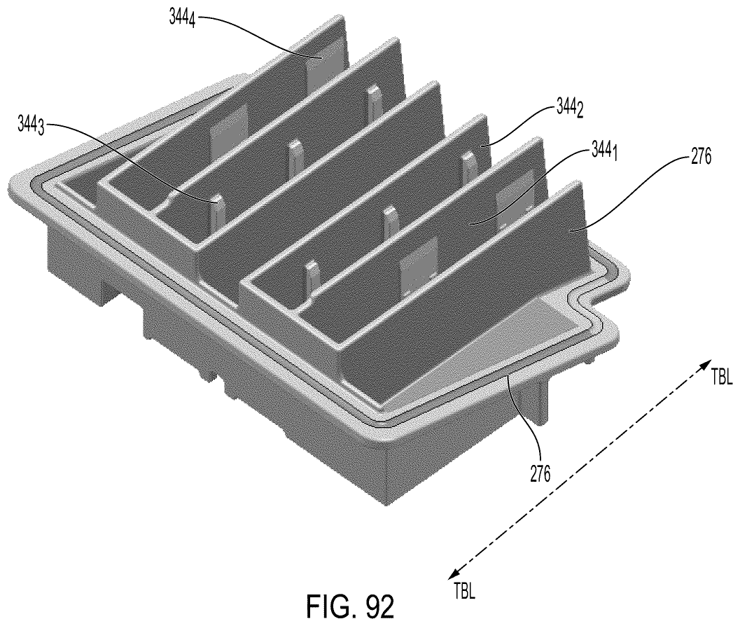

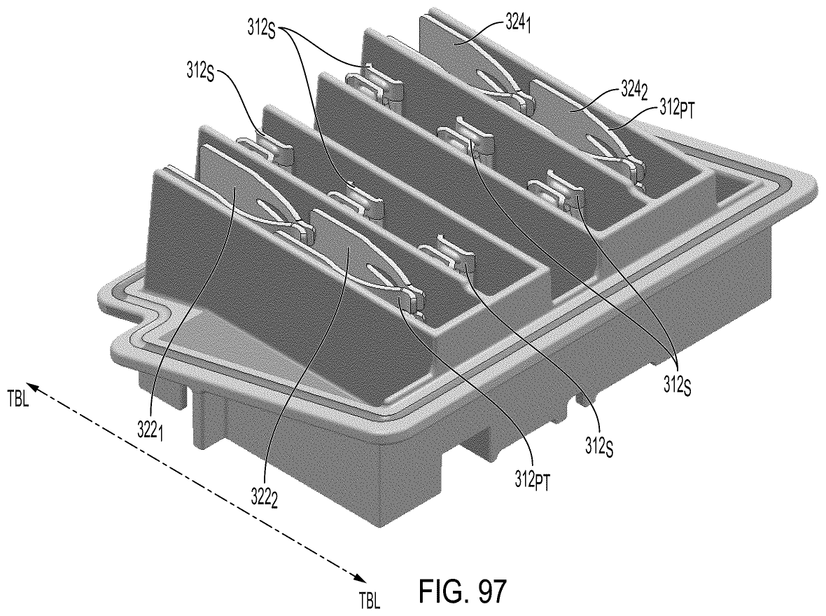

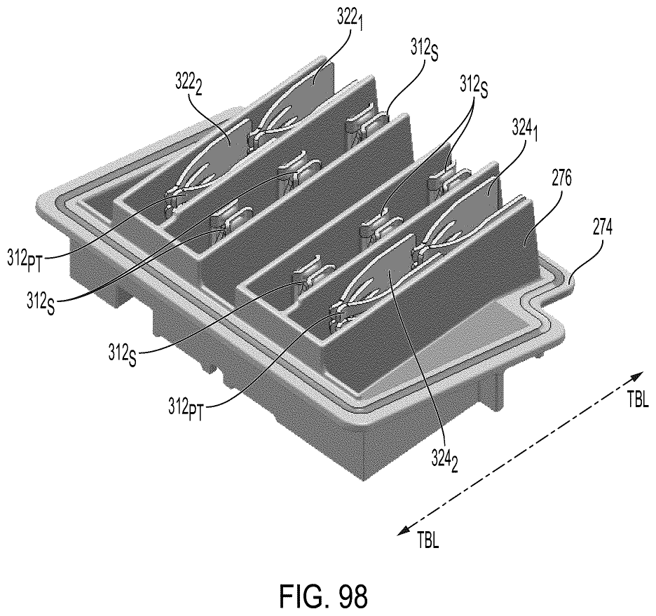

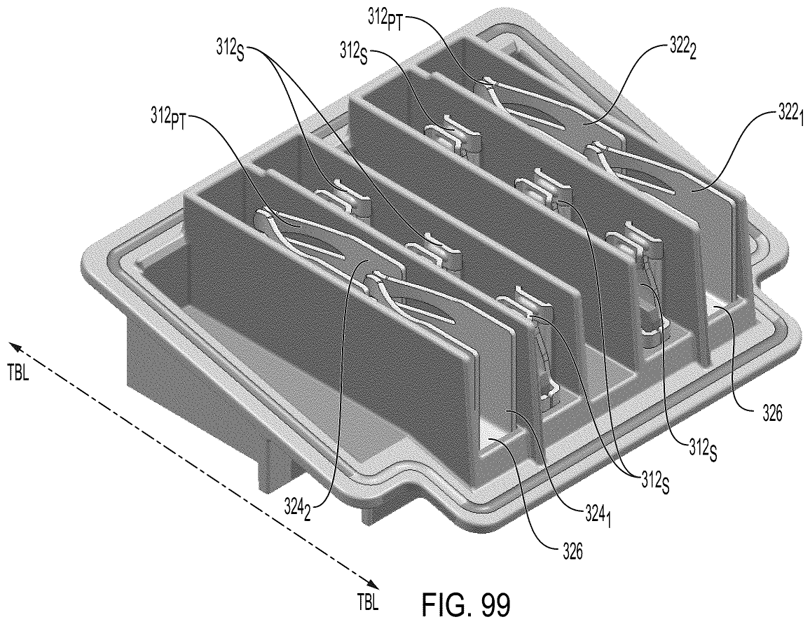

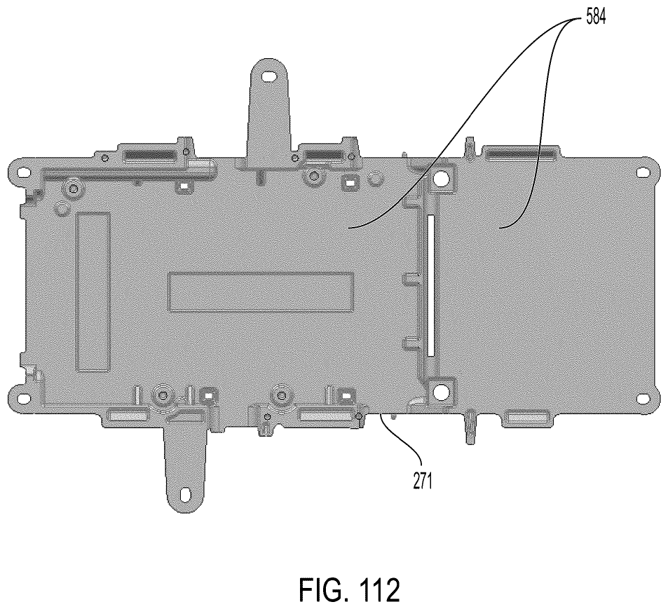

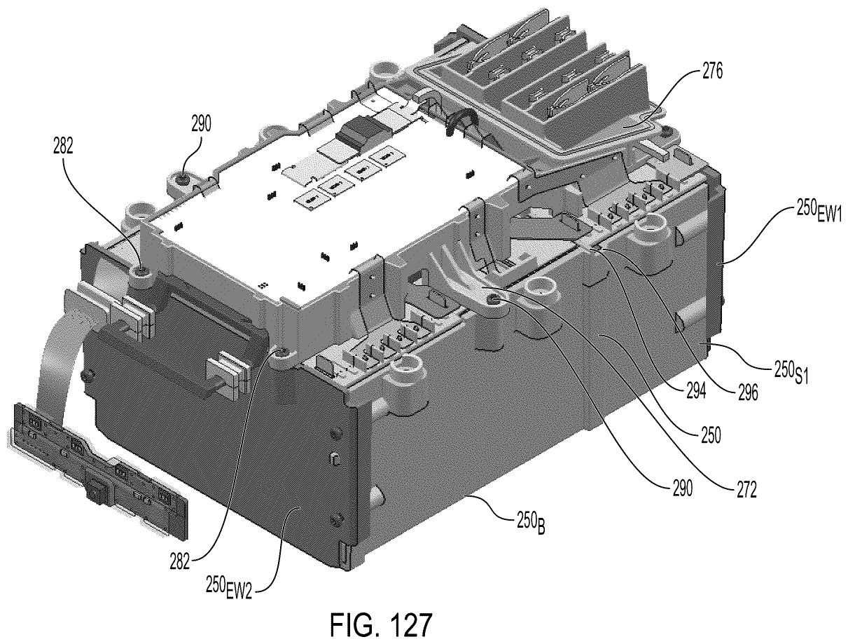

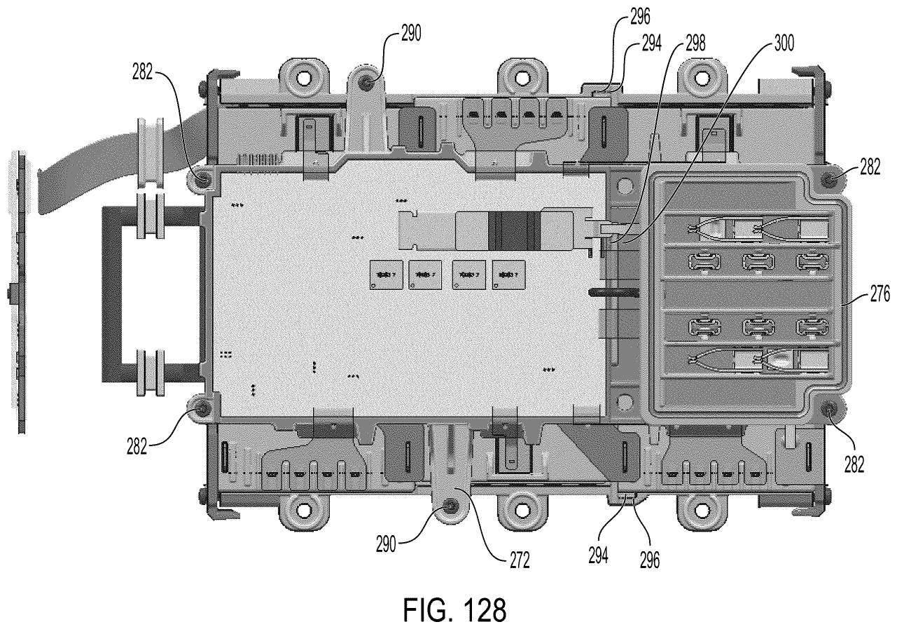

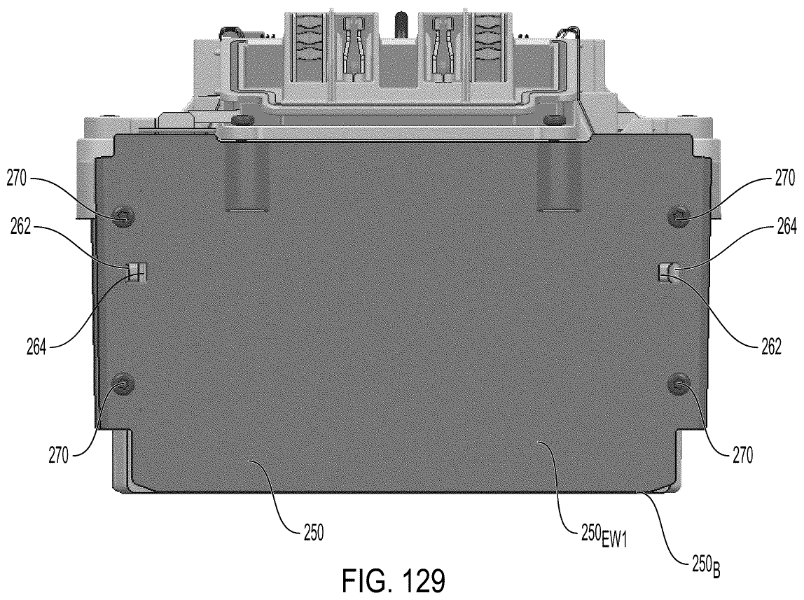

As shown in FIGS. 92-105, the battery pack 100 may also include a battery pack tool terminal block 276 including a terminal block housing 274 and a plurality of battery terminals 312 for transmitting current and signals between the battery pack 100 and the power tool/charger. The housing 102 may also include a plurality of slots 114 in a top portion 116 of the housing 102. The slots 114 may be positioned in other portions of the housing 102. The plurality of slots 114 forms a set of slots 114. The plurality of slots 114 corresponds to and are aligned with the plurality of battery terminals 312. The plurality of battery terminals 312 forms a set of battery terminals 312. The plurality of slots 114 also correspond to a plurality of (power tool or charger) terminals of the electrical device(s). The plurality of electrical device terminals forms a set of electrical device terminals. The electrical device terminals may be received by the battery terminal slots 114 and engage and mate with the battery terminals 312, as will be discussed in more detail below. The terminal block 276 and the battery terminals 312 are described in detail below with respect to, for example, FIGS. 82-129.

Further, the battery pack may be “slide-type” battery pack that is attached/connected by sliding into or onto corresponding engagement portions of the power tool or the charger. For example, the housing 102 of the battery pack 100 may include an interface 106 for mechanically coupling with a corresponding battery pack interface of an electrical device, for example, a HPHVPT or an HVC. In the illustrated example embodiment, the interface 106 may include a rail and groove system including a pair of rails 108 and a pair of grooves 110. The rail and groove system can be configured for a sliding connection of the battery pack 100 with the power tool or the charger. The power tool or the charger may include corresponding rails and grooves to mechanically connect the battery pack 100 and the power tool/charger together. Other types of interfaces are contemplated and encompassed by the present patent application. The structure of the battery pack connection to the power tool or the charger is not particularly limited and a wide variety of battery pack connection mechanisms known in the art also may be advantageously utilized with the present teachings.

The interface 106 of the battery pack 100 may also include a latch system 700 for fixing the battery pack 100 to the electrical device. The latch system 700 and/or the rail and groove system (including the pair of rails 108 and the pair of grooves 110) may form a connection mechanism that is configured for physically/mechanically coupling the battery pack 100 to the power tool or the charger.

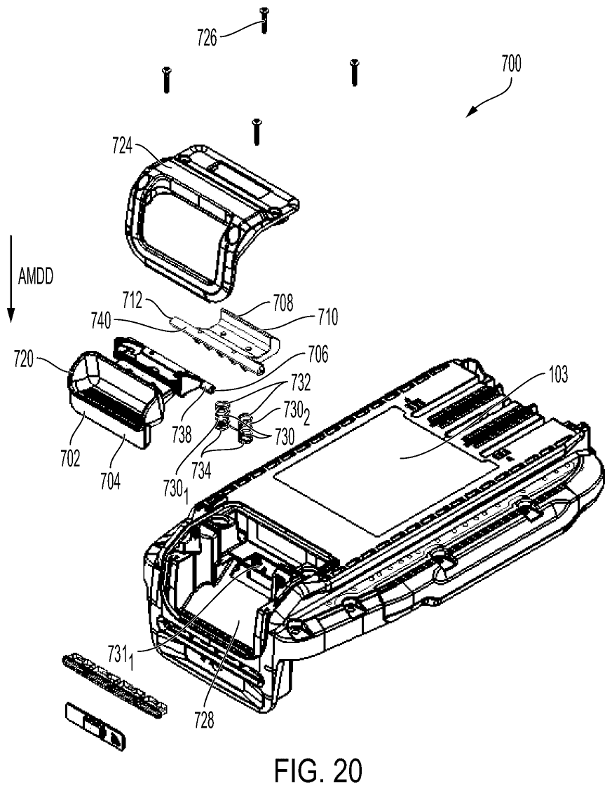

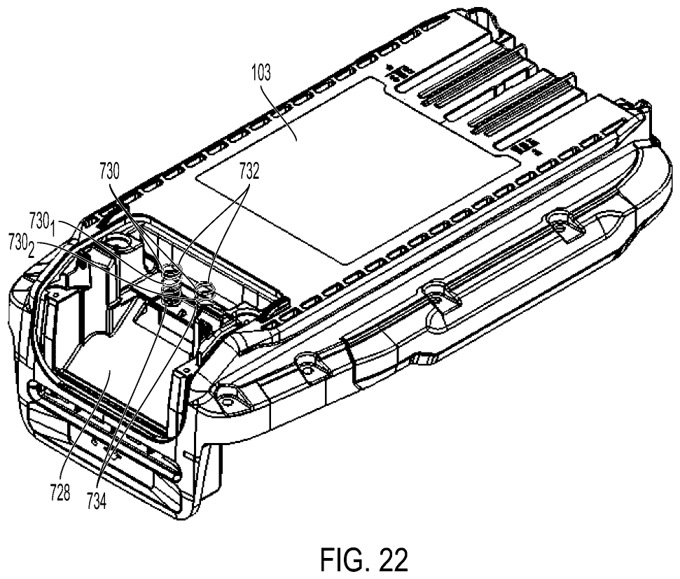

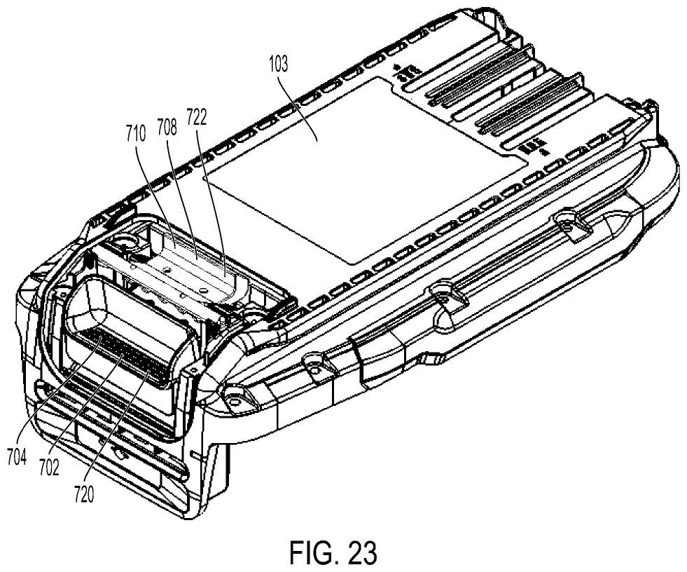

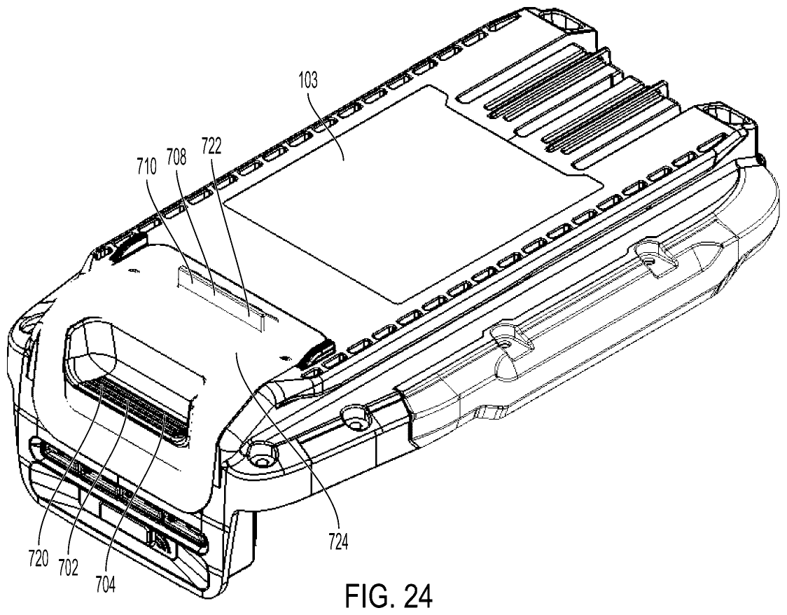

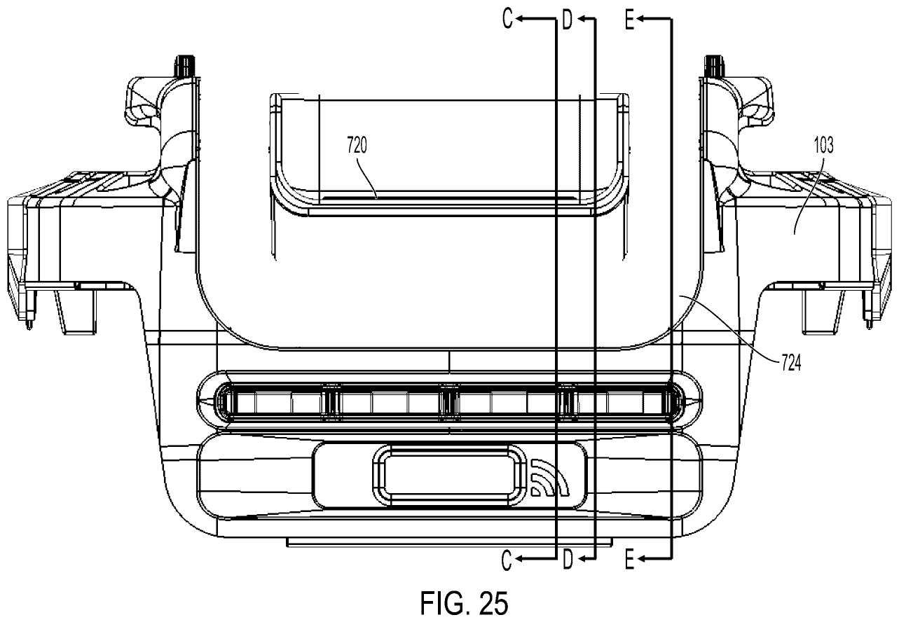

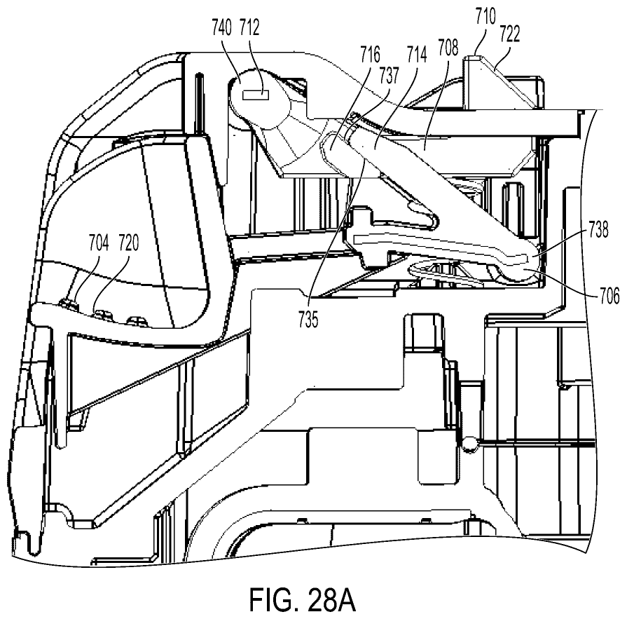

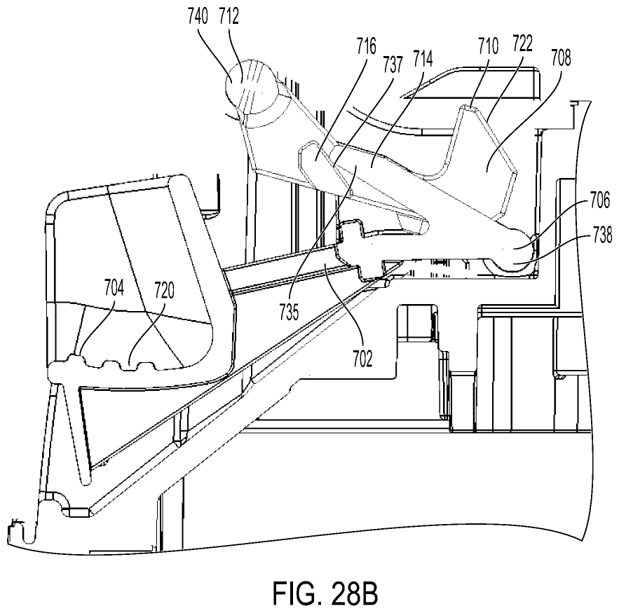

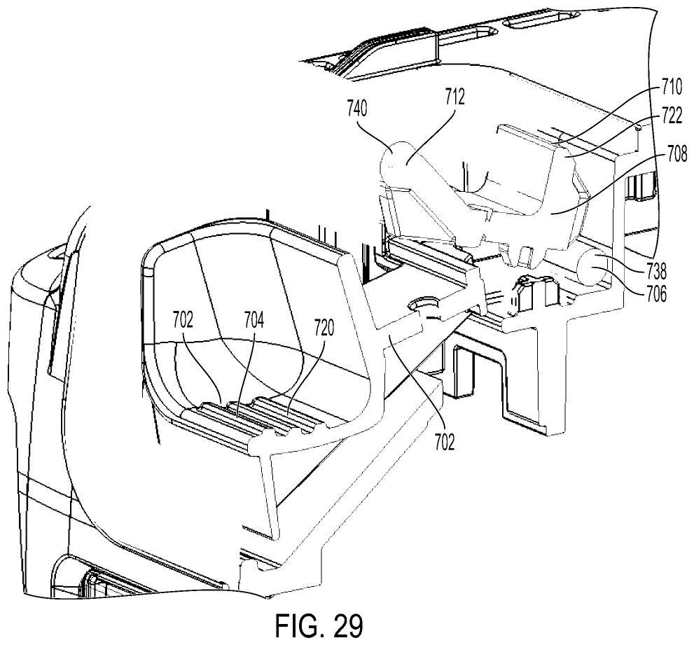

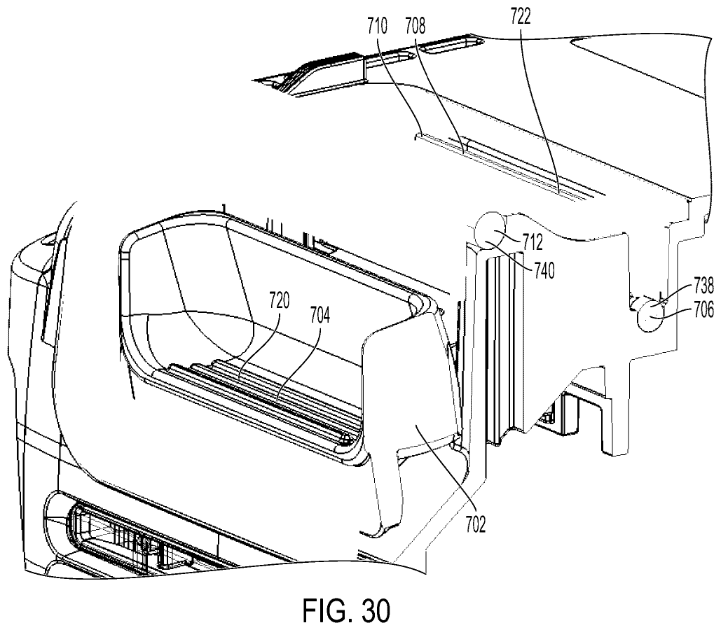

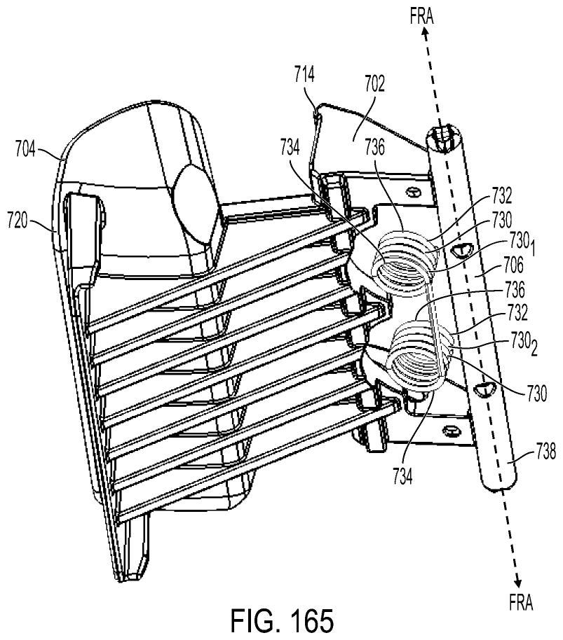

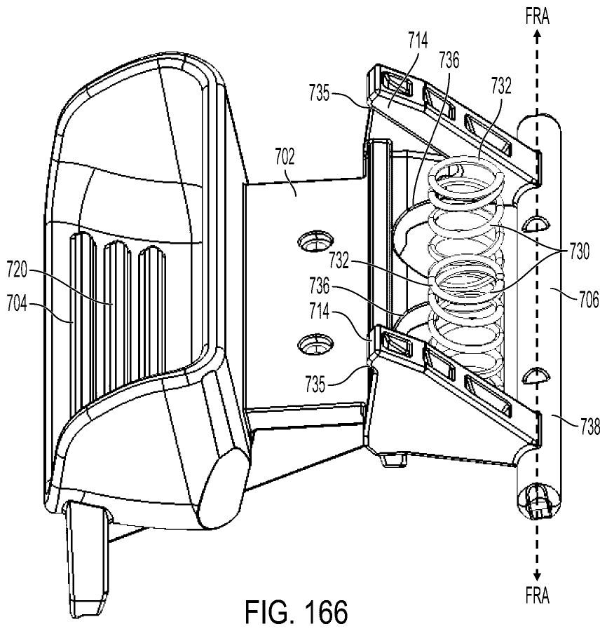

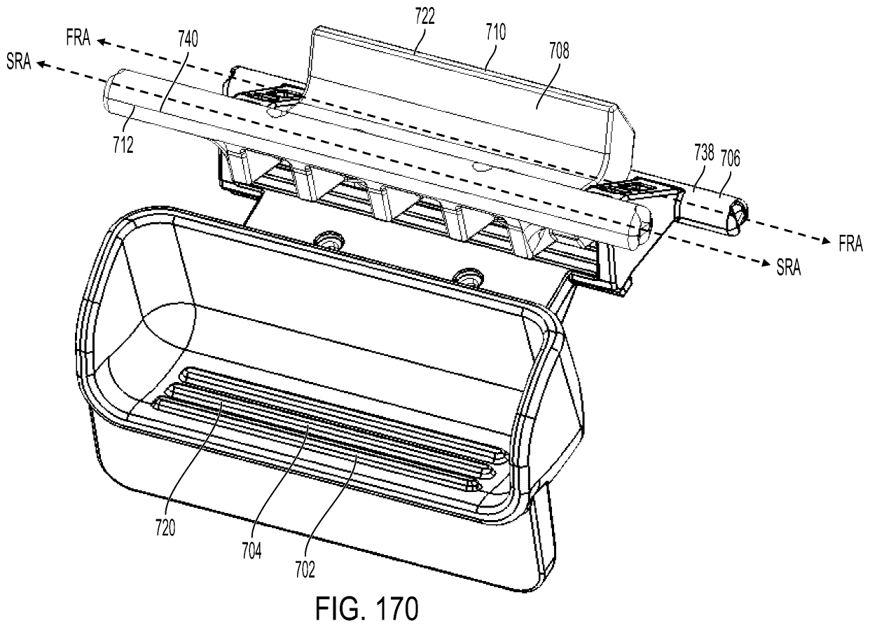

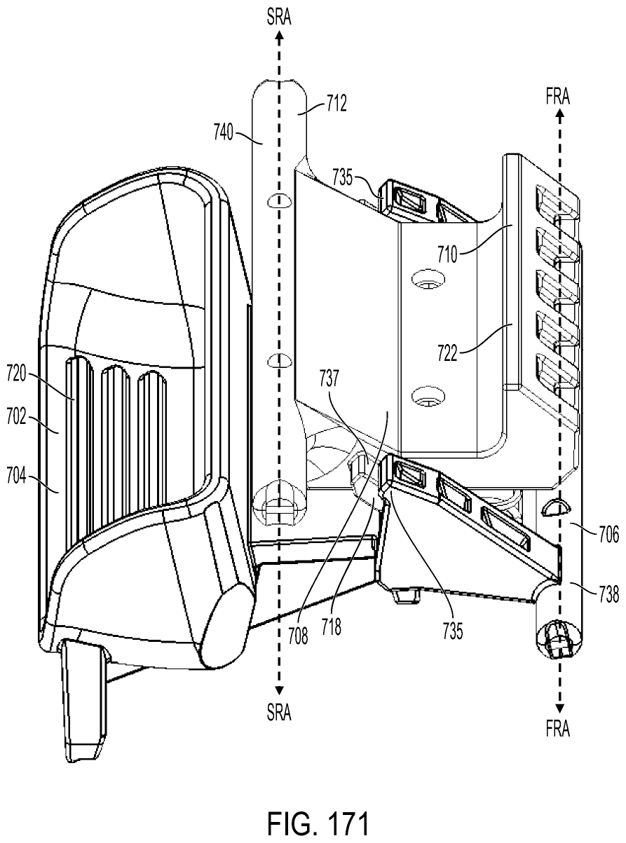

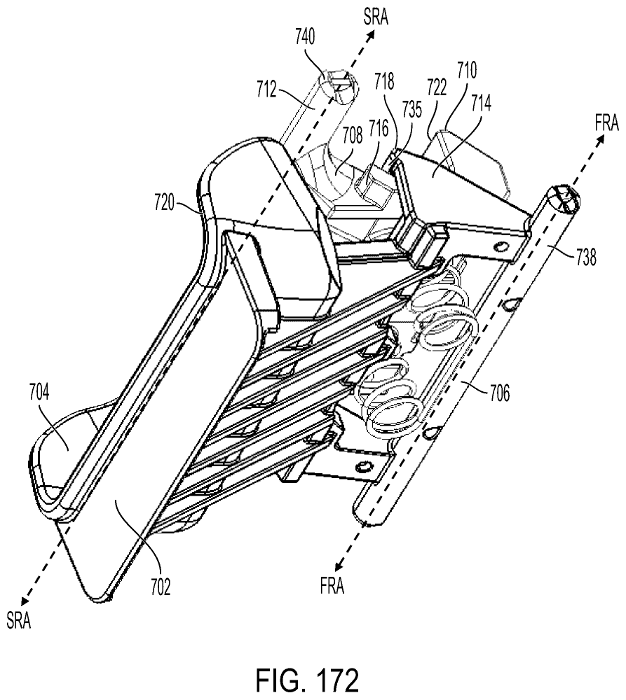

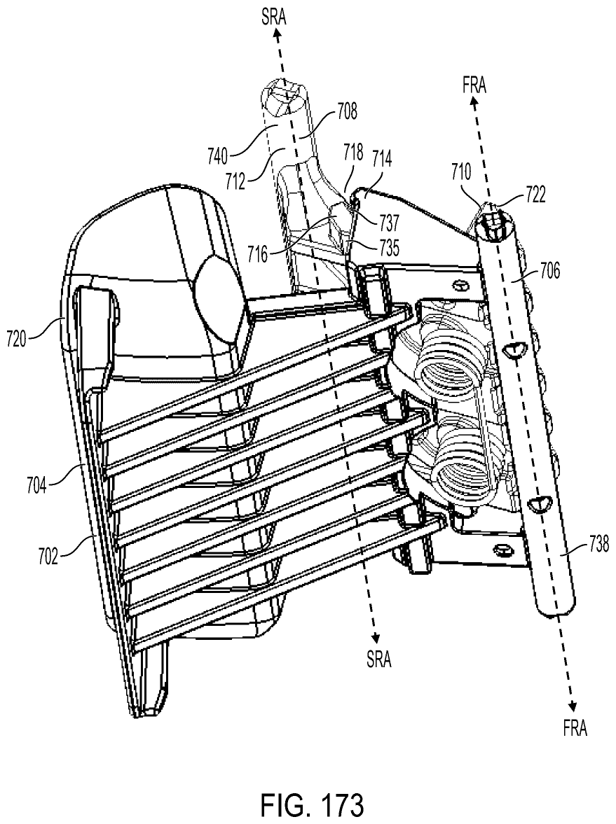

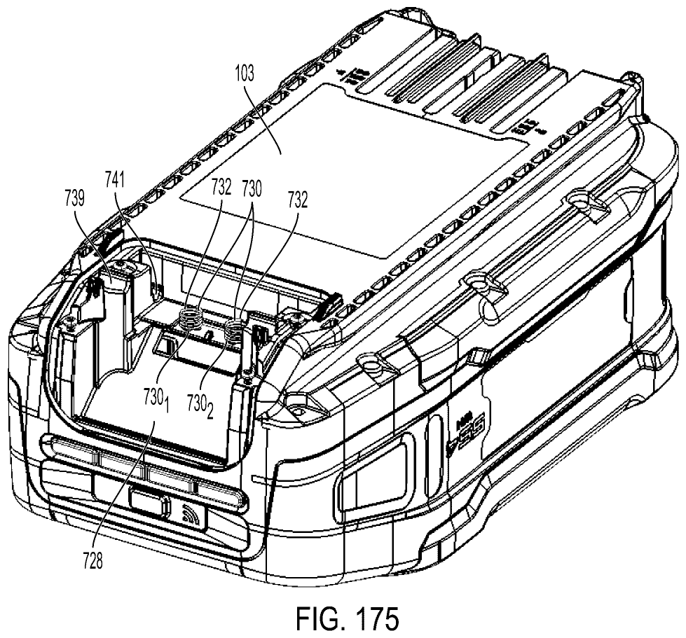

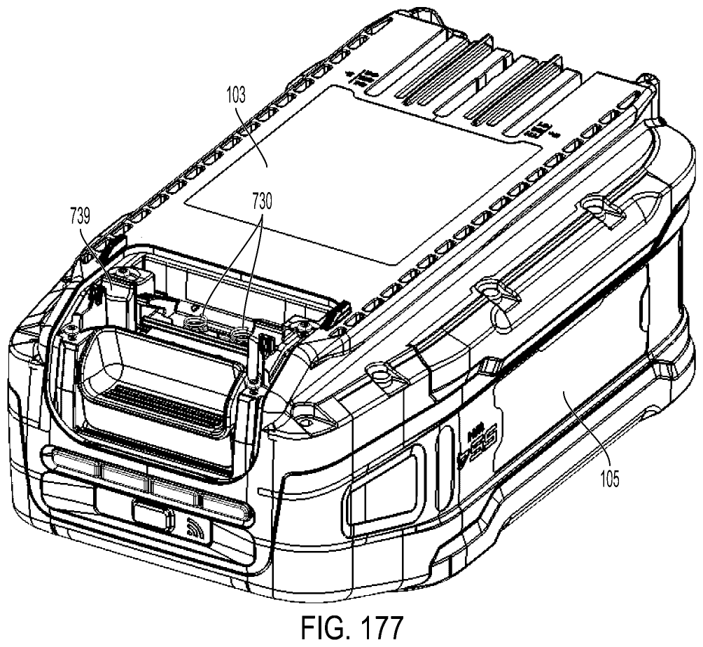

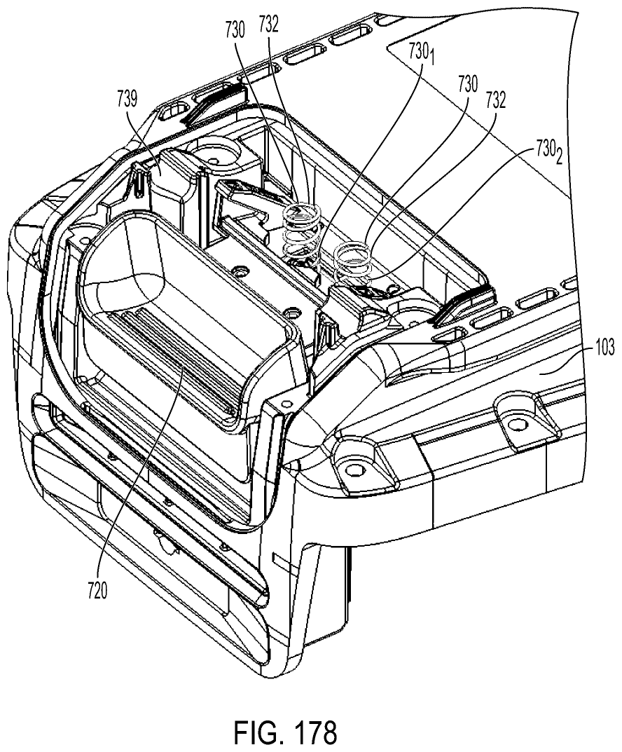

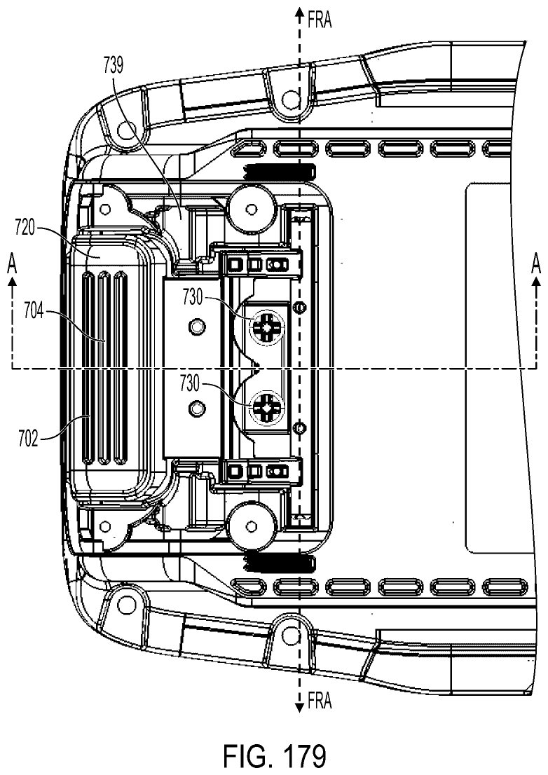

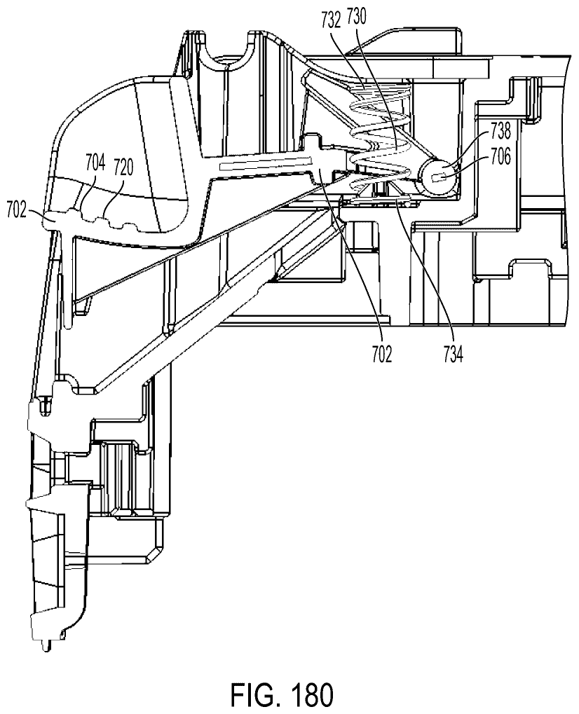

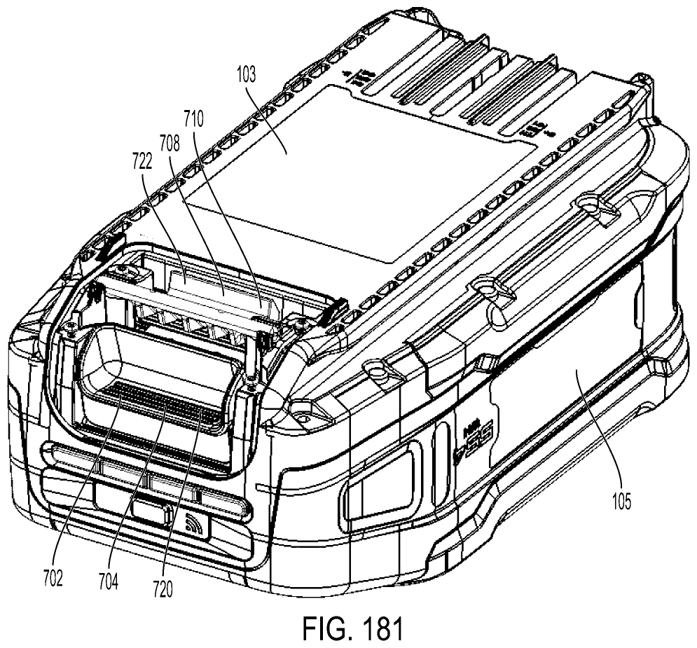

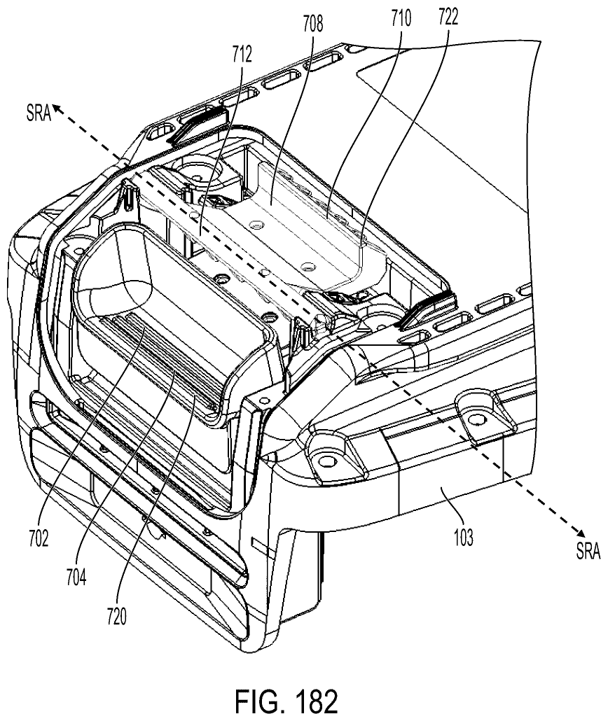

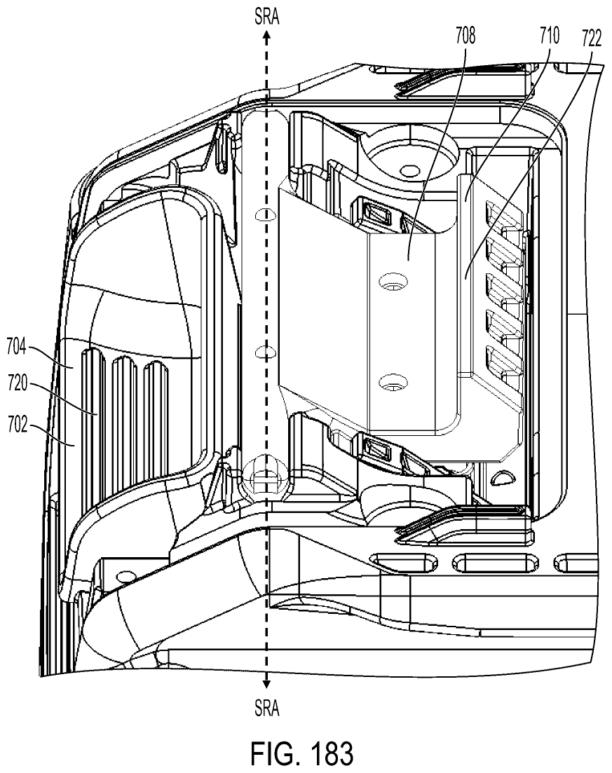

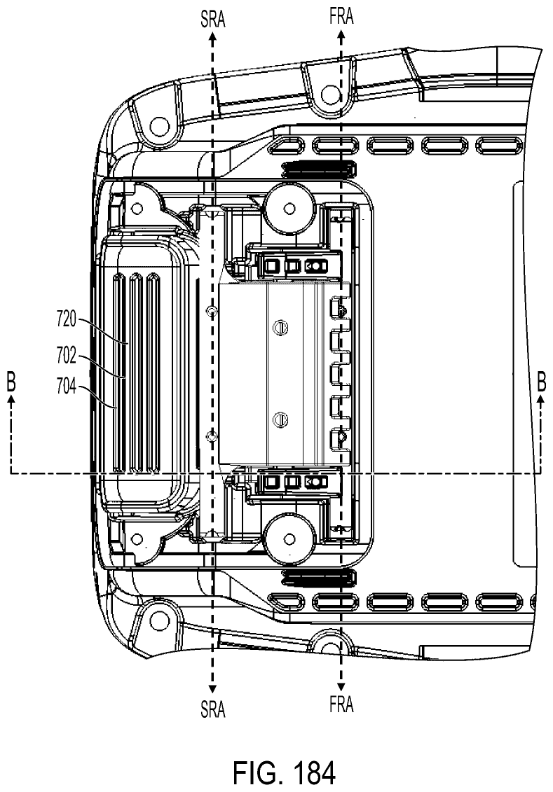

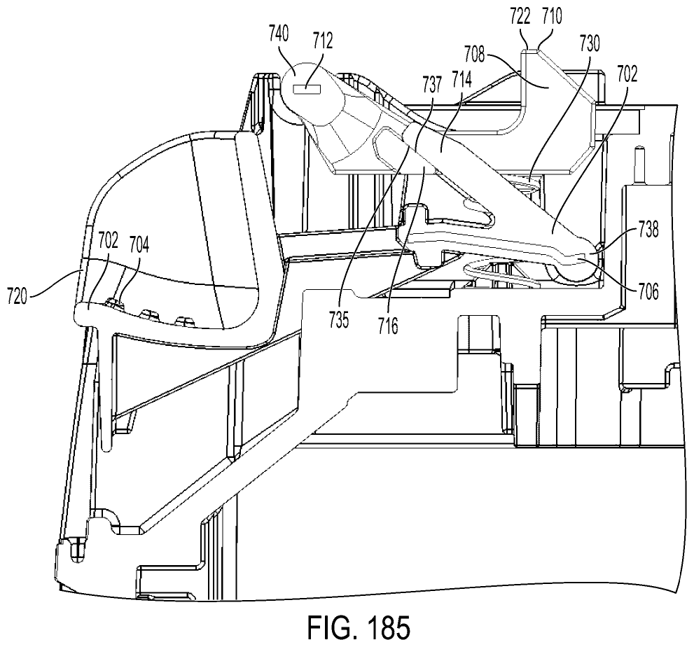

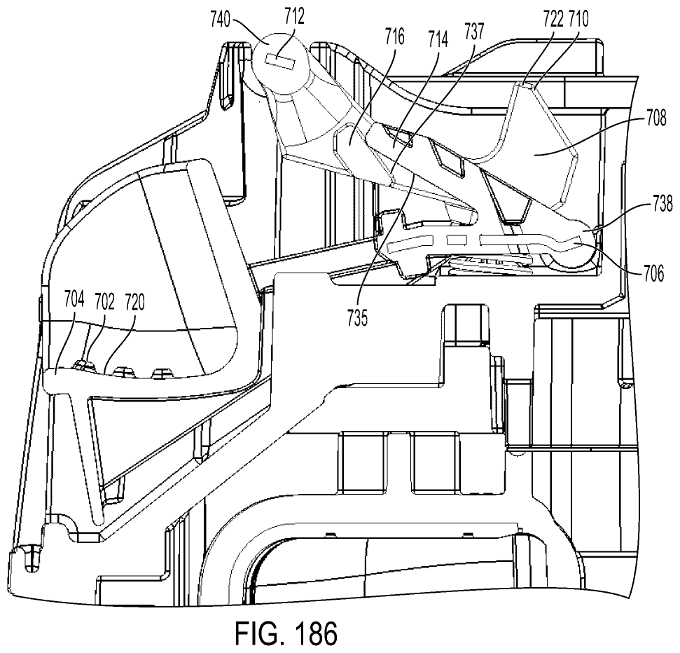

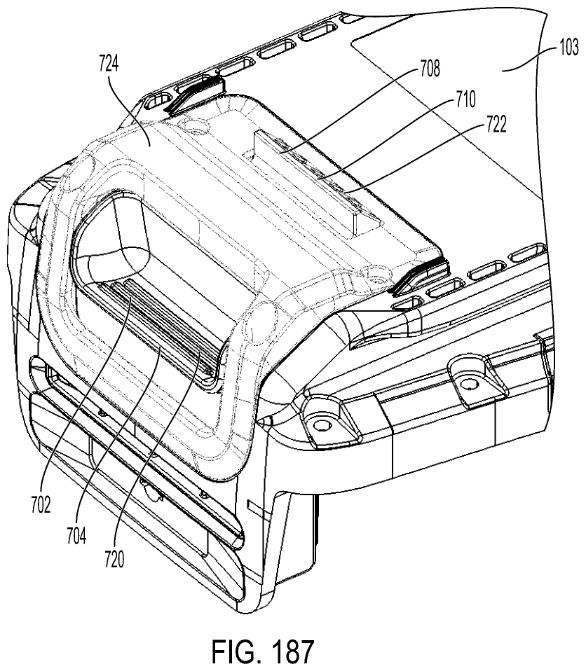

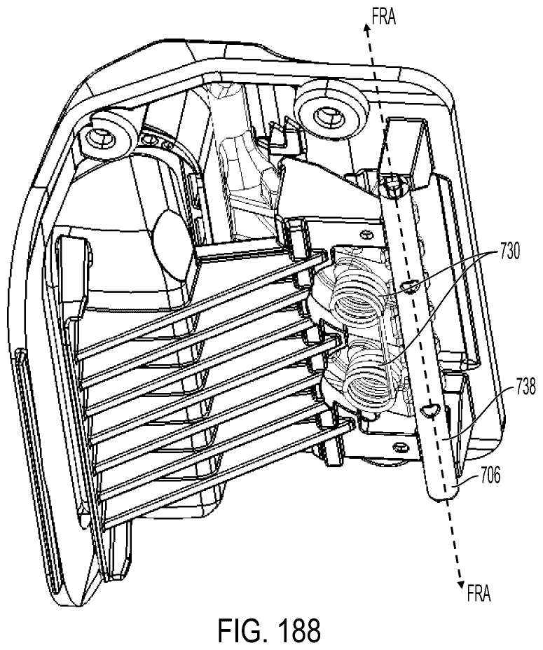

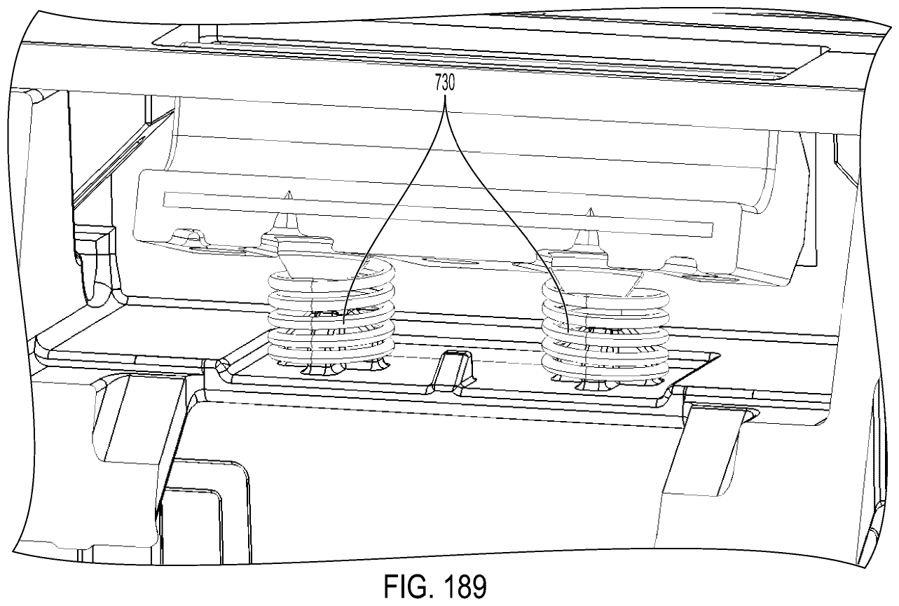

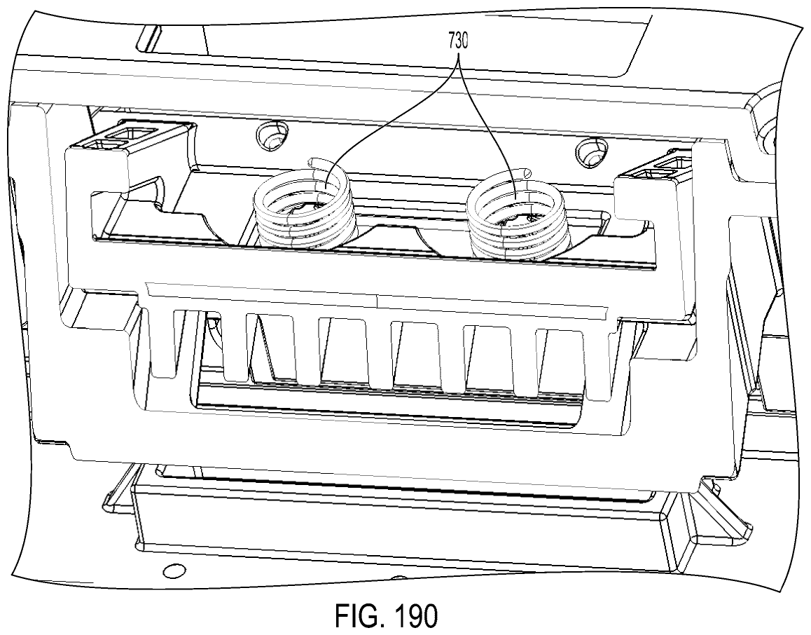

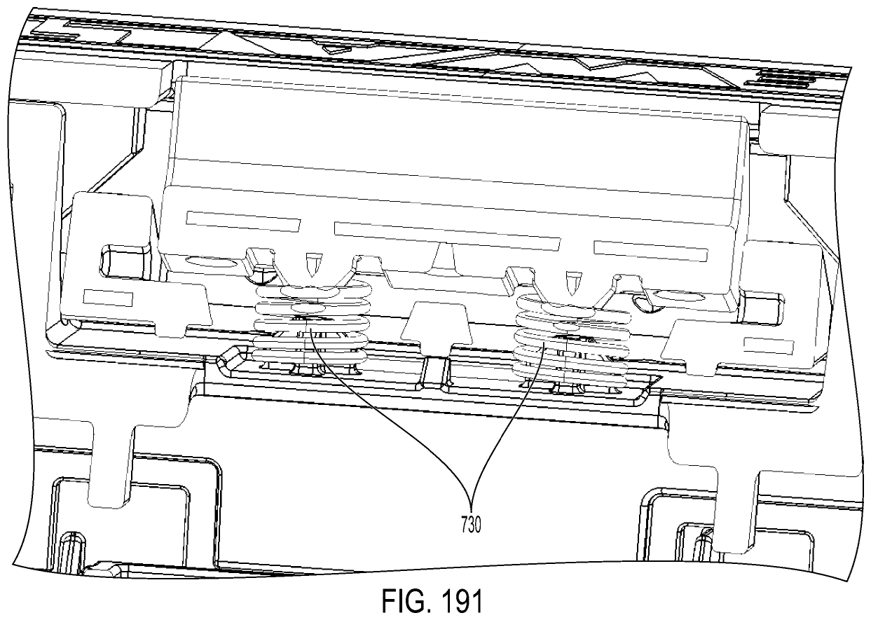

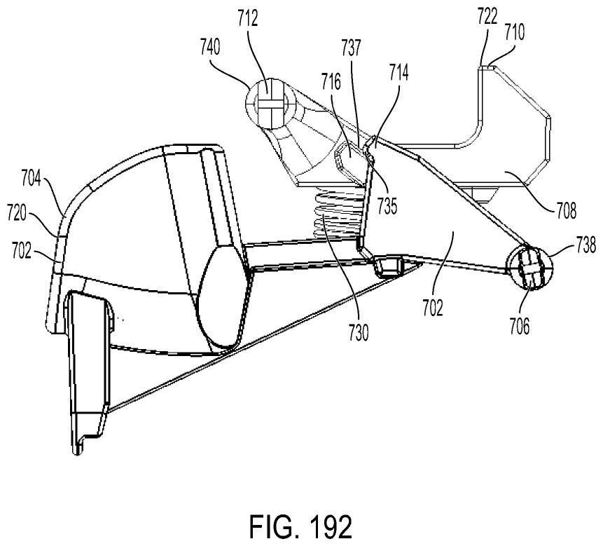

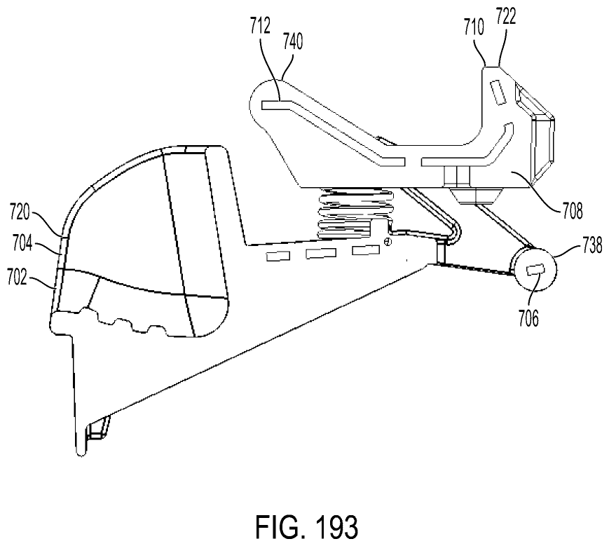

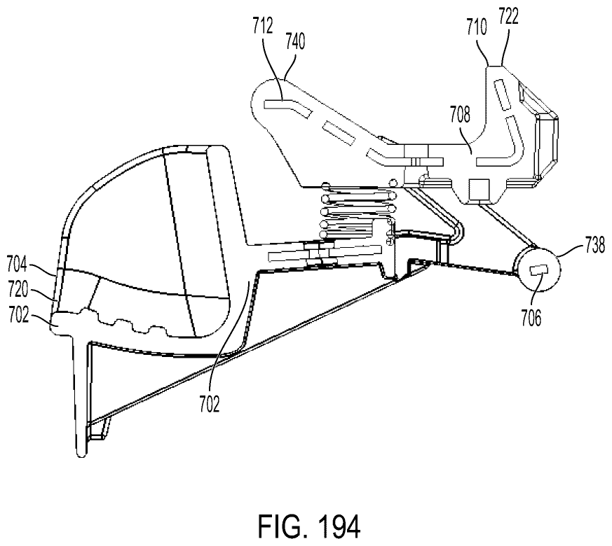

Referring to FIGS. 20-30 and 162-194, the latching system 700 of the battery pack 100 may be configured for latching the battery pack 100 to the electrical device upon mating the battery pack 100 to the electrical device along a mating direction. As noted above, the electrical device may be a power tool. The electrical device may be a charger. The latch system 700 may include a spring loaded latch.

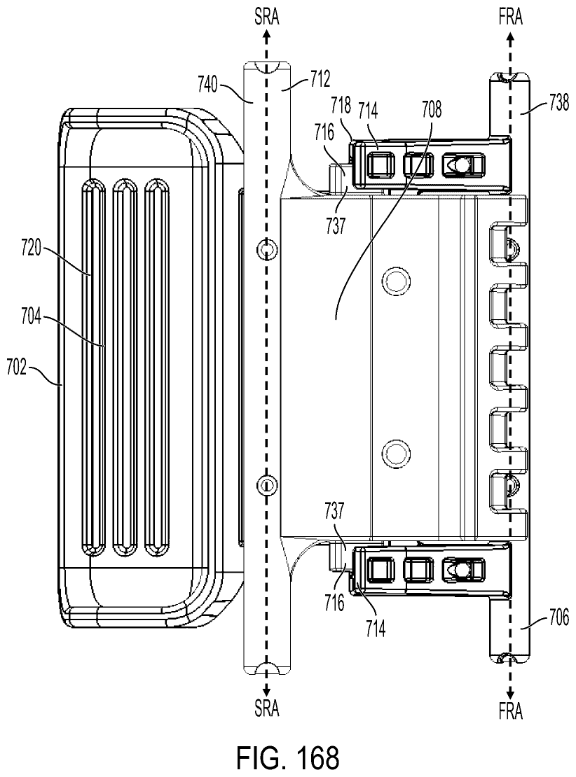

The latching system 700 may include a first component 702 with a first end 704 for user engagement and a second end 706 for rotation about a first rotation axis FRA-FRA. The latching system 700 may include a second component 708 with a first end 710 for engagement with portions of the electrical device and a second end 712 for rotation about a second rotation axis SRA-SRA. The second rotation axis SRA-SRA is generally parallel to the first rotation axis FRA-FRA as shown in FIGS. 168-173. The first component 702 may pivot about the first rotation axis FRA-FRA. The second component 708 may pivot about the second rotation axis SRA-SRA. The portions of the electrical device may include a latch engaging portions/catch as would be appreciated by a person of ordinary skill in the art.

The latch system 700 may also include a portion (e.g., user actuation member) 720 for receiving a user's finger to depress the first component 702 of the latch system 700 and a latch 722 (e.g., engaging portion) that may be received by the power tool or by the charger to maintain the battery pack 100 fixed to the power tool or the charger.

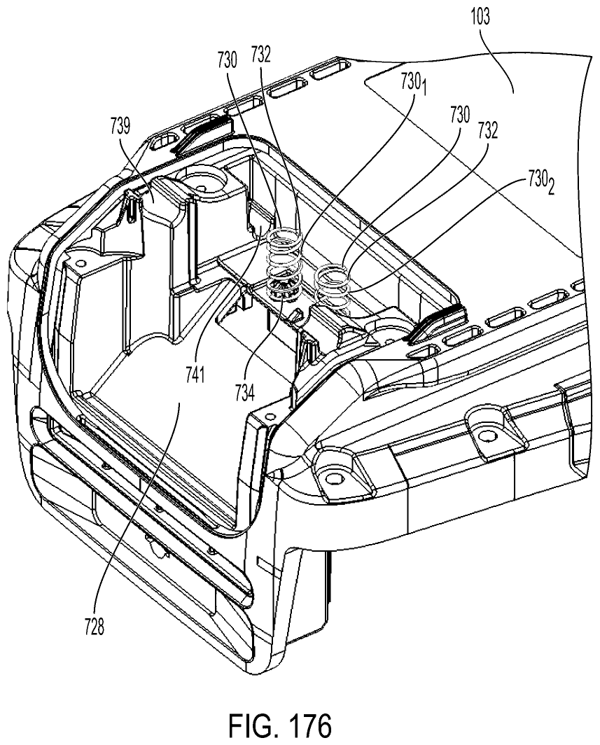

The first component 702 may include a pivot member 738 at the second end 706 and the user actuation element 720 at the first end 704. The second component 708 may include a pivot member 740 at the second end 712 and the latching element/latch 722 at the first end 710. As shown in FIG. 176, the pivot member 738 may be configured to be supported by portions 741 of the upper housing 103 of the battery pack 100 as the first component 702 is pivoted about the first rotation axis FRA-FRA. The pivot member 740 may be configured to be supported by portions 739 of the upper housing 103 of the battery pack 100 as the second component 708 is pivoted about the second rotation axis SRA-SRA. The support portions 739 and 741 may be disposed in a latch receiving cavity 728 of the upper housing 103 of the battery pack 100 and may be integrally formed with the upper housing 103 of the battery pack 100.

The latch system 700 may include a multi-part/two-piece latch having the first component 702 and the second component 708. The multi-part latch may be configured to be operable to mate and unmate the battery pack housing 102 from the power tool/the charger. As will be clear from the discussions in detail below, the first component 702 and the second component 708 may be configured to engage with each other. The first component 702 and the second component 708 may be referred to as a first latch portion and a second latch portion, respectively.

The latching system 700 may be referred to as a latch system or battery pack latching system. The first component 702 may also be referred to as user actuation element/user actuator. The second component 708 may also be referred to as a latching element/latch. The second rotation axis SRA-SRA may be referred to as a latching element/latch rotational axis. The first rotational axis FRA-FRA may be referred to as user actuation element/user actuator rotational axis.

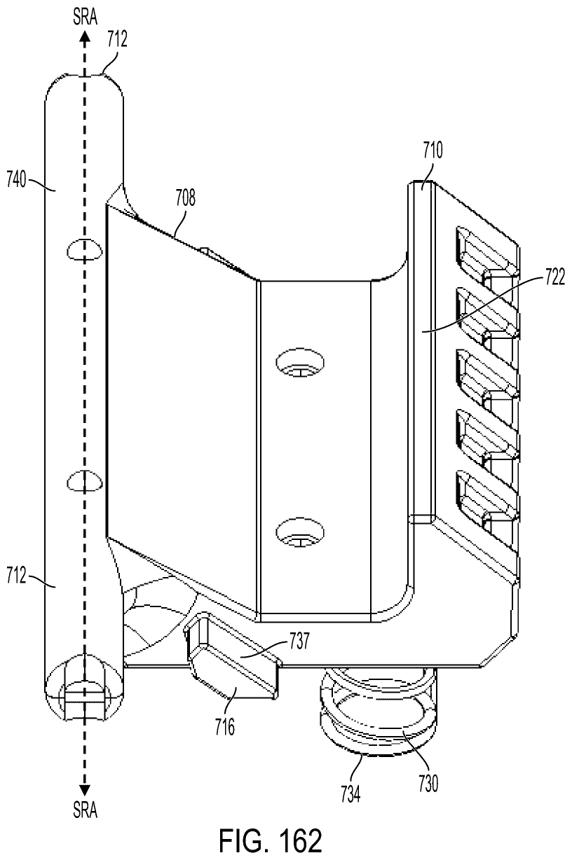

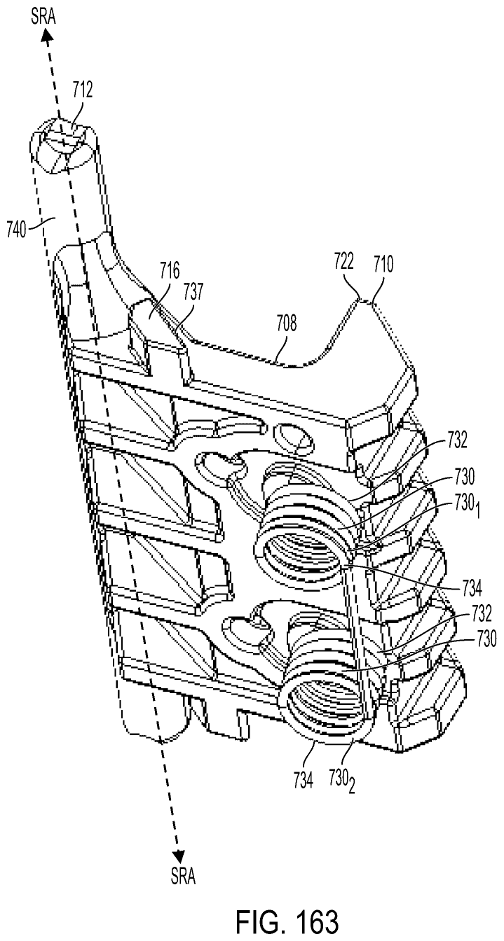

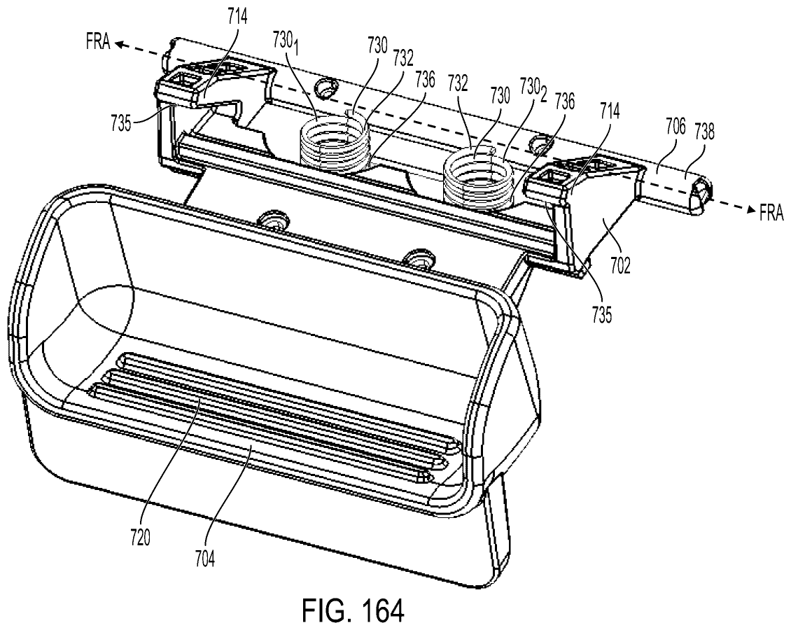

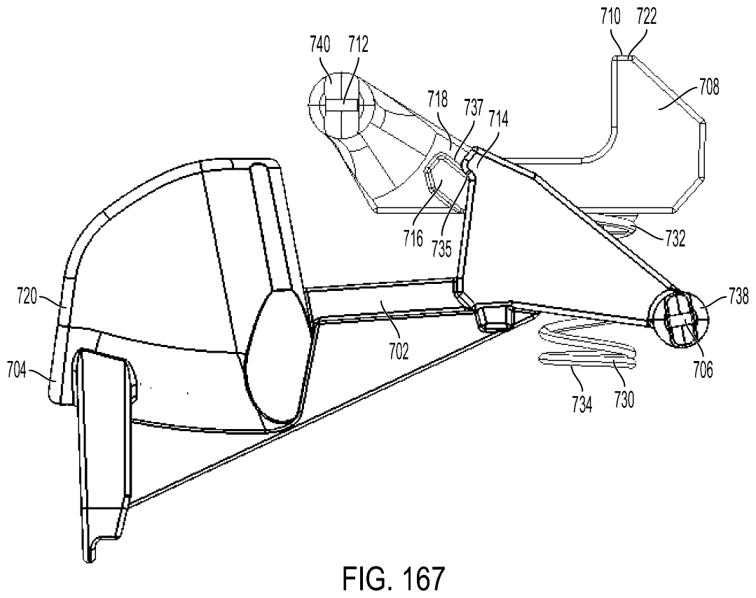

As shown in FIGS. 164-166, the first component 702 may include at least one shoulder 714 between the first end 704 and the second end 706 of the first component 702. As shown in FIGS. 162-163, the second component 708 may include at least one shoulder 716 between the first end 710 and the second end 712 of the second component 708. As shown in FIGS. 167-173, the first component shoulder 714 may be positioned to engage the second component shoulder 716 upon rotation of the first component 702 about the first rotation axis FRA-FRA forcing the second component 708 to rotate about the second rotation axis SRA-SRA.

The first component 702 may include the user actuation element 720 for user engagement. The second component 708 may include the latching element 722 configured to engage with the portions of the electrical device. The first end 710 of the second component 708 may include a latching element latching end 710 and the second end 712 of the second component 708 may include a latching element rotating end 712. The first end 704 of the first component 702 includes a user actuation element user end 704 and the second end 706 of the first component 702 includes a user actuation element rotating end 706.

As shown in FIGS. 167-173, the first component shoulder 714 engages the second component shoulder 716 in an area 718, the latching element rotating end 712 and the latching element latching end 710 are on opposite sides of a plane that is generally perpendicular to the mating direction and passes through the area 718. The latching element rotating end 712 may also be referred to as the second end 712 of the second component 708. Also, as shown in FIGS. 167-173, the first component shoulder 714 engages the second component shoulder 716 in the area 718.

The latch system 700 also may include a cover/latch cover 724. The latch cover 724 is shown in FIGS. 20, 24-25 and 187. The latch cover 724 may be connected to the upper housing member 103 (e.g., using mechanical fasteners 726) of the battery pack 100. The latch cover 724 may be configured to cover/enclose portions of the first component 702, portions of the second component 708, and other portions (e.g., spring system 730 that will be explained in detail below) of the latch system 700.

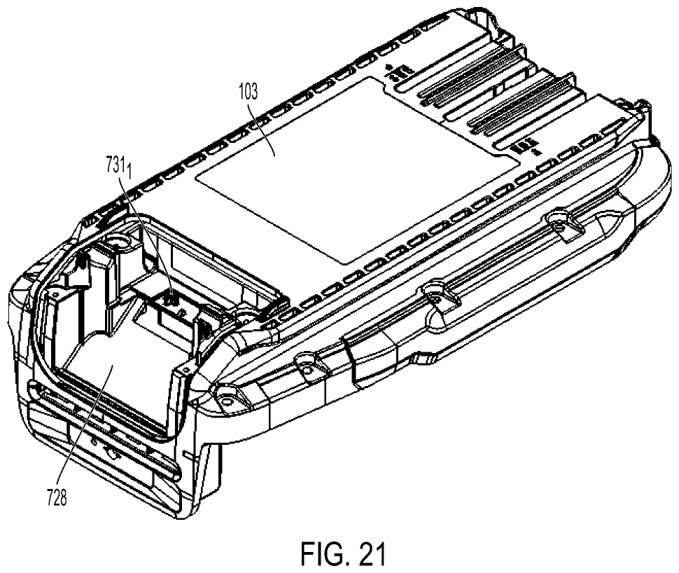

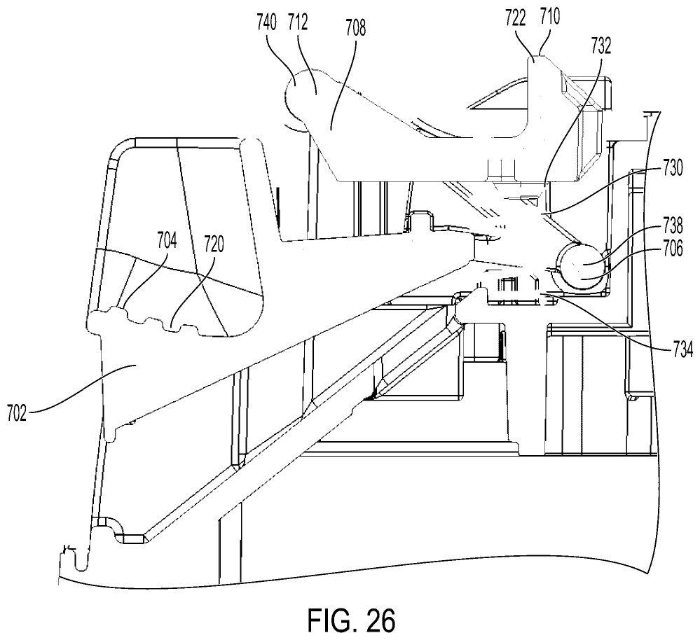

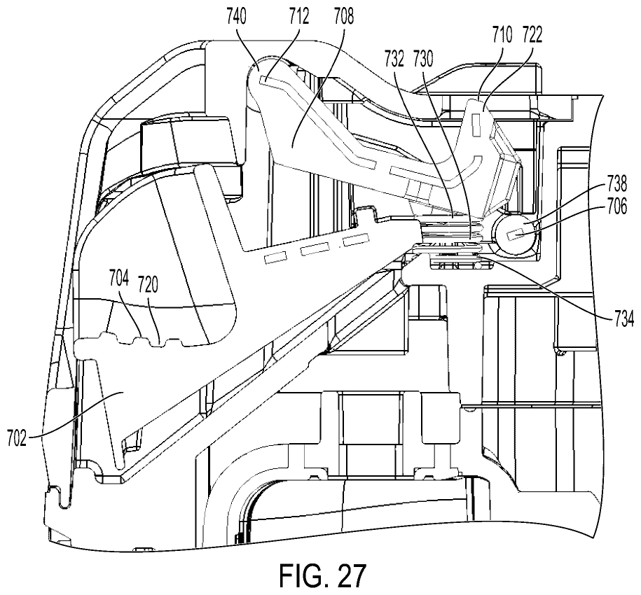

Referring to FIGS. 20-21, the latching system 700 may further comprise the spring assembly 730. The spring assembly 730 may have a first end 732 and a second end 734. The first end 732 of the spring assembly 730 may be configured to be operatively connected to the second component 708 of the latch system 700 and the second end 734 of the spring assembly 730 may be configured to be operatively connected to the housing 102 (e.g., the upper housing 103) of the battery pack 100. The spring assembly 730 may be configured to bias the second component 708 away from the housing 102 (e.g., the upper housing 103). Referring to FIG. 26, when the latching system 700 is in its unlatched configuration/position, the spring assembly 730 may be in its compressed configuration. Referring to FIG. 27, when the latching system 700 is in its latched configuration/position, the spring assembly 730 may be in its expanded configuration.

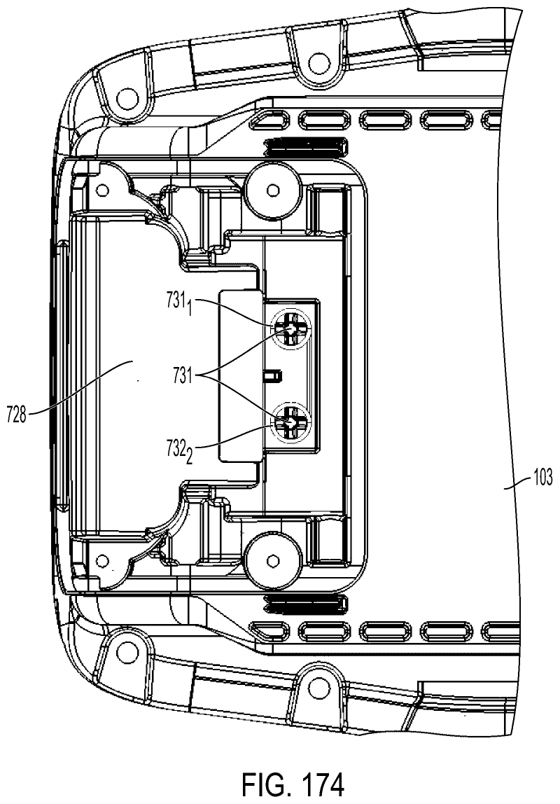

The spring assembly 730 may include two springs 730₁ and 730₂ in the illustrated embodiment. The number of springs may vary. The springs 730₁ and 730₂ may be disposed on a surface of the second component 708. The springs 730₁ and 730₂ may be disposed between the second component 708 and an inside surface of a top of the housing 102. The springs 730₁ and 730₂ may be connected to each other so they can operate simultaneously. The springs 730₁ and 730₂ may be disposed between spring supports 731₁ and 731₂ (as shown in FIG. 174) and a bottom surface of a portion of the second component 708. As shown in FIGS. 26-27 and 164-167, the springs 730₁ and 730₂ may be configured to pass through openings 736 in the first component 702 so as to engage with the bottom surface of the portion of the second component 708.

The first component 702 may be operatively associated with the actuation member 720 such the movement of the actuation member 720 causes the movement of the first component 702. When the actuation member 720 is depressed downwardly in the direction of an arrow AMDD (as shown in FIG. 20), it causes the first component 702 (i.e., operatively associated with the actuation member 720) to move along with the actuation member 720. This causes the first component 702 to pivot/rotate about the first rotation axis FRA-FRA.

As shown in FIGS. 26-27 and 185-186, when the first component shoulder 714 engages the second component shoulder 716 in the area 718, the second component 708 is forced to rotate about the second rotation axis SRA-SRA against the bias of the spring assembly 730. That is, upon rotation of the first component 702 about the first rotation axis FRA-FRA, cam surfaces 735 of the first component shoulder 714 may be configured to engage and force cam surfaces 737 of the second component shoulder 716. This forces the second component 708 to rotate about the second rotation axis SRA-SRA.

Referring to FIGS. 20-21 and 174-176, the latch system 700 (including the first component 702, the second component 708, the spring system 730) may be received in the latch receiving cavity 728. The latch receiving cavity 728 may be defined by a plurality of walls integrally formed by the upper/top housing portion 103 of the battery pack 100. The latch receiving cavity/volume/pocket 728 may be sealed off from the internal/interior cavity 104 of the battery pack 100. The sealed off latch receiving cavity/volume/pocket 728 may allow for the elimination or reduction of water and particulate ingress into the internal/interior cavity 104 of the battery pack 100. That is, the sealed off latch receiving cavity/volume/pocket 728 may be configured to maintain a seal against leaks and ingress of dust and water into the internal/interior cavity 104 of the battery pack 100.

When the user actuation element 720 is actuated by the user, the first component shoulder 714 engages the second component shoulder 716 upon rotation of the first component 702 about the first rotation axis FRA-FRA forcing the second component 708 to rotate about the second rotation axis SRA-SRA against the bias of the spring assembly 730. The rotation of the second component 708 about the second rotation axis SRA-SRA causes the latching element 722 of the second component 708 to disengage from the portions of the electrical device.

The latch element/latch 722 of the second component 708 may be configured to pass through an opening on the latch cover 724. The first component 702 including the user actuation element/user actuator 720, the second component 708 including the latching element/latch 722, and the spring assembly 730 may all be held in place in the latch receiving cavity 728 by the latch cover 724.

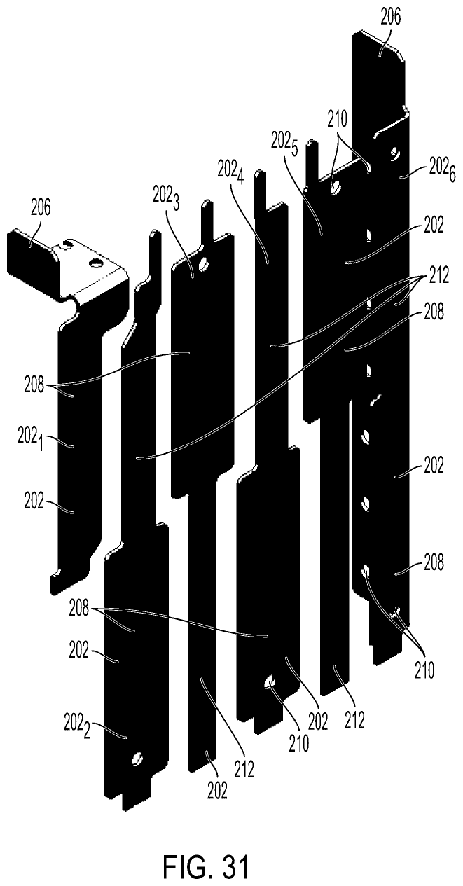

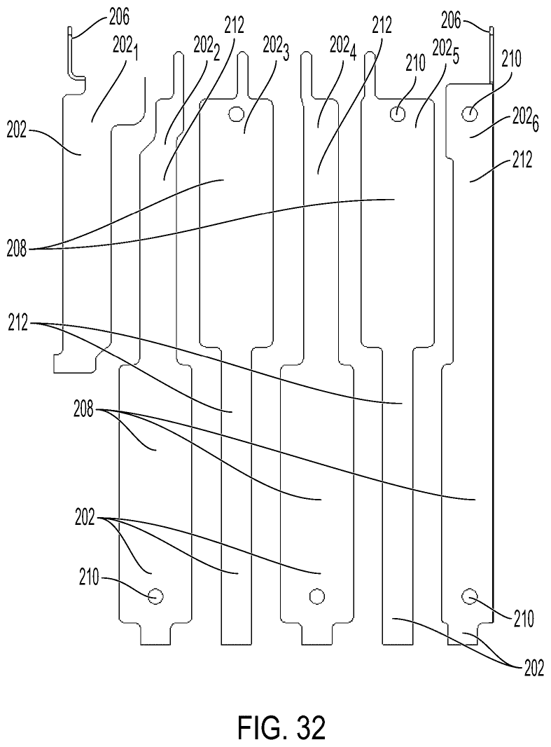

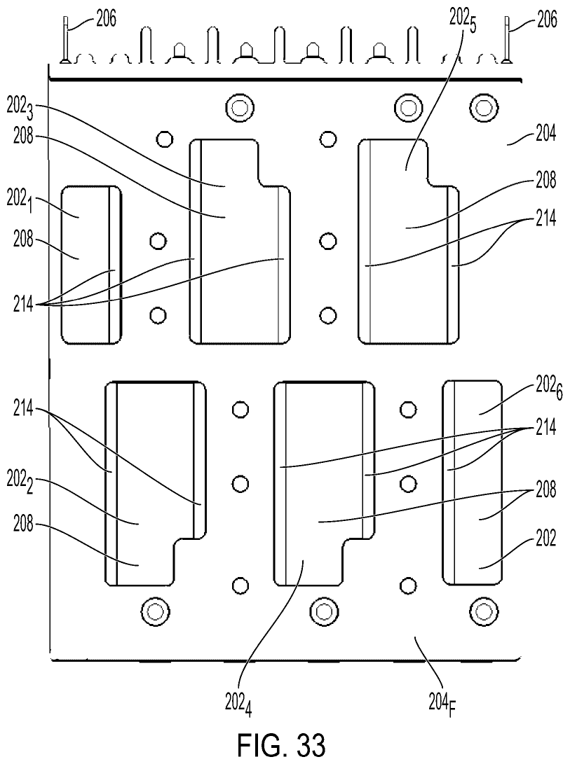

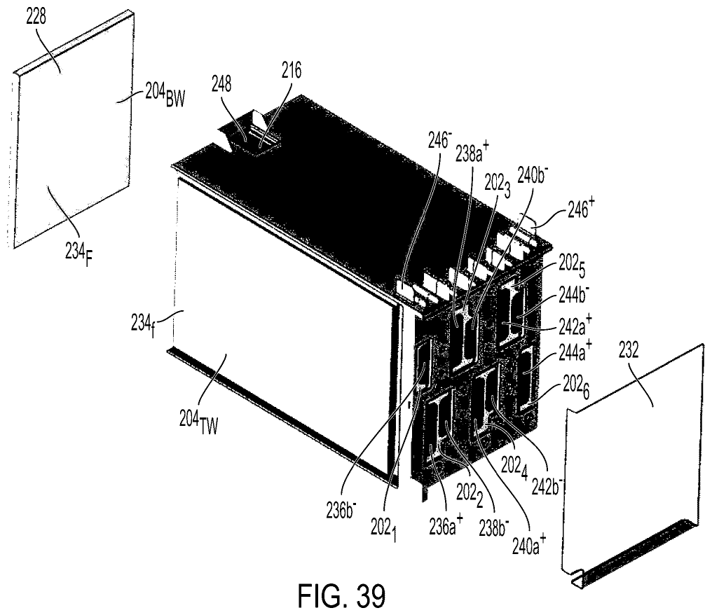

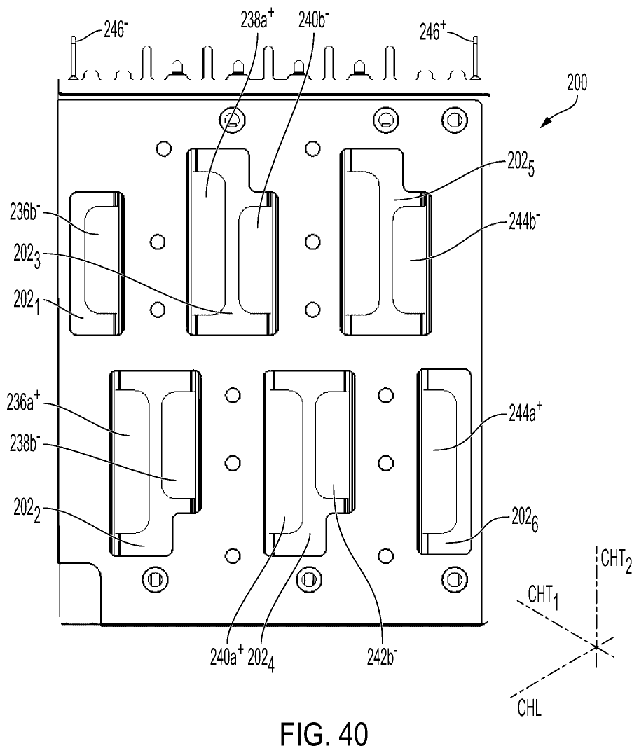

The battery pack 100 may include one or more battery cell modules 200 (as shown in FIGS. 39-40). Referring to FIGS. 31-40, the battery cell module 200 may include contacts 202. The contacts 202 may include battery cell holder collection straps 202. The battery cell module 200 may also include a battery cell holder 204 that is injection molded around the battery cell holder collection straps 202. For example, FIGS. 31-32 show various views of the battery cell holder collection straps 202 of the battery cell module 200. FIGS. 33-36 show various views of the battery cell holder 204 of the battery cell module 200, the battery cell holder collection straps 202 being fixedly held in place by the battery cell holder 204. In some embodiments, the battery cell module 200 can be laser welded to the battery cell holder 204.

As described below, due to the nature of the battery cell holder 204 and use of the battery cell holder 204 within a module holder and a cell holder subassembly, the battery cell holder 204 may be referred to and described as a battery cell holder that is modular or a modular cell holder.

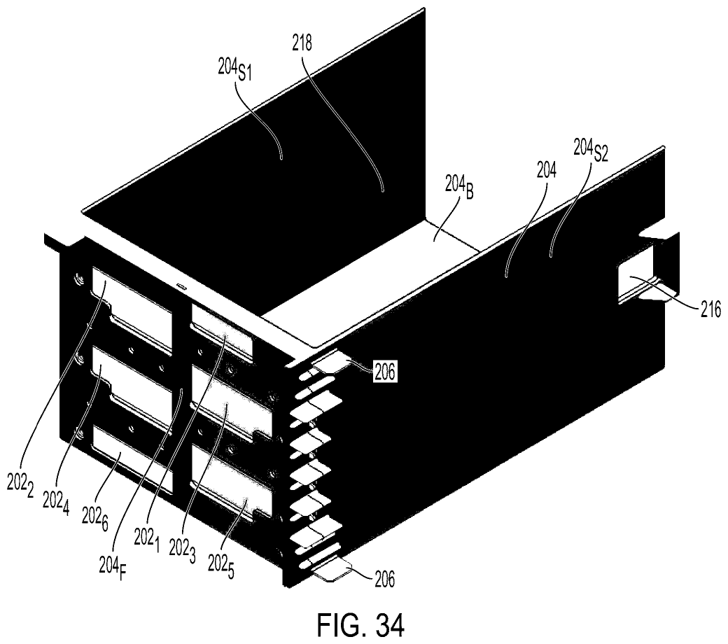

In the illustrated embodiment of FIG. 34, six battery cell holder collection straps 202₁, 202₂, 202₃, 202₄, 202₅ and 202₆ are shown. The number of the battery cell holder collection straps may vary. Each of the battery cell holder collection straps 202 may be made of a metal, electrically conductive material, as is well known in the art. The battery cell holder collection straps 202₁ and 202₆ may be referred to as end battery cell holder collection straps and may include their respective tangs 206 that protrude outwardly away from the battery cell holder 204. Each of the battery cell holder collection straps 202₁, 202₂, 202₃, 202₄, 202₅, and 202₆ may include a contact region 208. As will be explained in detail in discussions below, an end of a cell tab of a pouch battery cell or ends of cell tabs of adjacent pouch battery cells may be folded to connect to an associated contact region 208. Each of the battery cell holder collection straps 202 may also include an opening 210 and thinner portions 212 to enable the battery cell holder 204 to be injection molded around the battery cell holder collection straps 202. When the battery cell holder 204 is injection molded around the battery cell holder collection straps 202, openings 214 may be formed between portions of the battery cell holder 204 and the battery cell holder collection straps 202. These openings 214 may be configured to allow the end(s) of the cell tab(s) of pouch battery cell(s) to extend therethrough so as to be folded to connect to their associated contact region. In some embodiments, individual parts can be insert molded (e.g., by a connecting frame and then cut off afterwards).

The battery cell holder 204 includes a base 204_{B}, a pair of opposing side walls 204_{S1} and 204_{S2} extending perpendicularly to the base 204_{B}, and a front wall 204_{F} extending perpendicularly to the base 204_{B} and the pair of opposing side walls 204_{S1} and 204_{S2}. The front wall 204_{F} may include the wall that is injection molded around the battery cell holder collection straps 202. The front wall 204_{F} of the battery cell holder 204 may also be referred to as front collection wall. The front wall 204_{F}, the base 204_{B} and the pair of opposing side walls 204_{S1} and 204_{S2} of the battery cell holder 204 may together form/define an internal cavity 218 in which battery cells 220 are received. Two (or more) gap pads 222 may be disposed in the internal cavity 218 and may be positioned along or adjacent to the pair of opposing side walls 204_{S1} and 204_{S2}. The gap pads may include foam. Alternatively, a foam material may be used in place of the gap pads 222.

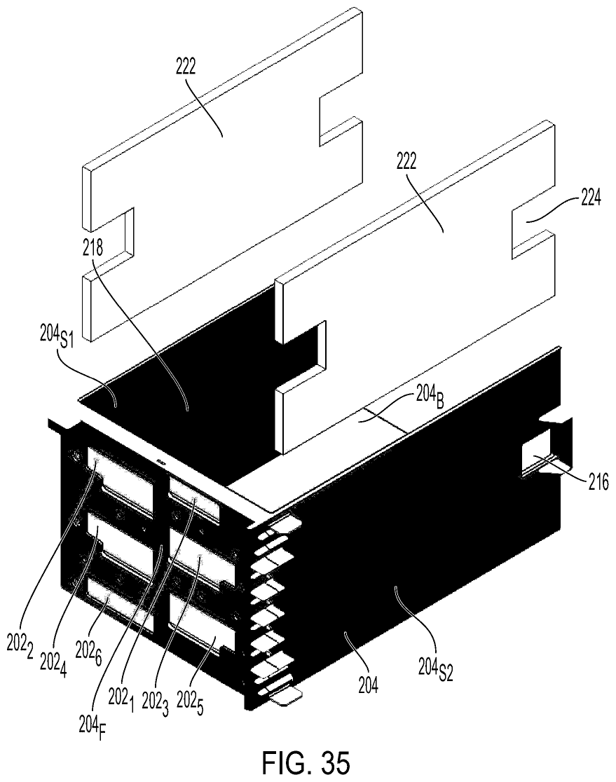

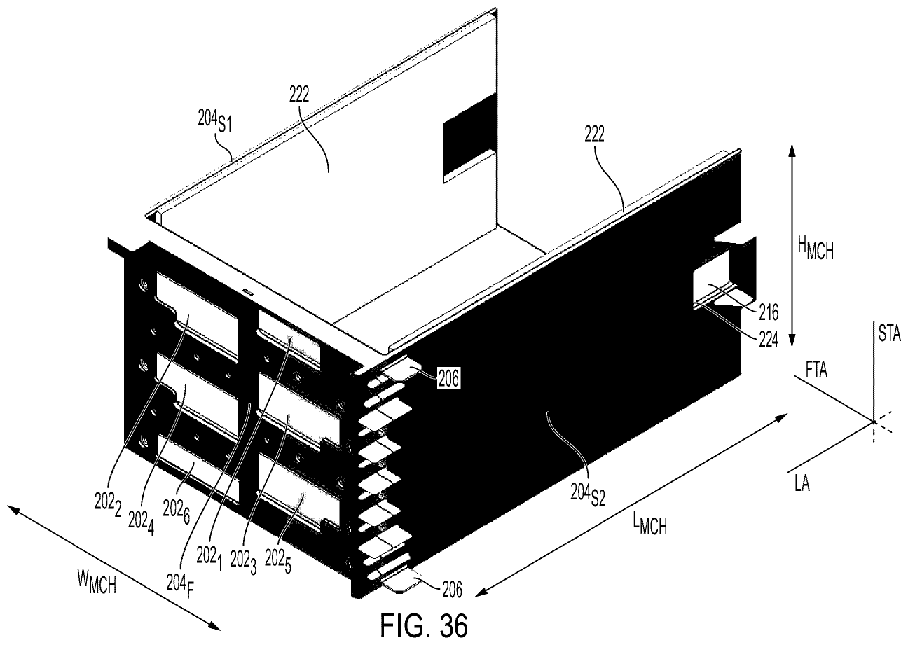

FIG. 35 shows the battery cell holder 204 before the gap pads 222 are installed/disposed in the battery cell holder 204 and FIG. 36 shows the battery cell holder 204 after the gap pads 222 are installed/disposed in the battery cell holder 204. The battery cell holder 204 may have a length L_{MCH} along a longitudinal axis LA-LA, a width WMCH along a first transverse axis FTA-FTA that is perpendicular to the longitudinal axis LA-LA, and a height H_{MCH} along a second transverse axis STA-STA that is perpendicular to the longitudinal axis LA-LA and the first transverse axis FTA-FTA.

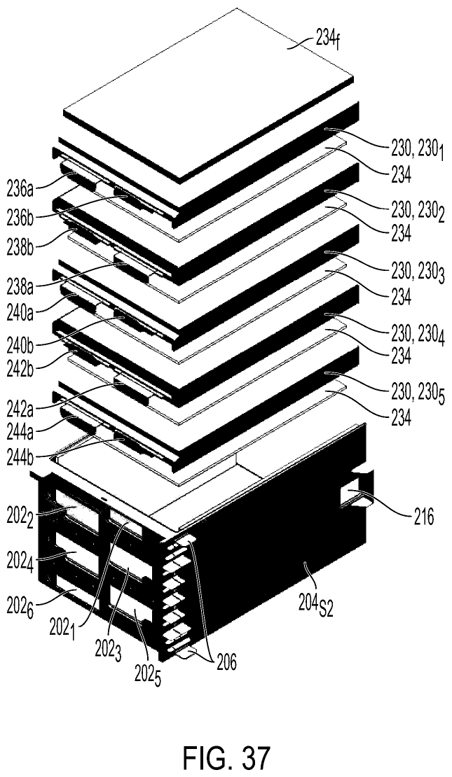

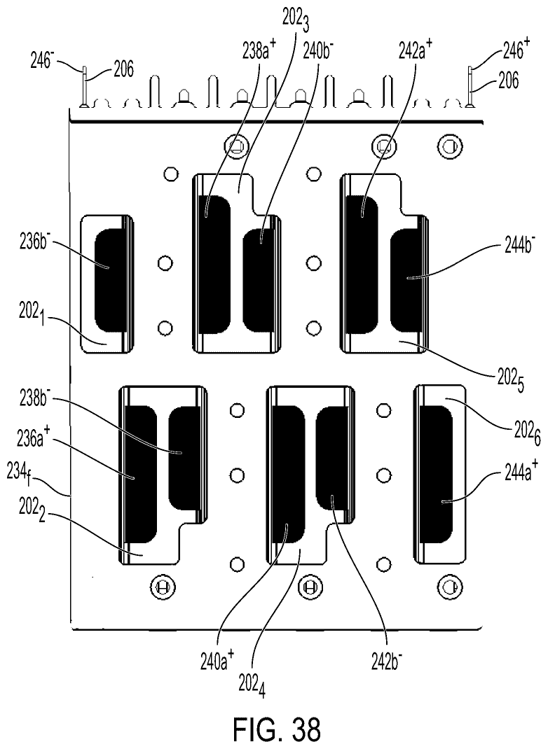

FIG. 37 shows an exploded view of the battery cell holder 204, a plurality of battery cells 230, and gap pads 234 (e.g., that are configured to be installed/disposed on each side of each battery cell 230) of the battery cell module 200. FIG. 37 shows the battery cell holder 204 before the battery cells 230 and the gap pads 234 are installed/disposed in the battery cell holder 204. The battery pad 234_{f} may be disposed at an end of the battery cell holder 204 after the battery cells 230 and the gap pads 234 are installed/disposed in the battery cell holder 204. FIG. 38 shows a front view of the battery cell holder 204 with the battery cells 230, and the gap pads 234 installed/disposed therein. FIG. 37 shows the battery cell module 200 resting on the base 204_{B} of the battery cell module 200, while FIG. 38 shows the battery cell module 200 turned to its side (i.e., resting on the side walls 204_{S1} of the battery cell holder 204).

FIG. 39 shows a perspective view of the battery cell holder 204 with the battery cells 230 and the gap pads 222, 234 installed/disposed therein. FIG. 39 also shows a thermistor connection 248, an end gap pad 228 and an end insulating layer 232 before the end gap pad 228 and the end insulating layer 232 are installed/disposed at the ends of the battery cell holder 200. The end insulating layer 232 is installed/disposed at the end of the battery cell holder 204 that has the battery cell tabs. FIG. 40 shows a front view of the battery cell module 200 of the battery pack. The battery cell module 200 includes the battery cell holder 204, the battery cells 230 with their battery cell tabs, the battery cell holder collection straps 202, all the gap pads 222, 234, 228, and the end insulating layer 232.

As shown in FIG. 39, the gap pad 234_{F} may form the top wall 204_{TW} and the gap pad 234_{f} may form the back wall 204_{BW} of the battery cell holder 204. The insulating layer 232 may be positioned on the front collection wall 204_{F}. The gap pads may generally be soft, conformable thermal pads that provide effective thermal interfaces between heat sinks and electronic devices, accommodating for uneven surfaces, air gaps, and rough surface textures. An insulating material or gap pad 234 may be positioned between two adjacent pouch battery cells 230. The insulating material may provide thermal insulation between two adjacent pouch battery cells 230. The insulating material may be thermally insulating, thermally conductive (e.g., to conduct heat away from unwanted locations), or thermally absorptive, between two adjacent pouch battery cells 230. The insulating material may also have compression properties to allow two adjacent pouch battery cells 230 to expand during charge and/or discharge of the cells 230. The insulating material may be, for example, a polyurethane or silicone foam of the closed or open cell variety, or a ceramic textile.

The battery cell holder 204 may include an opening 216 that is configured to enable a thermistor connection 248. An opening 224 of the gap pad 222 may be aligned with the opening 216 of the side wall 204_{S2} so as to facilitate the thermistor connection.

In the illustrated embodiment, referring to FIGS. 37-40, five pouch battery cells 230₁, 230₂, 230₃, 230₄, and 230₅ are shown. The number of the pouch battery cells 230 may vary. The pouch battery cells 230 are shown in a back-to-back or opposed to each other. Each of the pouch battery cells 230 may include a pouch case.

The first pouch battery cell 230₁ may include a first (positive) cell tab 236a+ and a second (negative) cell tab 236b⁻. The second pouch battery cell 230₂ may include a first (positive) cell tab 238a⁺ and a second (negative) cell tab 238b⁻. The third pouch battery cell 230₃ may include a first (positive) cell tab 240a⁺ and a second (negative) cell tab 240b⁻. The fourth pouch battery cell 230₄ may similarly include a first (positive) cell tab 242a⁺ and a second (negative) cell tab 242b⁻. The fifth pouch battery cell 230₅ may include a first (positive) cell tab 244a⁺ and a second (negative) cell tab 244b⁻.

In the context of the present disclosure, the tabs/taps of the same cell are considered aligned in a row (and are adjacent to each other) and the tabs of different cells are aligned are in a column. Furthermore, the tabs of adjacent cells that are aligned in a column are denoted as adjacent tabs. In other words, the positive tab 236a⁺ of the first pouch battery cell 230₁ is adjacent to the negative tab 236b⁻ of the first pouch battery cell 230₁ in a first direction, and the positive tab 238a⁺ of the second pouch battery cell 230₂ is adjacent to the negative tab 238b⁻ of the second pouch battery cell 230₂ in the first direction. Also, the positive tab 236a⁺ of the first pouch battery cell 230₁ is adjacent to the negative tab 238b⁻ of the second pouch battery cell 230₂ in a second direction (generally perpendicular to the first direction) and the negative tab 236b of the first pouch battery cell 230₁ is adjacent to the positive tab 238a⁺ of the second pouch battery cell 230₂ in the second direction. The positive tab 236a⁺ of the first pouch battery cell 230, 230₁ is not considered adjacent to the positive tab 238a⁺ of the second pouch battery cell 230₂ and the negative tab 236b of the first pouch battery cell 230₁ is not considered adjacent to the negative tab 238b⁻ of the second pouch battery cell 230₂. Although not detailed here, the cell tabs of the rest of the pouch battery cells are ordered in the same manner.

The ends of the cell tabs are folded to connect to an associated metallic pad. Specifically, the first (positive) cell tab 244a⁺ of the fifth battery cell 230₅ (the most positive cell tab once all of the battery cells of the set of battery cells 230 are connected in series) is folded to overlap the metallic pad 202₆. The second (negative) cell tab 236b⁻ of the first battery cell 230₁ (the most negative cell tab once all of the battery cells of the set of battery cells 230 are connected in series) is folded to overlap the metallic pad 202₁.

The second (negative) cell tab 242b⁻ of the fourth battery cell 230₄ and the first (positive) cell tab 240a⁺ of the third battery cell 230₃ are folded to overlap the metallic pad 202₄. The second (negative) cell tab 238b⁻ of the second battery cell 230₂ and the first (positive) cell tab 236a⁺ of the first battery cell 230₁ are folded to overlap the metallic pad 202₂. The first (positive) cell tab 238a⁺ of the second battery cell 230₂ and the second (negative) cell tab 240b of the third battery cell 230₃ are folded to overlap the metallic pad 202₃. The first (positive) cell tab 242a⁺ of the fourth battery cell 230₄ and the second (negative) cell tab 244b⁻ of the fifth battery cell 230₅ are folded to overlap the metallic pad 202₅.

Once all of the battery cells 230 are connected in series, the battery cell module 200 includes positive battery cell module terminal 246⁺ and negative battery cell module terminal 246⁻.

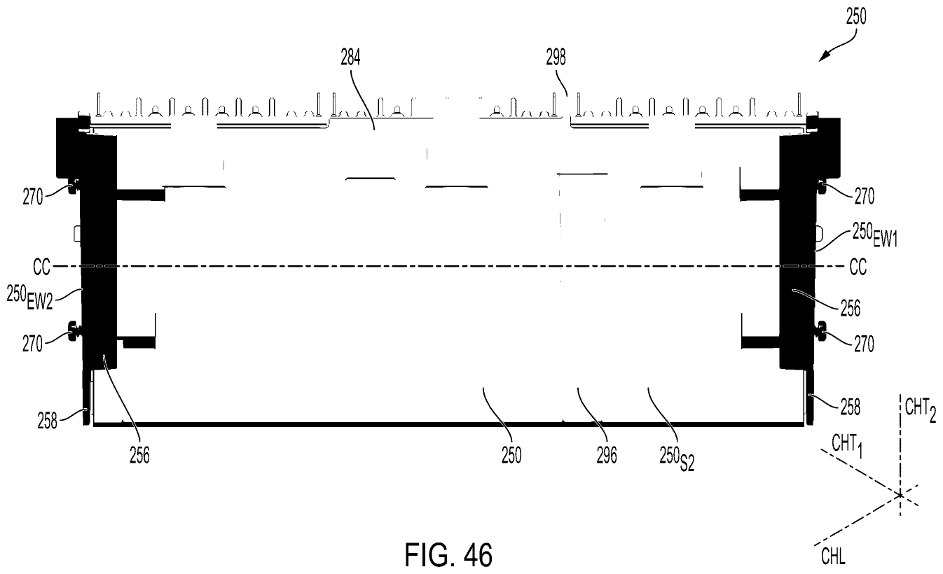

The battery pack 100 may include a cell holder subassembly 250. FIGS. 46-49 show perspective views of the assembled cell holder subassembly 250 of the battery pack 100. As will be clear from the discussions in detail below, the cell holder subassembly 250 may be received in the internal cavity 104 of the housing 102 of the battery pack 100. The cell holder subassembly 250 may also include a module(s) holder or battery cell module(s) holder 252. The module holder 252 may be configured to receive one or more battery cell modules 200 (200₁, 200₂, 200₃).

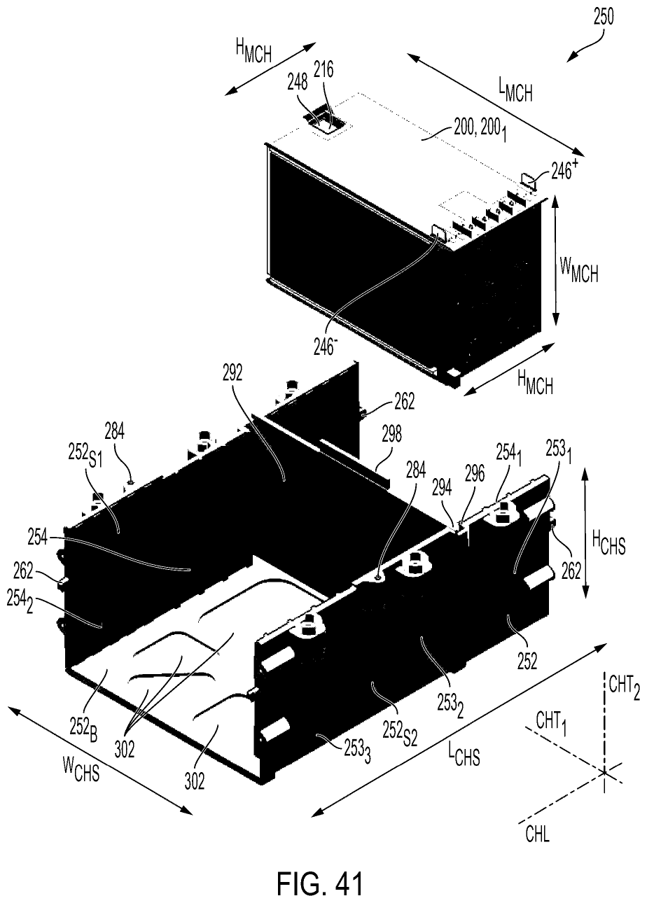

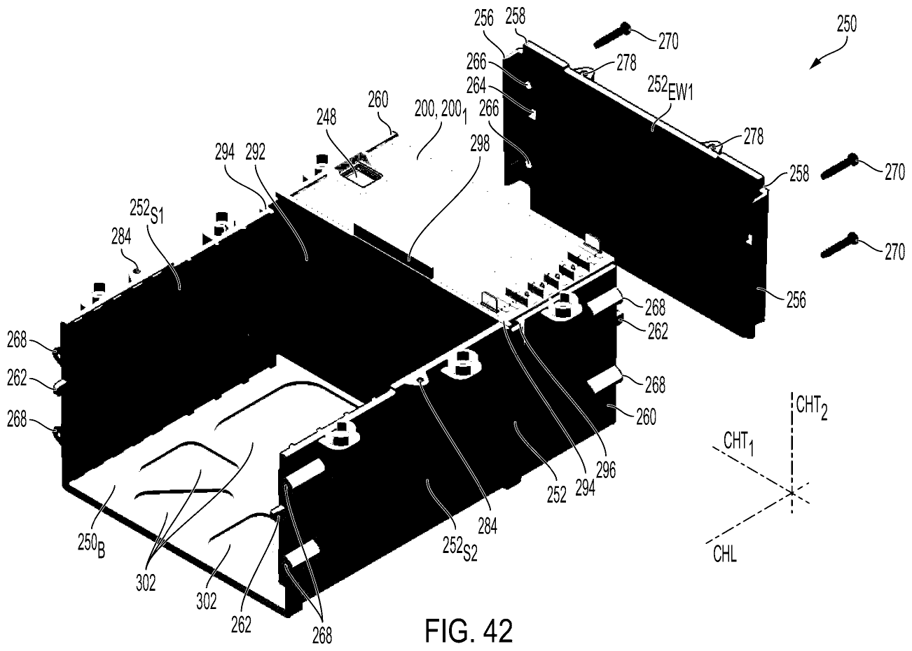

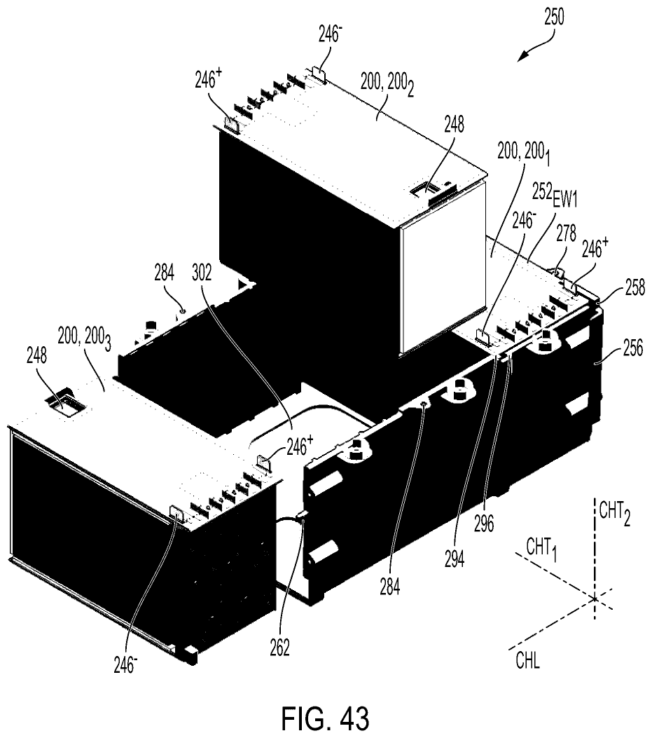

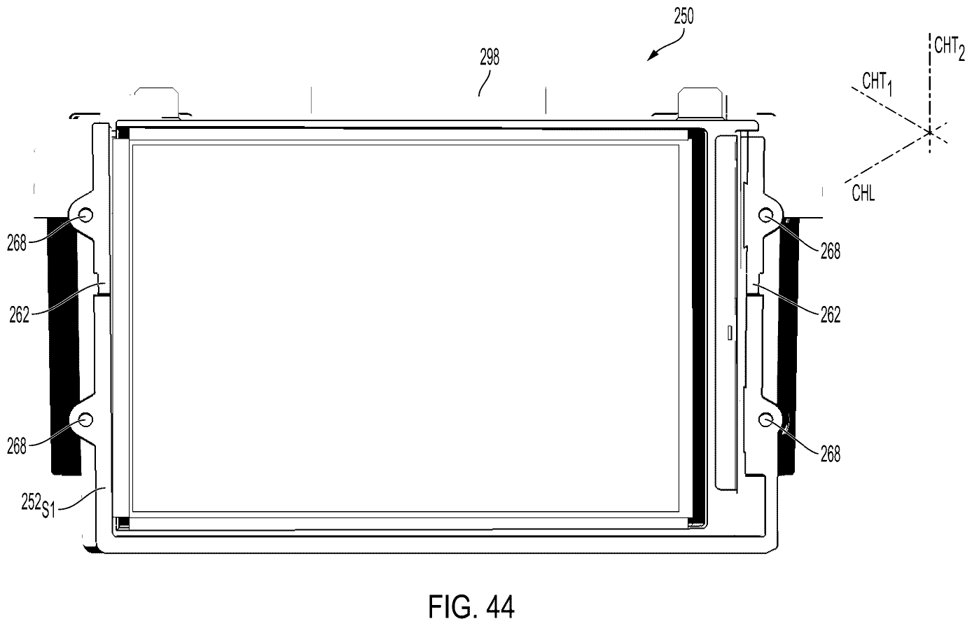

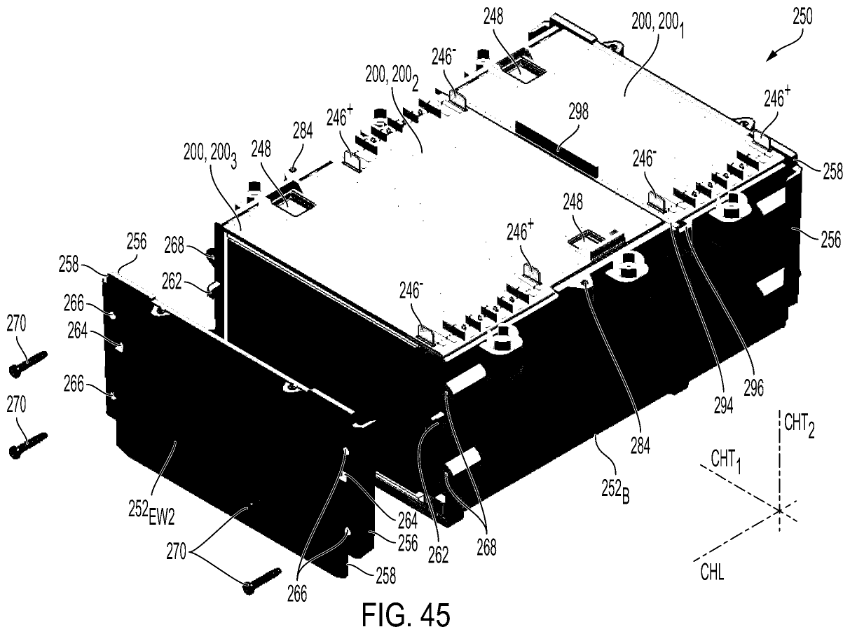

FIG. 41 shows a first battery cell module 200₁ before it is installed/disposed in the module holder 252, while FIG. 42 shows the first battery cell module 200₁ after it is installed/disposed in the module holder 252. FIG. 43 shows the first battery cell module 200₁ after it is installed/disposed in the module holder 252 and a second battery cell module 200₂ and a third battery cell module 200₃ before they are installed/disposed in the module holder 252. FIG. 43 also shows that each battery cell module 200 is disposed in reverse order/direction with respect to its adjacent battery cell modules 200. This reverse order/direction orientation of the adjacent battery cell modules is explained in detail below and can be observed by looking at battery cell module tabs 246⁺ and 246⁻ of each battery cell module 200 and thermistor connection 248 of each battery cell module 200. FIGS. 44 and 45 show with three battery cell modules 200 (200₁, 200₂, 200₃) installed/disposed in the module holder 252.

The module holder 252 may be configured to receive three battery cell modules 200 therein. That is, the module holder 252 of the cell holder subassembly 250 may include three locations 253 (253₁, 253₂, 253₃) for receiving a battery cell module 200. Each battery cell module receiving location 253₂ (253₁, 253₂, 253₃) may be configured to receive one of the battery cell modules 200 (200₁, 200₂, 200₃). The number of the battery cell modules 200 received in the cell holder subassembly 250 may vary. The number of battery cell module receiving locations 253 in the cell holder subassembly 250 may vary in accordance with the number of battery cell modules 200 in the cell holder subassembly 250.

The module holder 252 includes a base 252_{B} and two opposing side walls 252_{S1} and 252_{S2} that form an interior space/storage space 254 that is configured to receive a set of battery cell modules 200. The module holder 252 may have a length dimension L_{CHS} along a longitudinal axis CHL-CHL, a width dimension W_{CHS} along a first transverse axis CHT₁-CHT₁ that is perpendicular to the longitudinal axis CHL-CHL, and a height dimension H_{CHS} along a second transverse axis CHT₂-CHT₂ that is perpendicular to the longitudinal axis CHL-CHL and the first transverse axis CHT₁-CHT₁. The two side walls 252_{S1} and 252_{S2} extend along the longitudinal axis CHL-CHL of the module holder 252.

The base 252_{B} may have a length dimension L_{CHS} along the longitudinal axis CHL-CHL of the module holder 252 and a width dimension W_{CHS} along the first transverse axis CHT₁-CHT₁ of the module holder 252. The width dimension W_{CHS} of the base 252_{B} may be the same as the length dimension L_{MCH} of the battery cell module 200. Each side wall 252_{S1}, 252_{S2} may have a length dimension L_{CHS} along the longitudinal axis CHL-CHL of the module holder 252 and a height dimension H_{CHS} along the second transverse axis CHT₂-CHT₂ of the module holder 252. The height dimension H_{CHS} of each side wall 252_{S1}, 252_{S2} may be the same as the width dimension WMCH of the battery cell module 200.

The length dimension of each side wall 252_{S1}, 252_{S2} may be the same as the length dimension of the base 252_{B}. The length dimension of each side wall 252_{S1}, 252_{S2} may be different from the length dimension of the base 252_{B}. The length dimension of each side wall 252_{S1}, 252_{S2} and/or the length dimension of the base 252_{B} may be the same as the length dimension L_{CHS} of the module holder 252. The length dimension of each side wall 252_{S1}, 252_{S2} and/or the length dimension of the base 252_{B} may be at least equal to a sum of the height dimension H_{MCH} (as the battery cell modules 200 are received on their sides in the module holder 252) of each battery cell module 200 being received in the module holder 252. For example, when three battery cell modules 200, having the same height dimension are being received in the module holder 252, the length dimension of the base 252_{B} and/or the length dimension of each side wall 252_{S1}, 252_{S2} may be configured to be equal to three times the height dimension H_{MCH} of the battery cell module 200. When one or more partition walls are received by the module holder 252, the length dimension of the base 252_{B} and/or the length dimension of each side wall 252_{S1}, 252_{S2} may be configured to be equal to a sum of a thickness dimension of each partition wall being received and a height dimension H_{MCH} of each battery cell module 200 being received.

The two side walls 252_{S1}, 252_{S2} of the module holder 252 may be separated from each other by a separation distance along the first transverse axis CHT₁-CHT₁ of the module holder 252. The separation distance may be equal to at least the length dimension L_{MCH} of the battery cell module 200 being received.

The base 252_{B} and the two side walls 252_{S1}, 252_{S2} of the module holder 252 may be integrally formed. The base 252_{B} and the two side walls 252_{S1}, 252_{S2} of the module holder 252 may form a single piece assembly. The base 252_{B} and the two side walls 252_{S1}, 252_{S2} of the module holder 252 may be molded (e.g., injection molded) together. The base 252_{B} and the two side walls 252_{S1}, 252_{S2} of the module holder 252 may be made of a plastic material, a hard plastic material or other materials that are configured to support the weight of the battery cell modules 200 being received in the module holder 252.

The cell holder subassembly 250 may include two opposing end walls 252_{EW1}, 252_{EW2} that extend perpendicular to the base 252_{B} and the two side walls 252_{S1}, 252_{S2} and that extend along the first transverse axis CHT₁-CHT₁ of the module holder 252. The two end walls 252_{EW1}, 252_{EW2} may be configured to be removably connected to the two side walls 252_{S1}, 252_{S2}.

FIG. 42 shows one of the two opposing end walls 252_{EW1}, 252_{EW2} of the cell holder subassembly 250 before it is attached to the module holder 252, while FIG. 43 shows one of the two opposing end walls 252_{EW1}, 252_{EW2} of the cell holder subassembly 250 after it is attached to the module holder 252. FIGS. 44 and 45 show the cell holder subassembly 250 before the other of the two opposing end walls 252_{EW1}, 252_{EW2} is attached to the module holder 252. FIGS. 46-48 show the cell holder subassembly 250 after two opposing end walls 252_{EW1}, 252_{EW2} are attached to the module holder 252.

Each end wall 252_{EW1}, 252_{EW2} may include flange portions 256 at their ends 258. The flange portions 256 are configured to extend along the longitudinal axis CHL-CHL of the cell holder subassembly 250 to overlap with end portions 260 of the two side walls 252_{S1}, 252_{S2}. The flange portions 256 may be optional. Each side wall 252_{S1}, 252_{S2} may include aligning members 262 that protrude therefrom and may be configured to be received in a corresponding openings 264 of the end walls 252_{EW1}, 252_{EW2} so as to align the end walls 252_{EW1}, 252_{EW2} with respect to the side walls 252_{S1}, 252_{S2}. The end walls 252_{EW1}, 252_{EW2} may include fastener openings/holes 266 in a pattern corresponding to fastener openings/holes 268 of the side walls 252_{S1}, 252_{S2}. Mechanical fasteners (e.g., screws, etc.) 270 may be inserted through the fastener openings/holes 266, 268 after they are aligned, for connecting the end walls 252_{EW1}, 252_{EW2} to the side walls 252_{S1}, 252_{S2}.

Referring to FIG. 41-48, the cell holder subassembly 250 may include one or more partition walls 292 that extend parallel to the two end walls 252_{EW1}, 252_{EW2} and along the first transverse axis CHT₁-CHT₁ of the cell holder subassembly 250. The one or more partition walls 292 may be configured to be removably connected to the two side walls 252_{S1}, 252_{S2}. When installed, the one or more partition walls 292 may be configured to divide the interior storage space 254 of the cell holder subassembly 250 into two or more storage spaces 254₁, 254₂. Each of the two or more storage spaces 254₁, 254₂ may be configured to receive one or more of the set of battery cell modules 200.

In the illustrated embodiment, only one partition wall 292 is shown. This partition wall 292 separates the internal storage space 254 of the cell holder subassembly 250 into a first storage space 254₁ and a second storage space 254₂. In the illustrated embodiment, the first storage space 254₁ receives a single battery cell module 200, while the second storage space 254₂ may be configured to receive two battery cell modules 200.

In another embodiment, the cell holder subassembly 250 may be configured to receive two partition walls 292 that are configured to separate the internal storage space 254 of the cell holder subassembly 250 into three storage spaces. Each storage space may be configured to receive one battery cell module 200. The partition wall 292 is optional.

The partition wall 292 may include end portions 294 (e.g., ridges, etc.) that are configured to slide into and out of mating grooves or end receiving portions 296 disposed on the side wall 252_{S1}, 252_{S2} to removably or slidably connect the partition wall 292 to the cell holder subassembly 250. In another embodiment, the partition wall 292 may be integrally molded with the base 252_{B} and the two side walls 252_{S1}, 252_{S2} of the module holder 252.

The partition wall 292 may include an aligning member 298 that protrudes away from the partition wall 292 and extends along the second transverse axis CHT₂-CHT₂ of the module holder 252 (when the partition wall 292 is installed in the cell holder subassembly 250).

Referring to FIG. 41-48, when received in the module holder 252/cell holder subassembly 250, each battery cell module 200 may be configured to be positioned to be parallel to the first transverse axis CHT₁-CHT₁ of the module holder 252/cell holder subassembly 250. The battery cell module 200 may be configured to be positioned on its side as the battery cell module 200 is being disposed in the module holder 252.

The battery cell module 200 may include a plurality of battery cells 230 that are stacked in the battery cell module 200 along the longitudinal axis CHL-CHL of the cell holder subassembly 250. Each battery cell 230 of the battery cell module 200 may be in a plane that is parallel to the first transverse axis CHT₁-CHT₁ of the cell holder subassembly 250.

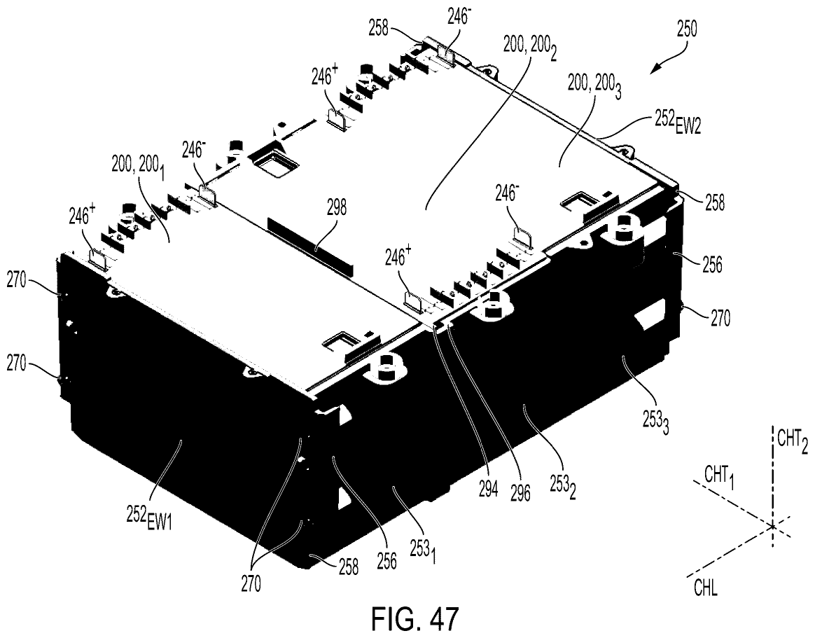

Referring to FIGS. 43, 45 and 47, the battery cell module tabs 246⁺ and 246⁻ of each battery cell module 200 may be disposed to be offset by 180 degrees with respect to its adjacent battery cell modules 200. The battery cell module tabs 246⁺ and 246⁻ of each battery cell module 200 may be configured to face away from the base 252_{B} and may be disposed in a plane that is parallel to the base 252_{B} of the module holder 252. It can also be seen from these figures that the thermistor connection 248 of each battery cell module 200 is disposed to be offset by 180 degrees with respect to its adjacent battery cell modules 200. Referring to FIGS. 45 and 47, the thermistor connection 248 and the battery cell module tabs 246⁺ and 246⁻ for each battery cell module 200 (200₁, 200₂, 200₃) may be disposed on their opposing sides/ends. Also, the thermistor connection 248 of the first battery cell module 200₁ may be disposed to be offset by 180 degrees with respect to the thermistor connection 248 of the second battery cell modules 200₂ and the thermistor connection 248 of the second battery cell module 200₂ may be disposed to be offset by 180 degrees with respect to the thermistor connection 248 of the third battery cell modules 200₃. Similarly, the battery cell module tabs 246⁺ and 246⁻ of the first battery cell module 200₁ may be disposed to be offset by 180 degrees with respect to the battery cell module tabs 246⁺ and 246⁻ of the second battery cell modules 200₂ and the battery cell module tabs 246⁺ and 246⁻ of the third battery cell module 200₂ may be disposed to be offset by 180 degrees with respect to the battery cell module tabs 246⁺ and 246 of the second battery cell modules 200₃.

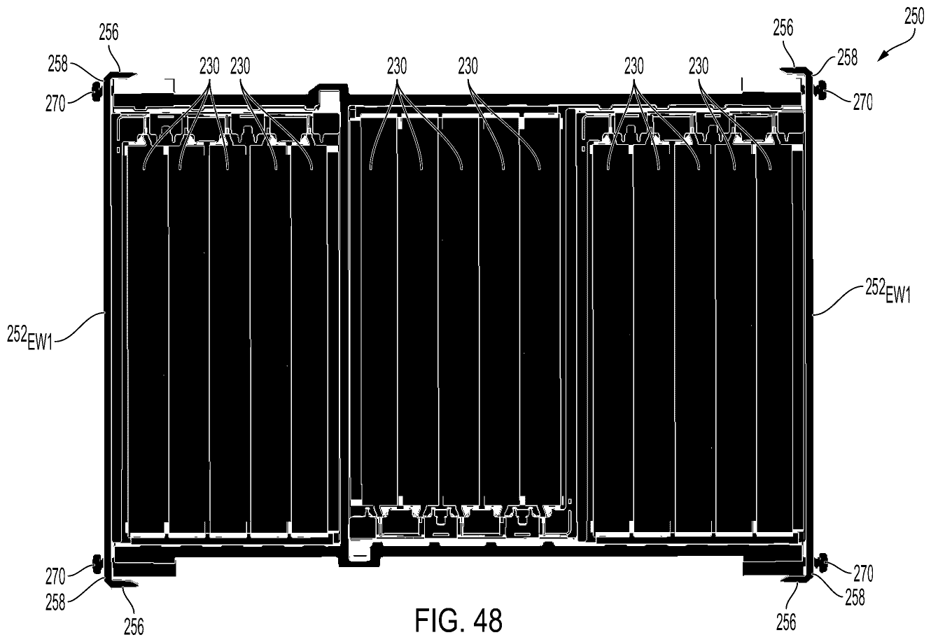

FIG. 48 shows an elevation (top down) cross-sectional view of the cell holder subassembly 250 with three battery cell modules 200 installed/disposed therein. As shown in FIG. 48, each battery cell module 200 may include five battery cells 230. The number of battery cells 230 in the battery cell module 200 may vary. A person of ordinary skill in the art would readily appreciate that the plurality of battery cells 230 disposed in the battery cell module 200 may include more or fewer pouch battery cells, depending upon the requirements of the battery pack or an associated tool platform.

The battery cells 230 in the battery cell module 200 may be pouch battery cells. The type/configuration of battery cells 230 in the battery cell module 200 may vary. A person of ordinary skill in the art would readily appreciate that the type of battery cells 230 disposed in the battery cell module 200 may include other battery cell types/configuration, depending upon the requirements of the battery pack or an associated tool platform.

The present patent application addresses various USDOT regulatory issues via a special shipping mode configuration of a shipping mode actuation switch (an internal switch or switches or switching network) operating with an actuation member/element. The switch or switching network opens and closes the power path in battery pack. The switch or switching network may separate fifteen battery cells into three groups of five battery cells. A plurality of contacts, for example, a leaf spring style contacts, may be disposed in the power path. The contacts will be described in detail in the discussions below. The shipping solution may be configured to provide a signal to the module that activates a low power shipping mode state for circuits. The shipping solution may be configured to pass through housing seals to be actuated by user input. Disclosed is the design for the battery pack shipping system, a shipping mode actuation switch, which is able to connect or disconnect three sub-core cell assemblies internal to the battery pack. By internally disconnecting the three sub-core cell assemblies, the battery is able to ship under the USDOT “smaller cells or batteries-transportation by highway or rail only” exception outlined in 49 CFR 173.185(c)(1)(iv). The shipping mode actuation switch may be actuated by an externally inserted shipping card (e.g., access to the pack internals is not required to actuate the shipping mode assembly switch). Internal access to the battery pack is not required to activate shipping mode. The battery module electronics are set to a low-power mode (e.g., shipping mode).

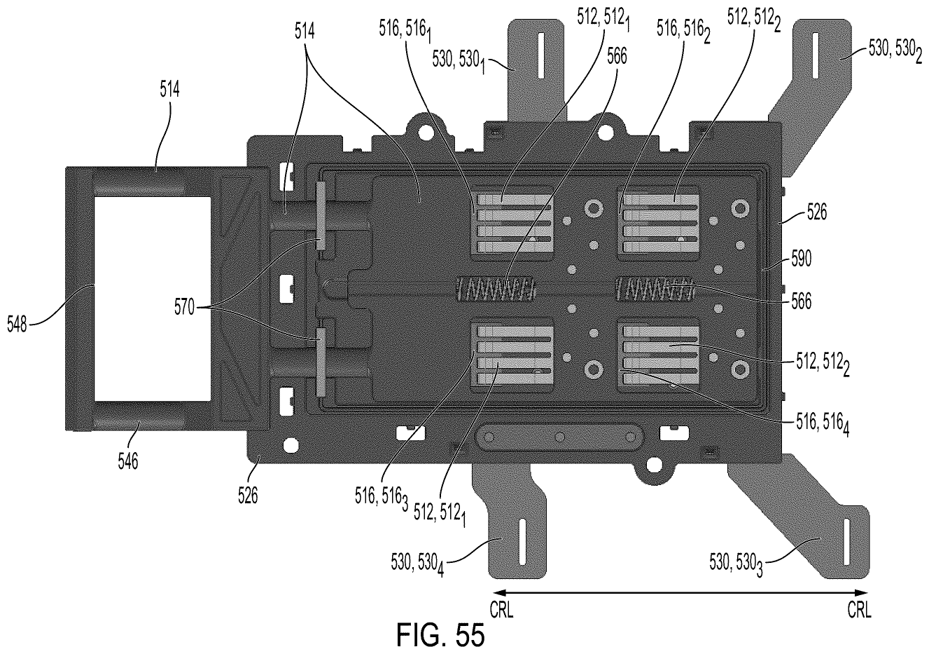

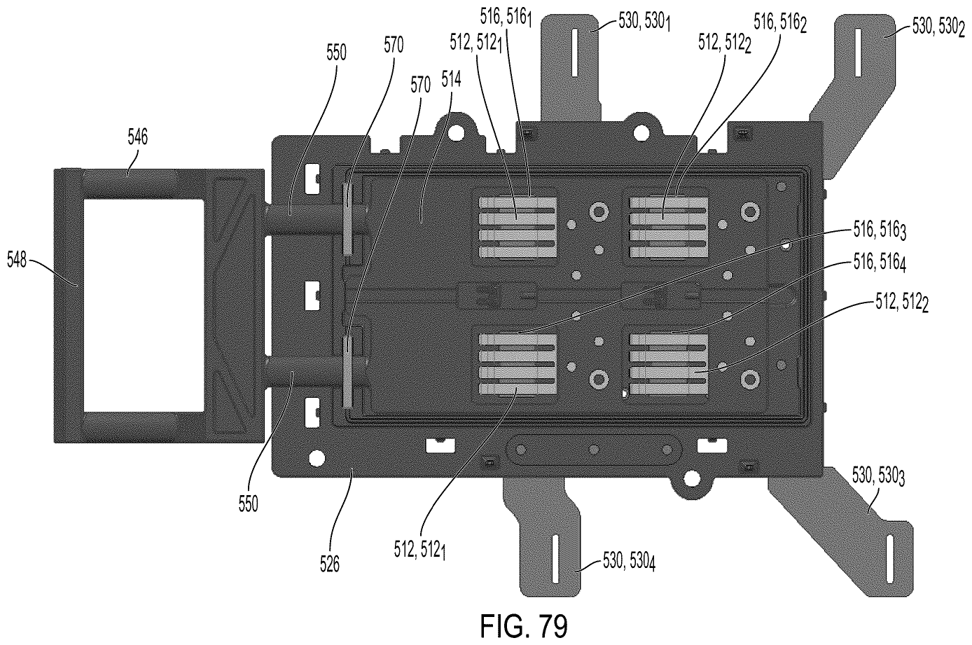

The shipping subassembly may include a set of (at least one) leaf springs that is insert-molded into a plastic card. The plastic card is constrained such that it can slide transversely in the shipping system subassembly and the battery pack. The shipping solution includes a base. The leaf springs are used to engage/disengage contact pads that, when connected, complete a power path (all the cells (for example, fifteen cells) of the battery pack are connected together in series). The plastic card is able to translate the leaf springs on to and off of the contact pads that are connected to cell taps. Internal coil springs allow the device to automatically return itself to the “ON”/active position. The user is able to remove a shipping actuator from the external area of the battery pack which allows the shipping mode actuation switch to return to the “ON”/active position. In a default/use mode/state/configuration, the internal springs are configured to assert a force (in direction Y as shown in FIG. 55) to hold the contacts in the use position. In the shipping mode/state/configuration, the shipping mode actuator is configured to move the bar in direction X, as shown in FIG. 79, against the internal springs, to move contacts into shipping position.

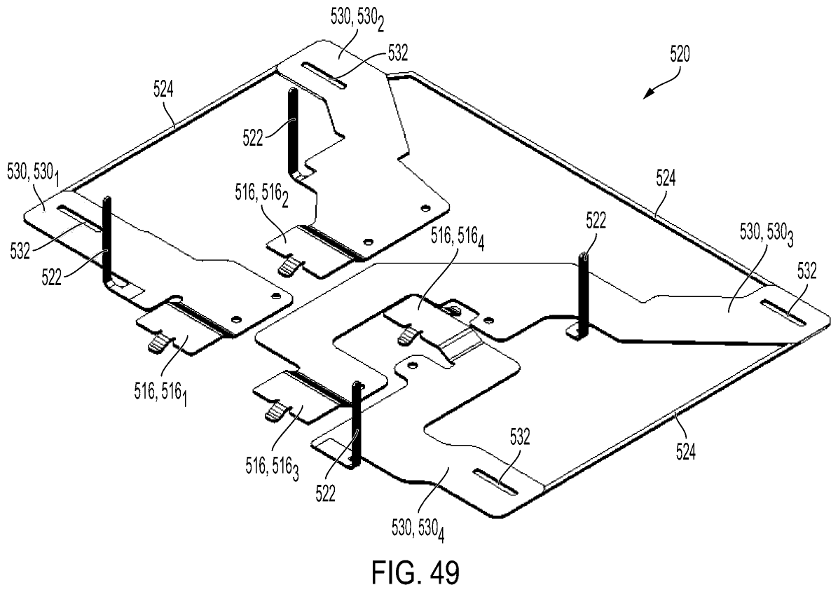

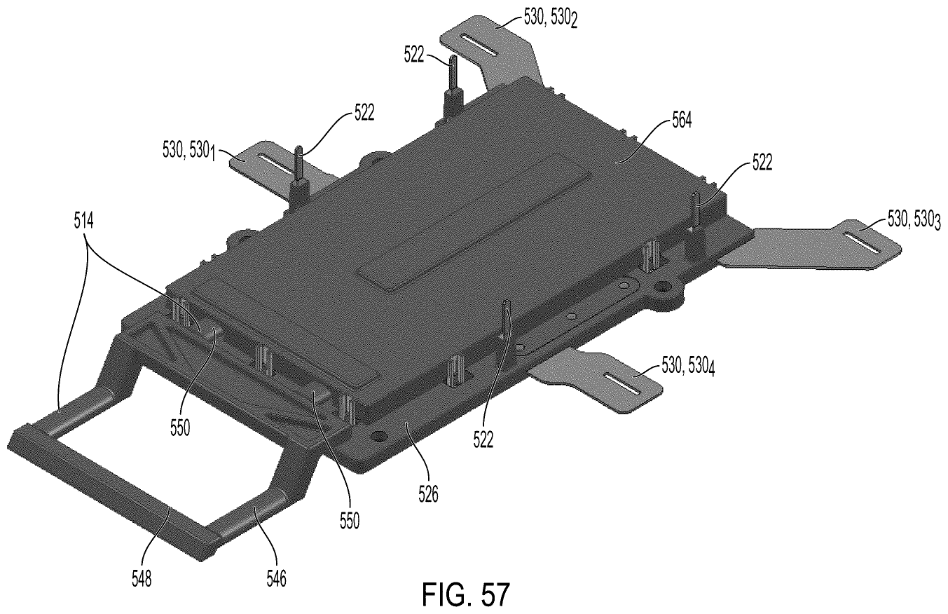

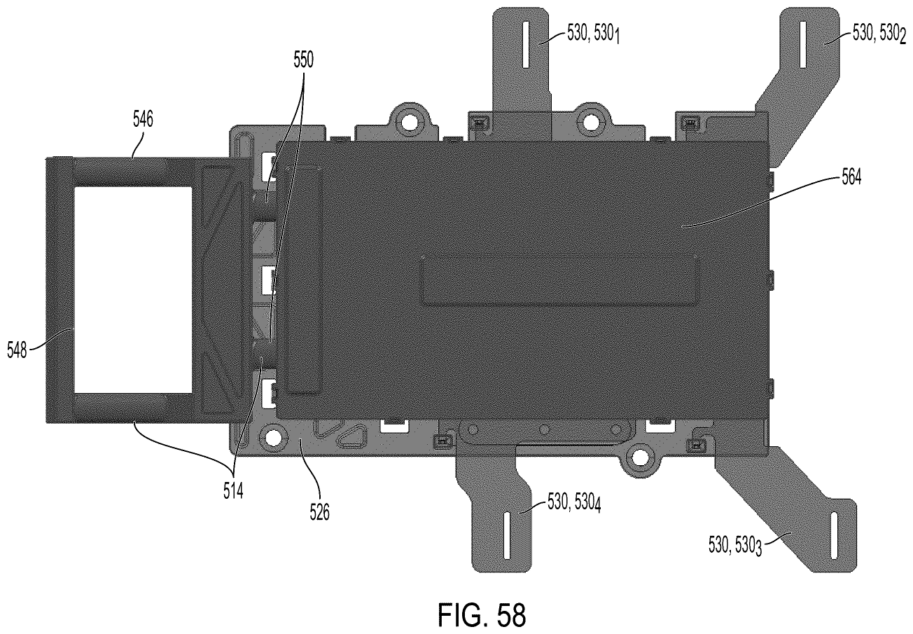

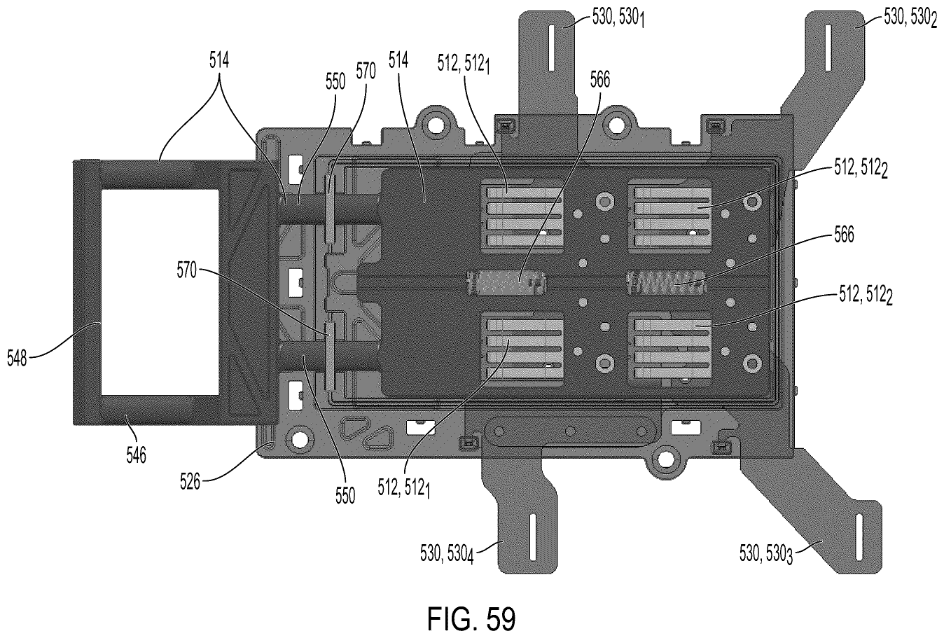

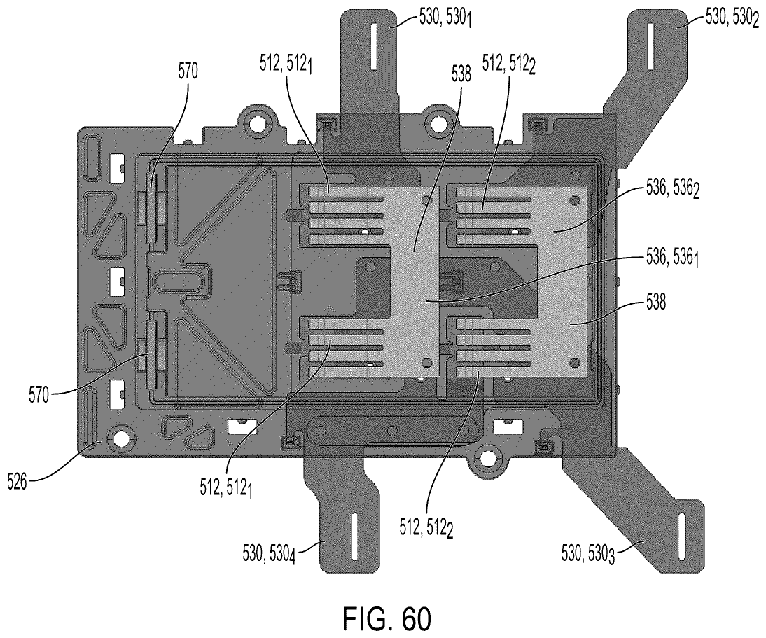

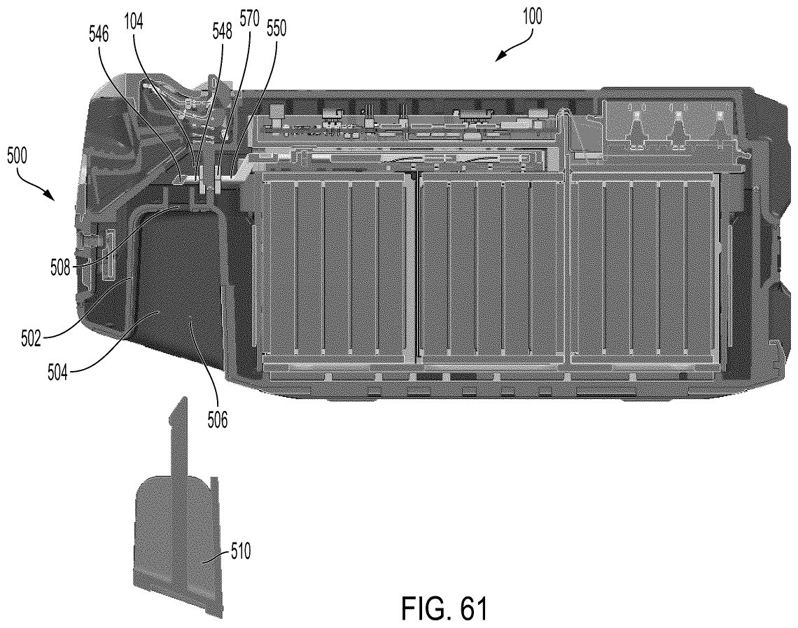

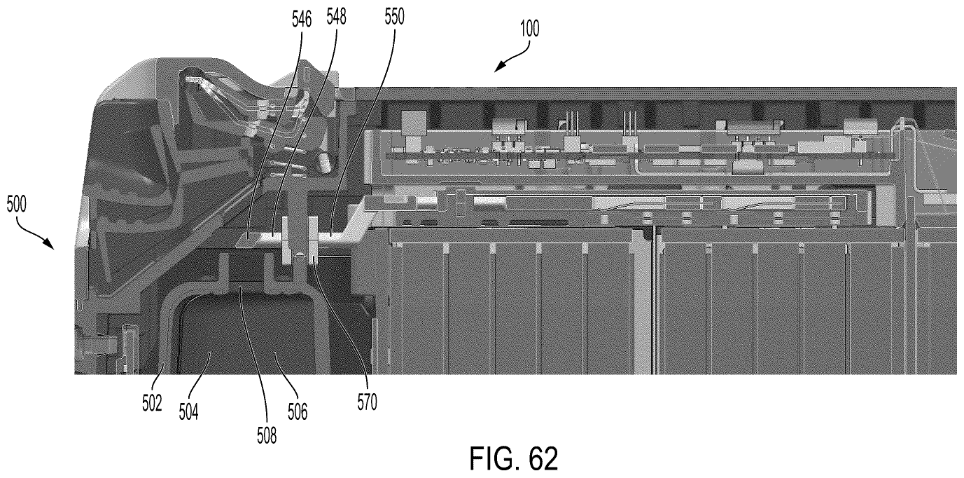

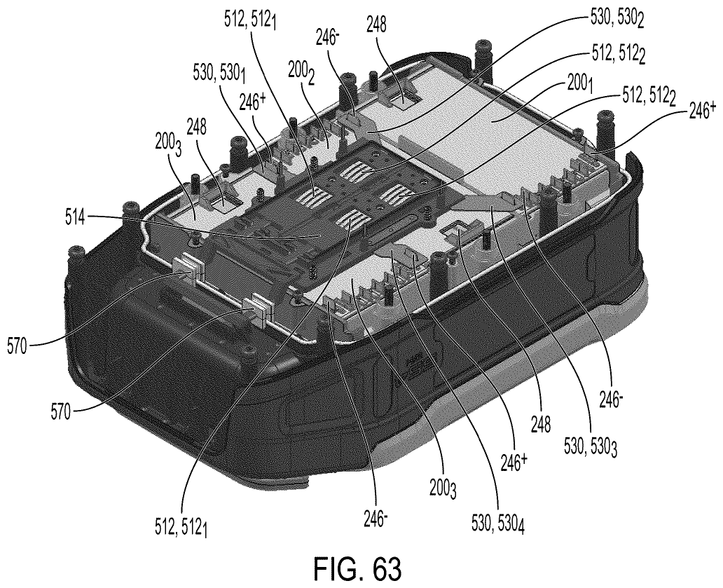

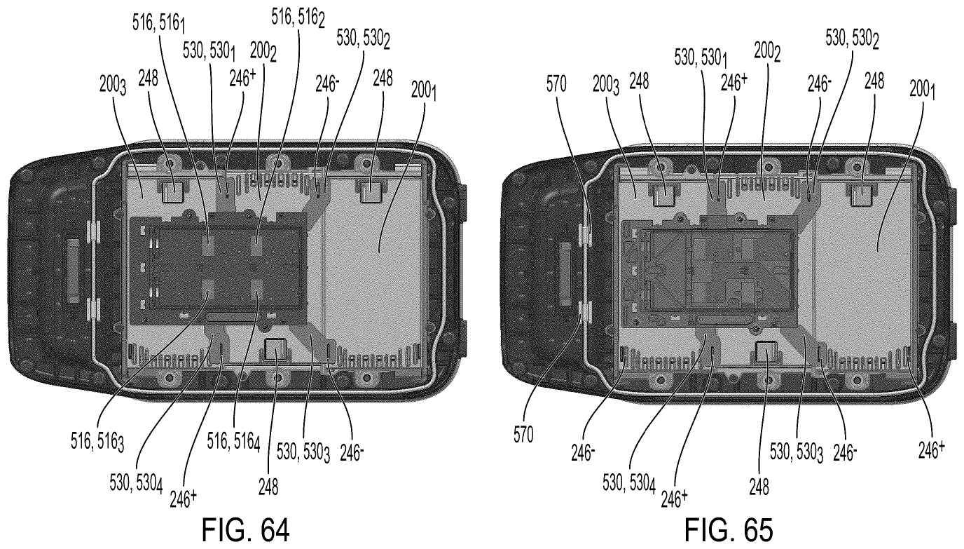

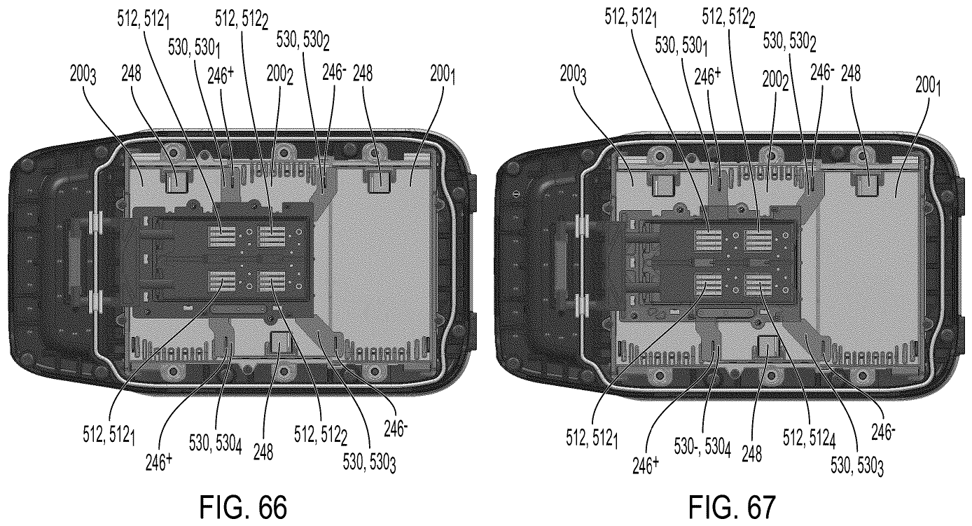

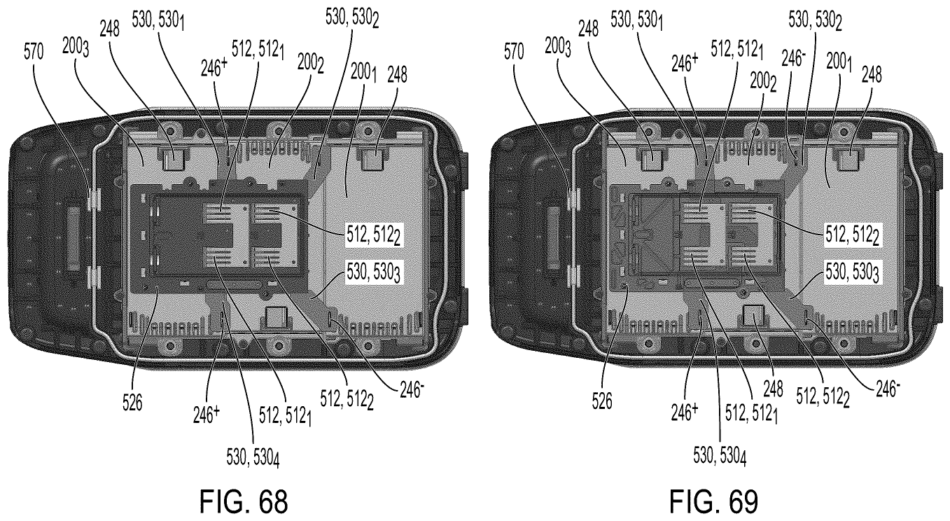

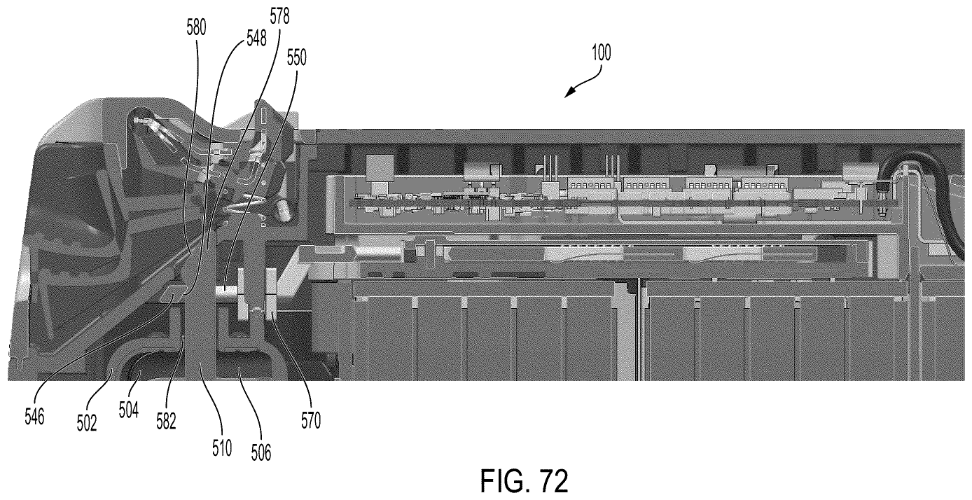

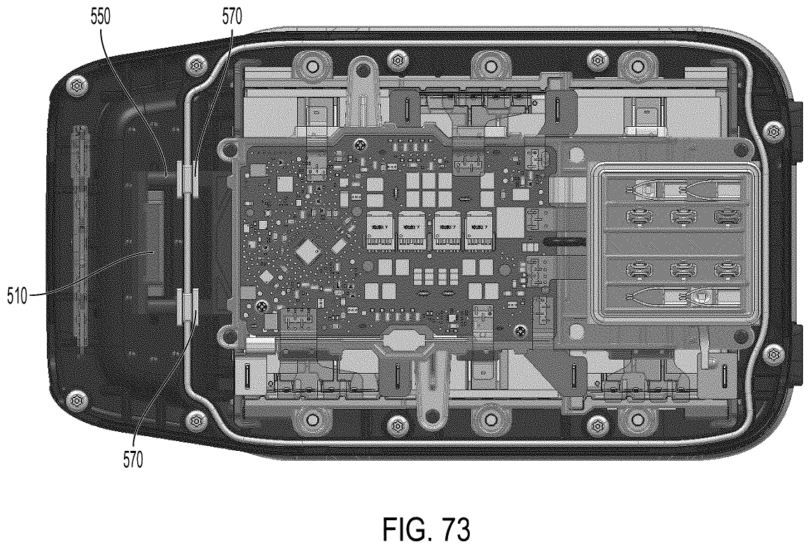

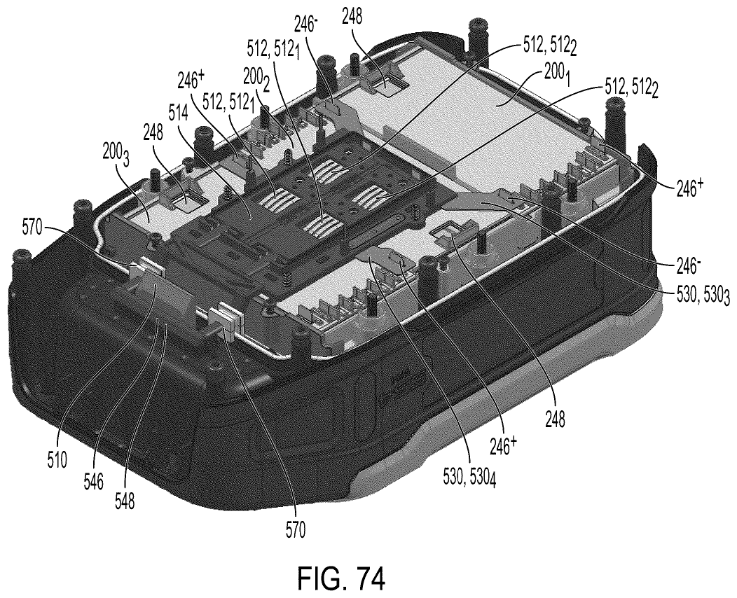

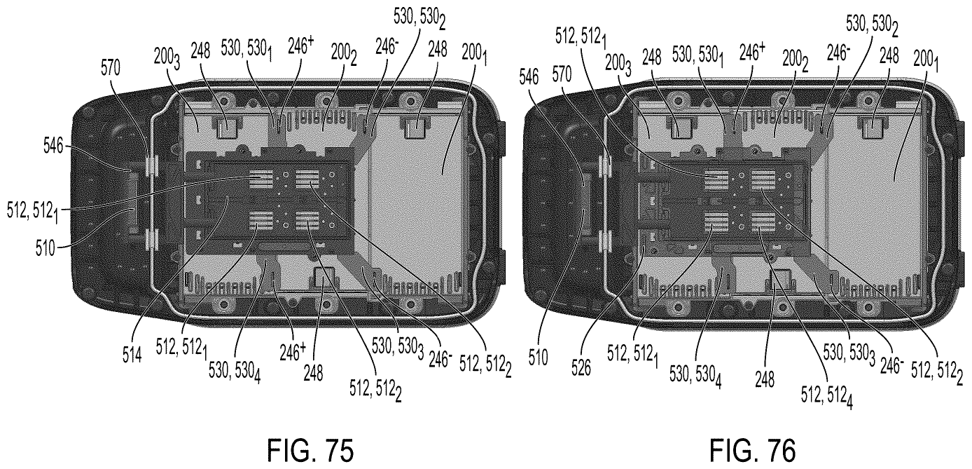

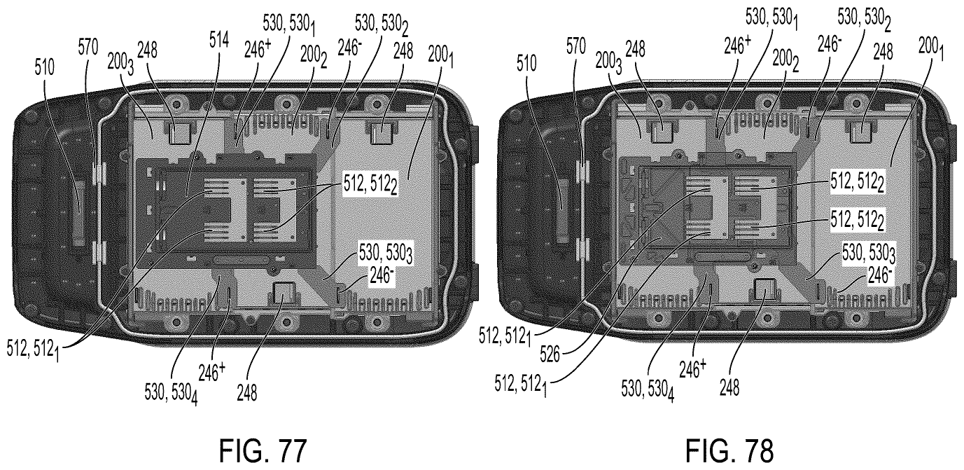

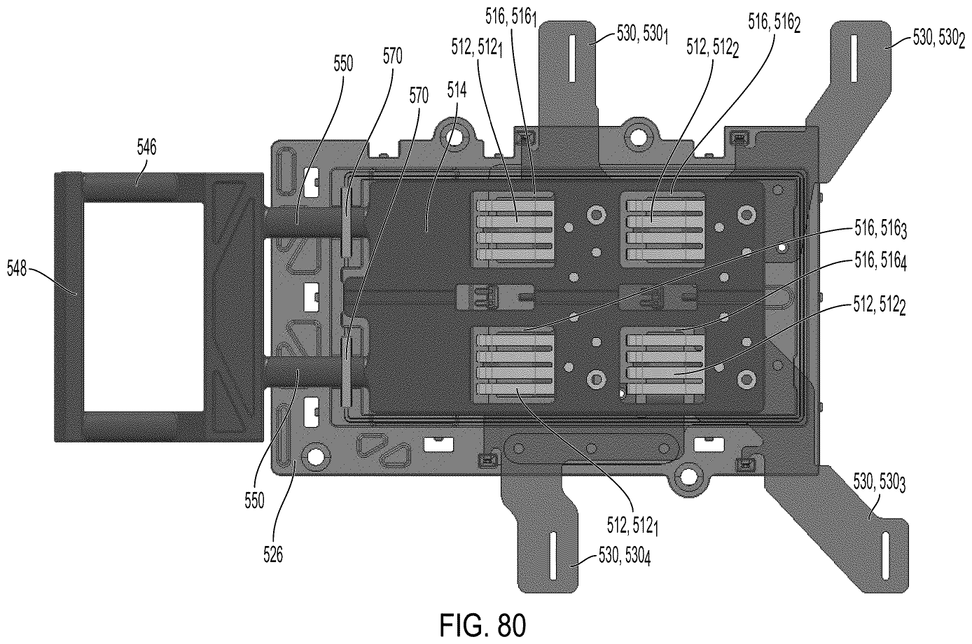

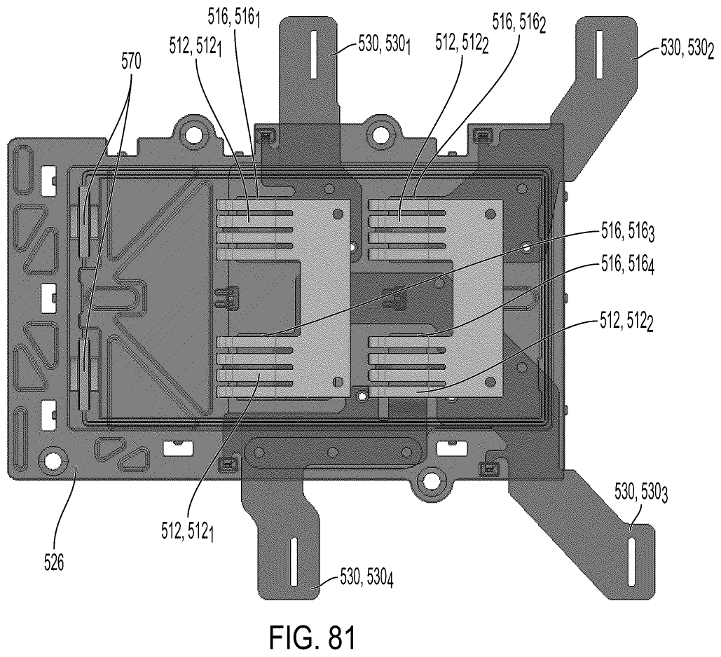

Referring to FIGS. 49-81, the battery pack 100 may include a shipping solution/system subassembly 500. As shown in FIG. 61, the shipping system subassembly 500 may include a handle 502 having a recess 504 forming a cavity 506. The handle cavity 506 may include an opening 508 to the internal cavity 104 of the battery pack 100 and an actuation component 510 that is received in the handle cavity 506.

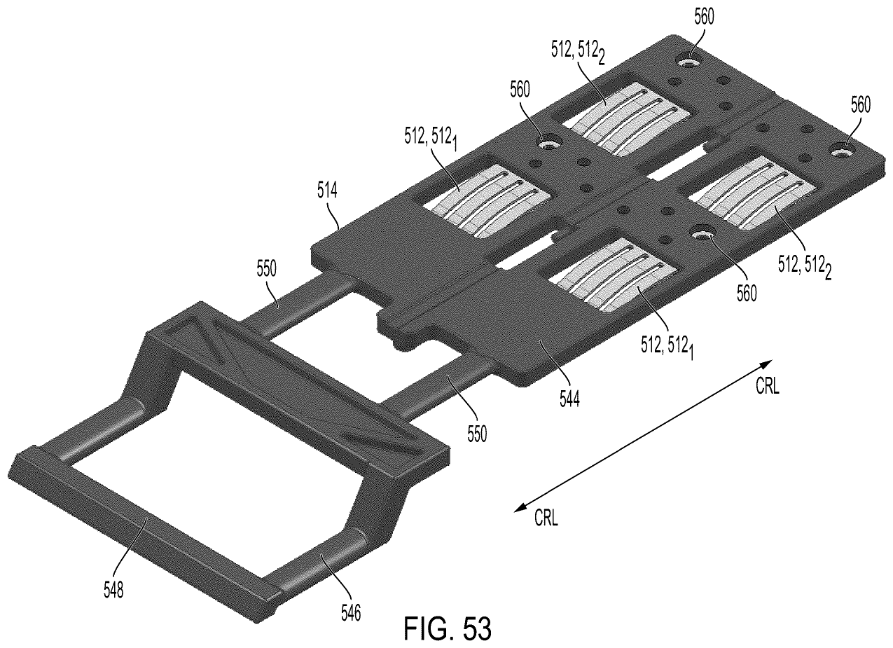

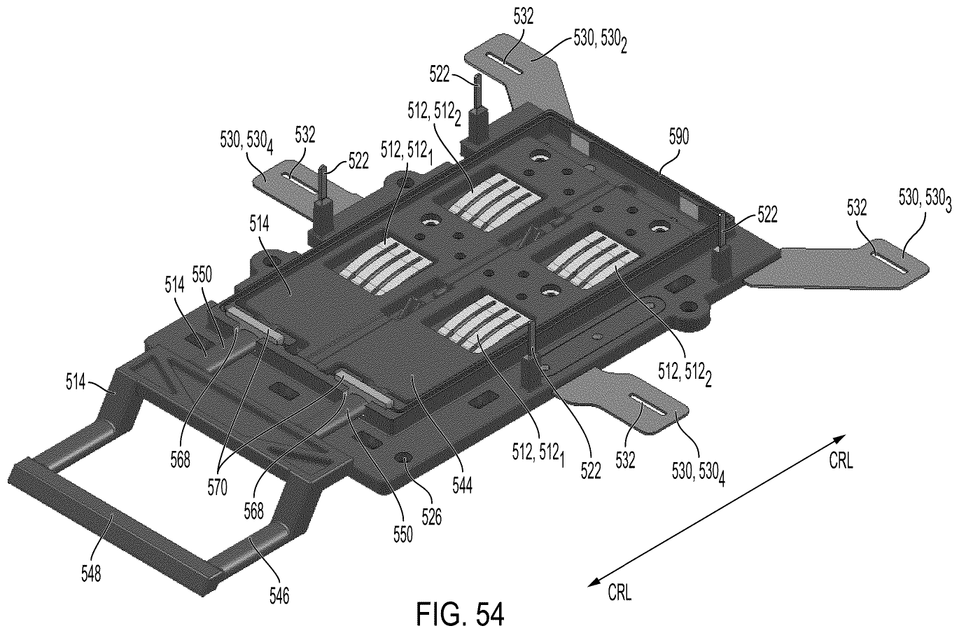

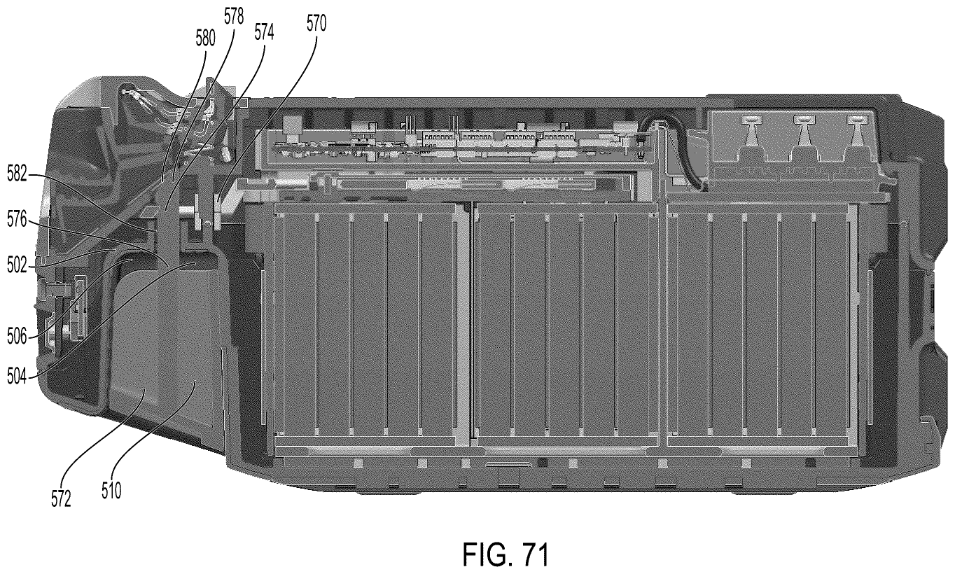

Referring to FIGS. 49-60, the shipping system subassembly 500 may include a plurality of contacts 512 and a contact holding member 514 that is configured to house the contacts 512. The contact holding member 514 may be configured to be translated along a longitudinal axis (e.g., along an axis CRL-CRL as shown in FIGS. 53-54 that is parallel to the longitudinal axis) of the battery pack 100 between a first position (as shown in FIGS. 55, 59-62, and 66-69) and a second position (as shown in FIGS. 71-73 and 75-81). When the contact holding member 514 is in the first position, the contacts 512 are configured to engage with contact pads 516 of the battery pack 100 to complete a power path between battery cells 230 of the battery pack 100 and to connect the battery cells 230 of the battery pack 100 together in series. The contact pads 516 of the battery pack 100 may be configured to be connected to cell taps 518 of the battery pack 100. When the contact holding member 514 is in the second position, the contacts 512 are configured to be disengaged from the contact pads 516 of the battery pack 100 to break the power path between battery cells 230 of the battery pack 100 and to disconnect the battery cells 230 of the battery pack 100. The contacts 512 may include leaf spring style contacts 512.

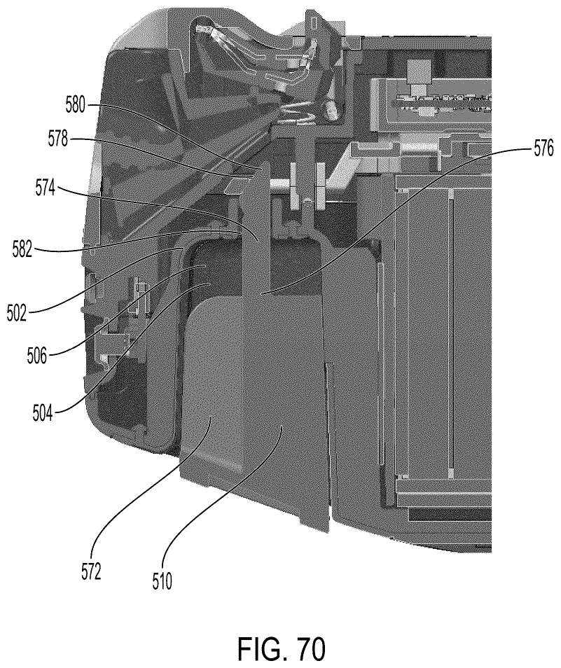

When the contact holding member 514/subassembly 500 is in the first position the battery pack 100 may be referred to as in a use or default mode/configuration/position/state. When the contact holding member 514/subassembly 500 is in the second position the battery pack 100 may be referred to as in the shipping mode/configuration/position/state (e.g., for transportation of the battery pack 100). As shown in FIG. 70, the contact holding member 514 may also have one or more intermediate positions between the first and the second position. The battery pack 100 may include a shipping mode for transportation of the battery pack from a manufacturing facility to a retail facility, a transportation mode where the user of the battery pack may carry the battery pack from one location to the other location, and a use/operation mode.

The contact pads 516 of the battery pack 100 may also be referred to as contacts. The contact pads 516 may be formed as part of a contact pad member 520. The contact pad member 520 is shown in FIG. 49. The contact pad member 520 may be made of a metal material. The contact pad member 520 may have a stamped pattern. Four contact pads 516 (516₁, 516₂, 516₃, and 516₄) are shown in the illustrated embodiments. The number of contact pads 516 in the contact pad member 520 may vary.

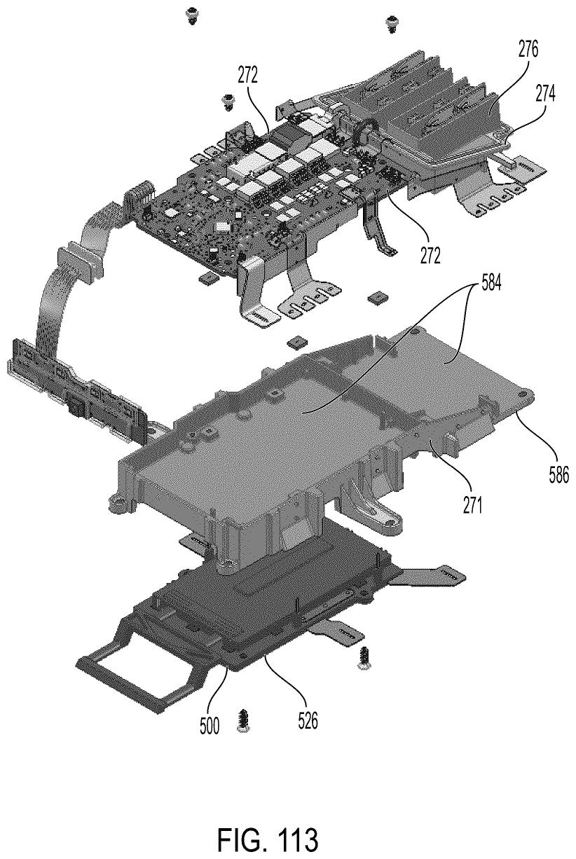

The contact pad member 520 may also include aligning members 522. Four aligning members 522 are shown in the illustrated embodiments. The number of aligning members 522 in the contact pad member 520 may vary. The aligning members 522 may extend generally perpendicular to the contact pad member 520. As will be clear from the discussions in detail with respect to FIGS. 113-119, the aligning portions 522 of the contact pad member 520 may be configured to align and extend through portions 528 of a shipping subassembly base member 526 and also align and extend through portions 592 of the subassembly support 271 to secure the contact pad member 520, the shipping subassembly base member 526 and the subassembly support 271 together.

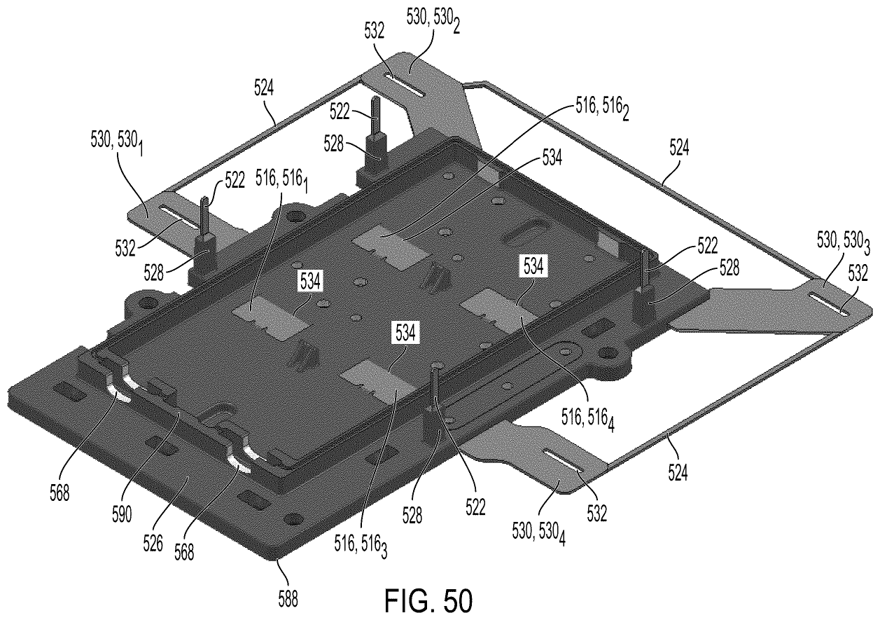

As shown in FIGS. 50-51 and 54-55, the shipping subassembly base member 526 may be disposed on and connected with the contact pad member 520 on a bottom surface 588 thereof. The shipping subassembly base member 526 may be connected to the shipping subassembly cover member 564 on a top surface 590 thereof to enclose the springs 566, the seal members 570, and the contact holding member 514 along with the contacts 512 between the shipping subassembly base member 526 and the shipping subassembly cover member 564.

The contact pad member 520 may also include terminals 530 (530₁, 530₂, 530₃, and 530₄). Four terminals 530 are shown in the illustrated embodiments. The number of terminals 530 in the contact pad member 520 may vary. Each of the terminals 530₁, 530₂, 530₃, and 530₄ may include a slot 532 through which a tang of collection strap or terminals 246⁺/246⁻ of the battery modules 200 may be received. The first terminal 530₁ may be configured to be connected to the B⁺/246⁺ terminal of the second battery cell module 200₂ and the second terminal 530₂ may be configured to be connected to the B⁻/246⁻ terminal of the second battery cell module 200₂. The third terminal 530₃ may be configured to be connected to the B⁻/246⁻ terminal of the first battery cell module 200₁ and the fourth terminal 530₄ may be configured to be connected to the B⁺/246⁺ terminal of the third battery cell module 200₃.

Each terminal 530 may be configured to be associated with a corresponding contact pad 516. For example, the first terminal 530₁ may be configured to be associated with the first contact pad 516₁, the second terminal 530₂ may be configured to be associated with the second contact pad 516₂, the third terminal 530₃ may be configured to be associated with the third contact pad 516₃, and the fourth terminal 530₄ may be configured to be associated with the fourth contact pad 516₄.

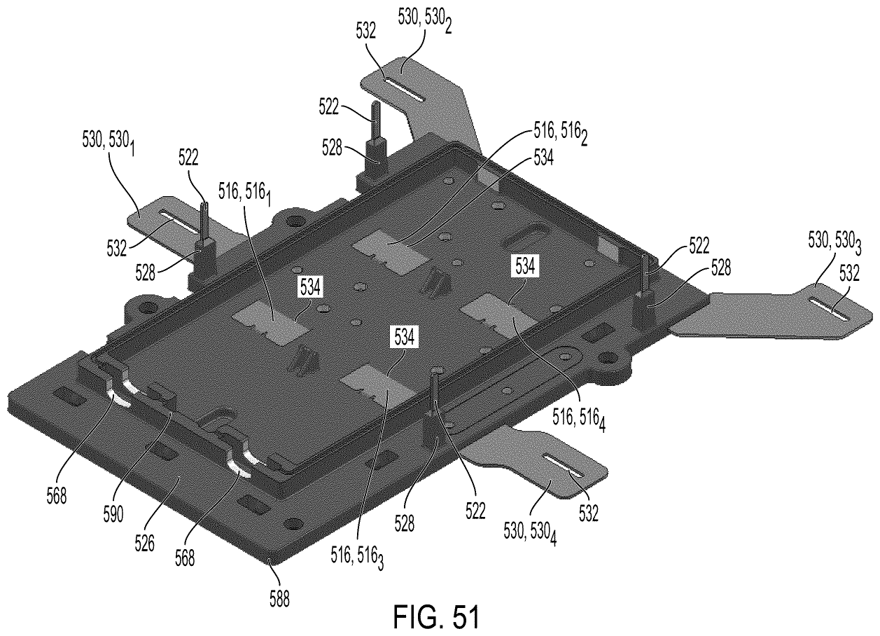

The contact pad member 520 may further include a plurality of connecting structures 524. Three connecting structures 524 are shown in the illustrated embodiments. The number of connecting structures 524 in the contact pad member 520 may vary. The connecting structures 524 of the contact pad member 520 may be configured to connect the terminals 530 (530₁, 530₂, 530₃, and 530₄) to each other (as the contact pad member 520 is being formed as a metal stamped pattern). Comparing FIGS. 50 and 51, the connecting structures 524 of the contact pad member 520 may be removed after the contact pad member 520 is insert molded within the base member 526. The shipping subassembly base member 526 may also be referred to as a base. The shipping subassembly base member 526 may be molded about the contact pad member 520 such that the portions 528 of the shipping subassembly base member 526 are aligned with the aligning portions 522 of the contact pad member 520. The aligning portions 522 of the contact pad member 520 may be configured to align and extend through the portions 528 of the shipping subassembly base member 526 to secure the contact pad member 520 and the shipping subassembly base member 526 together.

The shipping subassembly base member 526 may have openings 534 through which the contact pads 516 of the contact pad member 520 are exposed so as to engage with or disengaged from the contacts 512.

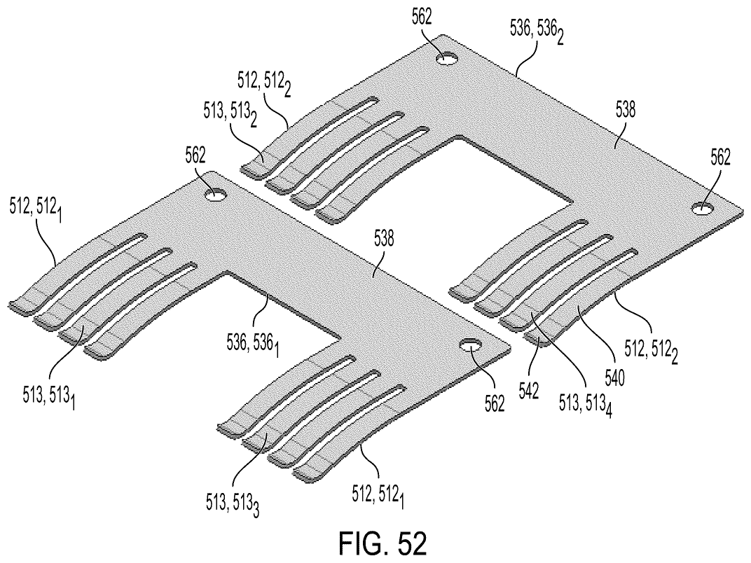

Referring to FIG. 52, the plurality of contacts 512 may include at least two contacts 512 (512₁ and 512₂). Each contact 512 may be configured to contact/engage with two corresponding contact pads 516 of the battery pack 100 to complete a power path between battery cells 230 of the battery pack 100 and to connect the battery cells 230 of the battery pack 100 together in series. For example, the first contact 512₁ may be configured to contact/engage with two corresponding contact pads 516₁, 516₃ and the second contact 512₂ may be configured to contact/engage with two corresponding contact pads 516₂, 516₄.

Each of the contacts 512 may include a contact body 536. The contact body 536 may include the at least two contact pad contact portions 513 and a connector portion 538 that is configured to connect the at least two contact pad contact portions 513. The connector portion 538 may also be referred to a connecting leg.

In the illustrated embodiment, as shown in FIG. 50, the first contact 512₁ may include a first contact pad contact portion 513₁ and a second contact pad contact portion 513₃ and the second contact pad 512₂ may include a first contact pad contact portion 513₂ and a second contact pad contact portion 513₄. Each contact pad contact portion 513 may include four leaf spring style contacts. Each contact 512 may include at least one curved tine 540 terminating in a mating portion/tulip 542. A person of ordinary skill in the art would readily appreciate that other configurations, sizes, and shapes of the contacts 512 may be used. Each contact 512 may be referred to as a leg. For example, the contact 512 may include a first leg 513 and a second leg 513. The contacts 512 may also be referred to as sliding jumper contacts as they are configured to be moved/slid along with the contact holding member 514 and they are configured to either engage/contact with or disengage from the contact pads 516 of the battery pack 100.

As shown in FIG. 53, the contact holding member 514 may include a body portion 544 configured to be connected with the contacts 512 and configured to retain the contacts 512 in place, a handle portion 546 having first cam surfaces 548, and connector portions 550 that are configured to connect the handle portion 546 and the body portion 544. As will be clear from the discussions in detail below, the handle portion 546 may be configured to engage with the actuation component 510. The handle portion 546 may be referred to as an engaging bar/arm as it is configured to engage with the actuation component 510. The body portion 544/contact holding member 514 may be referred to as a slider housing as it is configured to be connected to the contacts 512 and as it is configured to slide/move between its first position and its second position.

The contact holding member 514 may include fastener openings/holes 560 in a pattern corresponding to fastener openings/holes 562 of the body 536. Mechanical fasteners (e.g., screws, etc.) may be inserted through the fastener openings/holes 560, 562 after they are aligned, for connecting the contact holding member 514 to the body 536.

As shown in FIG. 54, the shipping subassembly base member 526 may be configured to receive the contact holding member 514 along with the contacts 512 therein.

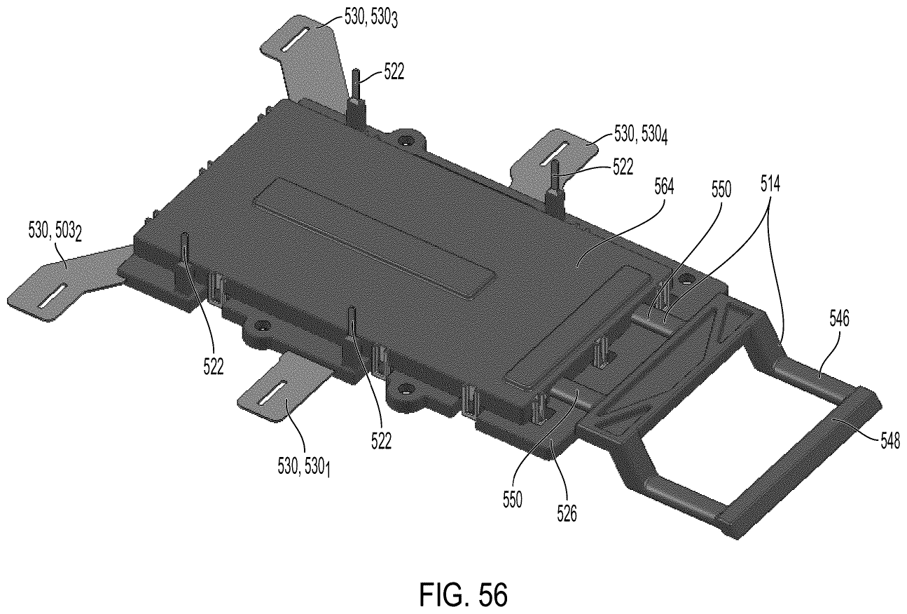

Referring to FIGS. 55-56, the shipping system subassembly 500 may include a shipping subassembly cover member 564 that is configured to connect with the shipping subassembly base member 526 and springs 566 configured to be connected between the contact holding member 514 and the shipping subassembly base member 526. The shipping subassembly cover member 564 may be configured to cover the contact holding member 514 and the contacts 512 received in the shipping subassembly base member 526. The spring 566 may also be referred to as internal springs. The springs 566 are configured to bias (exert a force against) the contact holding member 514 in a first direction (in the direction Y as shown in FIG. 55) along the longitudinal direction (e.g., the axis CRL-CRL) of the battery pack 100 and with respect to the shipping subassembly base member 526 so as to position and hold the contact holding member 514 in the first (use) position. As shown in FIG. 79, the handle 546 of the contact holding member 514 may be moved in the X direction, against the springs 566, by the actuation element 510 so as to move the contacts 512 into the shipping configuration/mode/state/position.

The actuation component 510 may be configured to engage with the contact holding member 514 to translate the contact holding member 514 from the first position to the second position against the bias of the springs 566 and in an opposing second direction (as shown by the X direction in FIG. 79) along the longitudinal axis (e.g., the axis CRL-CRL) of the battery pack 100.

The actuation component 510 may include an actuation component body 572 sized and configured to be received in the cavity 506 of the handle 502 of the shipping system subassembly 500. The actuation component 510 may also include an actuation element 574 having a first end 576 and second end 578. The actuation element 574 may be configured to be connected to the actuation component body 572 at the first end 576. The actuation element 574 may include second cam surfaces 580 at the second end 578.

Portions (e.g., near the second end 578) of the actuation element 574 may be configured to extend into an opening 582 to the internal cavity 104, when the actuation component body 572 is received in the cavity 506 of the handle 502 of the battery pack 100, such that the second cam surfaces 580 at the second end 578 of the actuation element 574 engages with the first cam surfaces 548 of the handle portion 546 of the contact holding member 514. Surface interactions between the second cam surfaces 580 of the actuation element 574 and the first cam surfaces 548 of the handle portion 546 of the contact holding member 514 cause the contact holding member 514 to translate from the first position to the second position against the bias of the springs 566 and in the opposing second direction (as shown by the X direction in FIG. 79) along the longitudinal axis (e.g., the axis CRL-CRL) of the battery pack 100.

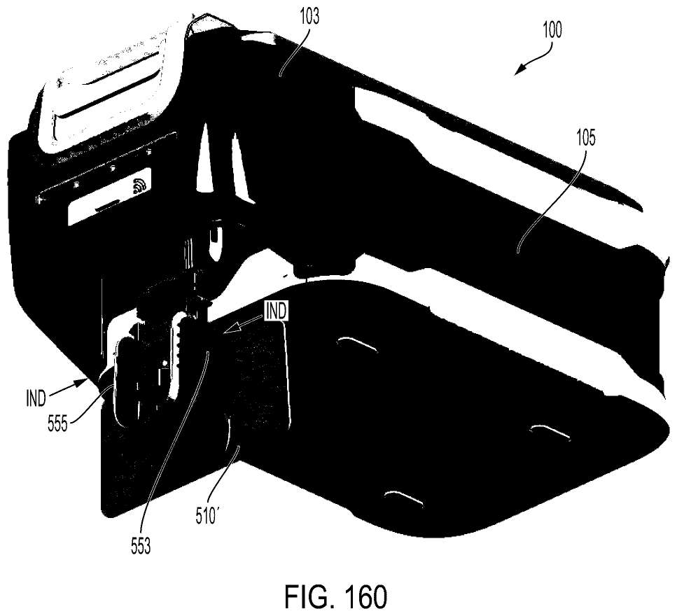

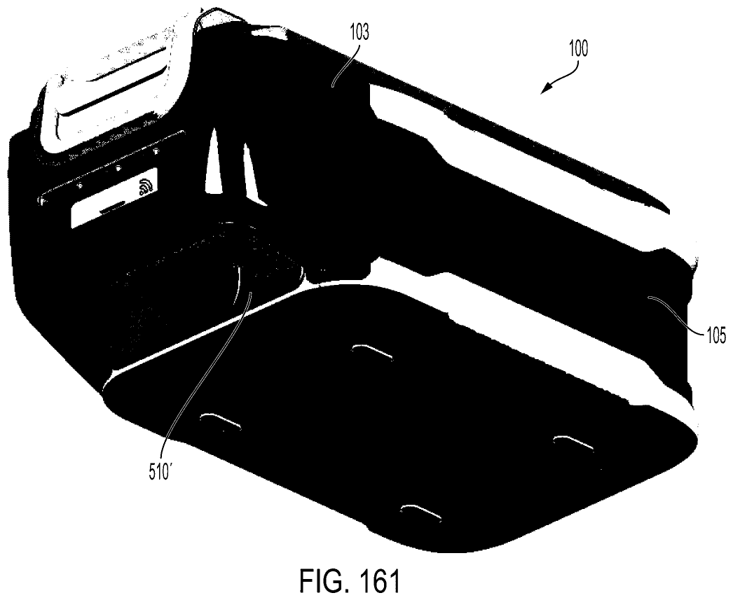

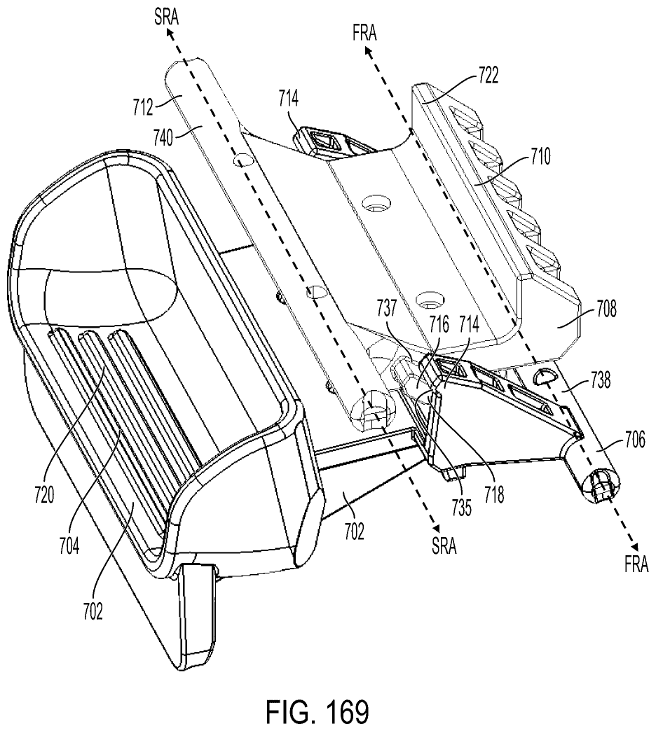

FIGS. 169-161 show another embodiment of the actuation component 510′. FIG. 160 shows the actuation component 510′ before being received in the handle cavity 506, while FIG. 161 shows the actuation component 510′ after being received in the handle cavity 506. For example, the actuation component 510′ may be configured to be held by the user using the user's thumb (e.g., engaging a portion 553 of the actuation portion 510′) and the user's finger (e.g., engaging a portion 555 of the actuation portion 510′) and may be configured to be pressed inwardly (e.g., in the direction IND) so as to release the actuation component 510′ from the handle cavity 506.

The handle 502 may be integrally formed in the housing 102 of the battery pack 100. The handle 502 may be used by a user to carry the battery pack 100 from one location to another location between use.

As shown in FIGS. 59-51 and 54-55, the shipping subassembly base member 526 may include grooves 568 that are configured to receive the connector portions 550 of the contact holding member 514 to allow the contact holding member 514 to translate along the longitudinal axis (e.g., the axis CRL-CRL) of the battery pack 100 and with respect to the shipping subassembly base member 526. Referring to FIGS. 54-55 and 59-60, the shipping subassembly base member 526 may include seal members 570 that are configured to be positioned adjacent the grooves 568 of the shipping subassembly base member 526 and the connector portions 550 of the contact holding member 514 so as to seal the internal cavity 104 of the battery pack 100. The shipping subassembly cover member 564 and the shipping subassembly base member 526 are configured to enclose the springs 566, the seal members 570, and portions of the contact holding member 514 (along with the contacts 512). That is, the handle 546 and some portions of the connector portions 550 of the contact holding member 514 are not disposed between the shipping subassembly cover member 564 and the shipping subassembly base member 526.

Referring to FIGS. 82-105, an electronics subassembly 272 may include the terminal block 276 and a set of battery pack terminals 312 fixedly held in place to the terminal block 276. The set of battery pack terminals 312 may be configured to mate with a corresponding set of terminals 318 of an electrical device 320.

The electrical device 320 may include a charger 320_{C} as shown in FIG. 151. As shown in FIG. 151, the charger 320_{C} may include a set of terminals 318 (e.g., including power terminal CB+, CG and signal terminals CM, S1, S3 and NTC). The electrical device 320 may include a power tool 320_{PT} as shown in FIG. 149. As shown in FIG. 149, the power tool 320_{PT} may include a set of terminals 318 (e.g., including power terminals PTB+, PTB−, signal terminals C4, CM, S1, S3 and NTC). The electrical device terminals 318 of the electrical device 320 may be received in a mating direction by the battery pack 100.

The set of battery pack terminals 312 may include power terminals 312_{PT} and signal terminals 312_{S}. For example, the power terminals 312_{PT} may include a first terminal 322 and a second terminal 324. One of the first terminal 322 and the second terminal 324 may be a positive (battery pack) terminal and the other of the first terminal 322 and the second terminal 324 may be a negative (battery pack) terminal. The first terminal 322 and the second terminal 324 are parallel to each other and extend along a longitudinal axis TBL-TBL (as shown in FIGS. 92-104) of the terminal block 276. For example, as shown in FIG. 150, one of the first terminal 322 and the second terminal 324 may be a positive (battery pack) terminal (i.e., BPB+) and the other of the first terminal 322 and the second terminal 324 may be a negative (battery pack) terminal (i.e., BPB−). Referring to FIG. 149, the signal terminals 312_{S} may include six signal or communication terminals. The signal terminals 312_{S} may include BPS1, BPS3, BPCM, BPNTC, and BPC4. During discharge, the power path may be through the terminal BPB+ and the terminal BPB−. During charge, the power path may be through the terminal BPB+ and the terminal CG (i.e., charge ground).

The terminal block 276 may be referred to as battery/battery pack terminal block. The terminal block 276 may include the (battery pack) terminal block housing 274. Referring to FIGS. 92-105, the terminal block housing 274 may include receiving portions 344₁, 344₂, 344₃, and 344₄. The receiving portions 344₁ and 344₄ may be disposed at the outer ends of the terminal block 276 and may be configured to receive the power terminals 312_{PT} (i.e., first terminal 322 and second terminal 324). The receiving portions 344₂ and 344₃ may be disposed between the receiving portions 344₁ and 344₄ and may be configured to receive the signal terminals 312_{S} (e.g., BPS1, BPS3, BPCM, BPNTC, and BPC4 as shown in FIG. 150) and the negative charging terminal CG. The terminal block housing 344 may be made of a plastic material.

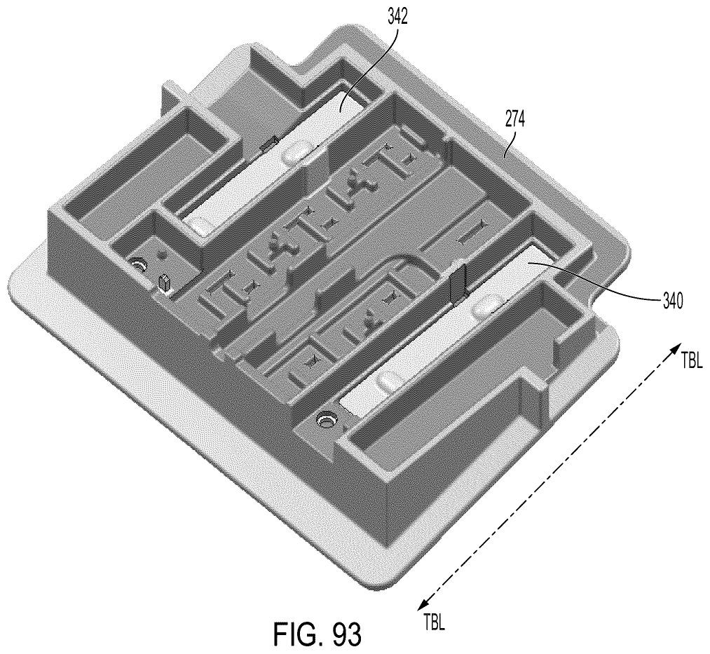

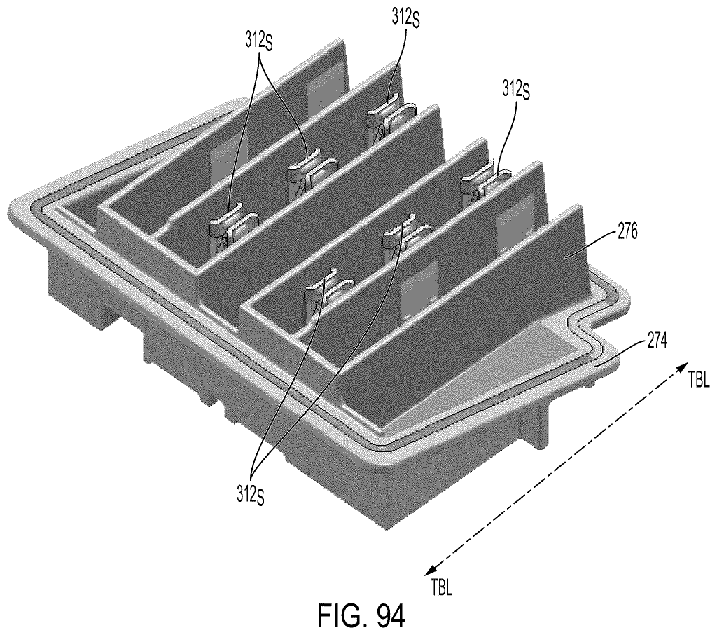

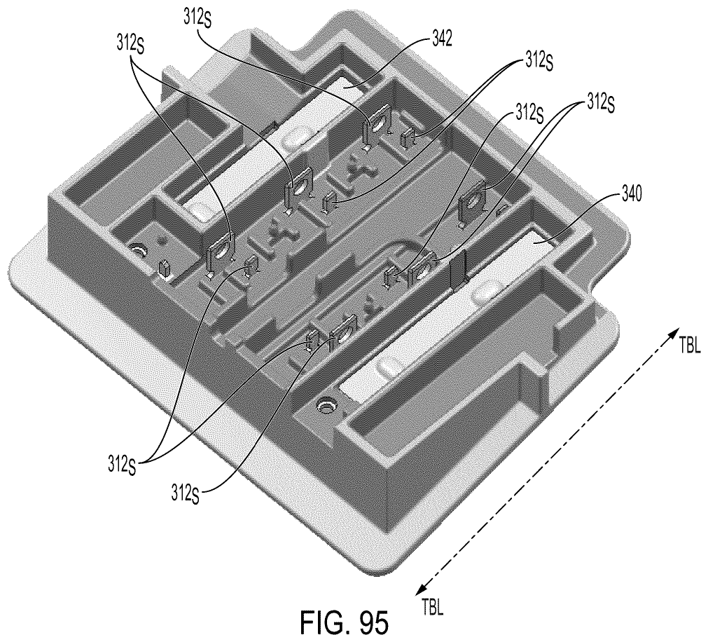

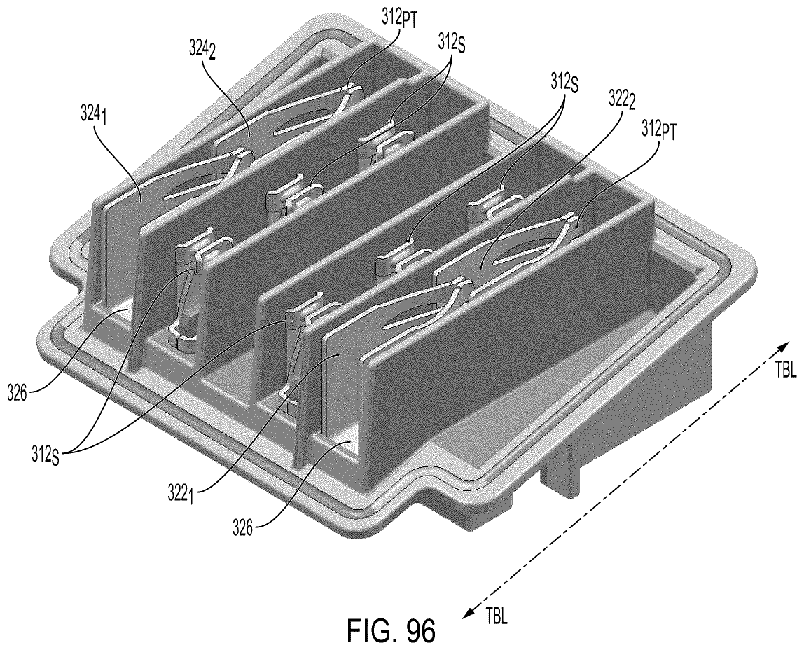

FIGS. 92 and 95 show top perspective views of the terminal block 276 of the battery pack 100, while FIGS. 93 and 95 show bottom perspective views of the terminal block 276 of the battery pack 100. FIGS. 92 and 93 show the terminal block housing 274 without the power terminals 312_{PT} and the signal terminals 312_{S} disposed therein. FIGS. 94 and 95 show the terminal block housing 274 (without the power terminals 312_{PT} disposed therein but) with the signal terminals 312_{S} disposed therein. FIGS. 96-99 show top perspective views of the battery pack terminal block, wherein the signal terminals 312_{S} and the power terminals 312_{PT} are both shown.

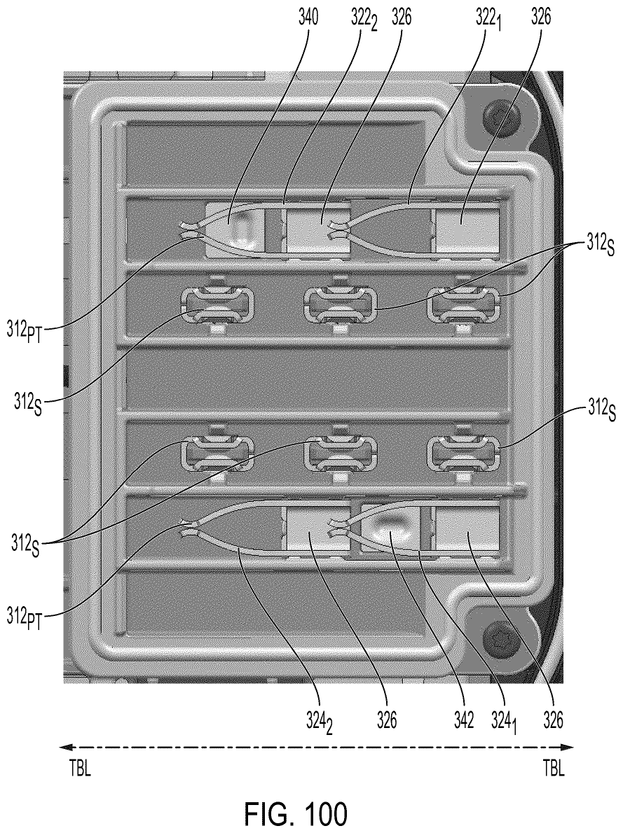

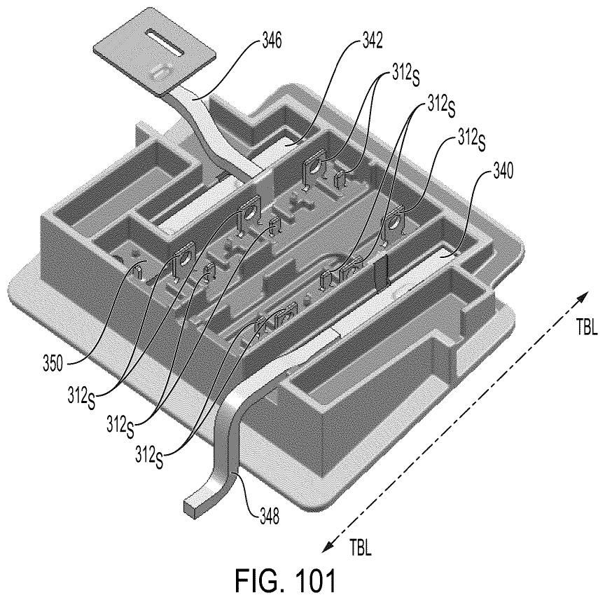

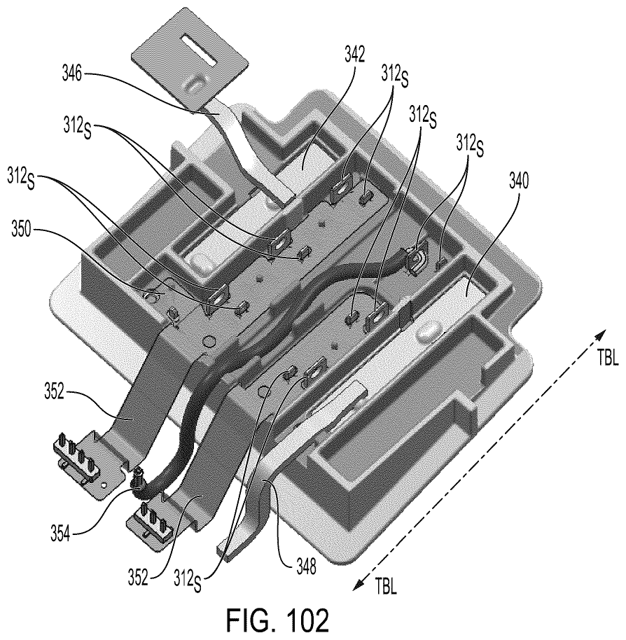

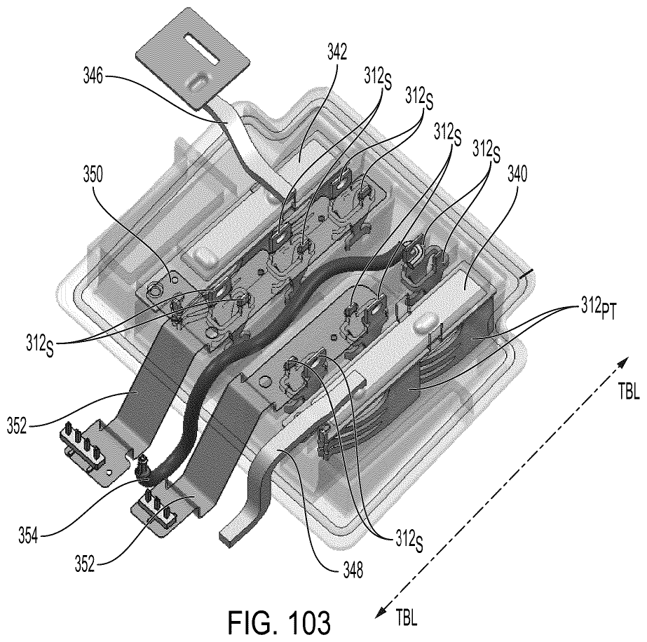

FIGS. 100-101 show top and bottom elevational views of the battery pack terminal block 276, wherein the metal, insert molded terminal base 340, 343, (portions of) the signal terminals 312_{S} and (portions of) the power terminals 312_{PT} are shown. FIGS. 102-103 show bottom plan views of the battery pack terminal block 276. Portions of the signal terminals 312_{S}, portions of the power terminals 312_{PT}, terminal block power path terminals 346, 348, flex circuits 352, wire 354, and soldered tang 350 for the flex circuit on insert molded metal are all shown. The battery pack terminal block housing 274 is shown as transparent in FIG. 103 so as to better illustrate other portions of the signal terminals 312_{S}, and other portions of the power terminals 312_{PT}.

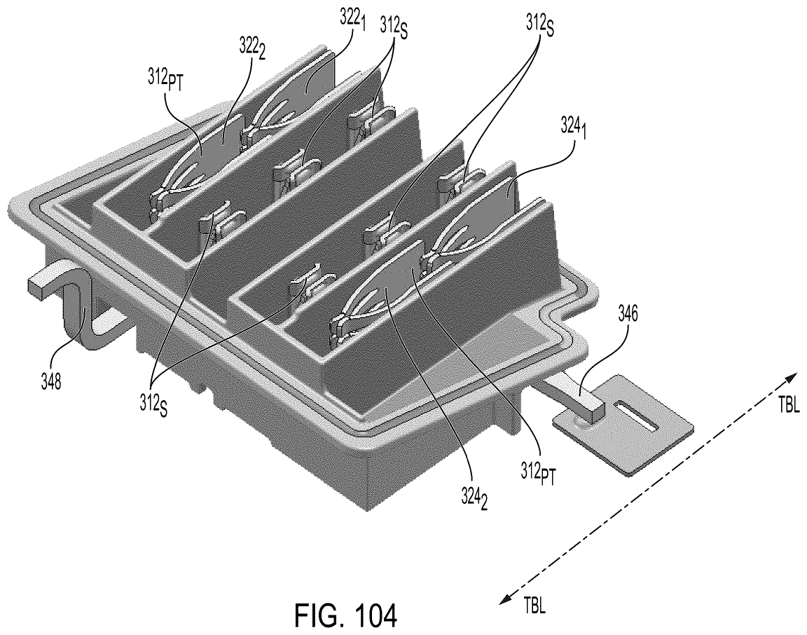

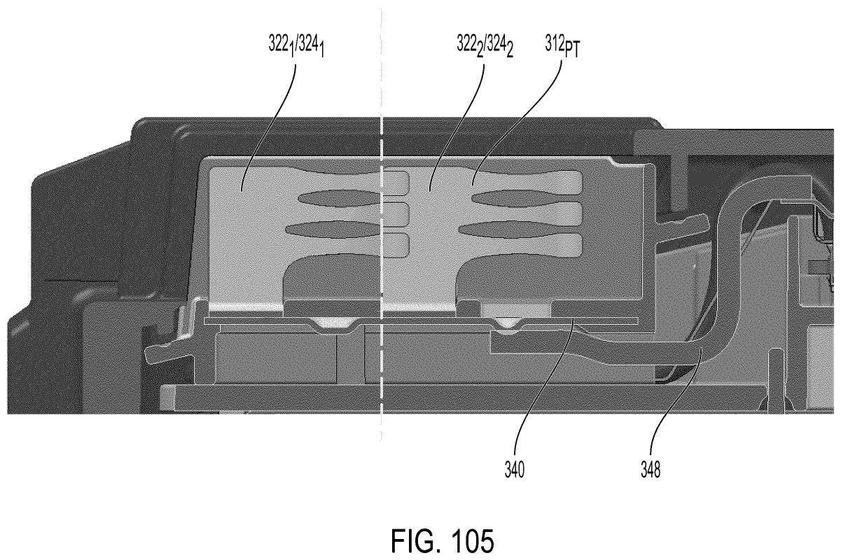

FIG. 104 shows a top plan view of the battery pack terminal block 276. Portions of the signal terminals 312_{S}, portions of the power terminals 312_{PT} and the terminal block power path terminals 346, 348 are shown. FIG. 105 shows a partial right side cross-sectional view of the battery pack terminal block 276 disposed in the battery pack 100. The portions of the power terminals 312_{PT}, the metal, insert molded terminal base 340, 342, and the terminal block power path terminals 346, 348 are shown. For example, the bases 326 of the first terminal 322/324 may be laser welded to the corresponding metal, insert molded terminal base 340, 342.

The first terminal 322 of the set of battery pack terminals 312 may include a first portion 322₁ for contacting a first electrical device contact (e.g., power terminal PTB+ or power terminals PTB− as shown in FIG. 149) and a second portion 322₂ for contacting the first electrical device contact (e.g., power terminal PTB+ or power terminals PTB− as shown in FIG. 149). The first portion 322₁ and the second portion 322₂ are nested together. FIGS. 82-91 show various views of the nested power terminals 322/324 of the battery pack 100.

The second terminal 324 of the set of battery pack terminals 312 includes a first portion 324₁ for contacting a second electrical device contact (e.g., power terminals PTB− or power terminal PTB+ as shown in FIG. 149) and a second portion 324₂ for contacting the second electrical device contact (e.g., power terminals PTB− or power terminal PTB+ as shown in FIG. 149). The first portion 324₁ and the second portion 324₂ of the second terminal 324 are nested together.

Each of the first portion 322₁ and the second portion 322₂ of the first terminal 322 and each of the first portion 324₁ and the second portion 324₂ of the second terminal 324 include (a) a base portion 326, (b) opposing side walls 328 that are spaced apart from each other and extend perpendicular to the base portion 326, and (c) terminal contacts 330 that extend forwardly, along the longitudinal axis of TBL-TBL of the terminal block 276, of the side walls 328 and the base portion 326.

For each of the first terminal 322 and the second terminal 324, the terminal contacts 330 of the first portion 322₁/324₁ is configured to be received between the opposing side walls 328 of the second portion 322₂/324₂, when the first portion 322₁/324₁ and the second portion 322₂/324₂ are nested together.

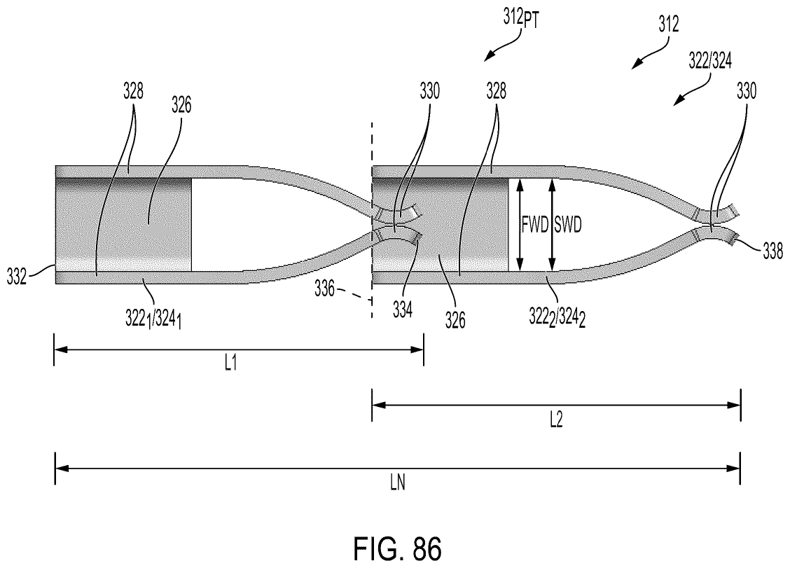

Referring to FIGS. 86-88, for each of the first terminal 322 and the second terminal 324, the first portion 322₁/324₁ includes a first length dimension L₁ measured, along the longitudinal axis TBL-TBL of the terminal block 276, from a first end 332 to a second end 334 of the first portion 322₁/324₁. The second portion 322₂/324₂ may include a second length dimension L₂ measured, along the longitudinal axis TBL-TBL of the terminal block 276, from a first end 336 to a second end 338 of the second portion 322₂/324₂. When the first portion 322₁/324₁ and the second portion 322₂/324₂ are nested together, a nested length dimension LN is measured, along the longitudinal axis TBL-TBL of the terminal block 276, from the first end 332 of the first portion 322₁/324₁ to the second end 338 of the second portion 322₂/324₂. The nested length dimension LN is less than a sum of the first length dimension L₁ of the first portion 322₁/324₁ and the second length dimension L₂ of the second portion 322₂/324₂.

The first length dimension L₁ of the first portion 322₁/324₁ may be the same as the second length dimension L₂ of the second portion 322₂/324₂. The first length dimension L₁ of the first portion 322₁/324₁ may be different from the second length dimension L₂ of the second portion 322₂/324₂.

Referring to FIGS. 92-105, the base portion 326 of the first portion 322₁ of the first terminal 322 may be configured to connect the first portion 322₁ of the first terminal 322 to a first contact portion 340 of the terminal block 276. The base portion 326 of the second portion 322₂/324₂ of the first terminal 322 is configured to connect the second portion 322₂/324₂ of the first terminal 322 to the first contact portion 340 of the terminal block 276.

The base portion 326 of the first portion 324₁ of the second terminal 324 is configured to connect the first portion 324₁ of the second terminal 324 to a second contact portion 342 of the terminal block 276. The base portion 326 of the second portion 324₂ of the second terminal 324 is configured to connect the second portion 324₂ of the second terminal 324 to the second contact portion 342 of the terminal block 276. FIG. 93 shows a bottom perspective view of the battery pack terminal block 276, where the metal, insert molded terminal base contacts 340, 342 are shown.

The first contact portion 340 and the second contact portion 342 of the terminal block 276 may be made of a metal material. The first contact portion 340 and the second contact portion 342 of the terminal block 276 may be insert molded into the terminal block housing 344.

The terminal contacts 330 of the first portion 322₁ and the second portion 322₂ of the first terminal 322 are configured to engage with the first electrical device contact (e.g., power terminal PTB+ or power terminals PTB− as shown in FIG. 149).

The terminal contacts 330 of the first portion 324₁ and the second portion 324₁ of the second terminal 324 are configured to engage with the second electrical device contact (e.g., power terminal PTB+ or power terminals PTB− as shown in FIG. 149).

The terminal contacts 330 of the first portion 322₁ and the second portion 322₂ of the first terminal 322 include tulip terminal contacts 330 that are configured to be separated from each other to receive portions of the first electrical device contact (e.g., power terminal PTB+ or power terminals PTB− as shown in FIG. 149) therebetween. The terminal contacts 330 of the first portion 324₁ and the second portion 324₂ of the second terminal 324 include tulip terminal contacts 330 that are configured to be separated from each other to receive portions of the second electrical device contact (e.g., power terminal PTB+ or power terminals PTB− as shown in FIG. 149) therebetween.

The opposing side walls 328 of the second portion 322₂ of the first terminal 322 are separated from each other by a first width dimension FWD. The first width dimension FWD is configured such that, when the first portion 322₁ and the second portion 322₂ of the first terminal 322 are nested together, the first width dimension FWD is configured to allow for separation of the tulips terminal contacts 330 of the first portion 322₁ of the first terminal 322 to receive the portions of the first electrical device contact (e.g., power terminal PTB+ or power terminals PTB− as shown in FIG. 149) therebetween.

The opposing side walls 328 of the second portion 324₂ of the second terminal 324 are separated from each other by a second width dimension SWD. The second width dimension SWD is configured such that, when the first portion 324₁ and the second portion 324₂ of the second terminal 324 are nested together, the second width dimension SWD is configured to allow for separation of the tulips terminal contacts 330 of the first portion 324₁ of the second terminal 324 to receive the portions of the second electrical device contact (e.g., power terminal PTB+ or power terminals PTB− as shown in FIG. 149) therebetween.

The first width dimension FWD of the second portion 322₂ of the first terminal 322 may be the same as the second width dimension SWD of the second portion 324₂ of the second terminal 324.

The first width dimension FWD of the second portion 322₂ of the first terminal 322 may be different from the second width dimension SWD of the second portion 324₂ of the second terminal 324.

The first portion 322₁ and the second portion 322₂ of the first terminal 322 are at the same potential. The first portion 324₂ and the second portion 324₂ of the second terminal 324 are at the same potential.

Referring to FIGS. 82-89, for each of the first terminal 322 and the second terminal 324, the terminal contacts 330 at the second end 334 of the first portion 322₁/324₁ are configured to overlap with the base portion 326 at the first end 336 of the second portion 322₂/324₂ when the first portion 322₁/324₁ and the second portion 322₂/324₂ are nested together. For each of the first terminal 322 and the second terminal 324, portions (e.g., near the terminal contacts 330) of the first portion 322₁/324₁ are configured to overlap, along the longitudinal direction TBL-TBL of the terminal block 276, with portions (e.g., near the base 326) of the second portion 322₂/324₂ when the first portion 322₁/324₁ and the second portion 322₂/324₂ are nested together.

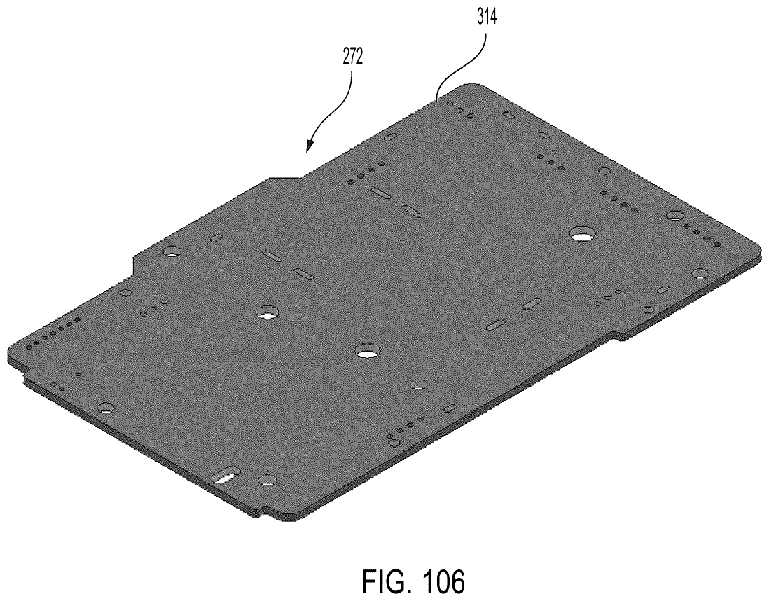

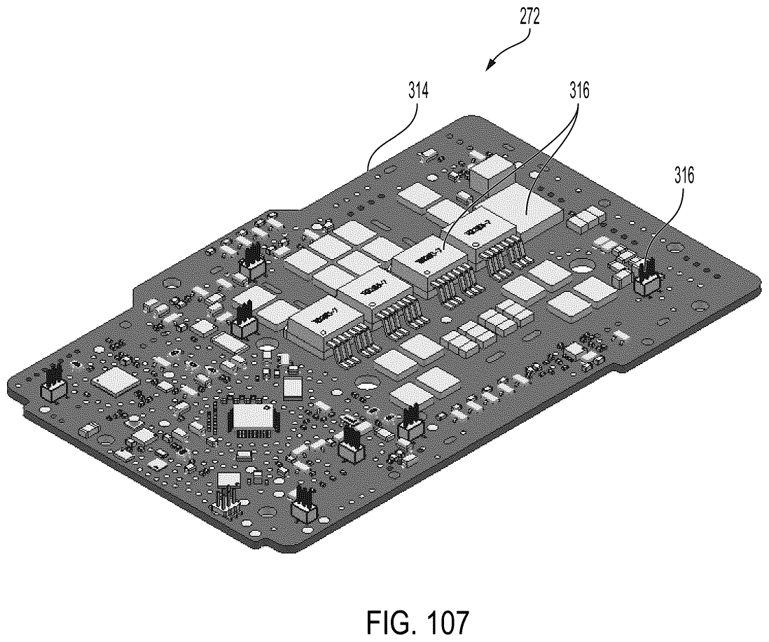

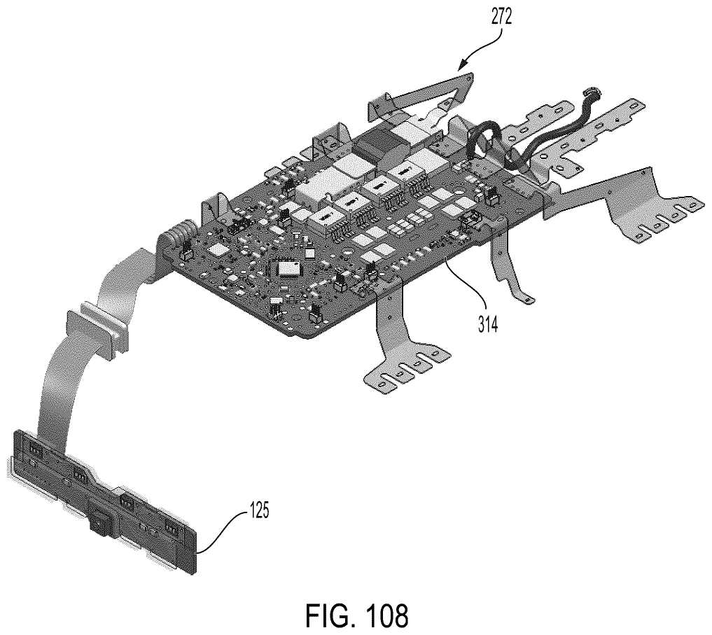

FIGS. 106-108 show perspective views of the electronics module subassembly 272 of the battery pack 100. FIG. 106 shows a base member 314 of the electronics module subassembly 272. The base member 314 may be a printed circuit board (PCB). FIG. 107 shows electronics 316 disposed on the PCB 314. FIG. 108 shows flexible circuits, wires, other connectors, and electronics 316 disposed on the PCB 314. The printed circuit boards may be replaced by other types of circuits, including but is not limited to flexible printed circuits. The electronics subassembly 272 may also be referred to as electronics module subassembly 272.

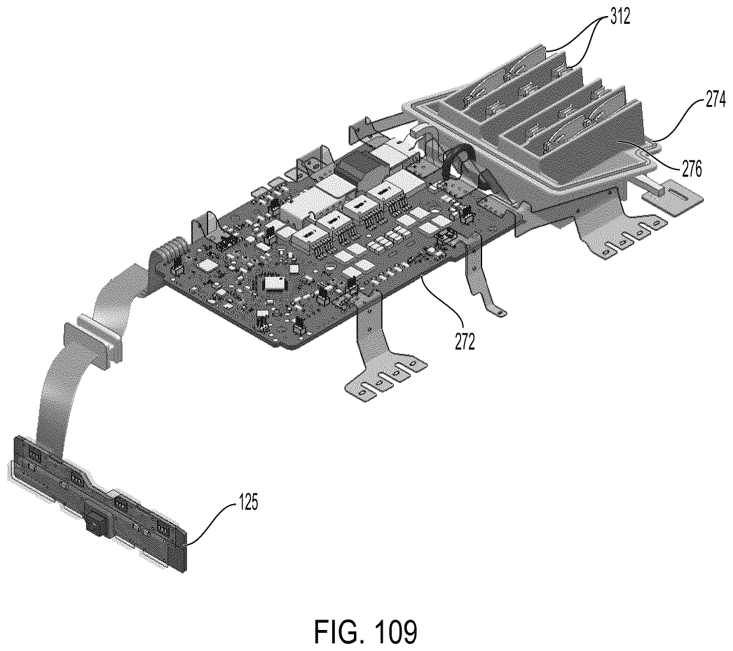

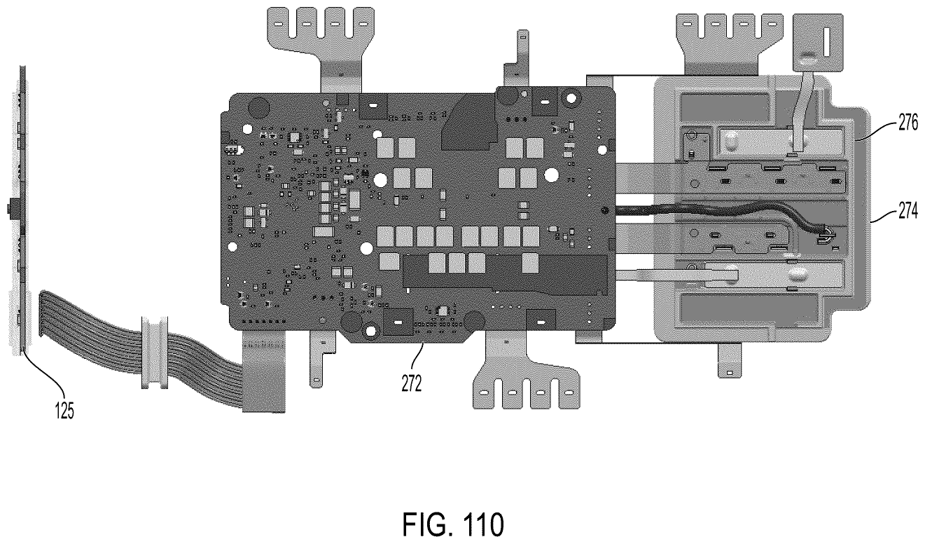

FIGS. 109-110 show views of the electronics module subassembly 272 of the battery pack 100 and the terminal block housing 274 connected thereto. As shown in FIGS. 110-112, the battery pack 100 may further include a subassembly support 271. The subassembly support 271 may be configured to support the electronics module subassembly 272 and the terminal block 276. FIGS. 109-110 also show the SOC PCB 125.

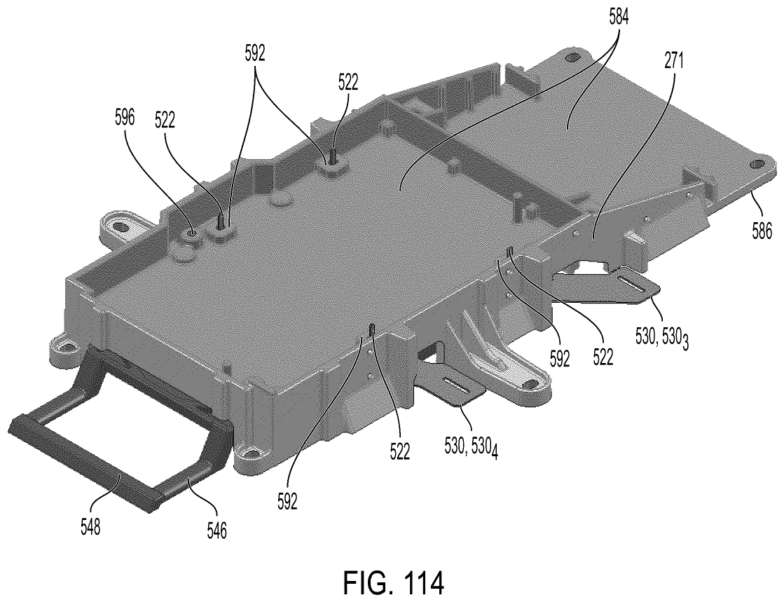

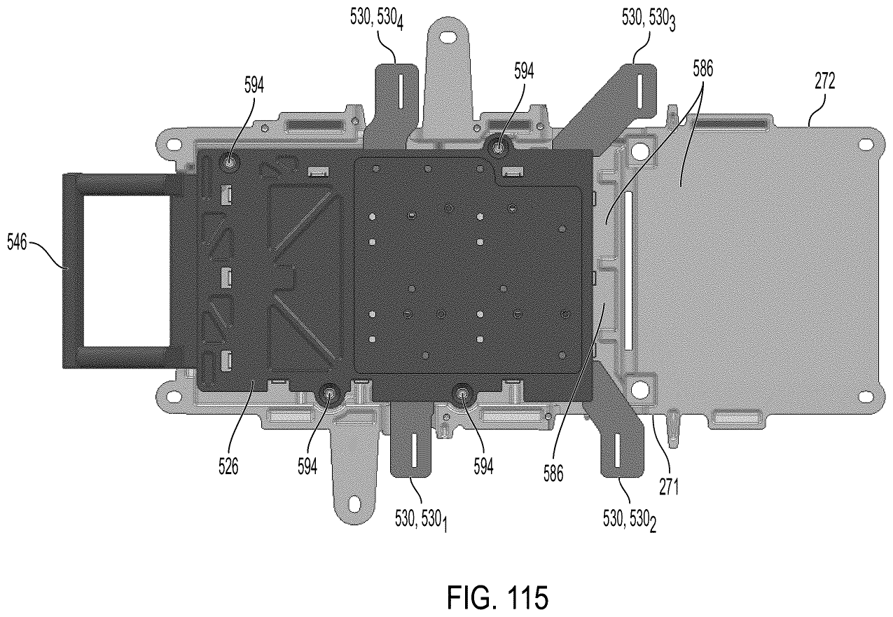

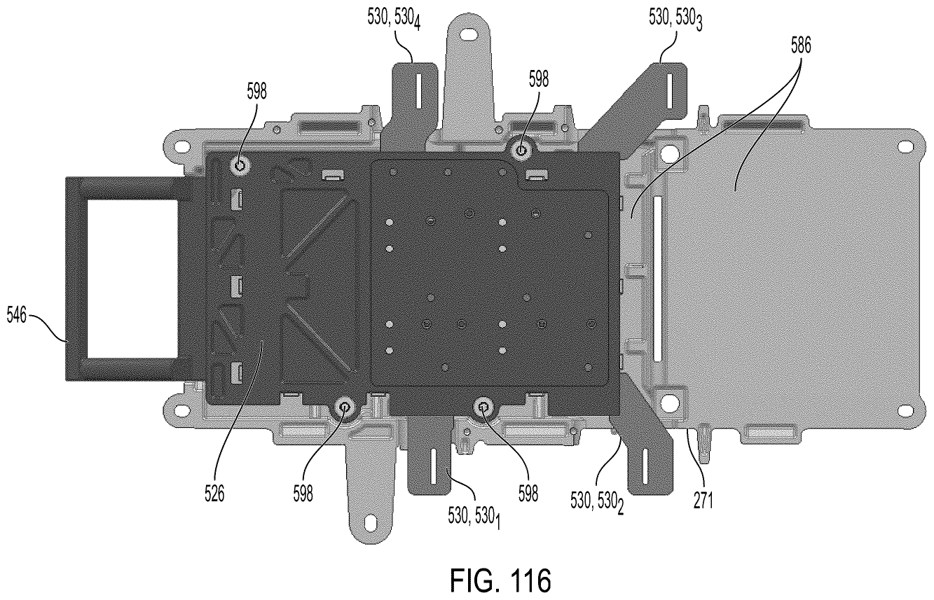

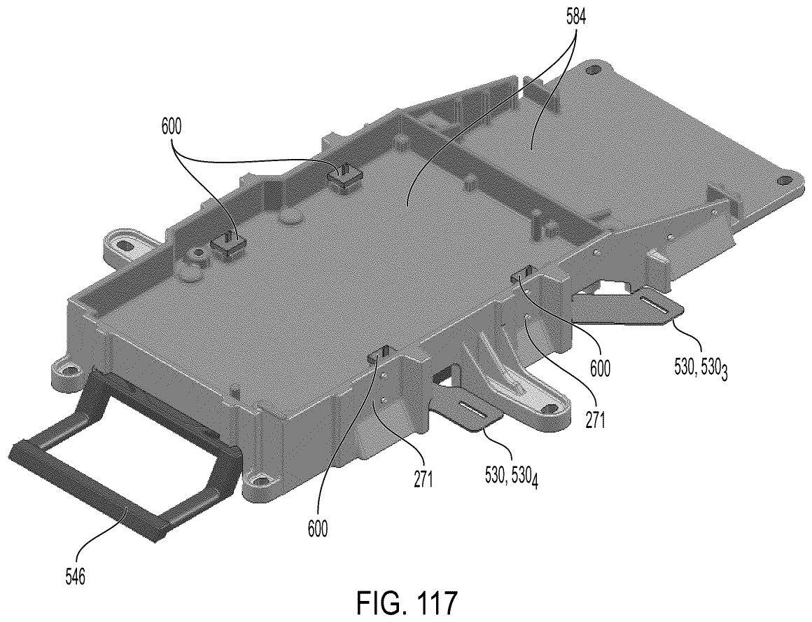

FIG. 113 shows an exploded perspective view of the subassembly holder/support 271, the shipping system 500 and the electronics module subassembly 272 and the terminal block 276. FIGS. 114-115 show views of the subassembly holder/support 271 and the shipping system 500, where the subassembly holder/support 271 and the shipping system 500 are aligned with each other and they are shown before being connected to each other. FIG. 116 shows a bottom plan view of the subassembly support 271 and the shipping system 500, where the subassembly support 271 and the shipping system 500 are shown after they are connected to each other. FIG. 117 shows a perspective view of the subassembly support 271 and the shipping system 500, where the subassembly support 271 and the shipping system 500 are shown after they are connected to each other. Portions of the shipping system 500 may extend through the subassembly support 271, as will be described in discussions below. These portions may be engaged with portions of the electronics module subassembly 272 to monitor the current of the battery pack 100. FIGS. 118-119 show views of the subassembly support 271, the shipping system 500, the battery pack terminal block 276, and the electronics module subassembly 272 after all are connected to each other.

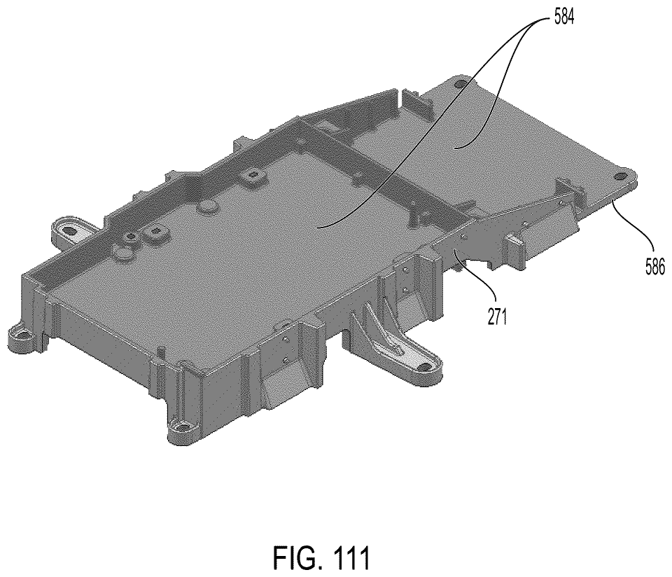

Referring to FIGS. 111-119, the subassembly support 271 may be configured to support the electronics module subassembly 272 and the terminal block 276 on a top surface 584 thereof and may be configured to be connected with a shipping subassembly base member 526 on a bottom surface 586 thereof. The shipping subassembly base member 526 may include fastener openings/holes 594 in a pattern corresponding to fastener openings/holes 596 of the subassembly support 271. Mechanical fasteners (e.g., screws, etc.) 598 may be inserted through the fastener openings/holes 594, 596 after they are aligned, for connecting the shipping subassembly base member 526 to the subassembly support 271. The shipping subassembly base member 526 may be positioned under the subassembly support 271.

As shown in FIG. 117, spacers or support members 600 may be disposed on the portions 592 of the subassembly support 271. The spacers 600 may be configured to align with the aligning portions 522 of the contact pad member 520 of the shipping system 500. The aligning portions 522 of the contact pad member 520 (e.g., protruding/extending through the portions 528 of the shipping subassembly base member 526, the portions 592 of the subassembly support 271, and the spacers 600) may be configured to align the electronics module subassembly 272 and the terminal block 276 on the top surface 584 of the subassembly support 271.

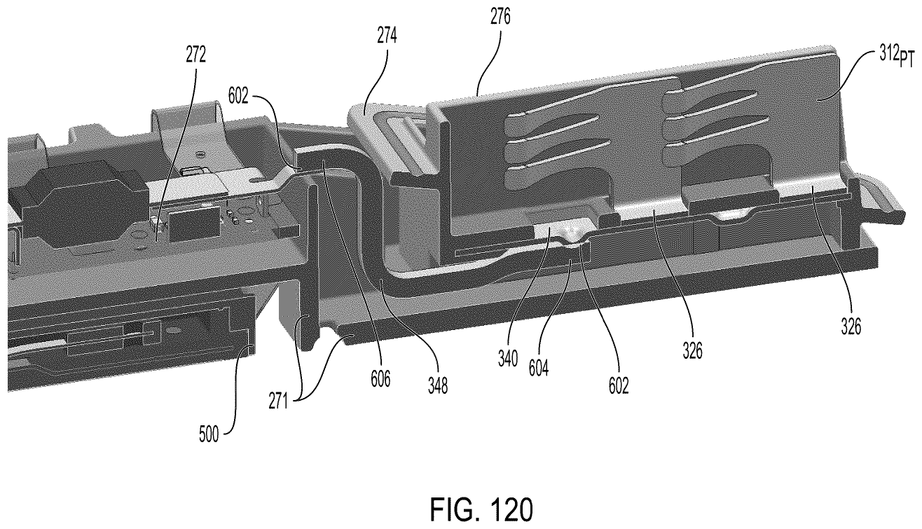

FIG. 120 shows a cross-sectional view of the battery pack terminal block 276 along with portions of the assembled subassembly support 271, the shipping system 500 and the electronics module subassembly 272. Resistance welds 602 may be formed between one end 604 of the terminal block power path terminal (e.g., copper strap) 348 and the metal, insert molded terminal base 340 and also between the other end 606 of terminal block power path terminal 348 and portions of the electronics module subassembly 272.

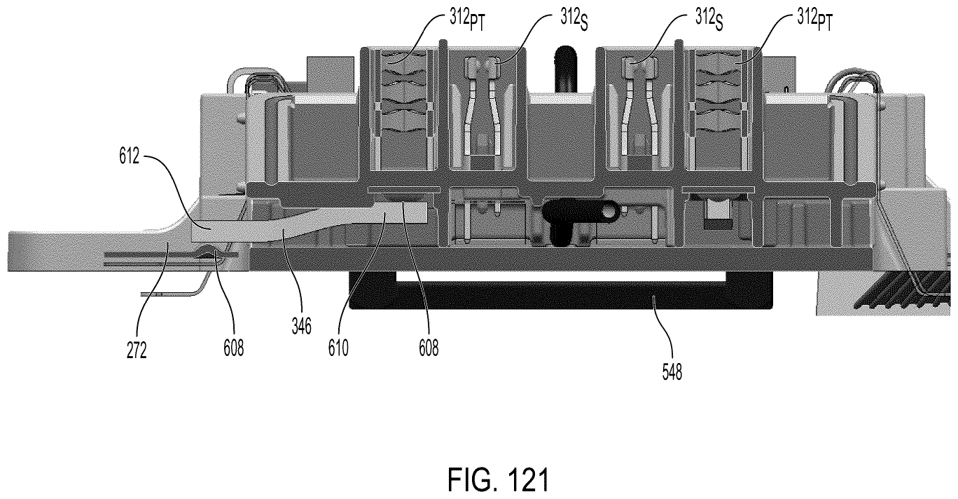

FIG. 121 shows a rear cross-sectional view of the battery pack terminal block 276 along with portions of the assembled subassembly support 271, the shipping system 500 and the electronics module subassembly 272. Resistance welds 608 between one end 610 of the terminal block power path terminal 346 and the metal, insert molded terminal base 342 and between the other end 612 of the terminal block power path terminal 346 and portions of the electronics module subassembly 272 are shown.

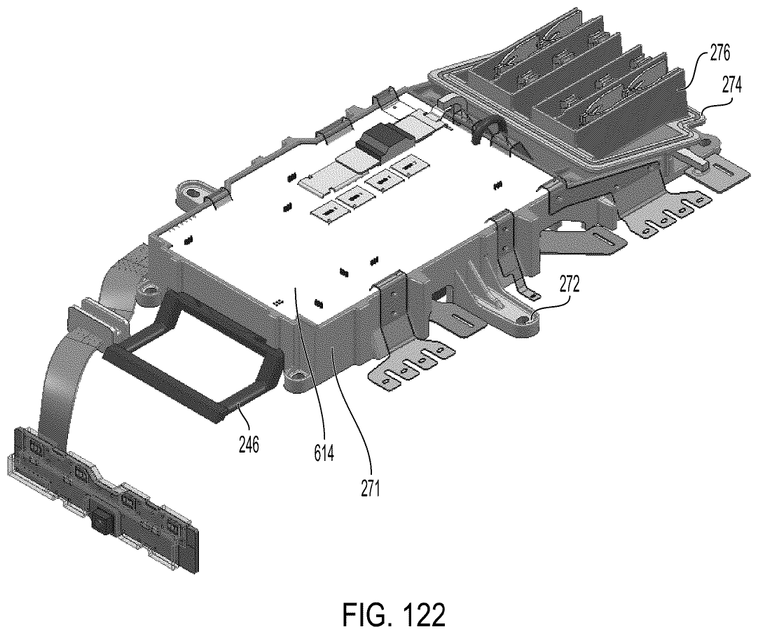

FIG. 122 shows a perspective view of the subassembly support 271, the shipping system 500, the battery pack terminal block 276, and the electronics module subassembly 272 after all are connected to each other. Potting material 614 may be received on the electronics module subassembly 272 that is received in the subassembly support 271.

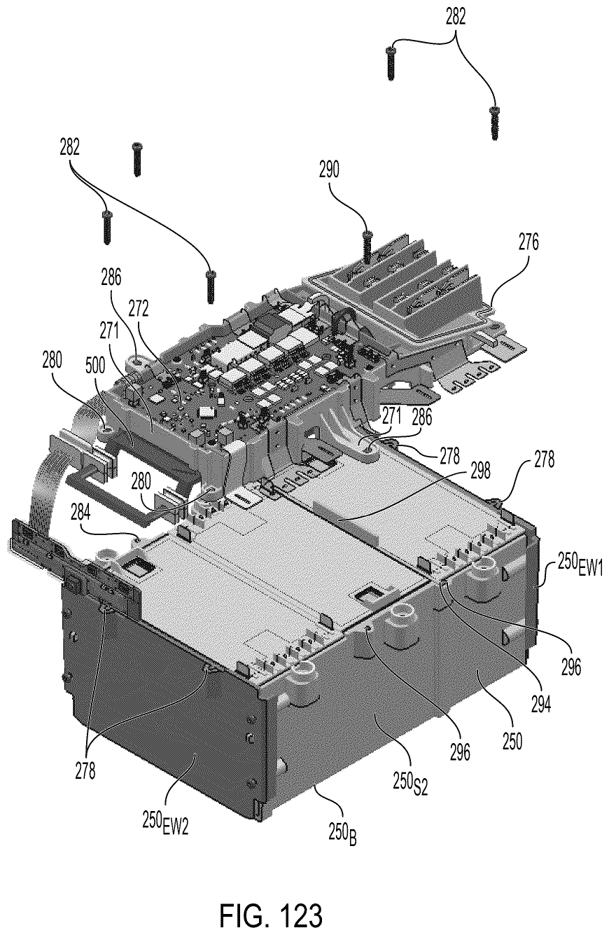

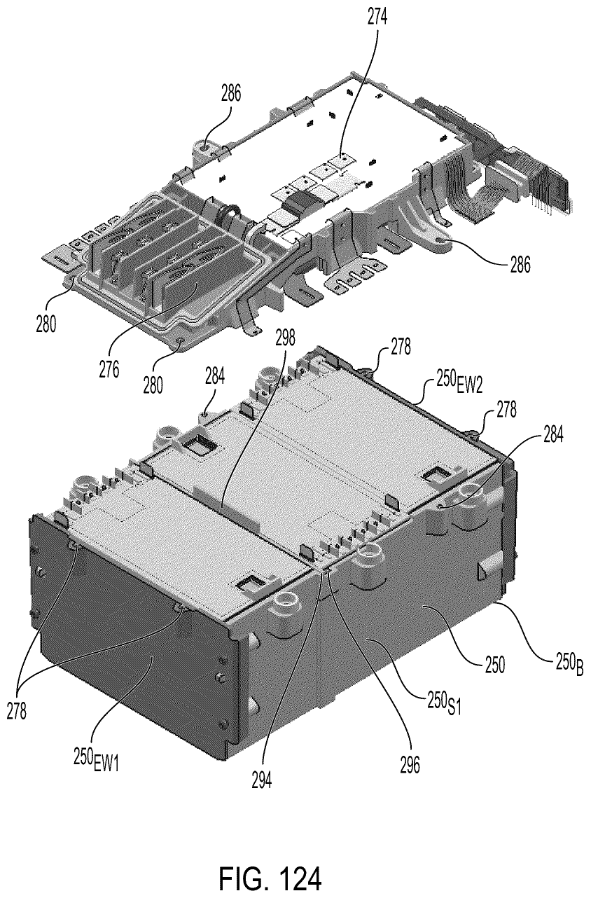

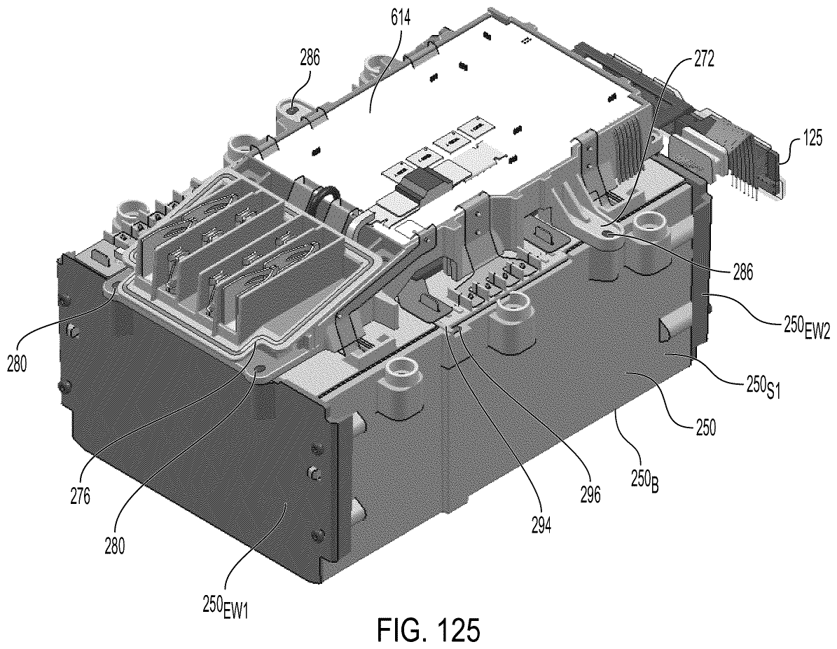

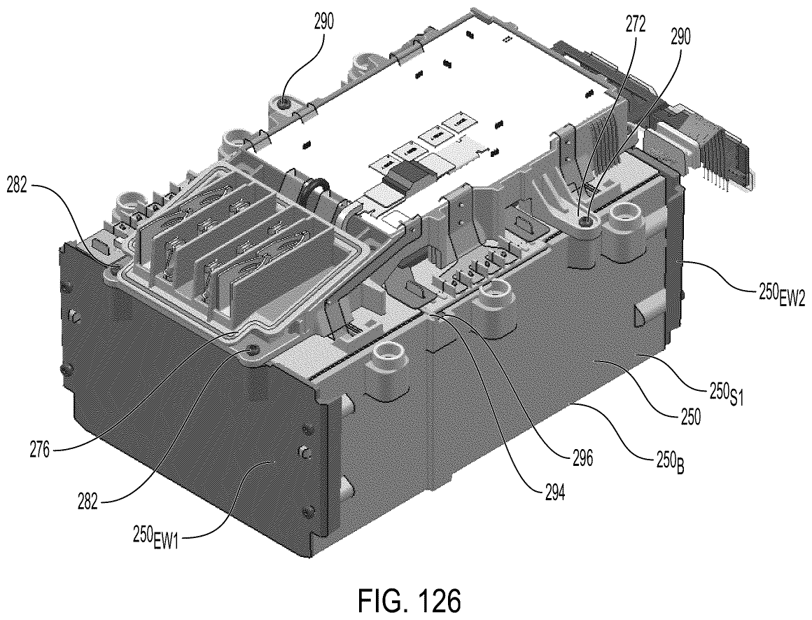

FIGS. 123-124 show various views of the assembled subassembly support 271, the battery pack terminal block 276, the shipping system 500 and the electronics module subassembly of FIG. 122 and the cell holder subassembly 250 of FIG. 47 before they are connected to each other. FIGS. 125-129 show various views of the cell subassembly 250 and the assembled subassembly support 271, the battery pack terminal block, the shipping system 500 and the electronics module subassembly 272. FIG. 125 shows them after they are aligned but before they are connected to each other, while FIGS. 126-129 show them after they are connected to each other. A core pack of the battery pack 100 may include the cell subassembly 250 with the cell modules 200, the subassembly support 271, the shipping system 500, the battery pack terminal block 276, and the electronics module subassembly 271 all connected to each other.

Referring to FIGS. 41-48, 124, and 128, the aligning member 298 of the partition wall 292 of the cell holder subassembly 250 may be configured to be received in a corresponding opening 300 of the subassembly support 271 so as to align the subassembly support 271 with respect to the cell holder subassembly 250.

Referring to FIGS. 123-129, the subassembly support 271 may be configured to be positioned parallel to the base 252_{B} of the cell holder subassembly 250 to form a top of the cell holder subassembly 250. The subassembly support 271 may be configured to be removably connected to the two side walls 252_{S1}, 252_{S2} and the two end walls 252_{EW1}, 252_{EW2} of the cell holder subassembly 250.

The end walls 252_{EW1}, 252_{EW2} may include fastener openings/holes 278 in a pattern corresponding to fastener openings/holes 280 of the subassembly support 271. Mechanical fasteners 282 (e.g., screws, etc.) may be inserted through the fastener openings/holes 278, 280 after they are aligned, for connecting the subassembly support 271 to the end walls 252_{EW1}, 252_{EW2}. The side walls 252_{S1}, 252_{S2} may include fastener openings/holes 284 in a pattern corresponding to fastener openings/holes 286 of the subassembly support 271. Mechanical fasteners 290 (e.g., screws, etc.) may be inserted through the fastener openings/holes 284, 286 after they are aligned, for connecting the subassembly support 271 to the side walls 252_{S1}, 252_{S2}.

FIGS. 46-48 show the module holder 252 with the battery modules 200 received therein and with the two end walls 252_{EW1}, 252_{EW2} attached thereto. The cell holder subassembly 250 of FIGS. 46-48 is then attached to the subassembly support 271 (i.e., configured to support the electronics module subassembly 272 and the terminal block 276 and to be attached to the shipping subassembly/system 500) of FIGS. 118-119. FIGS. 124-129 show the procedures of attachment between the subassembly support 271 of FIGS. 118-119 and the cell holder subassembly 250 of FIGS. 46-48.

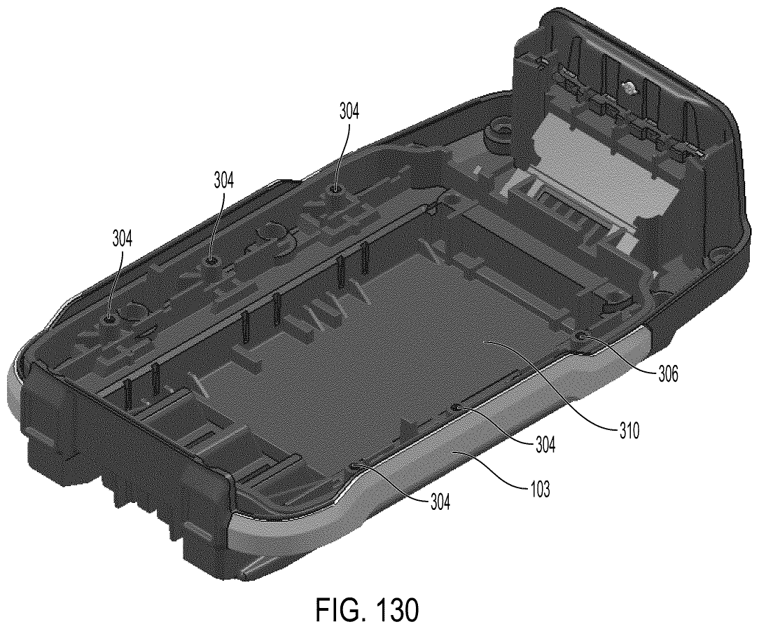

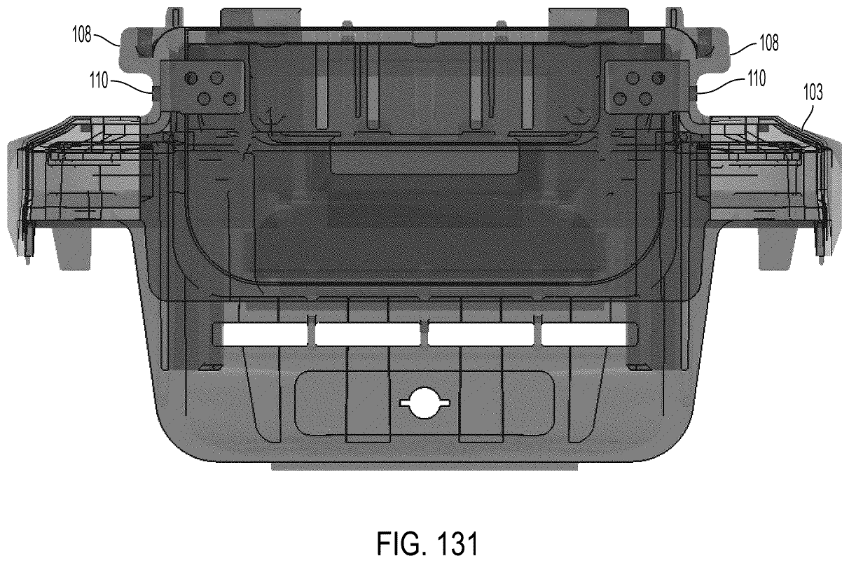

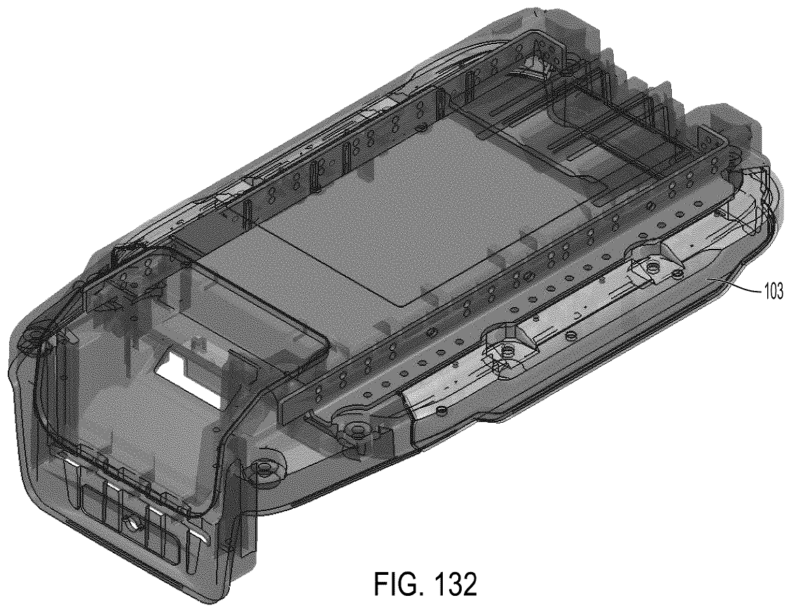

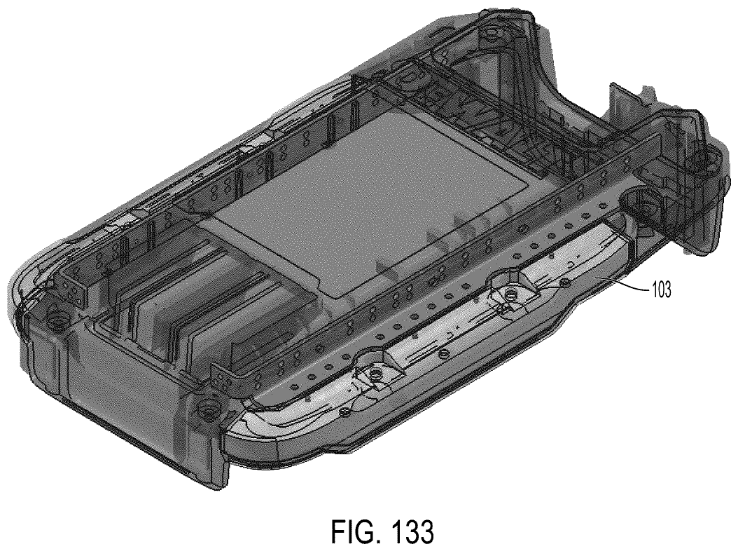

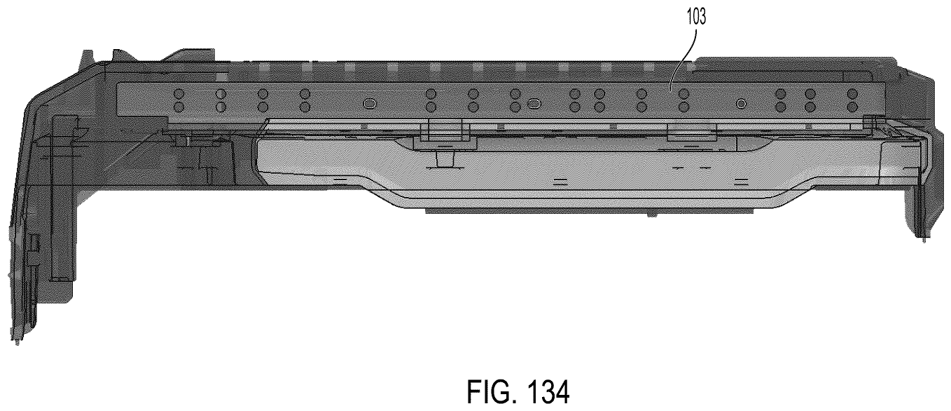

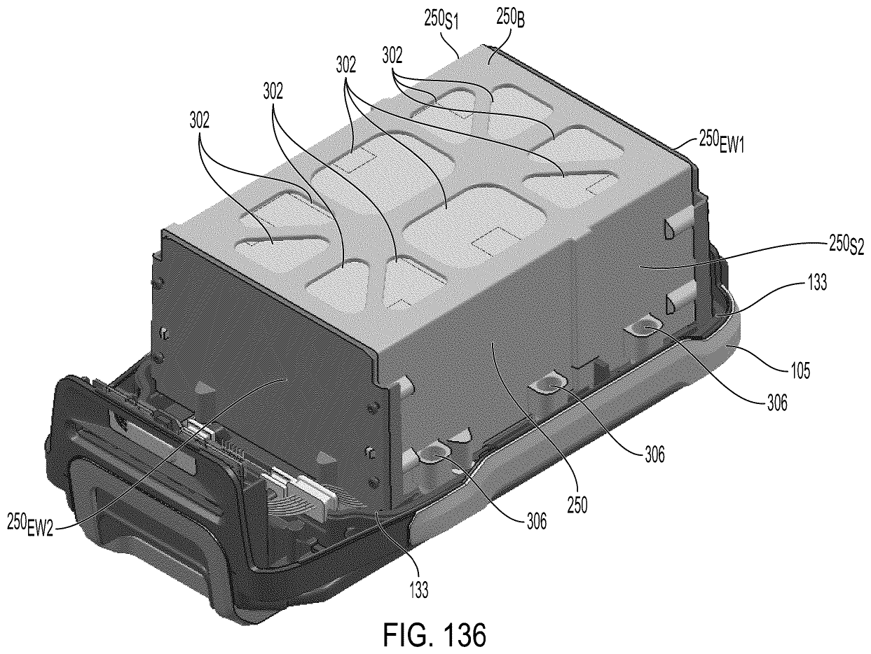

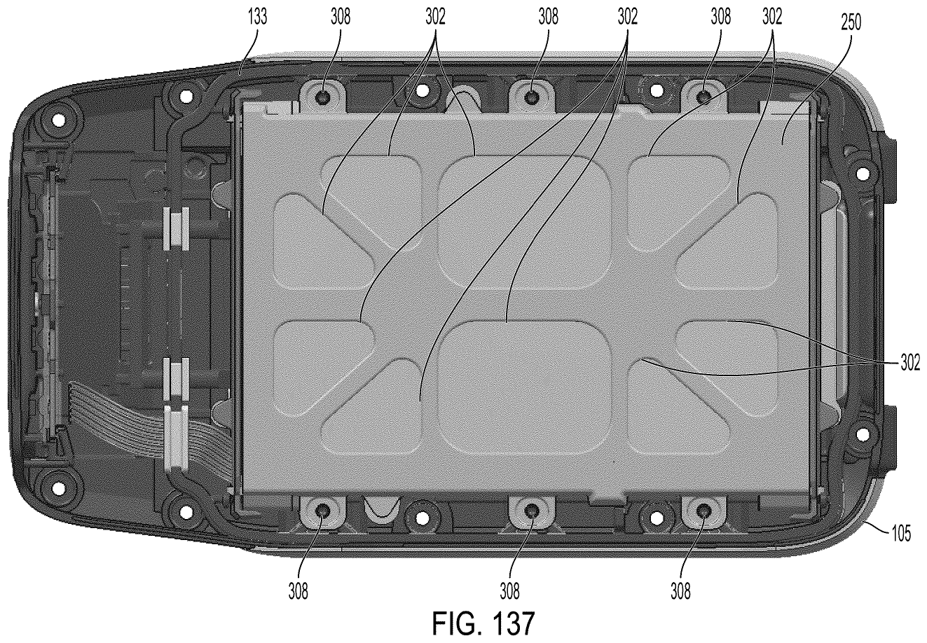

As shown in FIGS. 130, 132, and 135-137, the assembled cell holder subassembly 250 of FIGS. 125-129 may be configured to be removably connected to the upper housing portion 103. The upper housing portion 103 may be the first housing portion or the second housing portion of the battery pack 100. As shown in FIG. 130, the upper housing portion 103 may include recessed/receiving portion 310 that is configured to receive portions of the cell holder subassembly 250 therein when the cell holder subassembly 250 is removably connected to the upper housing portion 10. The upper housing portion 103 may include fastener openings/holes 304 in a pattern corresponding to fastener openings/holes 306 of the cell holder subassembly 250. The fastener openings/holes 306 may be disposed on the two opposing side walls 252_{S1}, 252_{S2} of the module holder 252. Mechanical fasteners (e.g., screws, etc.) 308 may be inserted through the fastener openings/holes 304, 306 after they are aligned, for connecting the cell holder subassembly 250 to the upper housing portion 103. FIGS. 130-134 show various views of the upper housing portion 103 of the battery pack 100.

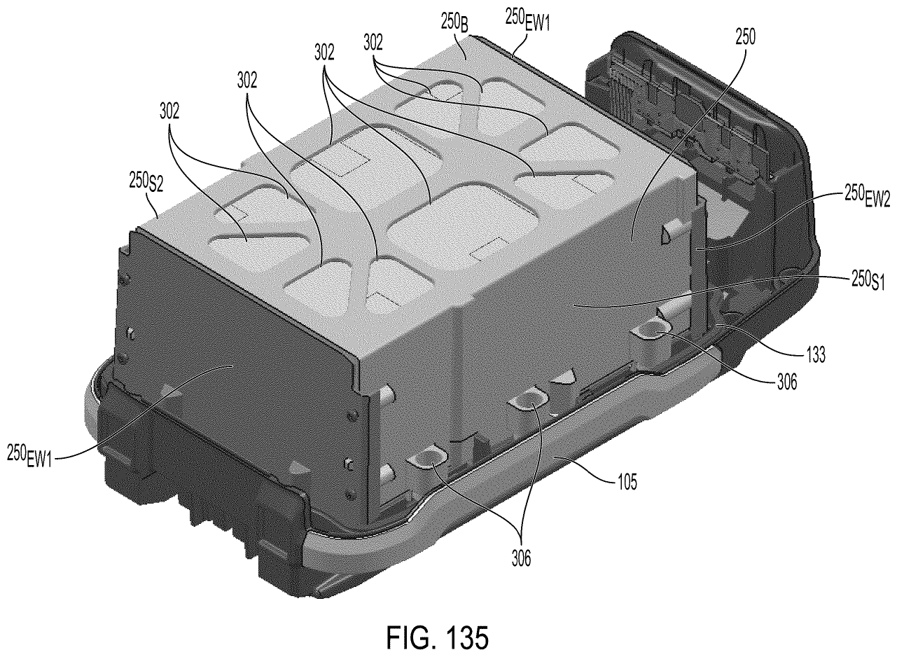

As shown in FIGS. 135-138, the base 252_{B} of the module holder 252/cell holder subassembly 250 may include a plurality of airflow openings 302 that are configured to allow airflow between the interior storage space 254 of the cell holder subassembly 250 and the internal cavity 104 of the housing 102 of the battery pack 100. In the illustrated embodiment, ten airflow openings 302 are shown. The number of airflow openings 302 may vary. The base 252_{B} with the airflow openings 302 may still be configured to support the battery cell modules 200 thereon.

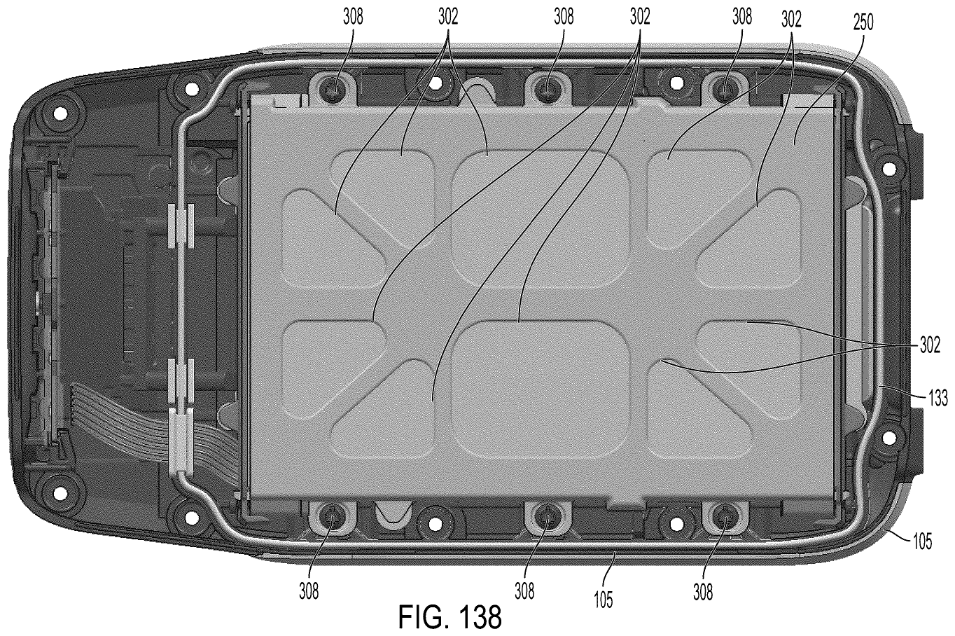

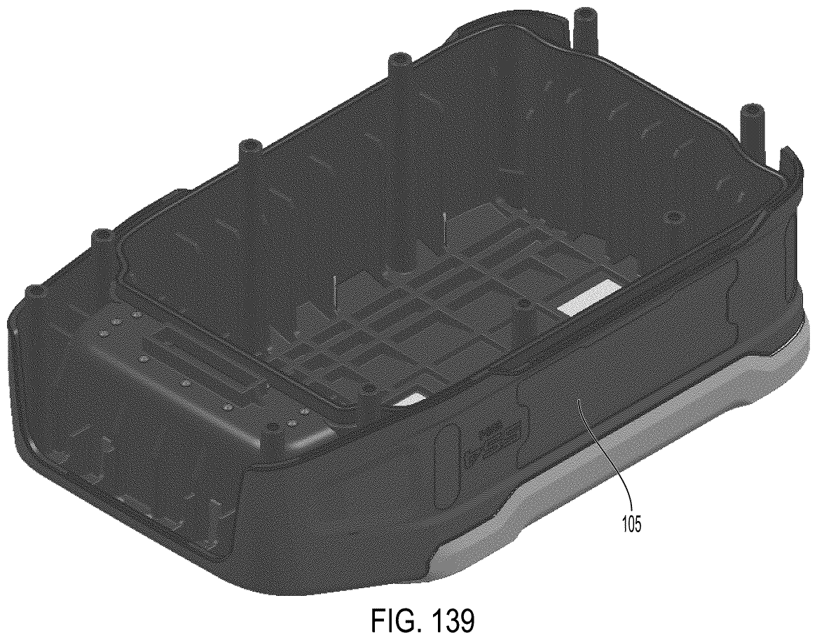

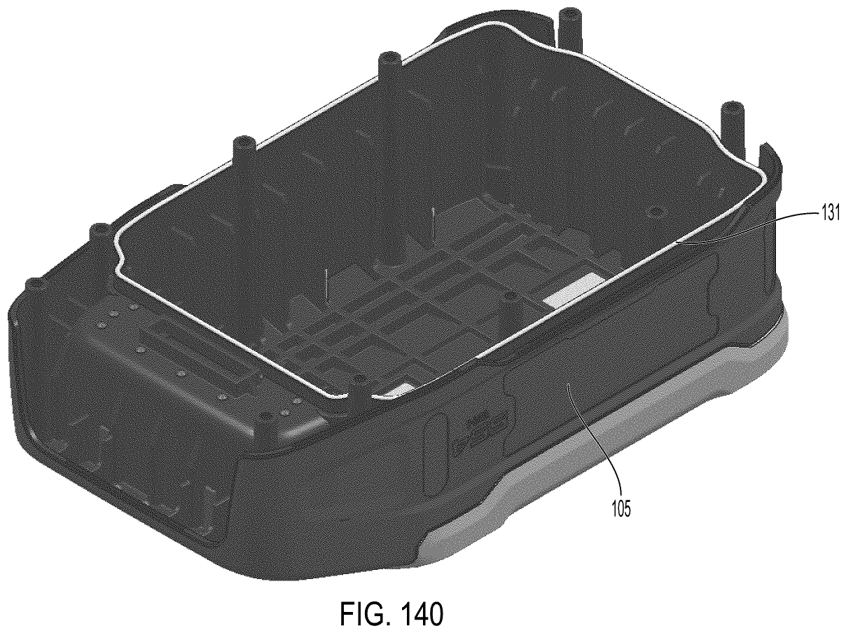

FIGS. 139-140 show various views of the lower housing portion 105 of the battery pack 100. As shown in FIG. 140, a seal or gasket 131 (e.g., a glue gasket) may be applied to the lower housing portion 105 of the battery pack 100. In another embodiment, as shown in FIG. 138, a seal or gasket 133 may be applied to the upper housing portion 103 of the battery pack 100. The seal or gasket 131/133 may be configured to extend peripherally around the inner cavity 104 of the battery pack 100.

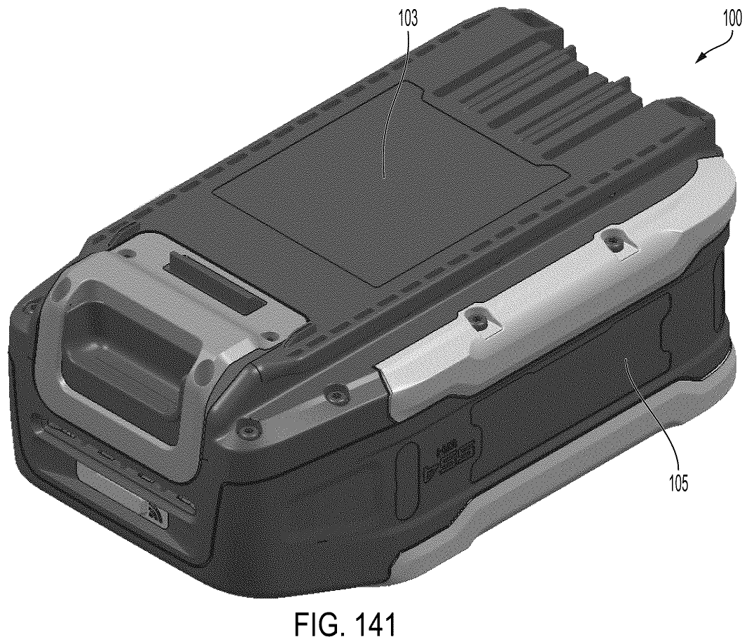

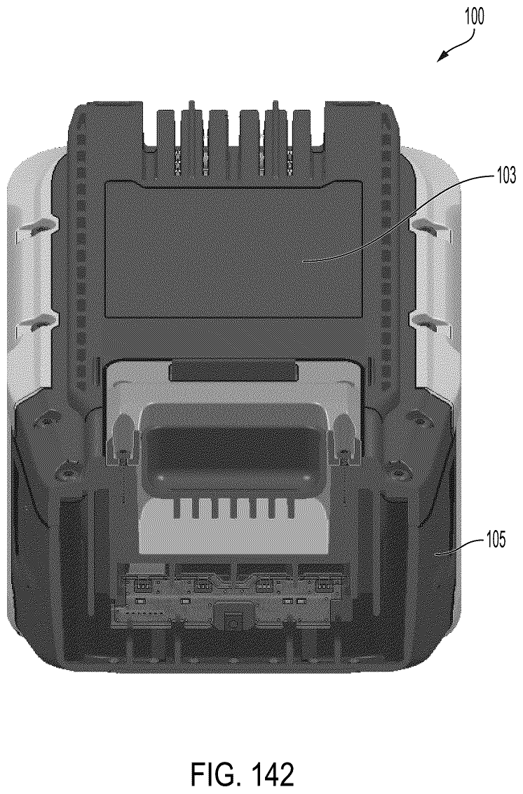

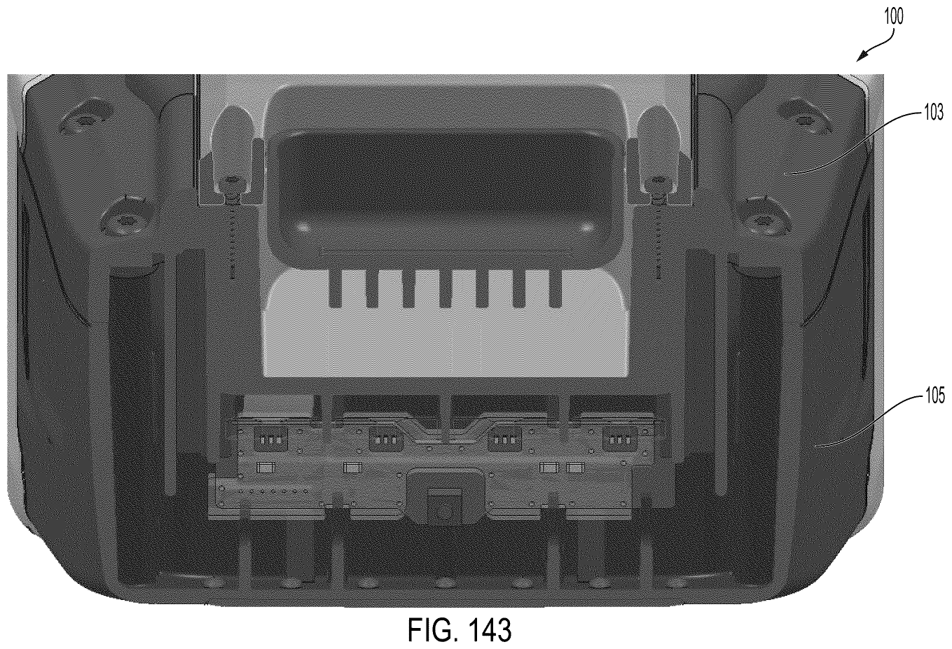

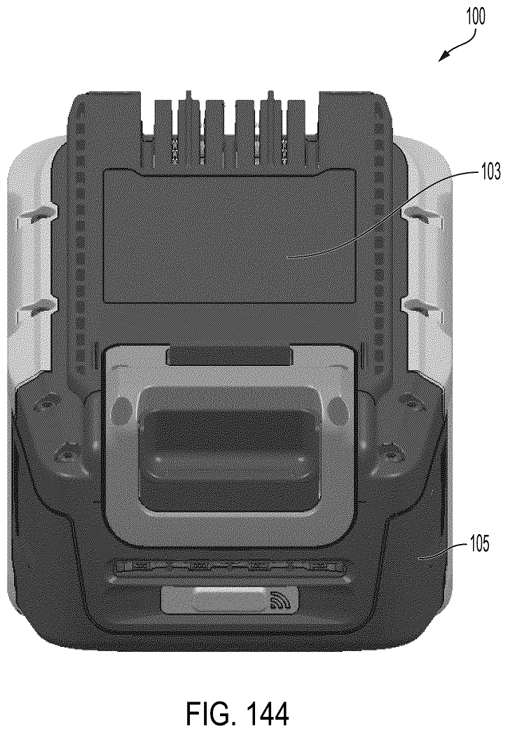

The upper housing portion 103 of the battery pack 100 may include fastener openings/holes and/or other engaging portions in a pattern corresponding to fastener openings/holes and/or other engaging portions of the lower housing portion 105 of the battery pack 100. Mechanical fasteners (e.g., screws, etc.) may be inserted through the fastener openings/holes of the upper housing portion 103 and the lower housing portion 105 after they are aligned, for connecting the upper housing portion 103 and the lower housing portion 105 of the battery pack 100 together. FIGS. 141-145 shows the assembled battery pack 100.

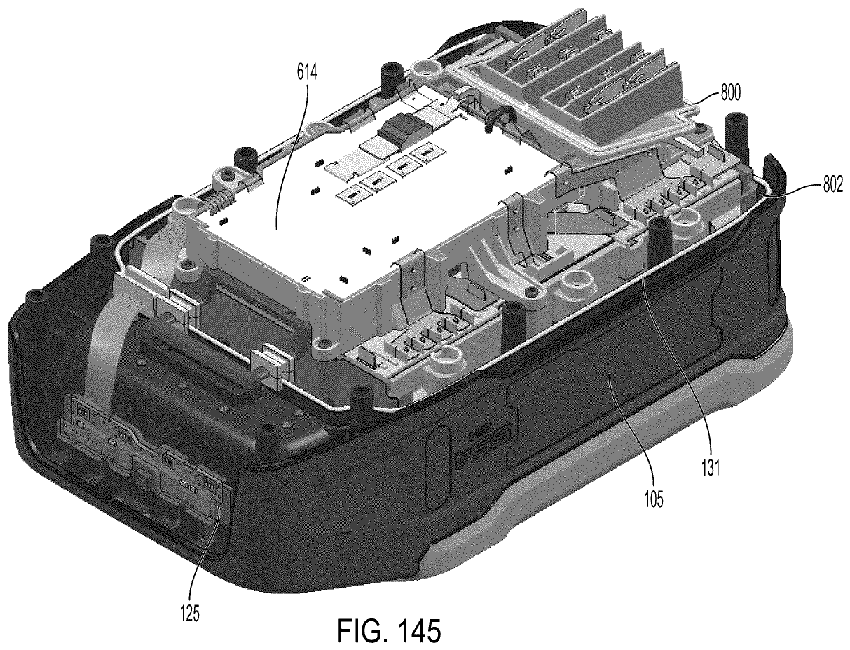

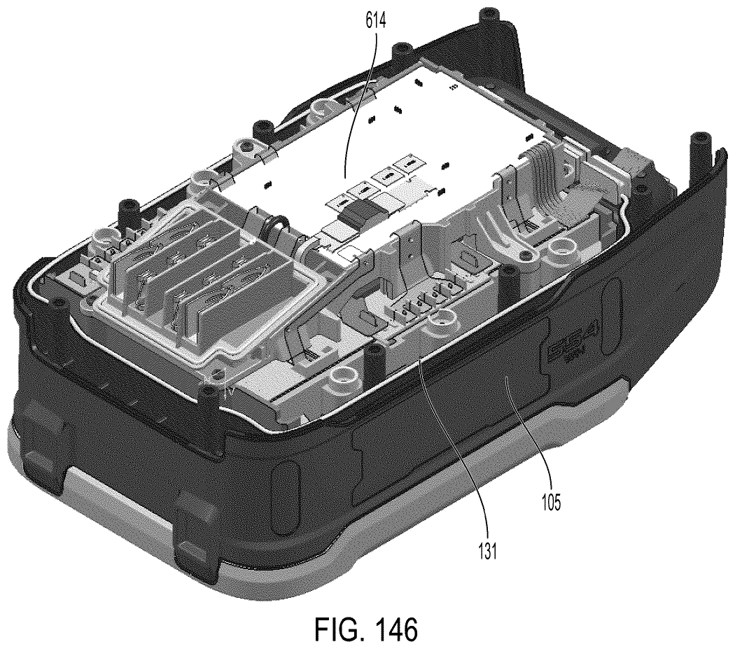

In one embodiment, as shown in FIGS. 135-138, the assembled cell holder subassembly 250 of FIGS. 125-129 may be configured to be removably connected to the upper housing portion 103 of the battery pack 100. In another embodiment, as shown in FIGS. 145-146, the assembled cell holder subassembly 250 of FIGS. 125-129 may be configured to be removably connected to the lower housing portion 105 of the battery pack 100.

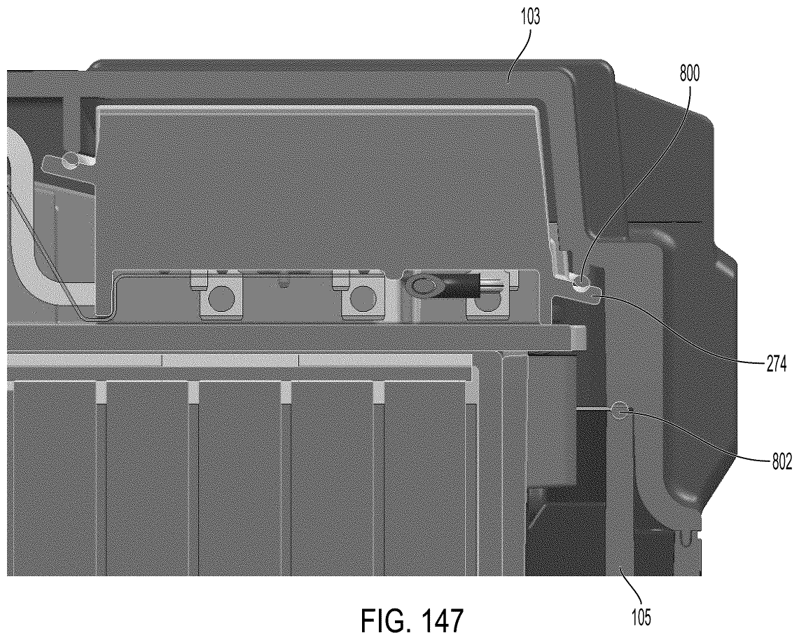

FIG. 147 shows a cross-sectional view of the battery pack 100 with the upper housing 103 and the lower housing 105 being engaged with each other. FIG. 147 shows some portions of the upper housing 103 may engage with the terminal block housing 274 at an engagement region, which includes a first seal or gasket 800. Other portions of the upper housing 13 may engage with portions of the lower housing 105 at an engagement region, which includes a second seal or gasket 802. The first and the second gasket 800 and 802 may also be shown in FIG. 145. The gaskets 800 and 802 may form a substantially water-sealed and/or air-sealed enclosure around the interior volume of the battery pack 100.

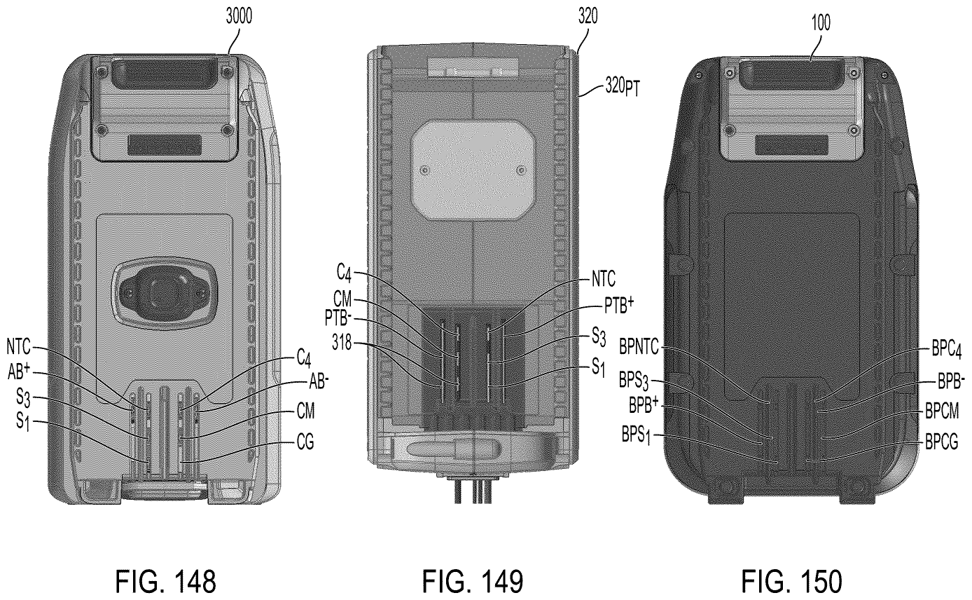

FIG. 148 shows an adaptor 3000 that may be configured to electrically interconnect a battery pack (not shown but from a distinct power tool system that would not otherwise mate with the electrical device/apparatus 320) with the electrical device/apparatus 320, such as the power tool (e.g., 320_{PT}) of a power tool system. That is, the adaptor 3000 may be configured to operatively couple the battery pack and the power tool 320_{PT}. For example, the adaptor 3000 may include an adaptor shown and described in detail in Patent Cooperation Treaty Application No. PCT/XX2024/0XXXXX, concurrently filed on Aug. 16/17, 2024, titled “Battery Pack Adaptor”, which in turn claims the benefit of priority from U.S. Provisional Patent Application Ser. No. 63/622,460, filed Jan. 18, 2024, the contents all of which are incorporated herein in their entireties by reference. The adaptor 3000 may include a first set of electrical terminals (not shown) that is connectable to the set of electrical terminals 312 of the battery pack so as to enable electrical coupling between the battery pack and the adaptor 3000. The first set of electrical terminals of the adaptor 3000 may be disposed in an internal cavity of the adaptor's housing. The battery pack terminals may engage and mate with adaptor battery pack terminals. The adaptor 3000 may also include adaptor device power terminals AB⁻ and AB⁺ (e.g., two discharge power terminals) and CG (e.g., charge power terminal along with AB+) and adaptor device signal terminals (e.g., five signal terminals C4, CM, S1, S3 and NTC). These device terminals are configured to be operatively coupled to the power tool 320_{PT}. The adaptor 3000 may also be configured to electrically connect the battery pack from the distinct power tool system to the charger 320_{C}.

FIGS. 149, 150, and 151 show the power tool 320_{PT}, the battery pack 100, and the charger 320_{C}. The power tool 320_{PT}, the battery pack 100, and the charger 320_{C} have been described in detail in the discussions above.

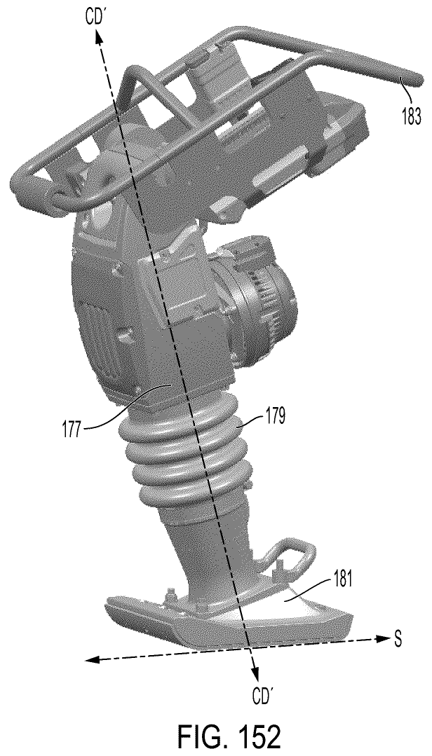

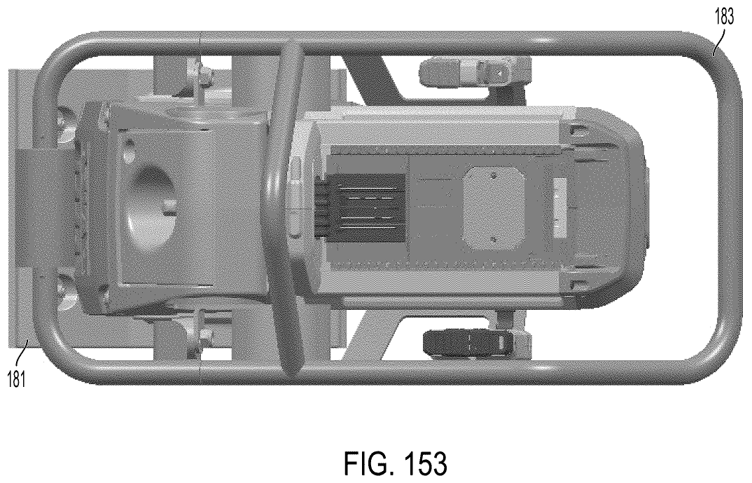

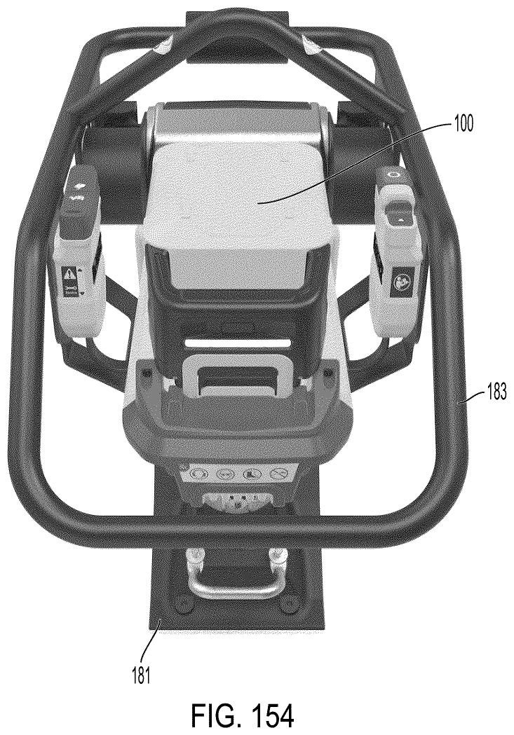

FIGS. 152-154 show an example cordless power tool (rammer) 175. The rammer (or electric rammer) 175 may include a primary housing 177 and a reciprocating leg portion 179 which may be coupled to a compacting foot 181. The compacting foot 181 may be adapted for compacting soil, hardcore, asphalt or any other material S to be compacted. The reciprocating leg portion 179 may include a reciprocating mechanism (not shown) which is arranged to drive the compacting foot 181 up and down along the longitudinal axis CD′-CD′ of the power tool 175. The rammer 175 may include a handle 183 by which a user can maneuver the rammer 175, and the battery pack 100 for powering the electric motor (not shown but located within the primary housing 177) of the rammer 175.

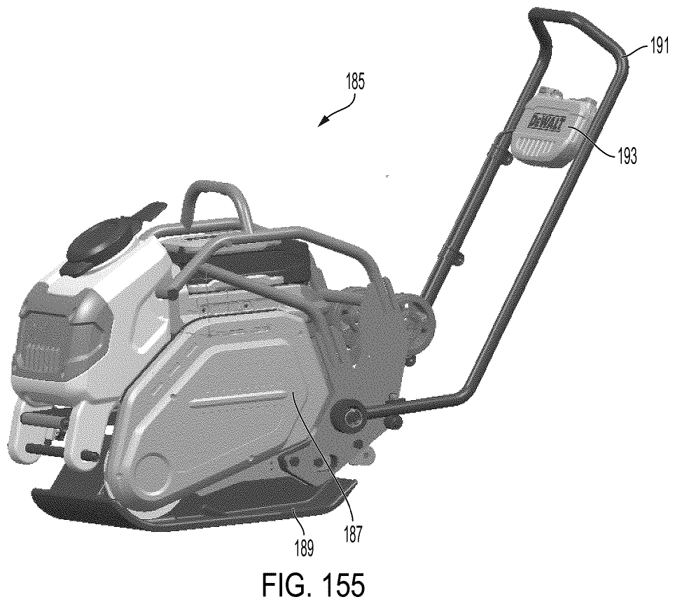

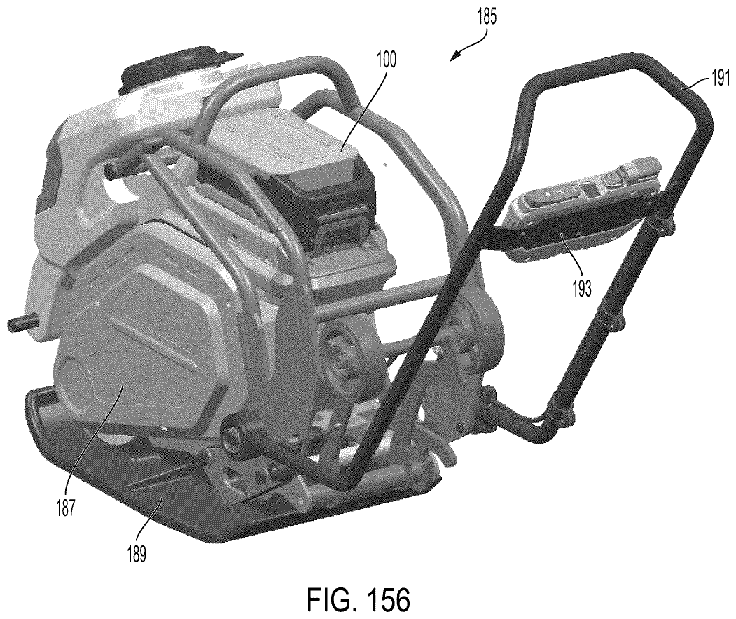

FIGS. 155-156 show another example cordless power tool (plate compactor) 185. The compactor 185 may include a main body 187 and a vibrating plate portion 189. The plate portion 189 may be adapted for compacting soil, gravel, sand, silt or any other material to be compacted. The compactor 185 also may include a handle 191 by which a user can maneuver the compactor 185, a motor, and the battery pack 100 for powering the motor of the compactor 185. The compactor 185 may include a user operable switch (may also be referred to as a “trigger” or “power switch”) and a control module (may also be referred to as “electronic control module”, or “motor control module”). The motor control module may include a controller and electronic switching components for regulating the supply of power from the battery pack 100 to the motor. The motor control module may be disposed within the housing of the main body of the compactor 185 or at any location within or on the compactor 185. The motor control module may also integrally include components to support a user operated input unit or user interface 193 (may be referred to as “input unit”) for receiving user function selections, such as an ON/OFF signal, variable-speed signal, and forward-reverse signal.

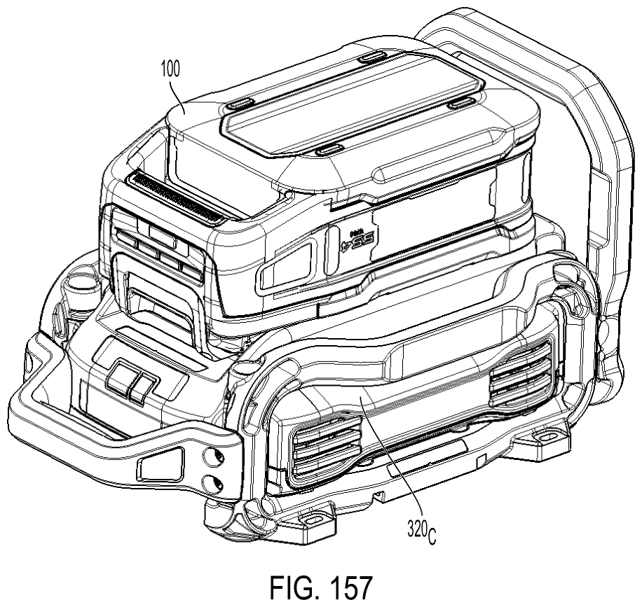

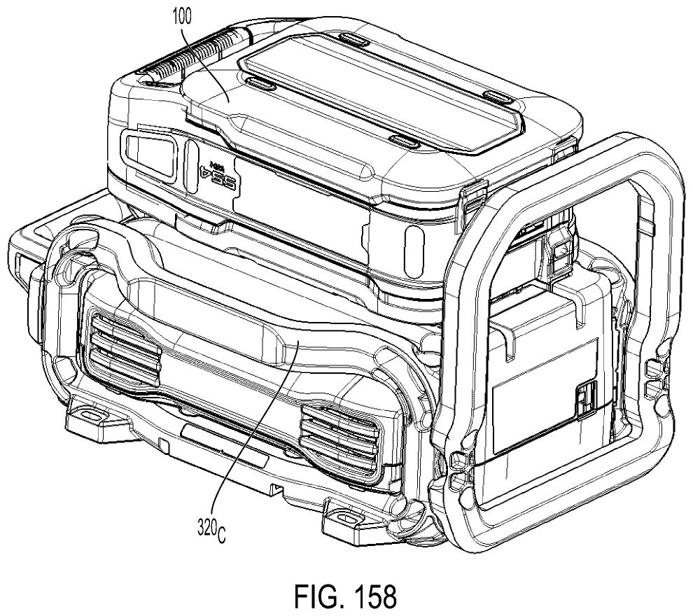

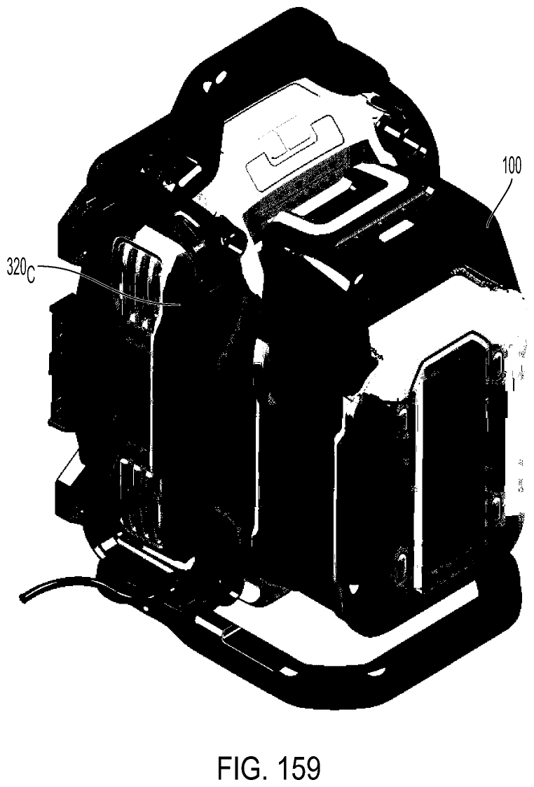

FIGS. 157-159 show the battery pack 100 connected to the charger 320_{C}. FIGS. 157-158 show the charger 320_{C} and the battery pack 100 in a horizontal orientation, while FIG. 159 shows the charger 320_{C} and the battery pack 100 in a vertical orientation.

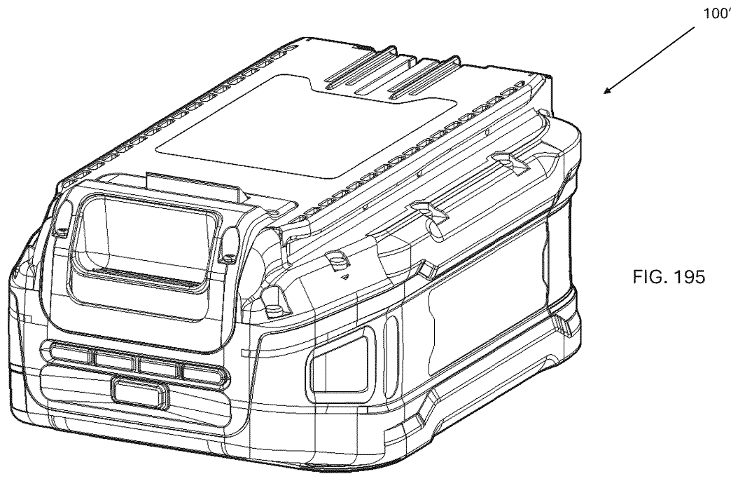

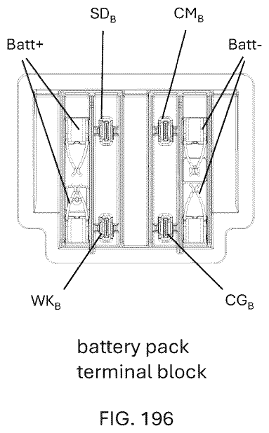

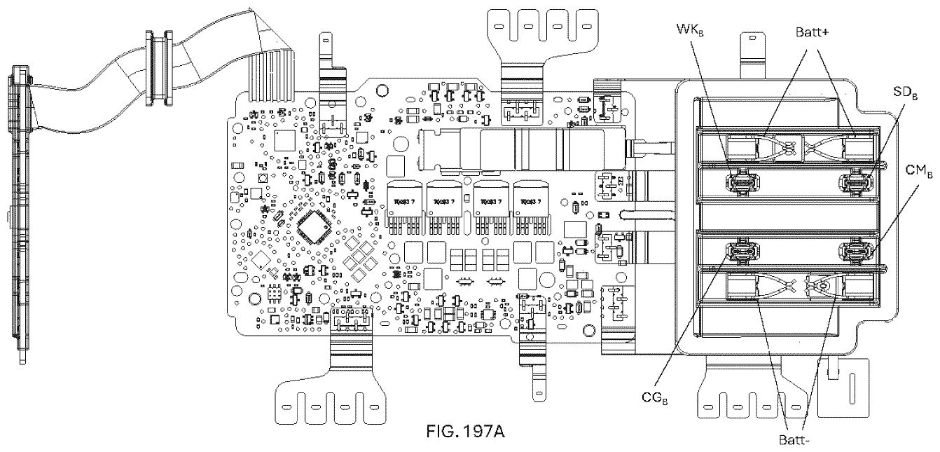

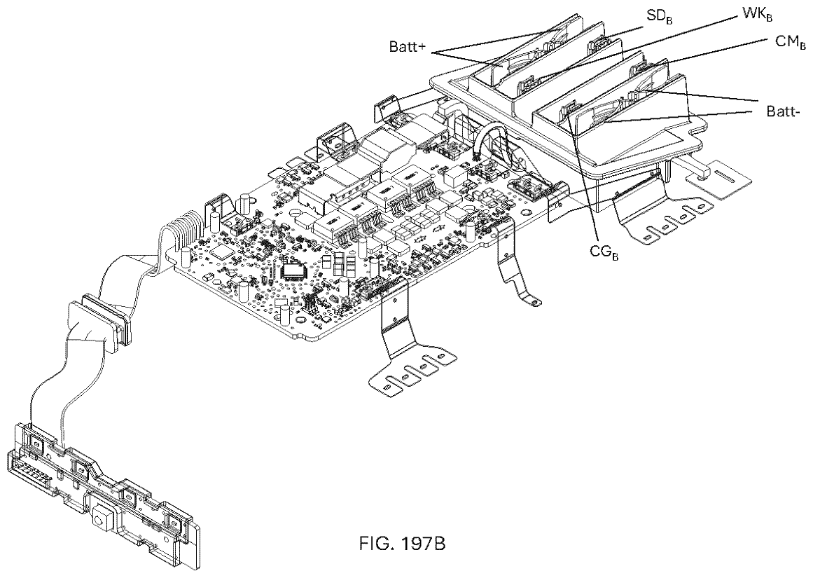

Referring to FIGS. 195-197B, an example battery pack 100′ of the present application may include an alternate example terminal block. The terminal block may include a plurality of battery pack terminals. The plurality of battery pack terminals may have a physical configuration and arrangement as illustrated in FIGS. 195-197. The terminal block may include a plastic housing. The plastic housing may maintain the physical position of the battery pack terminals relative to each other.

The plurality of battery pack terminals may include a subset of power terminals for transmitting charging and discharging currents and a subset of signal terminals for transmitting communications or data signals.

In an example battery pack, the subset of power terminals may include a battery pack positive terminal (Batt+), a battery pack negative terminal (Batt-) and a battery pack charge ground terminal (CG_{B}). The battery pack positive terminal and the battery pack negative terminal may be used for discharging the battery pack along a discharge path when connected to a power tool. The battery pack positive terminal and the charge ground terminal may be used for charging the battery pack along a charge path when connected to a power source/battery pack charger.

In an example battery pack, the subset of signal terminals may include a wake terminal (WK_{B}), a shutdown terminal (SD_{B}) and a data communications terminal (CM_{B}). The wake terminal may be used to communicate a wake signal between the battery pack and a power tool, a battery pack charger, or an adaptor. The wake signal may be used to put the battery pack into a “wake” state from a “sleep” state or to put the battery pack into the “sleep” state from the “wake” state. The shutdown terminal may be used to communicate a shutdown signal between the battery pack and a power tool, a battery pack charger or an adaptor. The shutdown signal may be used to “instruct” the power tool, the battery pack charger or the adaptor to stop/cease operations. The data communications terminal may be used to communicate digital data between the battery pack and a power tool, a battery pack charger or an adaptor.

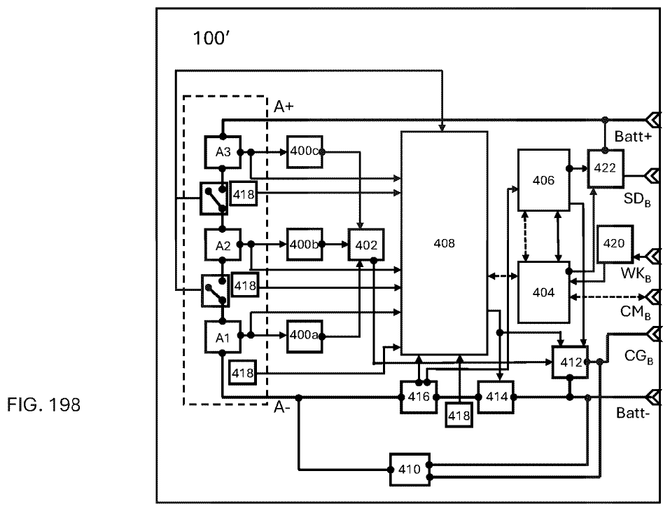

Referring to FIG. 198, there is illustrated a block diagram of an example battery pack. The battery pack may include the plurality of battery pack terminals, as noted above. The battery pack may include a plurality of battery cells. The plurality of battery cells may include a plurality of strings (or sets) of battery cells A1, A2, A3. Each string of the battery cells may include a string of series connected battery cells. Each string of battery cells may include a string of five battery cells. Each battery cell in each string of battery cells may have a nominal voltage of approximately 3.6 volts to approximately 3.7 volts. Each string of battery cells may have a nominal voltage of approximately 18 volts to approximately 18.5 volts.

The battery pack may include a shipping mode transportation switch. The shipping mode transportation switch may include a plurality of transport switches. The battery pack may include a first transport switch between the first string of battery cells A1 and the second string of battery cells A2 and a second transport switch between the second string of battery cells A2 and the third string of battery cells A3. The shipping mode transportation switch may disconnect the strings of battery cells for transportation (transport mode) and may connect the strings of battery cells for use-charge or discharge (use mode). The shipping mode transportation switch is in an open state (transport mode) in FIG. 198.

The battery pack may also include a plurality of cell-by-cell voltage collection circuits 400. One of the voltage collection circuits is associated with and electrically coupled to one of the strings of battery cells. More specifically, a first voltage collection circuit 400a is associated with the first string of battery cells A1, a second voltage collection circuit 400b is associated with the second string of battery A2 and a third voltage collection circuit 400c is associated with the third string of battery cells A3. Each voltage collection circuit 400 monitors/senses and collects/receives the voltage of each cell of the associated string of cells A. Each voltage collection circuit 400 analyzes the voltage level/value of each associated cell.

The battery pack may also include a voltage monitoring circuit 402. The voltage monitoring circuit 402 is associated with and electrically coupled to the voltage collection circuits 400. The voltage monitoring circuit 402 collects/receives an input signal from each voltage collection circuit 400. The voltage monitoring circuit 402 uses the input signals from the voltage collection circuits 400 to generate and transmit/output/provide an output control signal.

The battery pack may also include a first battery pack processing circuit 404. The first battery pack processing circuit 404 may be or referred to as a microcontroller, a microprocessor or another type of integrated circuit. The first battery pack processing circuit 404 may also be or referred to as a primary pack microprocessor or controller or simply a primary controller. The first battery pack processing circuit 404 may also be or referred to as a battery pack management system (BMS). The battery pack may also include a second battery pack processing circuit 406. The second battery pack processing circuit 406 may be or referred to as a microcontroller, a microprocessor or another type of integrated circuit. The second battery pack processing circuit 406 may also be or referred to as a secondary pack microprocessor or controller or simply a secondary controller. The second battery pack processing circuit 406 may also be or referred to as a Bluetooth low energy module (BLEM). The battery pack may also include an analog front-end circuit 408 (AFE). The analog front-end circuit may be or referred to as an analog front-end controller or simply an analog front-end. The AFE 408 may include a set of analog signal conditioning circuits that may use sensitive analog amplifiers, filters, and sometimes application-specific integrated circuits for sensors, radio receivers, and other circuits to provide a configurable and flexible electronics functional block needed to interface a variety of sensors to an analog-to-digital converter or, in some cases, to a microcontroller, as is well known to those of ordinary skill in the art.

The battery pack may include a bypass circuit 410. The bypass circuit 410 may include a first terminal connected to a negative terminal/node A− of the plurality of battery cells, a second terminal connected to the Batt-battery pack terminal and a third terminal connected to the CG_{B} battery pack terminal.

The battery pack may include a charge switch circuit 412. The charge switch circuit 412 may include one or more switches. The charge switch circuit 412 may include one or transistor switches. The charge switch circuit 412 may include one or more field effect transistors (FETs). The charge switch circuit 412 may be or referred to as a charge FET circuit or simply a charge FET 412. The charge FET 412 may be coupled to the CG_{B} terminal and the negative terminal A− of the plurality of battery cells in a charge path of the battery pack. The battery pack include a discharge switch circuit 414. The discharge switch circuit 414 may include one or more switches. The discharge switch circuit 414 may include one or transistor switches. The discharge switch circuit 414 may include one or more field effect transistors (FETs). The discharge switch circuit 414 may be or referred to as a discharge FET circuit or simply discharge FETs 414. The discharge FETs 414 may be coupled to the Batt− terminal and the negative terminal A− of the plurality of battery cells in a discharge path of the battery pack.

The battery pack may include a current monitoring circuit 416. The current monitoring circuit 416 may be coupled to the negative terminal A− of the plurality of battery cells and to the CG_{B} terminal and the Batt− terminal of the battery pack in the charge path and the discharge path.

The battery pack may include a plurality of thermistor circuits 418. The plurality of thermistor circuits 418 may include four thermistor circuits 418. Each of the plurality of thermistor circuits 418 may include one or more thermistors. Each of the plurality of thermistor circuits 418 may be or referred to simply as a thermistor 418. There may be a thermistor circuit 418 associated with each string of battery cells. In other words, there may be a first thermistor circuit 418 associated with (in close proximity to) the first string of battery cells A1, a second thermistor 418 associated with the second string of battery cells A2, and a third thermistor 418 associated with the third string of battery cells A3. Each of the first thermistor, the second thermistor and the third thermistor may provide an input (voltage) signal to the AFE 408. The input signal from each of the thermistor circuits 418 is representative of a temperature of the associated string of battery cells A. There may be a thermistor 418 associated with (in close proximity to) the discharge FETs 414. The fourth thermistor 418 may provide an input (voltage) signal to the AFE 408. The input signal from the fourth thermistor 418 is representative of a temperature of the associated discharge FETs 414.

The battery pack may include a wake circuit 420. The wake circuit 420 may include a first terminal coupled to the WK_{B} terminal of the battery pack and a second terminal coupled to the primary controller 404. The battery pack may include a shutdown circuit 422. The shutdown circuit 422 may include a first terminal coupled to the SD_{B} terminal of the battery pack, a second terminal coupled to the primary controller 404, a third terminal coupled to the secondary controller 406 and a fourth terminal coupled to the Batt+ terminal of the battery pack.

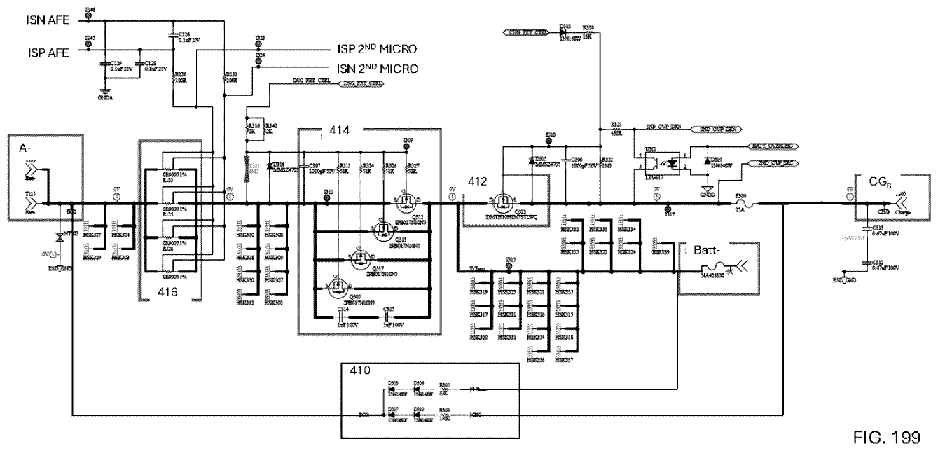

Referring to FIG. 199, there is illustrated an example schematic diagram of the charge path between the negative terminal A− of the plurality of battery cells and the CG_{B} terminal of the battery pack and the discharge path between the negative terminal A− of the plurality of battery cells and the Batt− terminal of the battery pack.

In a default (sleep) state, the discharge FETs 414 and the charge FET 412 are placed in an open (off) state. As such, when in the sleep state, when the battery pack is not connected to a power tool or a charger or even when the battery pack is coupled to a power tool or a charger a charging or a discharging current will not flow through the discharge FETs 414 and the charge FET 412 to the power terminals. This provides a measure of protection to a user in that there will not be a high current present at the power terminals. However, it is desirable to be able to provide a low current (high voltage) to a power tool or a charger to provide power to a tool portion or a charger portion of a wake circuit to provide a wake signal to the battery pack. It is also desirable to provide a low current (high voltage) to a power tool to charge a plurality of motor control capacitors to enable immediate start-up upon trigger pull.

As noted above, the battery pack may include the bypass circuit 410 to provide the low current (high voltage) to the power tool or the charger when the discharge FETs 414 are open. The bypass circuit 410 may include a first circuit path between the negative terminal A− of the plurality of battery cells and the Batt− terminal of the battery pack and a second circuit path between the negative terminal A− of the plurality of battery cells and the CG_{B} terminal of the battery pack. Both the first circuit path and the second circuit path bypass the discharge FETs 414 and the charge FET 412. Each circuit path of the bypass circuit 410 may include a pair of diodes and a resistor. These components enable the bypass circuit 410 to provide a low current (high voltage) to a power tool or a charger when the battery pack is coupled to a power tool or a charger when in the sleep state—the discharge FETs 414 and the charge FET 412 being open in the sleep state.

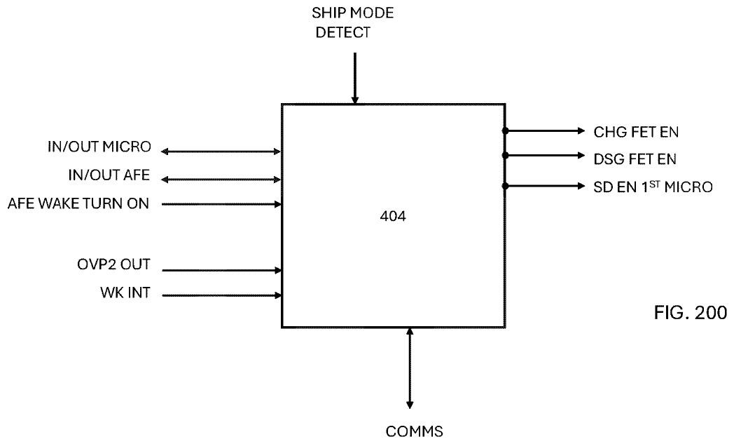

As illustrated in FIG. 200, the primary controller 404 may include a pin/terminal for receiving an input signal (SHIP MODE DETECT) from the shipping mode transportation switch. The input signal from the shipping mode transportation switch indicates whether or not the transport switches are open or closed. The primary controller 404 may include a pin/terminal for transmitting/receiving communications signals (IN/OUT MICRO) to/from the secondary controller 406. The primary controller 404 may include a pin/terminal for transmitting/receiving communications signals (IN/OUT AFE) to/from the AFE 408. The primary controller 404 may include a pin/terminal for receiving an input signal (AFE WAKE TURN ON) from the wake circuit 420. The primary controller 404 may include a pin/terminal for receiving an input signal (2^{nd} OVP OUTPUT) from the secondary overvoltage protection circuit (OVP2). The primary controller 404 may include a pin/terminal for receiving an input signal (WK INT) from the wake circuit 420. The primary controller 404 may include a pin/terminal for sending an output signal (CHG FET EN) to the AFE 408. The primary controller 404 may include a pin/terminal for sending an output signal (DSG FET EN) to the AFE 408. The primary controller 404 may include a pin/terminal for transmitting an output signal (SD EN 1^{ST} MICRO) from the primary controller 404 to the shutdown circuit 422. The primary controller 404 may include a pin/terminal for transmitting/receiving communications signals (COMMS) to/from the CM_{B} terminal of the battery pack.

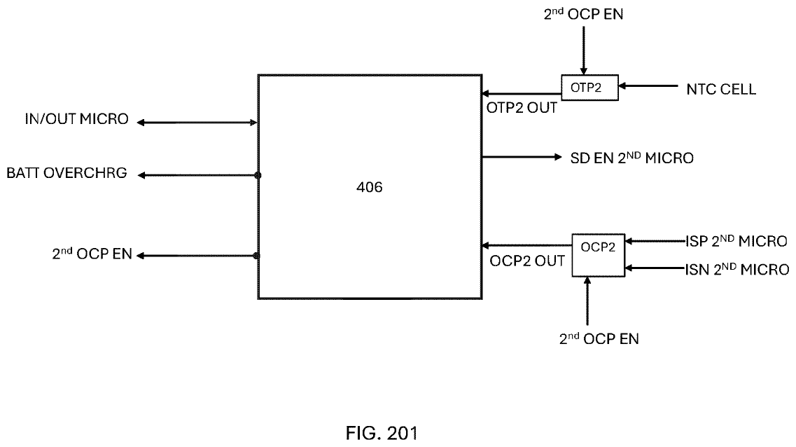

Referring to FIG. 201, the secondary controller 406 may include a pin/terminal for transmitting/receiving communications signals (IN/OUT MICRO) to/from the primary controller 404. The secondary controller 406 may include a pin/terminal for transmitting an output signal (BATT OVERCHRG) to the charge FET 412. The secondary controller 406 may include a pin/terminal for receiving an input signal (OTP2 OUT) from a second overtemperature protection circuit OTP2. The second overtemperature protection circuit OTP2 may include an input terminal for receiving an input signal (NTC CELL) output from a first thermistor 418a. The secondary controller 406 may include a pin/terminal for receiving an input signal (OCP2 OUT) output from a second overcurrent protection circuit OCP2. The second overcurrent protection circuit OCP2 may include two input terminals for receiving input signals (ISP 2^{nd} MICRO and ISN 2^{nd} MICRO) output from the current monitoring circuit 416. The secondary controller 406 may include a pin/terminal for transmitting an output signal (SD EN 2^{nd} MICRO) from the secondary controller 406 to the shutdown circuit 422.

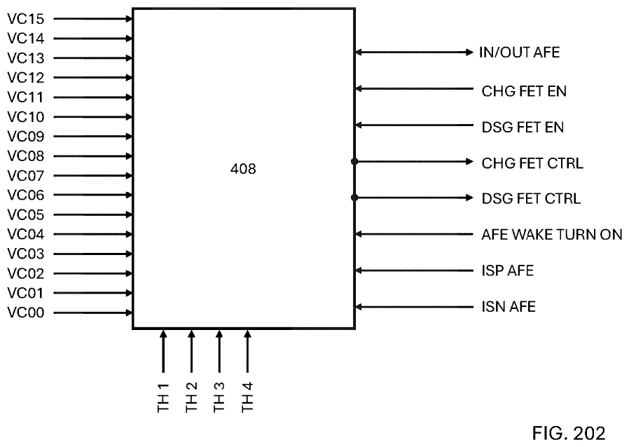

Referring to FIG. 202, the AFE 408 may include a plurality of input pins/terminals for receiving voltage signals from the plurality of battery cells. The AFE 408 may include sixteen input pins/terminals for receiving voltage signals from the plurality of battery cells. The AFE 408 may include a pair of input pins/terminals for receiving voltage signals from each of the plurality of battery cells. For example, the AFE 408 may use a first input pin/terminal VC00 for receiving a signal representing the voltage at the negative terminal of a first battery cell of the plurality of battery cells and a second input pin/terminal VC01 for receiving a signal representing the voltage at the positive terminal of the first battery cell of the plurality of battery cells to sense the voltage of the first battery cell. Furthermore, the AFE 408 may use the second input pin/terminal VC01 for receiving a signal representing the voltage at the negative terminal of a second battery cell of the plurality of battery cells and a third input pin/terminal VC02 for receiving a signal representing the voltage at the positive terminal of the second battery cell of the plurality of battery cells to sense the voltage of the second battery cell. Still further, the AFE 408 may use the third input pin/terminal VC02 for receiving a signal representing the voltage at the negative terminal of a third battery cell of the plurality of battery cells and a fourth input pin/terminal VC03 for receiving a signal representing the voltage at the positive terminal of the third battery cell of the plurality of battery cells to sense the voltage of the third battery cell. The AFE 408 may use the remainder of the input pins/terminals VC to sense the voltage of all fifteen battery cells of the plurality of battery cells. The AFE 408 may include a plurality of pins/terminals for receiving voltage signals (TH1, TH2, TH3, TH4) output from the plurality of thermistors. The AFE 408 may include four input pins/terminals for receiving voltage signals from the plurality of thermistors. The AFE 408 may include two pins/terminals for receiving input signals (ISP AFE and ISN AFE) output from the current monitoring circuit 416. The AFE 408 may include a pin/terminal for receiving an input signal (AFE WAKE TURN ON) output from the wake circuit 420. The AFE 408 may include a pin/terminal for transmitting an output signal (DSG FET CTRL) input to the discharge FETs 414 and a pin/terminal for transmitting an output signal (CHG FET CTRL) input to the charge FET 412. The AFE 408 may include a pin/terminal for receiving an input signal (DSG FET EN) output from the primary controller 404 and a pin/terminal for receiving an input signal (CHG FET EN) output from the primary controller 404. The AFE 408 may include a pin/terminal for transmitting/receiving communications signals (IN/OUT MICRO) to/from the primary controller 404.

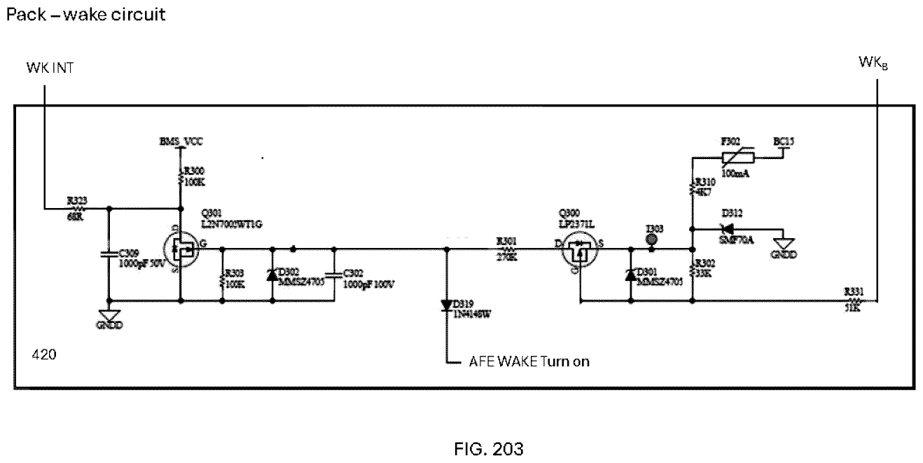

Referring to FIG. 203, there is illustrated an example wake circuit 420 of the battery pack. As noted above, in a default state, the battery pack is in a sleep mode or state. In the sleep mode, the discharge FETs 414 are in an off/open state. This discharge FETs 414 are controlled by an input control signal (DSG FET CTRL) output from the AFE 408 to the discharge FETs 414. The discharge FETs 414 change their state in response to a change of state of the input control signal from the AFE 408 to the discharge FETs 414. The AFE 408 changes the state of the input control signal to the discharge FETs 414 in response to an input enable signal (DSG FET EN) transmitted from the primary controller 404. The primary controller 404 changes the state of the input enable signal transmitted to the AFE 408 in response to a wake signal (WK INT) transmitted from the wake circuit 420. The wake circuit 420 changes the state of the wake signal transmitted to the primary controller in response to an input signal read on the WK_{B} terminal of the battery pack-no signal as the battery pack is not connected to any electrical device-power tool or charger or a signal received from a connected power tool or a connected charger.

For example, in a sleep state, the input signal read on the WK_{B} terminal of the battery pack may be a SLEEP signal (open circuit voltage signal).

In response to the SLEEP signal read on the WK_{B} terminal of the battery pack, the wake signal output from the wake circuit 420 and transmitted to the primary controller 404 may be an OFF/OPEN signal (high voltage signal).

In response to the wake signal output from the wake circuit 420 to the primary controller 404, the input enable signal output from the primary controller 404 and transmitted to the AFE 408 may be a OFF/OPEN signal (high output voltage).

In response to the input enable signal output from the primary controller 404 to the AFE 408, the input control signal output from the AFE 408 and transmitted to the discharge FETs 414 may be an OFF/OPEN signal.

In the specific example of the battery pack wake circuit 420 illustrated in FIG. 203, when the input signal read on the WK_{B} terminal is high (open circuit), a high voltage signal is placed on the gate of Q300 which places Q300 in an open state. With Q300 in an open state a low voltage signal is placed on the gate of Q301 which places Q301 in an open state. With Q301 in an open state, a high voltage signal is provided to the primary controller 404 on the WK INT terminal. When the primary controller 404 receives the high voltage signal on the WK INT terminal the primary controller instructs the AFE 408, via the DSG FET EN terminal to disable (turn off) the discharge FETs 414. When the AFE is 408 receives the disable signal from the primary controller 404 the AFE sends a low voltage signal on the DSG FET CTRL terminal to the gates of the discharge FETs 414 (Q305, Q317, Q315, Q312) which places the discharge FETs 414 in an open state. With the discharge FETs in an open state, the battery pack is unable to discharge to a power tool or to charge the plurality of battery cells.

Referring to again to FIG. 203, in order to provide power to a power tool to operate the power tool or to a charger to charge the plurality of battery cells, the battery pack must be placed in a wake mode or state. In the wake mode, the discharge FETs 414 are in an on/open state.

For example, in a wake state, the input signal read on the WK_{B} terminal of the battery pack may be a WAKE signal (low voltage signal—as provided by the power tool or the charger as described below).

In response to the WAKE signal read on the WK_{B} terminal of the battery pack, the wake signal output from the wake circuit 420 and transmitted to the primary controller 404 may be an ON/CLOSED signal (low voltage signal).

In response to the wake signal output from the wake circuit 420 to the primary controller 404, the input enable signal output from the primary controller 404 and transmitted to the AFE 408 may be an ON/CLOSED signal (low output voltage).

In response to the input enable signal output from the primary controller 404 to the AFE 408, the input control signal output from the AFE 408 and transmitted to the discharge FETs 414 may be an ON/CLOSED signal.

In the specific example of the battery pack wake circuit 420 illustrated in FIG. 203, when the input signal read on the WK_{B} terminal is low (pulled to ground), a low voltage signal is placed on the gate of Q300 which places Q300 in a closed state. With Q300 in a closed state a high voltage signal is placed on the gate of Q301 which places Q301 in a closed state. With Q301 in a closed state, a low voltage signal is provided to the primary controller 404 on the WK INT terminal. When the primary controller 404 receives the low voltage signal on the WK INT terminal the primary controller instructs the AFE 408, via the DSG FET EN terminal to enable (turn on) the discharge FETs 414. When the AFE is 408 receives the enable signal from the primary controller 404 the AFE sends a high voltage signal on the DSG FET CTRL terminal to the gates of the discharge FETs 414 (Q305, Q317, Q315, Q312) which places the discharge FETs 414 in a closed state. With the discharge FETs in a closed state, the battery pack is able to provide a discharge current to a power to in order to operate the power tool or receive a charge current from a battery charger to charge the battery cells.

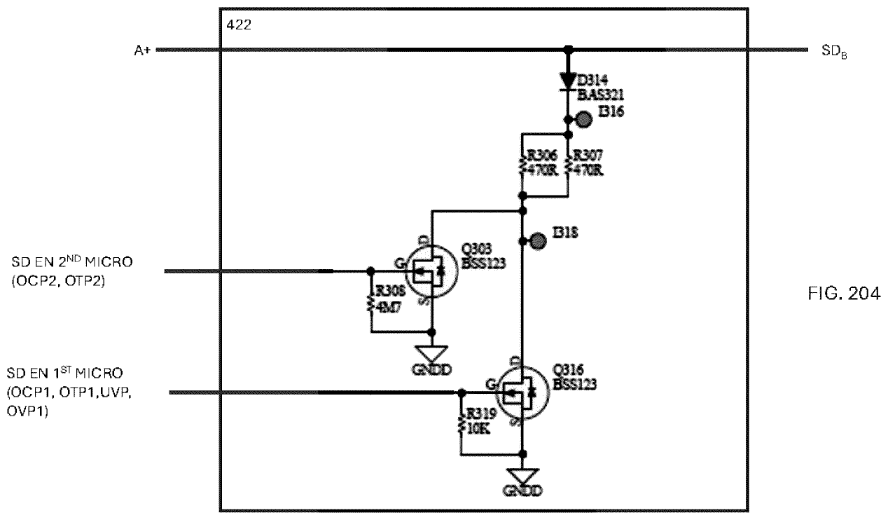

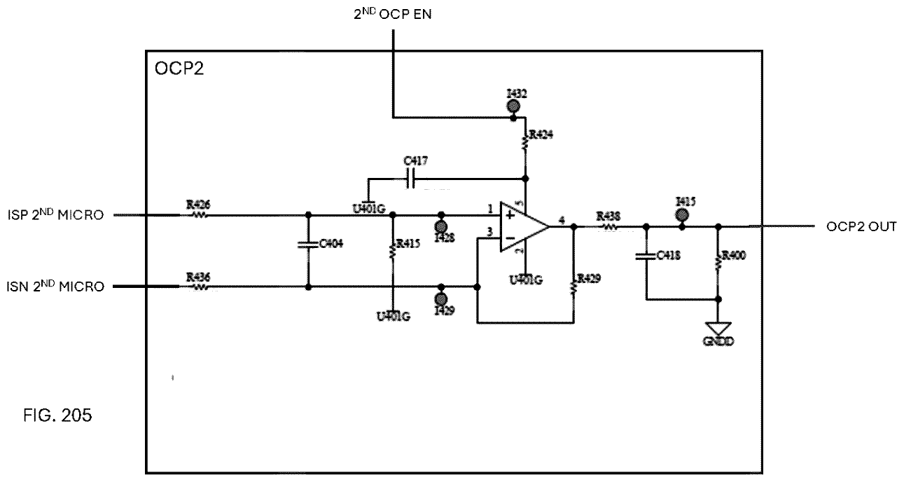

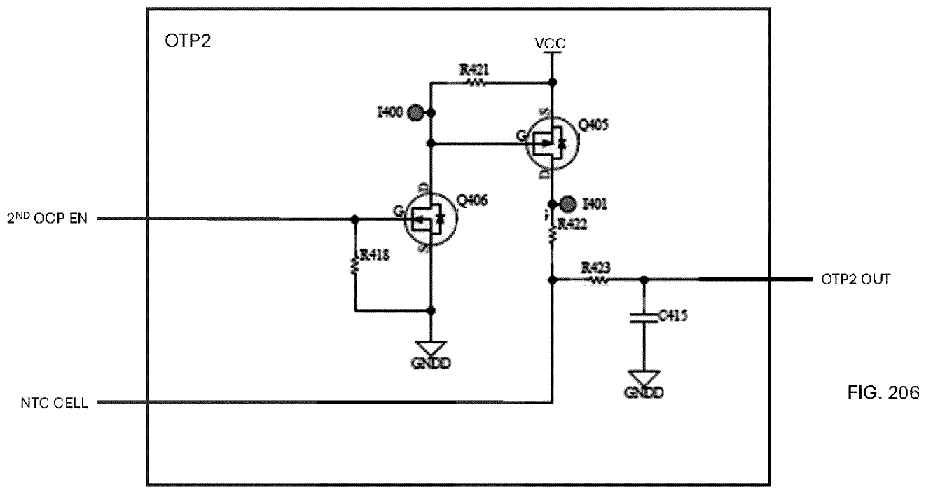

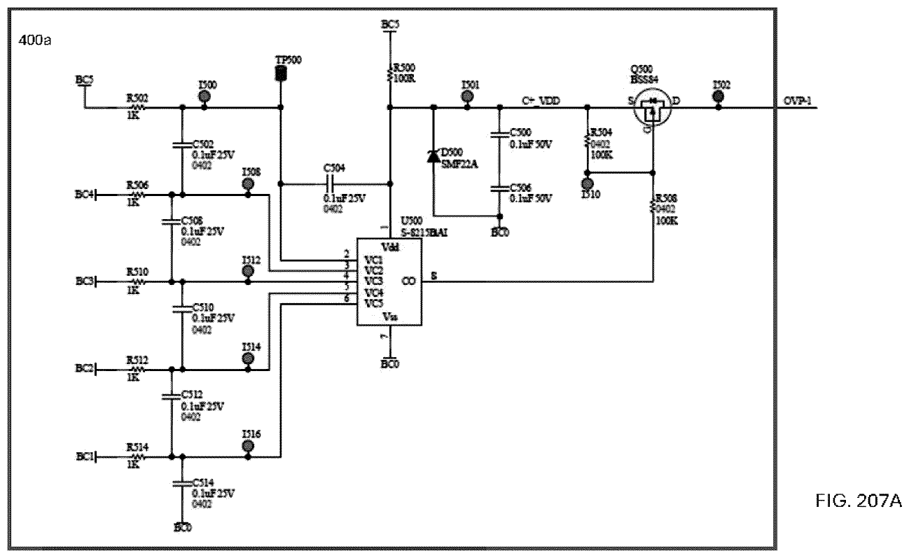

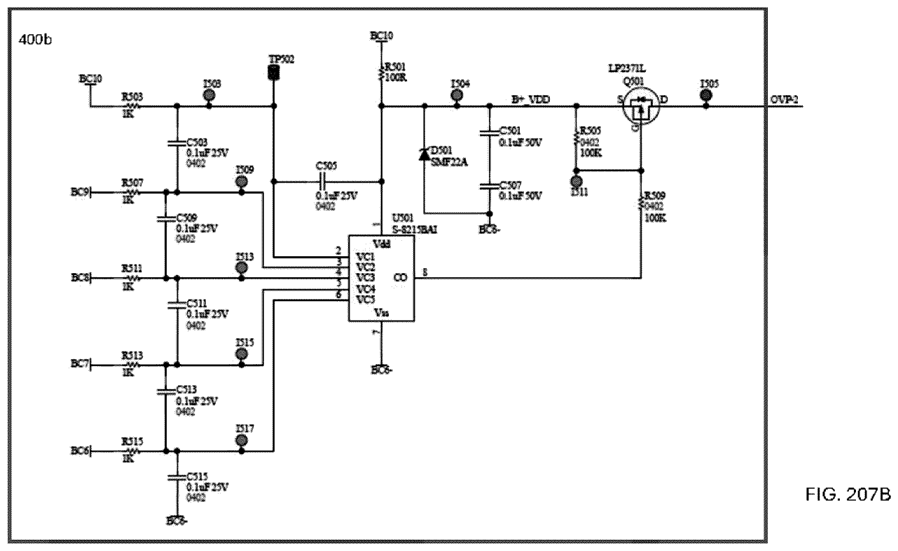

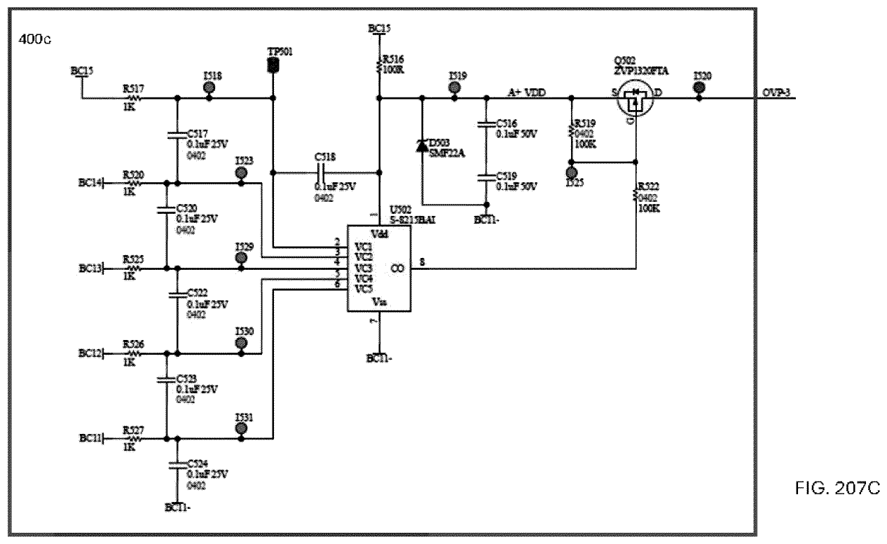

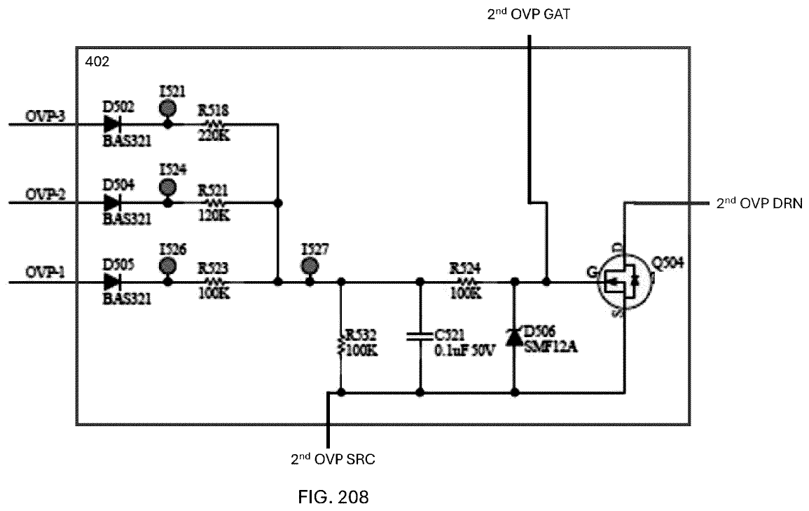

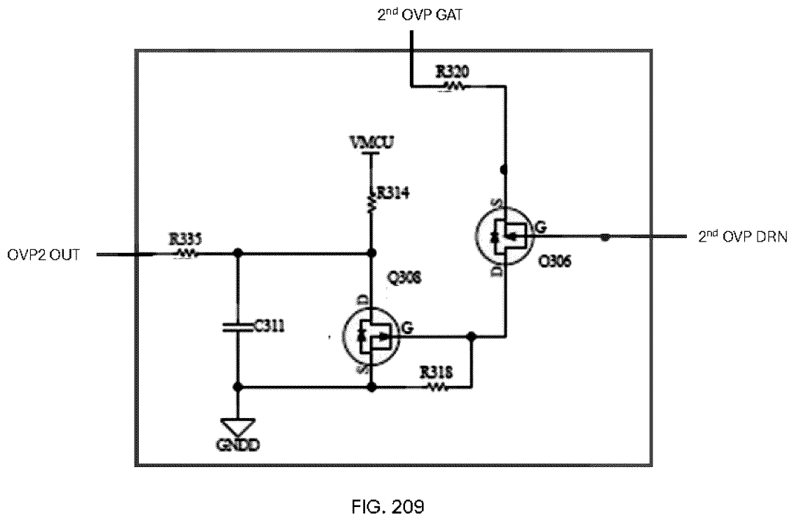

Referring to FIG. 204, there is illustrated an example shutdown circuit 422. The shutdown circuit 422 performs the function of signaling a connected electrical device, e.g., a power tool or a charger, that the battery pack is (1) in a working/operational state or (2) in a shutdown condition/state. When the battery pack is in normal working/operational order, the shutdown circuit 422 provides a signal to the connected electrical device in a first state and when the battery pack experiences a shutdown condition the shutdown circuit 422 provides a signal to the connected electrical device in a second state. In other words, the shutdown circuit 422 changes a state of the signal provided to the connected electrical device upon a change in operational condition.

For example, in the operational state, the shutdown circuit 422 may provide a high volage signal (e.g., a voltage of the plurality of battery cells, such as 60V) to the SD_{B} terminal and in the shutdown state, the shutdown circuit 422 may provide a low voltage signal (e.g., a ground signal, such as 0V) to the SD_{B} terminal.

Primary overcurrent protection (OCP1): the AFE 408 collects/receives current data/information (the ISP AFE signal and the ISN AFE signal) from discharge/charge current monitoring circuit 416. The AFE 408 sends the current information to the primary controller 404. If the primary controller 404 determines that the current on the discharge/charge path is greater than a threshold (as determined by a lookup table that is cell specific and temperature dependent), then the primary controller 404 sends a shutdown control signal (SD EN 1^{st} MICRO) to the shutdown circuit 422 indicating a shutdown condition. Such a shutdown control signal SD EN 1^{st} MICRO indicating a shutdown condition may be a change of state of the SD EN 1^{st} MICRO control signal, for example, from a low voltage to a high voltage. In response to the shutdown control signal from the primary controller 404, the shutdown circuit 422 changes the state of the signal on the SD_{B} terminal. When the battery pack is connected to a charger, the SD_{B} terminal of the battery pack is connected to the SD_{C} terminal of the charger, the charger reads the change of state of the signal on the SD_{C} terminal and the charger ceases operation of the charger, as described below. When the battery pack is connected to a tool, the SD_{B} terminal of the battery pack is connected to the SD_{T} terminal of the tool, the tool reads the change of state of the signal on the SD_{T} terminal and the tool ceases operation of the tool, as described below.

Secondary overcurrent protection (OCP2): a secondary overcurrent protection (OCP2) circuit collects/receives current data/information (the ISP 2^{nd} MICRO signal and the ISN 2^{nd} MICRO signal) from the discharge/charge current monitoring circuit 416. The OCP2 circuit generates and transmits an output voltage signal (OCP2 OUT) representative of the current on the discharge/charge path to the secondary controller 406. If the secondary controller 406 determines that the OCP2 OUT signal is greater than a threshold (as determined by a lookup table that is cell specific and temperature dependent), then the secondary controller 406 sends a shutdown control signal (SD EN 2^{nd} MICRO) to the shutdown circuit 422 indicating a shutdown condition. Such a shutdown control signal SD EN 2^{ND} MICRO indicating a shutdown condition may be a change of state of the SD EN 2^{nd} MICRO control signal, for example, from a low voltage to a high voltage. In response to the shutdown control signal from the secondary controller 406, the shutdown circuit 422 changes the state of the signal on the SD_{B} terminal. When the battery pack is connected to a charger, the SD_{B} terminal of the battery pack is connected to the SD_{C} terminal of the charger, the charger reads the change of state of the signal on the SD_{C} terminal and the charger ceases operation of the charger, as described below. When the battery pack is connected to a tool, the SD_{B} terminal of the battery pack is connected to the SD_{T} terminal of the tool, the tool reads the change of state of the signal on the SD_{T} terminal and the tool ceases operation of the tool, as described below.

Primary Overtemperature (OTP1): the AFE 408 collects/receives temperature data/information (the TH1 signal, the TH2 signal, the TH3 signal and the TH4 signal) from the four thermistors 418. There is one thermistor 418 for each string of battery cells and one for thermistor 418 for the discharge FETS 414. The AFE 408 sends the temperature information to the primary controller 404. If the primary controller 404 determines that the temperature of any of the string thermistors is greater than a threshold, e.g., above 60 degrees C. during charge or 70 degrees C. during discharge or if the discharge FET thermistor is greater than a threshold, e.g., above 125 degrees C., then then the primary controller 404 sends a shutdown control signal (SD EN 1^{st} MICRO) to the shutdown circuit 422 indicating a shutdown condition. Such a shutdown control signal SD EN 1^{st} MICRO indicating a shutdown condition may be a change of state of the SD EN 1^{st} MICRO control signal, for example, from a low voltage to a high voltage. In response to the shutdown control signal from the primary controller 404, the shutdown circuit 422 changes the state of the signal on the SD_{B} terminal. When the battery pack is connected to a charger, the SD_{B} terminal of the battery pack is connected to the SD_{C} terminal of the charger, the charger reads the change of state of the signal on the SD_{C} terminal and the charger ceases operation of the charger, as described below. When the battery pack is connected to a tool, the SD_{B} terminal of the battery pack is connected to the SD_{T} terminal of the tool, the tool reads the change of state of the signal on the SD_{T} terminal and the tool ceases operation of the tool, as described below.

Secondary Overtemperature (OTP2): a secondary overtemperature protection (OTP2) circuit collects/receives temperature data/information (the NTC CELL signal) from the first thermistor. The OTP2 circuit generates and transmits a output voltage signal (OTP2 OUT) representative of the temperature on the first string of battery cells A3 to the secondary controller 406. If the secondary controller 406 determines that the OTP2 OUT signal is greater than a threshold, e.g., 70 degrees C., then the secondary controller 406 sends a shutdown control signal (SD EN 2^{nd} MICRO) to the shutdown circuit 422 indicating a shutdown condition. Such a shutdown control signal SD EN 2^{ND} MICRO indicating a shutdown condition may be a change of state of the SD EN 2^{nd} MICRO control signal, for example, from a low voltage to a high voltage. In response to the shutdown control signal from the secondary controller 406, the shutdown circuit 422 changes the state of the signal on the SD_{B} terminal. When the battery pack is connected to a charger, the SD_{B} terminal of the battery pack is connected to the SD_{C} terminal of the charger, the charger reads the change of state of the signal on the SD_{C} terminal and the charger ceases operation of the charger, as described below. When the battery pack is connected to a tool, the SD_{B} terminal of the battery pack is connected to the SD_{T} terminal of the tool, the tool reads the change of state of the signal on the SD_{T} terminal and the tool ceases operation of the tool, as described below.

Undervoltage Protection (UVP): the AFE 408 collects/receives voltage data/information (the VC00-VC15 signals) directly from each of the plurality of battery cells A1, A2, A3. The AFE 408 sends the voltage information to the primary controller 404. If the primary controller 404 determines that the voltage on any cell falls below a threshold, e.g., 2.75 volts per cell, then the primary controller 404 sends a shutdown control signal (SD EN 1^{st} MICRO) to the shutdown circuit 422 indicating a shutdown condition. Such a shutdown control signal SD EN 1^{st} MICRO indicating a shutdown condition may be a change of state of the SD EN 1^{st} MICRO control signal, for example, from a low voltage to a high voltage. In response to the shutdown control signal from the primary controller 404, the shutdown circuit 422 changes the state of the signal on the SD_{B} terminal. When the battery pack is connected to a charger, the SD_{B} terminal of the battery pack is connected to the SD_{C} terminal of the charger, the charger reads the change of state of the signal on the SD_{C} terminal and the charger ceases operation of the charger, as described below. When the battery pack is connected to a tool, the SD_{B} terminal of the battery pack is connected to the SD_{T} terminal of the tool, the tool reads the change of state of the signal on the SD_{T} terminal and the tool ceases operation of the tool, as described below.

Primary overvoltage protection (OVP1): the AFE 408 collects/receives voltage data/information (the VC00-VC15 signals) directly from each of the plurality of battery cells A1, A2, A3. The AFE 408 sends the voltage information to the primary controller 404. If the primary controller 404 determines that the voltage on any cell rises above a threshold, e.g., 4.2 volts per cell, then the primary controller 404 sends a shutdown control signal (SD EN 1^{st} MICRO) to the shutdown circuit 422 indicating a shutdown condition. Such a shutdown control signal SD EN 1^{st} MICRO indicating a shutdown condition may be a change of state of the SD EN 1^{st} MICRO control signal, for example, from a low voltage to a high voltage. In response to the shutdown control signal from the primary controller 404, the shutdown circuit 422 changes the state of the signal on the SD_{B} terminal. When the battery pack is connected to a charger, the SD_{B} terminal of the battery pack is connected to the SD_{C} terminal of the charger, the charger reads the change of state of the signal on the SD_{C} terminal and the charger ceases operation of the charger, as described below. When the battery pack is connected to a tool, the SD_{B} terminal of the battery pack is connected to the SD_{T} terminal of the tool, the tool reads the change of state of the signal on the SD_{T} terminal and the tool ceases operation of the tool, as described below.

Secondary overvoltage protection (OVP2): the cell-by-cell circuits 400 collect/receive voltage data/information (the BC00-BC15 signals) directly from each of the plurality of battery cells A1, A2, A3. More specifically, the first cell-by-cell circuit 400a collects/receives voltage data/information (the BC00-BC05 signals) directly from the first set of battery cells A1, the second cell-by-cell circuit 400b collects/receives voltage data/information (the BC05-BC10 signals) directly from the second set of battery cells A2, and the third cell-by-cell circuit 400c collects/receives voltage data/information (the BC11-BC15 signals) directly from the third set of battery cells A3. The cell-by-cell circuits 400 generate and transmit an output voltage signal (OVP-1, OVP-2, OVP-3) representative of the voltage off the associated set of battery cells to the voltage monitoring circuit 402. If the voltage monitoring circuit 402 determines that any of the output voltage signals OVP-1, OVP-2, OVP-3 are greater than a threshold, e.g., 3.75 voltage per cell, then the voltage monitoring circuit 402 sends an overvoltage control signal to the charge FET 412 to open/turn off the charge FET 412.

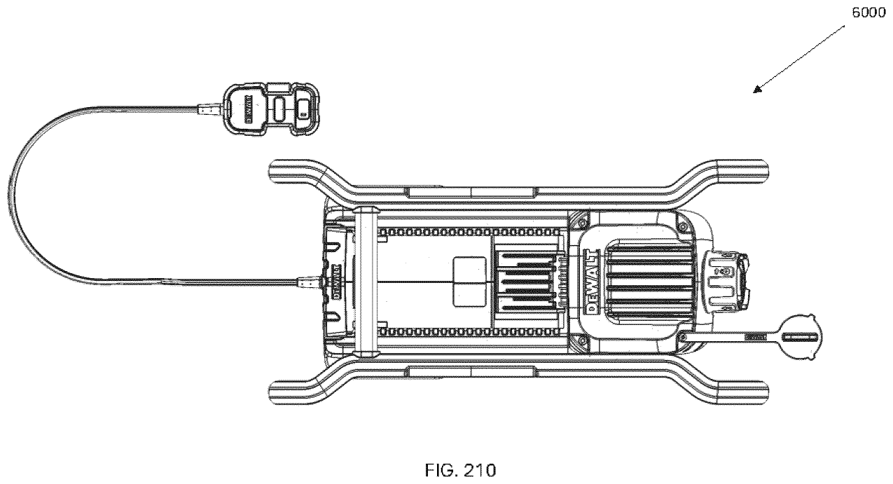

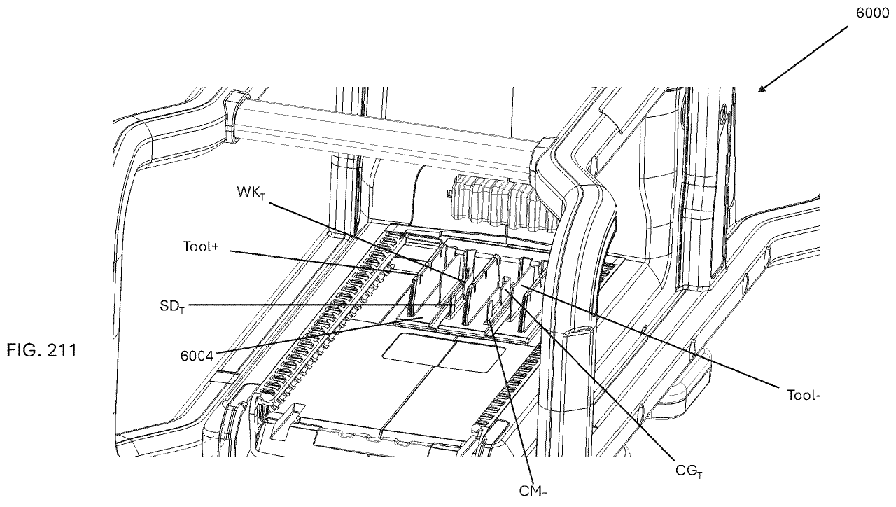

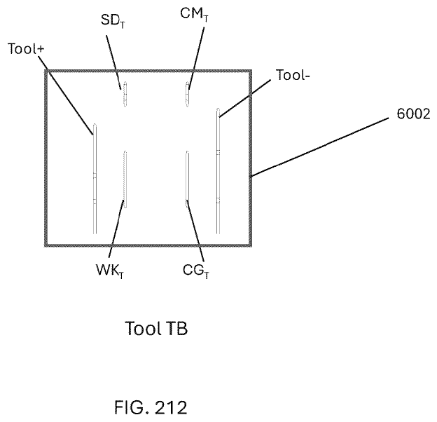

Referring to FIGS. 210 and 211, there is illustrated an example power tool 6000 of the present application. The power tool 6000 may include an example terminal block 6002. The terminal block 6002 may include a plurality of power tool terminals. The plurality of power tool terminals may have a physical configuration and arrangement as illustrated in FIG. 211. The terminal block may include a plastic housing 6004. The plastic housing 6004 may maintain the physical position of the battery pack terminals relative to each other.

The plurality of power tool terminals may include a subset of power terminals for transmitting charging and discharging currents and a subset of signal terminals for transmitting communications or data signals.

In the example power tool 6000, the subset of power terminals may include a power tool positive terminal (Tool+) and a power tool negative terminal (Tool−). The power tool positive terminal and the power tool negative terminal may be used for discharging the power tool along a discharge path when connected to a battery pack. The subset of power terminals may also include a power tool charge ground terminal (CG_{T}).

In the example power tool 6000, the subset of signal terminals may include a wake terminal (WK_{T}), a shutdown terminal (SD_{T}) and a data communications terminal (CM_{T}). The wake terminal may be used to communicate a wake signal between the power tool and a battery pack or an adaptor. The wake signal may be used to put the battery pack or the adaptor into a “wake” state from a “sleep” state or to put the battery pack into the “sleep” state from the “wake” state. The shutdown terminal may be used to communicate a shutdown signal between the power tool and a battery pack or an adaptor. The shutdown signal may be used to “instruct” the power tool to stop/cease operations. The data communications terminal may be used to communicate digital data between the power tool and a battery pack or an adaptor.

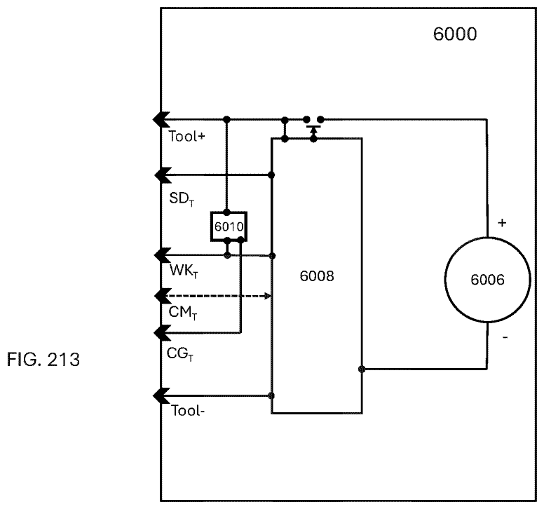

Referring to FIG. 213, there is illustrated an example block diagram of the power tool 6000. The power tool 6000 may include the plurality of power tool terminals, as noted above. The power tool 6000 may include a motor 6006. The power tool 6000 may also include a tool control module 6008.

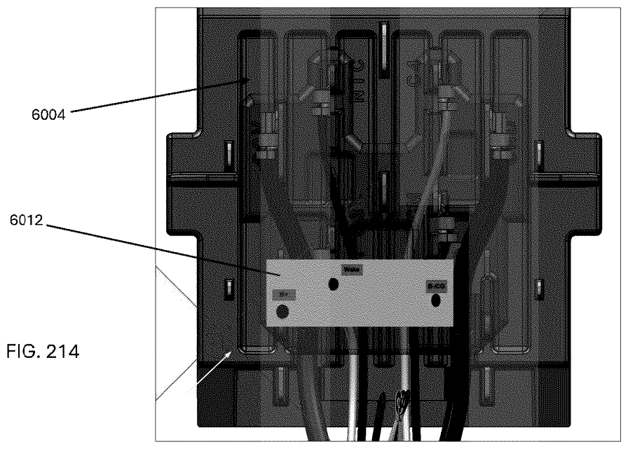

The power tool may include a first wake circuit 6010. The first wake circuit 6010 may include a first terminal coupled to the WK_{T} terminal of the power tool, a second terminal coupled to the Tool+ terminal and a third terminal coupled to the CG_{T} terminal. Referring to FIG. 214, the first wake circuit 6010 may be incorporated in a printed circuit board 6012. The first wake circuit PCB 6012 may be attached to the tool terminal block 6002/terminal block housing 6004.

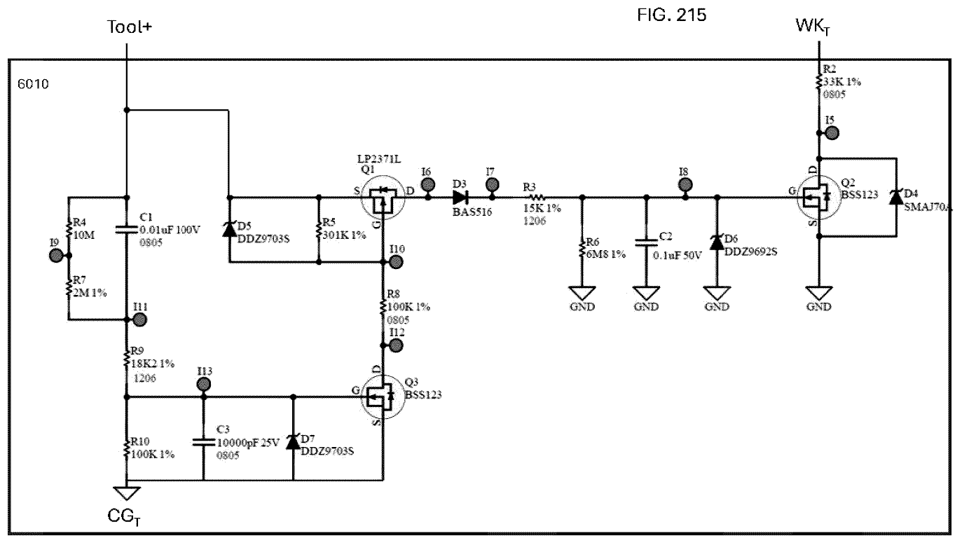

Referring to FIG. 215, there is illustrated an example schematic diagram of the first wake circuit 6010 of the power tool 6000.

The tool control module 6008 may also include a power tool processing circuit 6014. The power tool processing circuit 6014 may be or referred to as a microcontroller, a microprocessor or another type of integrated circuit. The power tool processing circuit 6014 may also be or referred to as a power tool microprocessor or controller or simply a power tool controller. The power tool processing circuit 6014 may also be or referred to as a power tool management system (TMS).

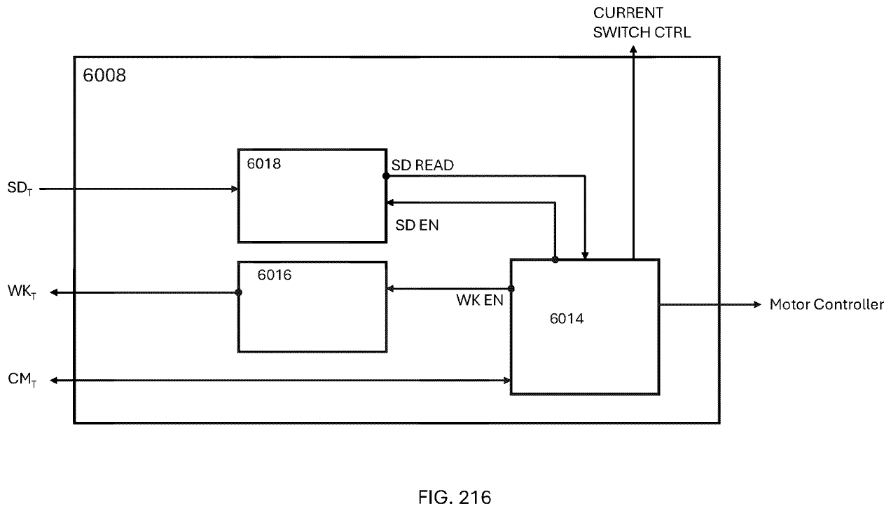

Referring to FIG. 216, the power tool controller 6014 may include a pin/terminal for transmitting/receiving communications signals (COMMS) to/from the CM_{T} terminal of the power tool. The power tool controller 6104 may include a pin/terminal for transmitting an output signal (WK EN) to the second wake circuit 6016. The power tool controller 6104 may include a pin/terminal for transmitting an output signal (SD EN) to the shutdown circuit 6018. The power tool controller 6014 may include a pin/terminal for receiving an input signal (SD READ) from the shutdown circuit 6018. The power tool controller 6014 may include a pin/terminal for transmitting an output signal to a motor controller.

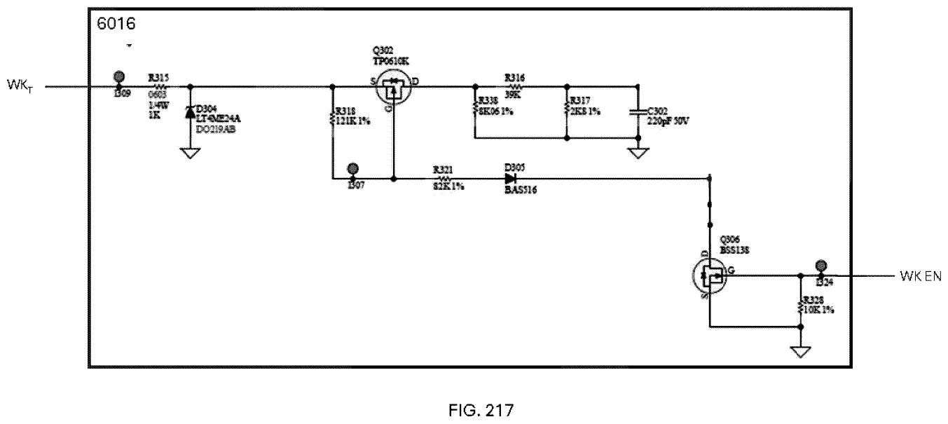

The tool control module 6008 may also include a second wake circuit 6016. The second wake circuit 6016 may include a first terminal coupled to the WK_{T} terminal of the power tool and a second terminal coupled to the power tool controller 6014. Referring to FIG. 217, there is illustrated an example schematic diagram of the second wake circuit 6016 of the power tool controller 6008.

The tool control module 6008 may also include a shutdown circuit 6018. The shutdown circuit 6018 may include a first terminal coupled to the SD_{T} terminal of the power tool, a second terminal coupled to the power tool processing circuit 6014 and a third terminal coupled to the power tool processing circuit 6014. Referring to FIG. 6018, there is illustrated an example schematic diagram of the shutdown circuit 6018 of the power tool controller 6008.

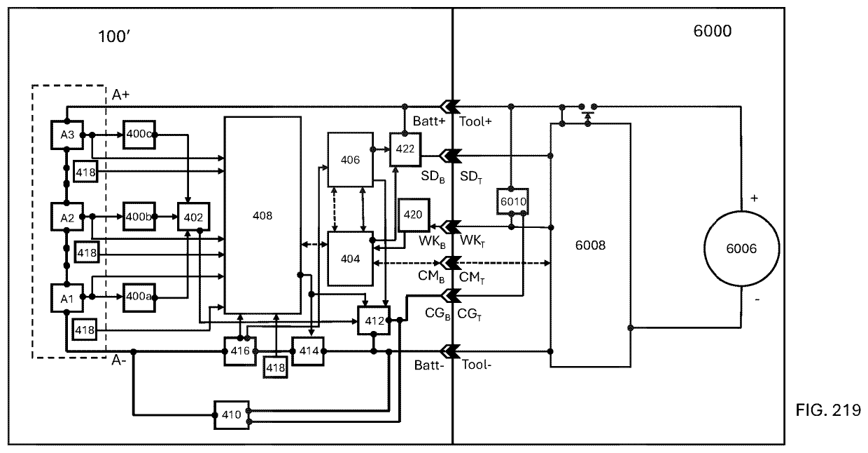

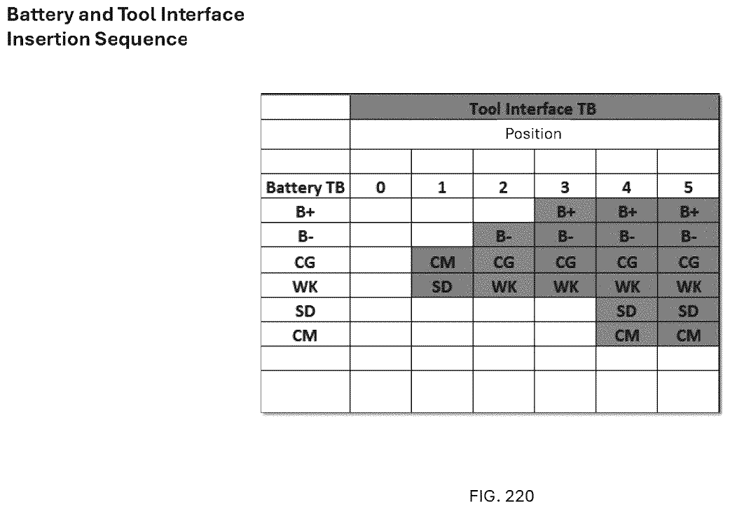

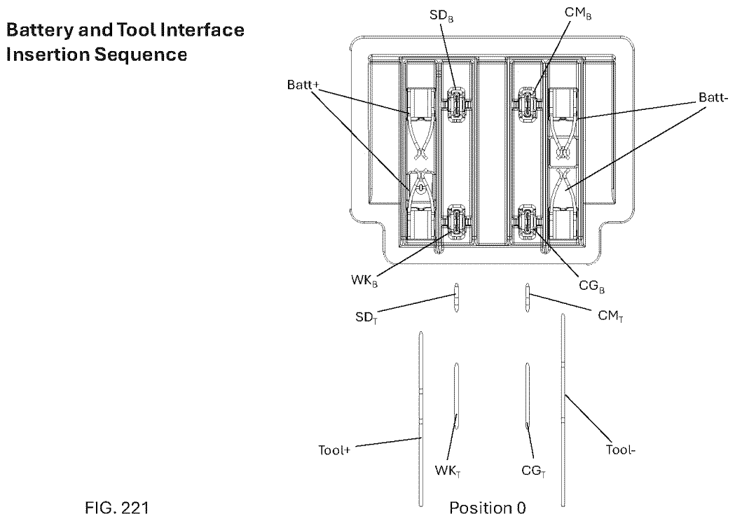

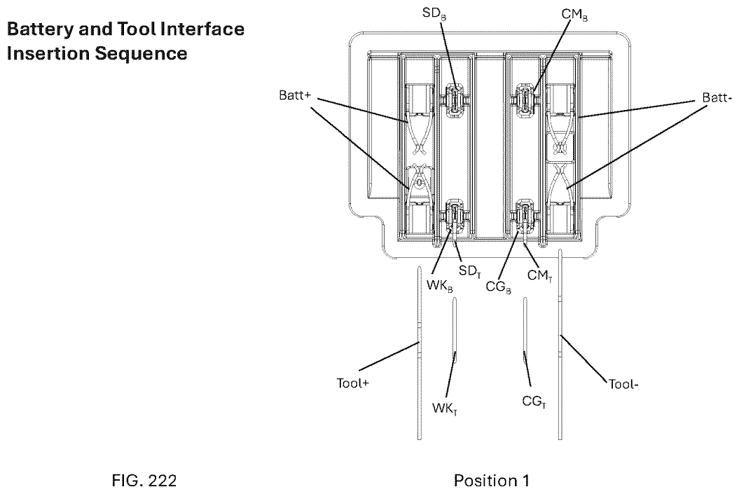

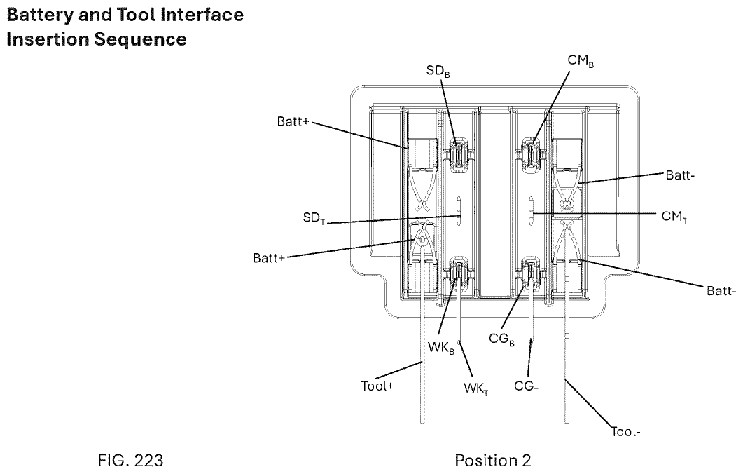

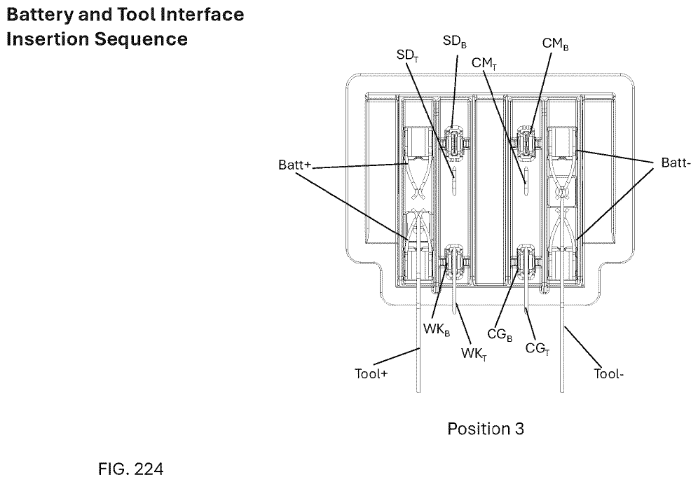

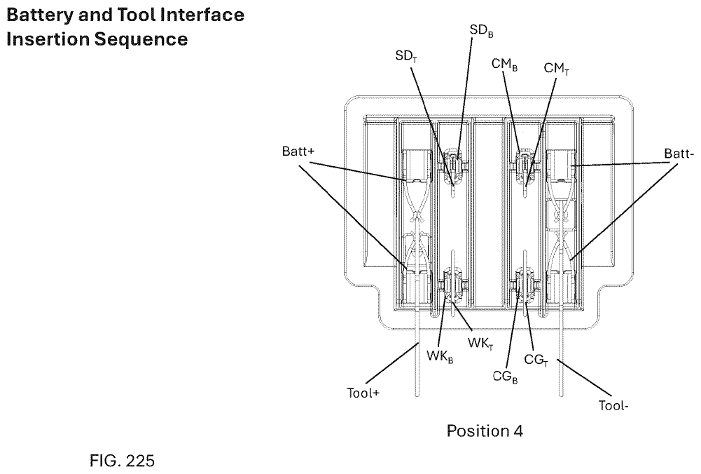

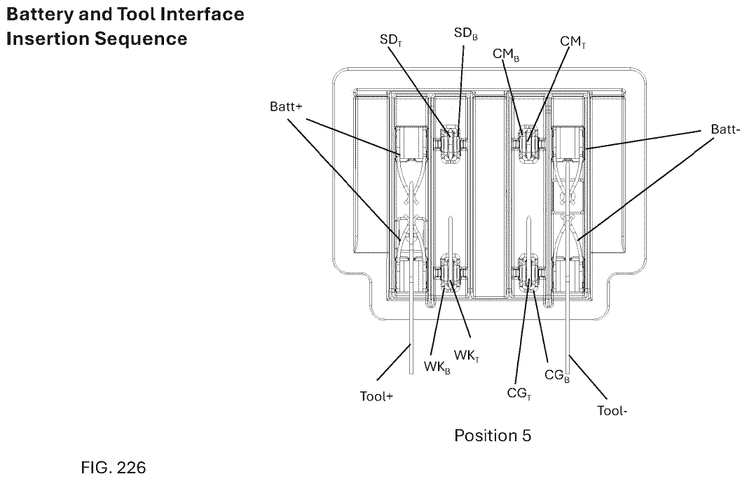

When a battery pack 100′ is mated/coupled to a power tool 6000, as illustrated in FIG. 219, the Batt+/Batt− terminals will present a HIGH voltage signal, e.g., 60V through the bypass circuit 410 to the Tool+/Tool− terminals. As a result, a HIGH voltage signal will be presented to the Tool+ terminal of the first wake circuit 6010 of the power tool 6000. In response to the HIGH voltage signal on the Tool+ terminal of the first wake circuit 6010, a HIGH voltage signal will be placed on the gate of the transistor Q3. The transistor Q3 will close (turn on) in response to the HIGH voltage signal on its gate. When the transistor Q3 closes a LOW voltage signal will be place on the gate of the transistor Q1. The transistor Q1 will be close in response to the LOW voltage signal on its gate. When the transistor Q1 closes the HIGH voltage signal on the Tool+ terminal will be placed on the gate of the Q2 transistor. The transistor Q2 will close in response to the HIGH voltage signal on its gate. When the Q2 transistor closes, the WK_{T} terminal will be pulled to 0V/ground and a LOW voltage signal will be presented/read on the WK_{T} terminal.

The battery pack 100′ closes the discharge FETs in response to the LOW voltage signal on the WK_{T}/WK_{B} terminals, as described above. The battery pack provides a charging current to the motor control capacitors through the discharge path. At the same time, a timing capacitor C2 begins to discharge. If a user does not establish a trigger pull event (pull the trigger) before the timing capacitor C2 discharges then a LOW voltage signal (0V/ground through a timing resistor R6) will be placed on the gate of the transistor Q2 and in response to the LOW voltage signal on its gate, the transistor Q2 will open (turn off). In response to the transistor Q2 opening, a HIGH voltage signal will be read/presented on the WK_{T} terminal. If a HIGH voltage signal is presented on the WK_{T}/WK_{B} terminals when the battery pack 100′ is mated/coupled to the power tool 6000 then the battery pack will open the discharge FETs in response to the HIGH voltage signal on the WK_{T}/WK_{B} terminals, as described above. However, the battery pack 100′ will continue to provide a charging current to the motor control capacitors through the bypass circuit 410 in order to enable the motor controller to start on a subsequent trigger pull, as described below.

If the first wake circuit 6010 is still active, i.e. the timing capacitor C2 has not fully discharged and the transistor Q2 is still closed, and the battery pack 100′ is in the wake state, when a user pulls the power tool trigger, the tool controller 6014 may provide an ON (HIGH) voltage signal on the WK EN terminal to the gate of the transistor Q306. When the transistor Q306 closes a LOW voltage signal will be placed on the gate of the transistor Q302 and in response to the LOW voltage signal on its gate, the transistor Q302 will close. In response to the transistor Q302 closing, a LOW voltage signal is presented on the WK_{T} terminal (pulled to 0V/ground through R316, R317, R338). For as long as the trigger is pulled, the battery pack 100′ will keep the discharge FETs closed in response to the LOW voltage signal on the WK_{T}/WK_{B} terminals. However, if a shutdown event occurs the tool 6000 will shut down, as described below.

If the first wake circuit 6010 is not active, i.e., the timing capacitor C2 has fully discharged and the transistor Q2 is open and the battery pack 100′ is in the sleep state- and therefore the battery pack discharge FETS are open-then the tool controller 6014 may provide an ON (HIGH) voltage signal on the WK EN terminal to the gate of the transistor Q306. When the transistor Q306 closes, a LOW voltage signal will be placed on the gate of the transistor Q302 and in response to the LOW voltage signal on its gate, the transistor Q302 will close. In response to the transistor Q302 closing, a LOW voltage signal is presented on the WK_{T} terminal (pulled to 0V/ground through R316, R317, R338). For as long as the trigger is pulled, the battery pack 100′ will keep the discharge FETs closed in response to the LOW voltage signal on the WK_{T}/WK_{B} terminals. However, if a shutdown event occurs the tool 6000 will shut down, as described below.

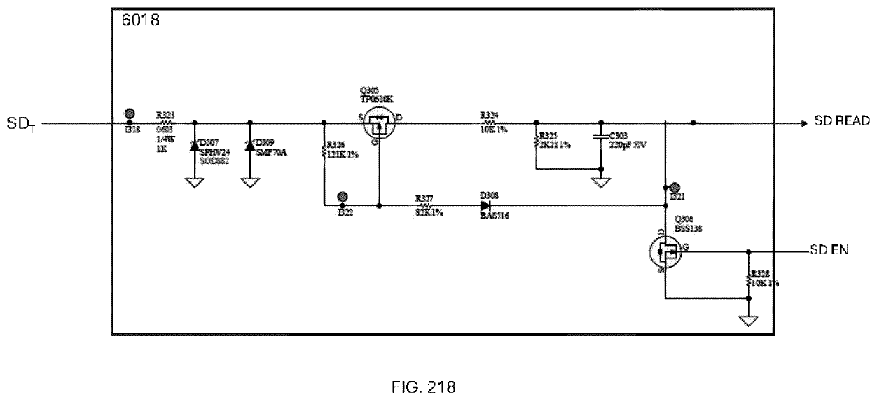

Referring to FIGS. 216, 218, 219, when a battery pack 100′ is coupled/mated to the power tool 6000 and the battery pack 100′ is in the operational state, the battery pack shutdown circuit 422 may present a HIGH voltage signal on the SD_{B} terminal (e.g., a voltage of the plurality of battery cells, such as 60V) and the power tool shutdown circuit 6018 may read a HIGH voltage signal on the SD_{T} terminal. When the battery pack 100′ is coupled/mated to the power tool 6000 and the battery pack 100′ is in the shutdown state, the battery pack shutdown circuit 422 may present a LOW voltage signal on the SD_{B} terminal (e.g., a ground signal, such as 0V) and the power tool shutdown circuit 6018 may read a LOW voltage signal on the SD_{T} terminal.

When the battery pack is in the operational state and there is a trigger pull event, the power tool controller 6014 may send an enable signal (SD EN) to the input terminal of the power tool shutdown circuit 6018. In response to the HIGH signal on the SD_{T} terminal the power tool shutdown circuit 5514 transmits a HIGH (operational) signal (SD READ) to the power tool controller 6014. The power tool controller 6014 reading a HIGH signal on the input terminal from the shutdown circuit 6018 understands the battery pack 100′ to be in an operational state and continues to draw current from the battery pack 100′ and allow to the power tool 6000 to operate.

As described above, if a shutdown event occurs during a trigger pull event, the power tool controller 6014 may send an enable signal (SD EN) to the input terminal of the power tool shutdown circuit 6018 and the battery pack shutdown circuit 422 may present a LOW voltage signal on the SD_{B} terminal and the power tool shutdown circuit 6018 may read a LOW voltage signal on the SD_{T} terminal. In response to the LOW signal on the SD_{T} terminal, the power tool shutdown circuit 6018 transmits a LOW (shutdown) signal (SD READ) to the power tool controller 6014.

In response to receiving the shutdown signal from the shutdown circuit 6018, the power tool controller 6014 may transmit a shutdown signal to the motor controller to stop operation of the motor. In response to receiving the shutdown signal from the shutdown circuit 6018, the power tool controller 6014 may transmit a control signal (CURRENT SWITCH CTRL) to the power tool power current switch to open the power tool power current switch that will create an open circuit between the Tool+ terminal and the motor 6006 and interrupt current from the battery pack 100′ to the motor 6006.

Referring to FIG. 216, 218, more specifically, when the battery pack 100′ is coupled/mated to the power tool 6000, whether or not the battery pack 100′ is in the sleep state or the wake state and there is neither a trigger pull event nor a shutdown event, a LOW voltage signal will be presented on the SD EN terminal. The LOW voltage signal on the SD EN terminal will place a LOW voltage signal on the gate of the transistor Q306 and in response to the LOW voltage signal on its gate, the transistor Q306 will open. When the transistor Q306 opens, a HIGH voltage signal will be placed on the gate of the transistor Q305 and in response to the HIGH voltage signal on its gate, Q305 will open. As such, a LOW voltage signal will be presented at the SD READ terminal (0V/to ground through R325) and the tool controller 6014 will not allow the motor/tool to operate.

However, when the battery pack 100′ is coupled/mated to the power tool 6000 and the battery pack 100′ is in the wake state and there is a trigger pull event but there is no shutdown event, the tool controller 6014 will place a HIGH voltage signal on the SD EN terminal. The HIGH voltage signal on the SD EN terminal will place a HIGH voltage signal on the gate of the transistor Q306 and in response to the HIGH voltage signal on its gate, the transistor Q306 will close. When the transistor Q306 closes, a LOW voltage signal will be placed on the gate of the transistor Q305 and in response to the LOW voltage signal on its gate, Q305 will close. As such, a HIGH voltage signal will be presented at the SD READ terminal (HIGH voltage signal on the SD_{T} terminal due to no shutdown event) and the tool controller 6014 will allow the motor/tool to operate.

But, when the battery pack 100′ is coupled/mated to the power tool 6000 and the battery pack 100′ is in the wake state and there is a trigger pull event and there is a shutdown event, the tool controller 6014 will place a HIGH voltage signal on the SD EN terminal. The HIGH voltage signal on the SD EN terminal will place a HIGH voltage signal on the gate of the transistor Q306 and in response to the HIGH voltage signal on its gate, the transistor Q306 will close. When the transistor Q306 closes, a LOW voltage signal will be placed on the gate of the transistor Q305 and in response to the LOW voltage signal on its gate, Q305 will close. As such, a LOW voltage signal will be presented at the SD READ terminal (LOW voltage signal on the SD_{T} terminal due to the shutdown event) and the tool controller 6014 will not allow the motor/tool to operate.

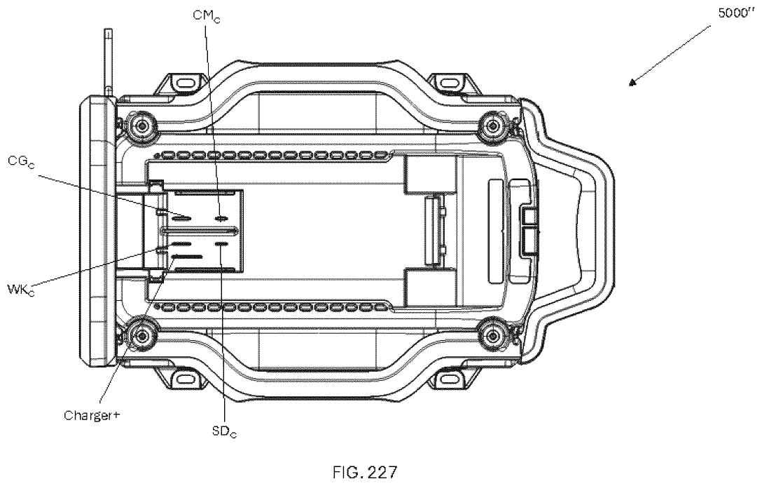

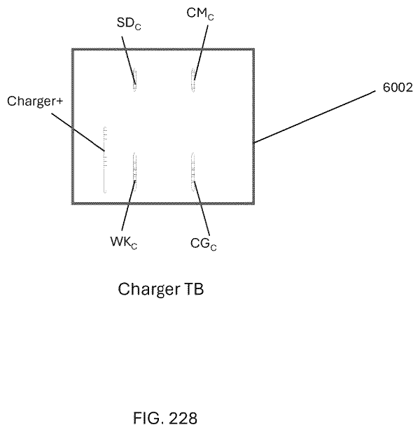

Referring to FIGS. 227-229, an example battery pack charger 5000″ of the present application may include an alternate example terminal block. The terminal block may include a plurality of battery charger terminals. The plurality of battery charger terminals may have a physical configuration and arrangement as illustrated in FIGS. 227, 228. The terminal block may include a plastic housing (not shown). The plastic housing may maintain the physical position of the battery pack terminals relative to each other.

The plurality of battery charger terminals may include a subset of power terminals for transmitting charging currents and a subset of signal terminals for transmitting communications or data signals.

In the example battery charger, the subset of power terminals may include a battery charger positive terminal (Charger+), a battery charger charge ground terminal (CG_{C}). The battery charger positive terminal and the charge ground terminal may be used for providing a charging current along a charge path when connected to a battery pack.

In the example battery charger, the subset of signal terminals may include a wake terminal (WK_{C}), a shutdown terminal (SD_{C}) and a data communications terminal (CM_{C}). The wake terminal may be used to communicate a wake signal between the battery charger and a battery pack. The wake signal may be used to put the battery pack into a “wake” state from a “sleep” state or to put the battery pack into the “sleep” state from the “wake” state. The shutdown terminal may be used to communicate a shutdown signal between the battery pack charger and a battery pack. The shutdown signal may be used to “instruct” the battery pack charger to stop/cease operations. The data communications terminal may be used to communicate digital data between the battery pack charger and a battery pack.

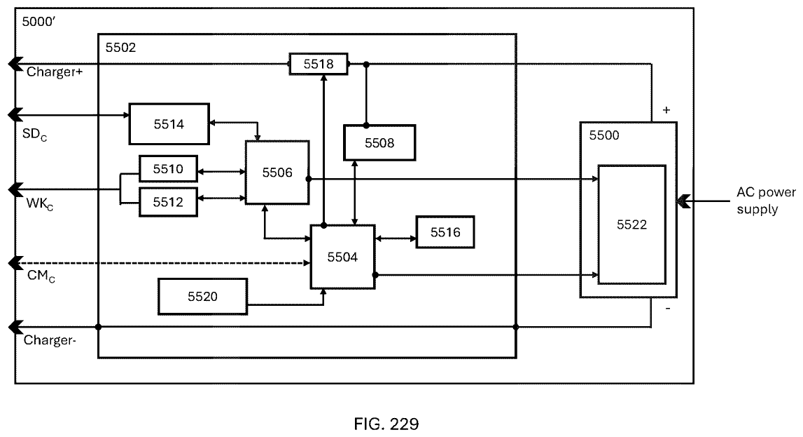

Referring to FIG. 229, there is illustrated a block diagram of an example battery charger. The battery charger may include the plurality of battery charger terminals, as noted above. The battery charger may include a power supply 5500. The power supply may include a power supply shutoff circuit 5522. The battery charger may include a power supply cord and plug set for plugging the battery charger into an AC power supply, as is well known in the art.

The battery charger may also include a battery charger control module 5502. The control module 5502 may include a first battery charger processing circuit 5504. The first battery charger processing circuit 5504 may be or referred to as a microcontroller, a microprocessor or another type of integrated circuit. The first battery charger processing circuit 5504 may also be or referred to as a primary charger microprocessor or controller or simply a primary controller. The first battery charger processing circuit 5504 may also be or referred to as a battery charger management system (CMS). The battery charger may also include a second battery charger processing circuit 5506. The second battery charger processing circuit 5506 may be or referred to as a microcontroller, a microprocessor or another type of integrated circuit. The second battery charger processing circuit 5506 may also be or referred to as a secondary charger microprocessor or controller or simply a secondary controller.

The battery charger may also include a voltage monitoring circuit 5508. The voltage monitoring circuit 5508 may be electrically coupled to the Charger+ terminal. The voltage monitoring circuit 5508 may collect/receive an input signal from the Charger+ terminal.

The battery charger may include a pack detect circuit 5510 and a wake circuit 5512. The pack detect circuit 5510 may include a first terminal coupled to the WK_{C} terminal of the battery charger, a second terminal coupled to the secondary controller 5506, and a third terminal coupled to the secondary controller 5506. The wake circuit 5512 may include a first terminal coupled to the WK_{C} terminal of the battery charger, a second terminal coupled to the secondary controller 5506, and a third terminal coupled to the secondary controller 5506. The battery charger may include a shutdown circuit 5514. The shutdown circuit 5514 may include a first terminal coupled to the SD_{C} terminal of the battery charger, a second terminal coupled to the secondary controller 5506, and a third terminal coupled to the secondary controller 5506.

The battery charger may also include a fan 5116 coupled to the primary controller 5504. The battery charger may also include an output relay 5518 in a charge path between the Charger+ terminal and the power supply 5500. The battery charger may also include a thermistor 5520.

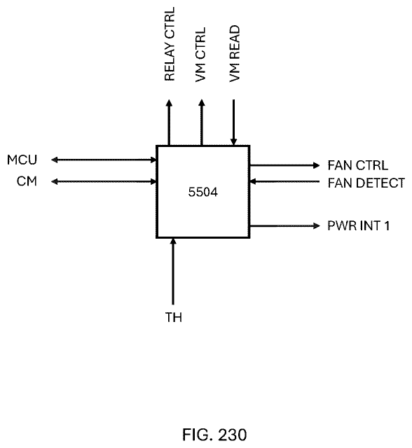

Referring to FIG. 230, there is illustrated a diagram of the primary controller 5504. The primary controller 5504 may include a pin/terminal for transmitting/receiving two way communications signals (MCU) to/from the secondary controller 5506. The primary controller 5504 may also include a pin/terminal for transmitting/receiving two way communications signals (CM) to/from the CM_{C} terminal of the battery charger. The primary controller 5504 may also include a pin/terminal for receiving an input signal (TH) from the thermistor 5520. The primary controller 5504 may also include a pin/terminal for transmitting a control signal (PWR INT 1) to the shutoff circuit 5522. The primary controller 5504 may also include a pin/terminal for receiving an input signal (FAN DETECT) from the fan 5116 and a pin/terminal for transmitting a control signal (FAN CTRL) to the fan 5116. The primary controller 5504 may include a pin/terminal for transmitting a control signal (VM CTRL) to the voltage monitor 5508 and a pin/terminal for receiving an input signal (VM READ) from the voltage monitor 508. The primary controller 5504 may include a pin/terminal for transmitting a control signal (RELAY CTRL) to the relay 5518.

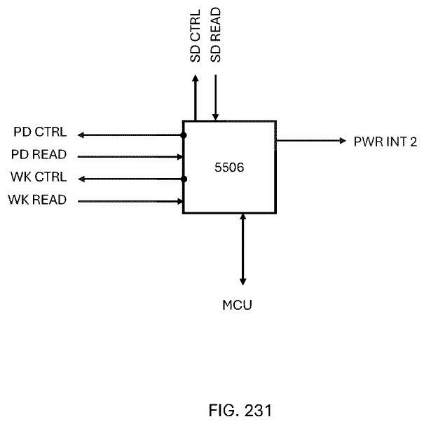

Referring to FIG. 231, there is illustrated a diagram of the secondary controller 5506. The secondary controller may include a pin/terminal for transmitting/receiving two way communications signals (MCU) to/from the primary controller 5504. The secondary controller 5506 may also include a pin/terminal for receiving an input signal (PD READ) from the pack detect circuit 5510 and a pin/terminal for transmitting a control signal (PD CTRL) to the pack detect circuit 5510. The secondary controller 5506 may include a pin/terminal for transmitting a control signal (WK CTRL) to the wake circuit 5512 and a pin/terminal for receiving an input signal (WK READ) from the wake circuit 5512. The secondary controller 5506 may include a pin/terminal for transmitting a control signal (SD CTRL) to the shutdown circuit 5514 and pin/terminal for receiving an input signal (SD READ) from the shutdown circuit 5514. The secondary controller 5506 may also include a pin/terminal for transmitting a control signal (PWR INT 2) to the shutoff circuit 5522.

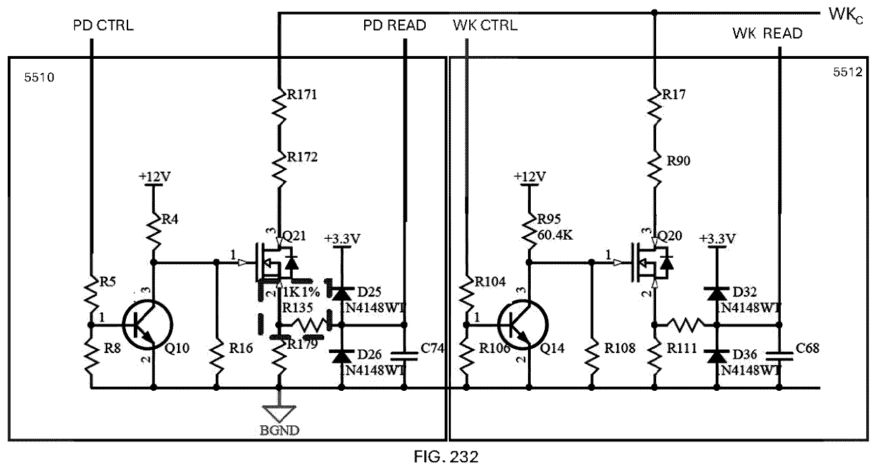

Referring to FIGS. 231 and 232, the secondary controller 5506 may transmit a PWM signal (PD CTRL) to an input terminal of the pack detect circuit 5510 when the battery charger is connected to an AC power supply—see (1) in FIG. 232. Due to high resistance, a noise signal can be seen on the PD READ signal—see (2) in FIG. 232. This noise signal does not indicate a pack detection.

Upon mating/coupling of a battery pack with a battery charger, a HIGH signal is read/presented on the WK_{C} terminal—see (3) in FIG. 232. Furthermore, the PD READ signal increases indicating a battery pack is connected to the battery charger—see (4) in FIG. 232.

In response to reading a HIGH signal on the PD READ terminal, the secondary controller 5506 transmits a PWM signal (WK CTRL) to an input terminal of the wake circuit 5512. In response to the PWM WK CTRL signal, a HIGH PWM signal (WK) is read on the WK_{C} terminal and the battery pack reads a HIGH signal on the WK_{B} terminal of the battery pack wake circuit. In response to reading a HIGH signal on the WK_{B} terminal the battery pack wake circuit “wakes” the battery pack as described above.

Upon charge completion, the secondary controller 5506 transmits a HIGH (on) control signal (WK CTRL) to the input terminal of the wake circuit 5512. In response, a HIGH output signal is presented at the WK_{C} terminal and the battery pack is placed in the sleep state, as described above.

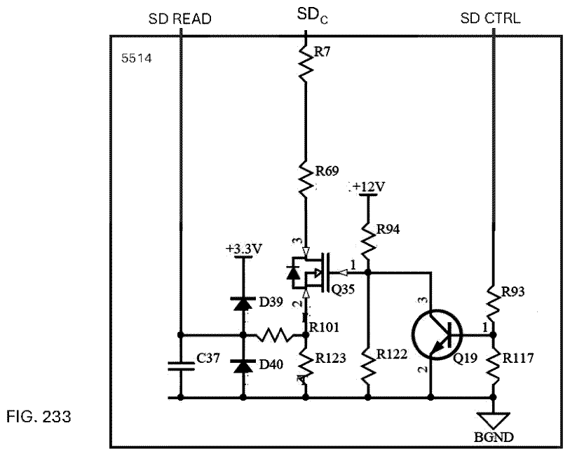

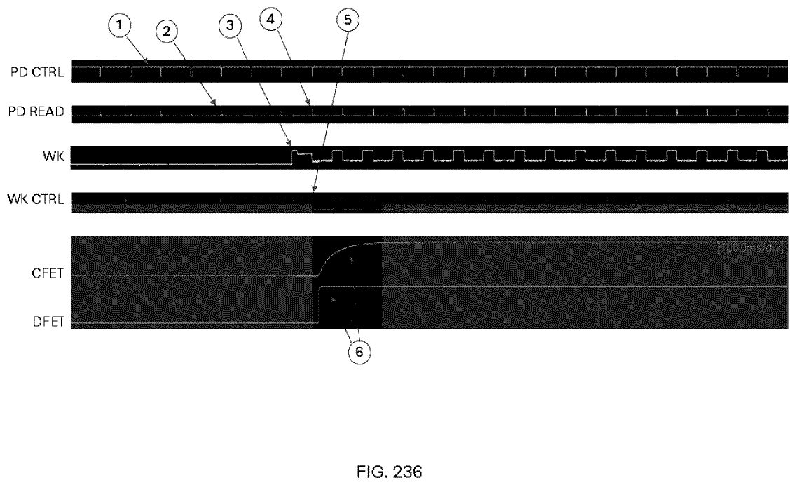

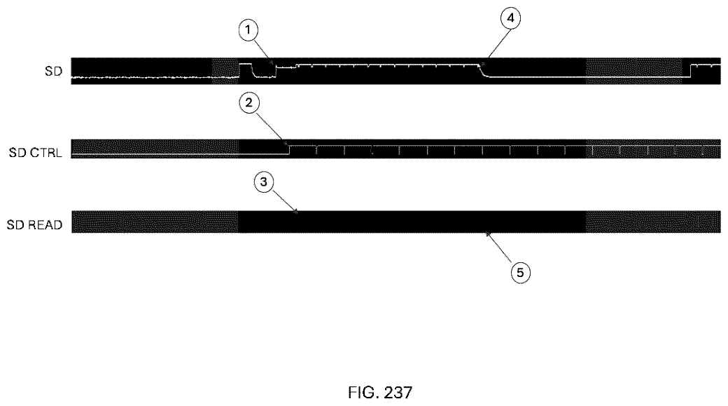

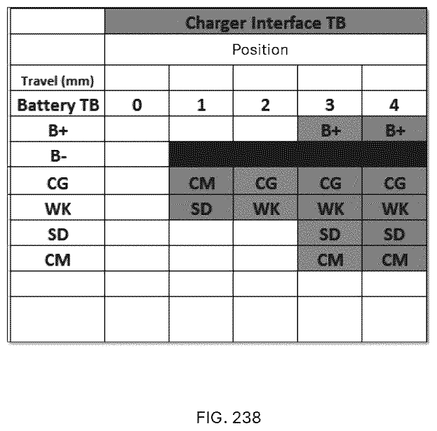

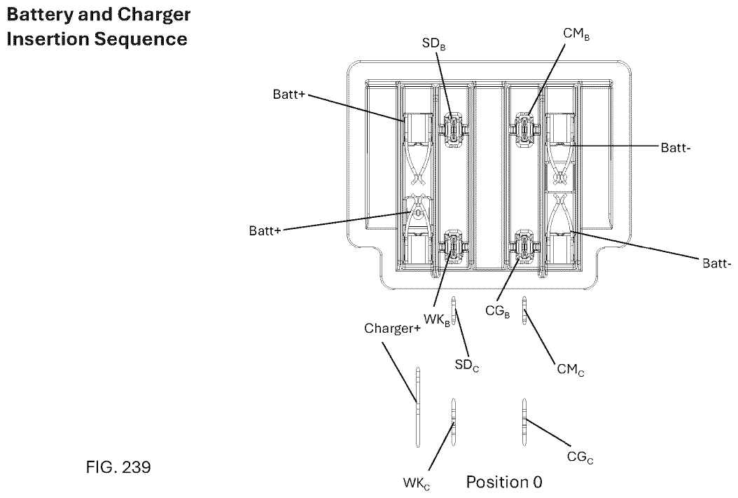

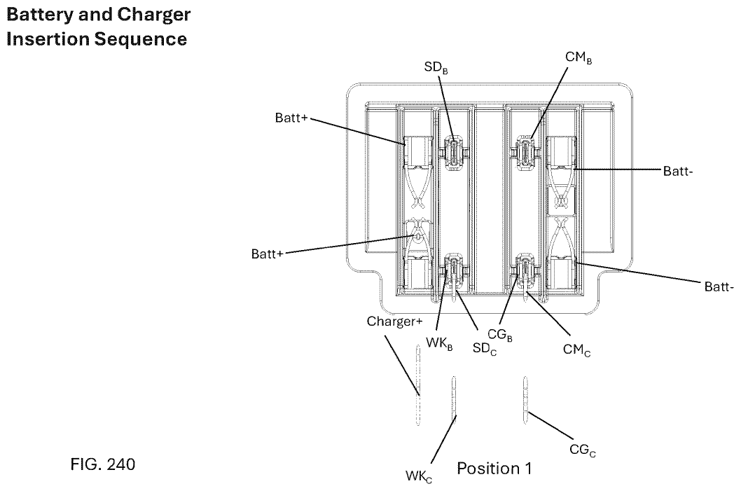

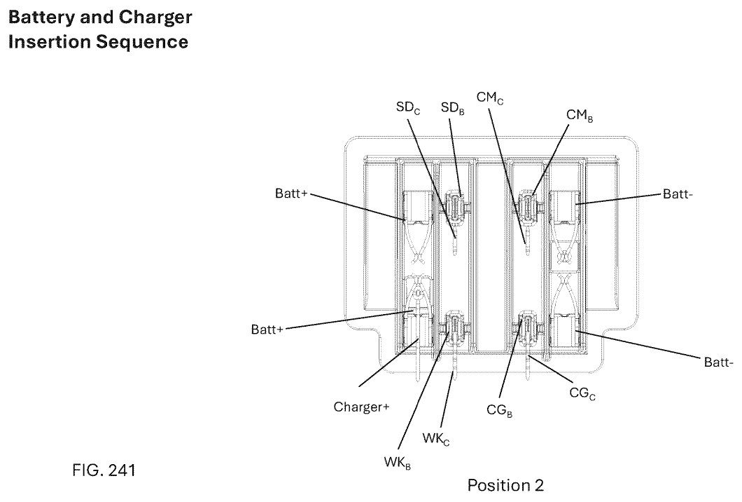

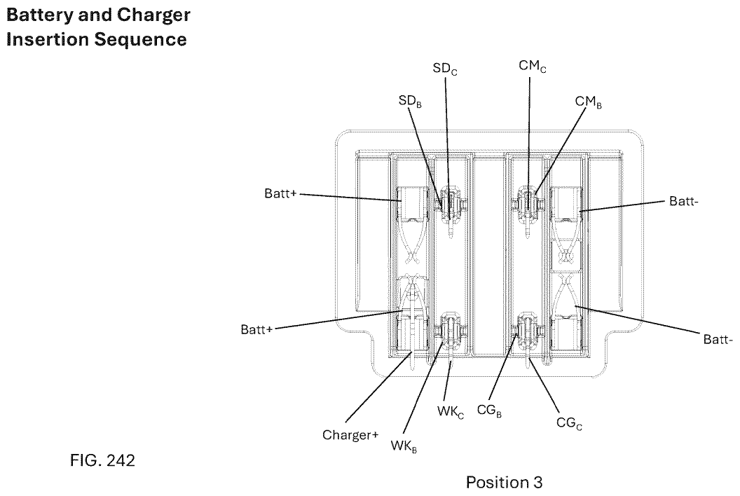

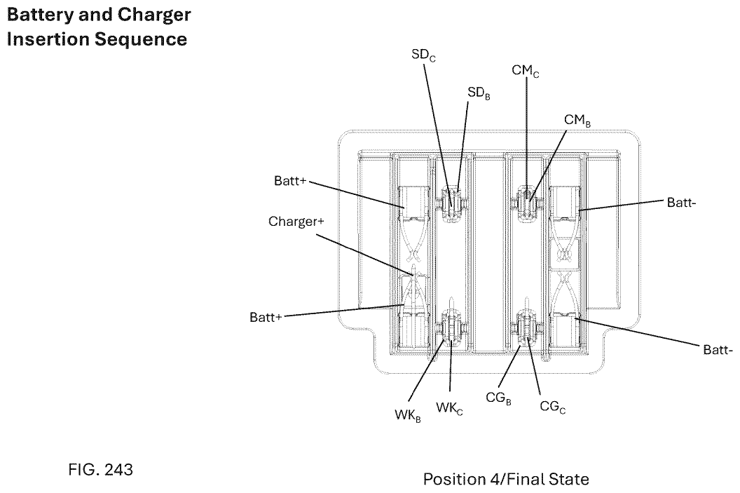

Referring to FIG. 233, when a battery pack is coupled/mated to the battery charger and the battery pack is in the operational state, the battery pack shutdown circuit 422 may present a HIGH voltage signal on the SD_{B} terminal (e.g., a voltage of the plurality of battery cells, such as 60V) and the charger shutdown circuit 5514 may read a HIGH voltage signal on the SD_{C} terminal—see (1) on FIG. 236. When a battery pack is coupled/mated to the battery charger and the battery pack is in the shutdown state, the battery pack shutdown circuit 422 may present a LOW voltage signal on the SD_{B} terminal (e.g., a ground signal, such as 0V) and the charger shutdown circuit 5514 may read a LOW voltage signal on the SD_{C} terminal—see (4) on FIG. 236.

When the battery pack is in the operational state, the secondary controller 5506 may sends a PWM signal (SD CTRL) to the input terminal of the charger shutdown circuit 5514—see (2) on FIG. 236. In response to the HIGH signal on the SD_{C} terminal and the HIGH SD CTRL signal, the charger shutdown circuit 5514 transmits a HIGH (operational) signal (SD READ) to the secondary controller 5506—see (3) on FIG. 236.

As described above, if a shutdown event occurs, the battery pack shutdown circuit 422 may present a LOW voltage signal on the SD_{B} terminal and the charger shutdown circuit 5514 may read a LOW voltage signal on the SD_{C} terminal. In response to the LOW signal on the SD_{C} terminal and the HIGH SD CTRL signal, the charger shutdown circuit 5514 transmits a LOW (shutdown) signal (SD READ) to the secondary controller 5506—see (5) on FIG. 233.

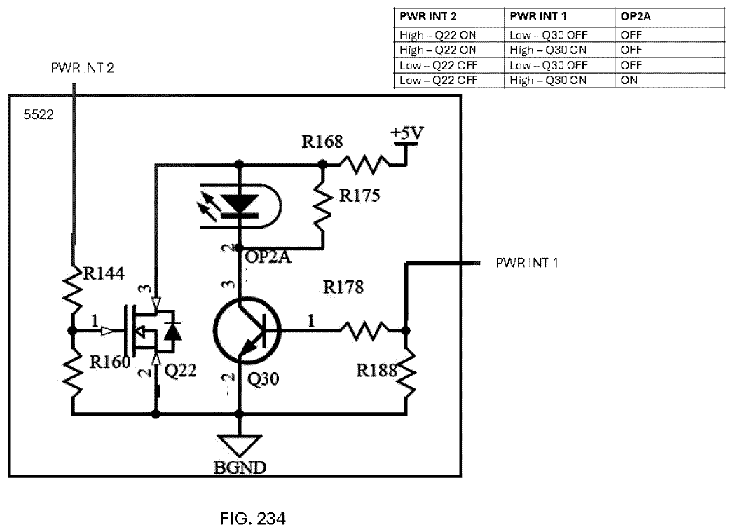

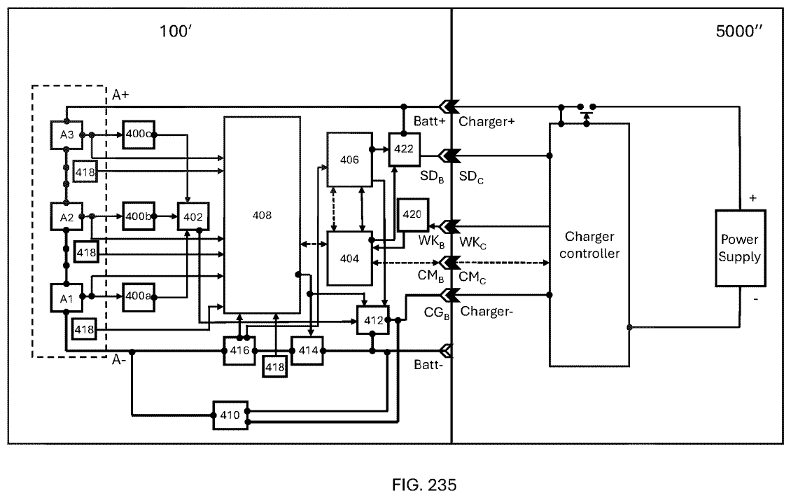

In response to receiving the shutdown signal, the secondary controller 5506 may transmit a shutdown signal to the primary controller 5504. In response to receiving the shutdown signal from the secondary controller 5506, the primary controller 5504 may transmit a control signal (RELAY CTRL) to the output relay 5518 to open the output relay 5518 and create an open circuit between the power supply 5500 and the Charge+ terminal. In addition, referring to FIG. 234, the primary controller 5504 may transmit a shutdown control signal (PWR INT 1) to a first input terminal of the shutoff circuit 5524.

In addition, referring to FIG. 234, in response to receiving the shutdown signal, the secondary controller 5506 may also transmit a shutdown control signal (PWR INT 2) to a second input terminal of the shutoff circuit 5524. In response to receiving the shutdown control signal from the primary controller 5504 and the shutdown control signal from the secondary controller 5506, the shutoff circuit shuts down the power supply 5500, thereby preventing the power supply 5500 from providing current to the Charge+ and CG_{C} terminals.

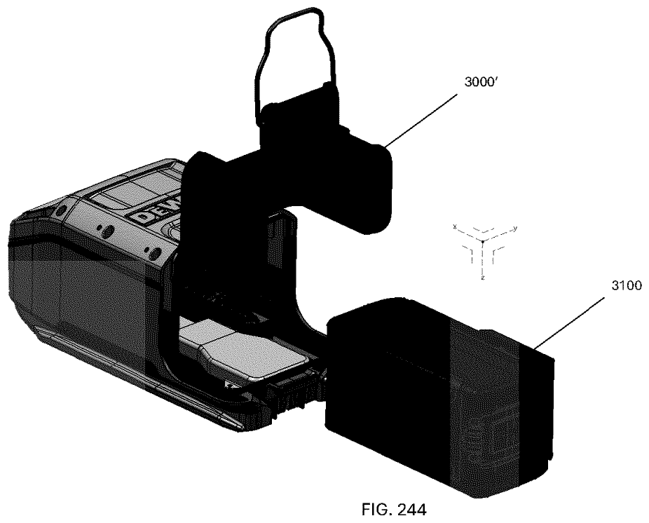

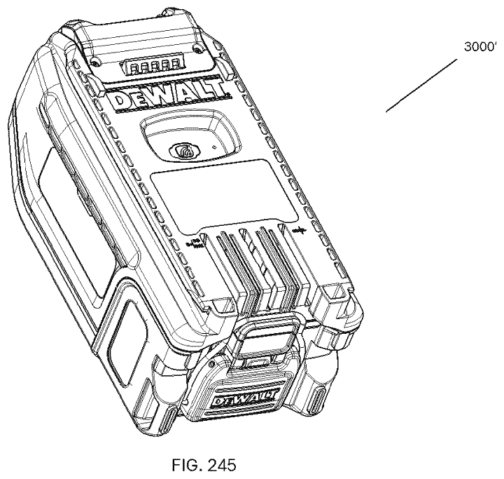

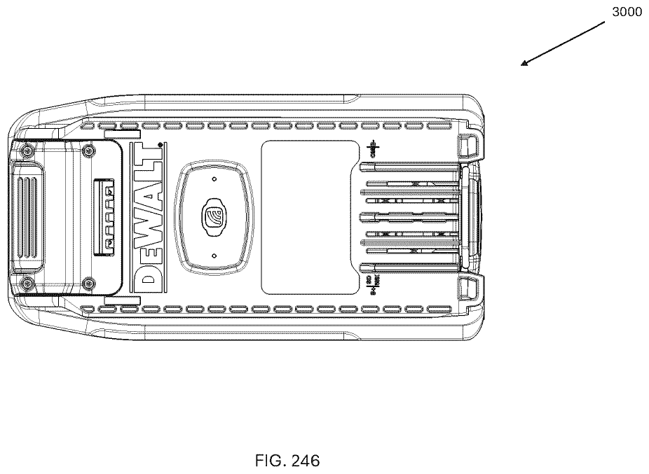

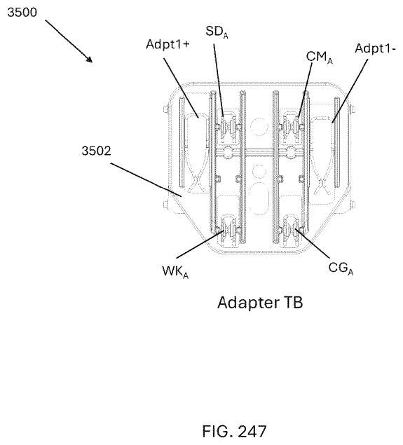

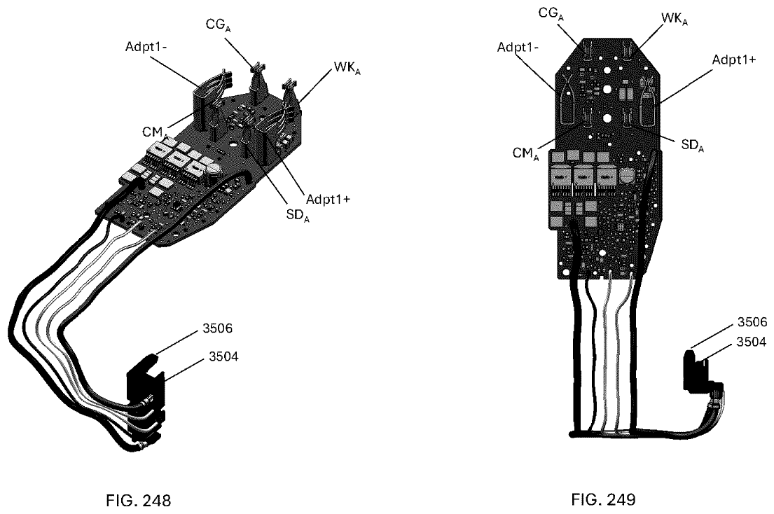

Referring to FIGS. 244-247, an example battery pack adaptor 3000′ of the present application may include an alternate example first terminal block 3500 for mating with an example high power, high voltage power tool 6000, as described above or an example high power charger 5000″. The first terminal block 3500 may include a first plurality of adaptor terminals. The first plurality of adaptor terminals may have a physical configuration and arrangement as illustrated in FIGs. The first terminal block 3500 may include a first plastic housing 3502. The first plastic housing 3502 may maintain the physical position of the first plurality of adaptor terminals relative to each other.

The first plurality of adaptor terminals may include a first subset of power terminals for transmitting discharging currents or charging currents and a first subset of signal terminals for transmitting communications or data signals.

In the example adaptor 3000′, the first subset of power terminals may include a first adaptor positive terminal (Adpt1+), a first adaptor negative terminal (Adpt1−) and an adaptor charge ground terminal (CG_{A}). The first adaptor positive terminal and the first adaptor negative terminal may be used for discharging a coupled battery pack 3100 along a discharge path when connected to a power tool. The first adaptor positive terminal and the charge ground terminal may be used for charging the coupled battery pack 3100 along a charge path when connected to a power source/battery pack charger.

In the example adaptor 3000′, the first subset of signal terminals may include a wake terminal (WK_{A}), a shutdown terminal (SD_{A}) and a data communications terminal (CM_{A}). The wake terminal may be used to communicate a wake signal between the adaptor and a power tool or a battery charger. The wake signal may be used to put the adaptor into a “wake” state from a “sleep” state or to put the adaptor into the “sleep” state from the “wake” state. The shutdown terminal may be used to communicate a shutdown signal between the adaptor and a battery pack charger or a power tool. The shutdown signal may be used to “instruct” the battery pack charger or the power tool to stop/cease operations. The data communications terminal may be used to communicate digital data between the adaptor and a battery pack charger or a power tool.

The example adaptor 3000′ may include a second terminal block 3504 for mating with an example battery pack, for example a battery pack 3100. The second terminal block 3504 may include a second plurality of adaptor terminals. The second plurality of adaptor terminals may have a physical configuration and arrangement as illustrated in FIGs. The second terminal block 3504 may include a second plastic housing 3506. The second plastic housing 3506 may maintain the physical position of the second plurality of adaptor terminals relative to each other.

The second plurality of adaptor terminals may include a second subset of power terminals for transmitting discharging currents or charging currents and a second subset of signal terminals for transmitting communications or data signals.

In the example adaptor 3000′, the second subset of power terminals may include a second adaptor positive terminal (Adpt2+) and a second adaptor negative terminal (Adpt2−). The second adaptor positive terminal and the second adaptor negative terminal may be used for discharging the coupled battery pack along a discharge path when connected to a power tool. The second adaptor positive terminal and the second adaptor negative terminal may be used for charging the coupled battery pack along a charge path when connected to a power source/battery pack charger.

In the example adaptor 3000′, the second subset of signal terminals may include a first signal terminal (AT1), a second signal terminal (AT3) and a third signal terminal (AT4). The first signal terminal may be used to communicate with a thermistor of the coupled battery pack. The second signal terminal may be used to receive a voltage signal of a first subset of battery cells of the coupled battery pack. The third signal terminal may be used to receive a voltage signal of a second subset of battery cells of the coupled battery pack.

The adaptor may also include an adaptor processing circuit 3508. The adaptor processing circuit 3508 may be or referred to as a microcontroller, a microprocessor or another type of integrated circuit. The adaptor processing circuit 3508 may also be or referred to as an adaptor microprocessor or controller or simply a controller.

The adaptor may also include a bypass circuit 410′. The adaptor bypass circuit 410′ is similar to and operates in a similar fashion to the battery pack bypass circuit 410, described above.

The adaptor may also include a discharge switch circuit 414′. The adaptor discharge switch circuit 414′ is similar to and operates in a similar fashion to the battery pack discharge switch circuit 414, described above.

The adaptor may also include a current monitoring circuit 416′. The adaptor current monitoring circuit 416′ is similar to and operates in a similar fashion to the battery pack current monitoring circuit 416, described above.

The adaptor may also include a thermistor circuit 418′. The thermistor circuit 418′ may include one or more thermistors. The thermistor circuits 418′ may be or referred to simply as a thermistor 418′. There may be a thermistor circuit 418′ associated with (in close proximity to) the discharge FETs 414′. The thermistor 418′ may provide an input (voltage) signal to the adaptor controller 3508. The input signal from the thermistor 418′ is representative of a temperature of the associated discharge FETs 414′. The adaptor thermistor circuit 418′ is similar to and operates in a similar fashion to the battery pack thermistor circuit 418, described above.

The adaptor may include a wake circuit 420′. The wake circuit 420′ may include a first terminal coupled to the WK_{A} terminal of the adaptor and a second terminal coupled to the adaptor controller 3508, and a third terminal coupled to the Adpt1+ terminal of the adaptor. The wake circuit 420′ is similar to and operates in a similar fashion to the battery pack wake circuit 420, described above.

The adaptor may include a shutdown circuit 422′. The shutdown circuit 422′ may include a first terminal coupled to the SD_{A} terminal of the adaptor, a second terminal coupled to the adaptor controller 3508, and a third terminal coupled to the Adpt1+ terminal of the adaptor. The adaptor shutdown circuit 422′ is similar to and operates in a similar fashion to the battery pack shutdown circuit 422, described above.

As illustrated in FIG. 244, the adaptor controller 3508 may include a pin/terminal for receiving an input signal (WK INT) from the wake circuit 420′. The adaptor controller 3508 may also include a pin/terminal for transmitting/receiving two way communications signals (CM) to/from the CM_{A} terminal of the adaptor. The adaptor controller 3508 may also include a pin/terminal for transmitting a control signal (DSG FET EN) to the discharge FETs 414′. The adaptor controller 3508 may also include a pin/terminal for transmitting a control signal (TH EN) to the thermistor 418′. The adaptor controller may also include a pin/terminal for receiving an input signal (TH READ) from the thermistor 418′. The adaptor controller may also include a pin/terminal for receiving an input signal (CM READ) from the current monitoring circuit 416′. The adaptor controller 3508 may also include a pin/terminal for receiving an input signal (AT1 READ) from the first terminal AT1 of the second set of signal terminals. The adaptor controller 3508 may also include a pin/terminal for receiving an input signal (AT3 READ) from the second terminal AT3 of the second set of signal terminals. The adaptor controller 3508 may also include a pin/terminal for receiving an input signal (AT4 READ) from the third terminal AT4 of the second set of signal terminals. The adaptor controller 3508 may include a pin/terminal for receiving an input signal (ADPT+) from the ADPT2+ terminal. The adaptor controller 3508 may include a pin/terminal for transmitting a control signal (SD EN) to the shutdown circuit 422′.

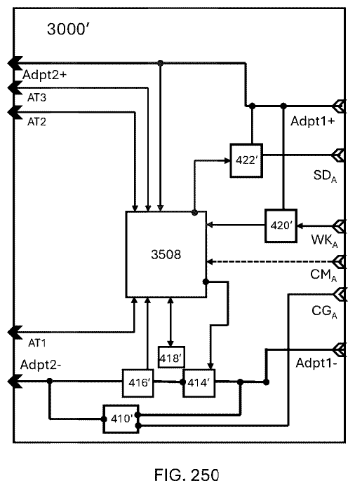

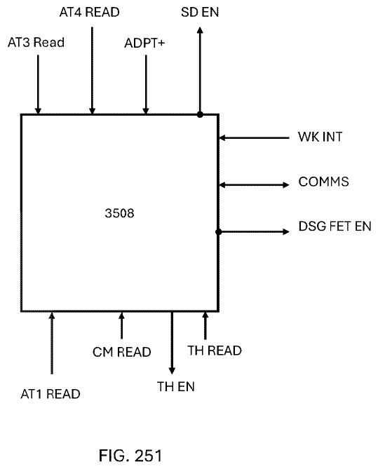

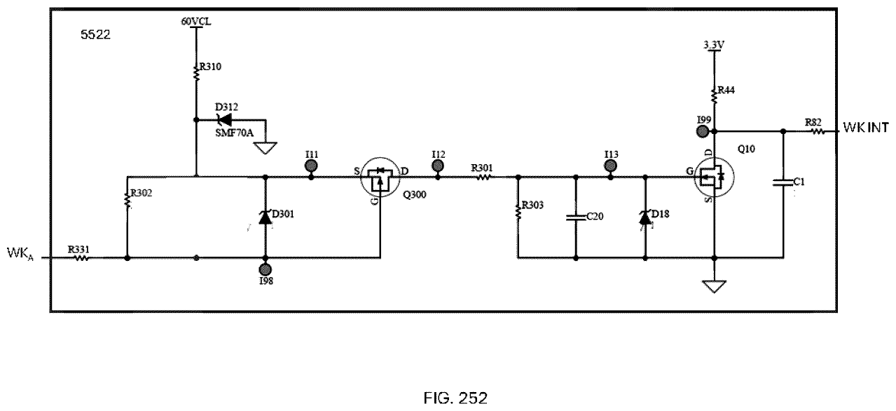

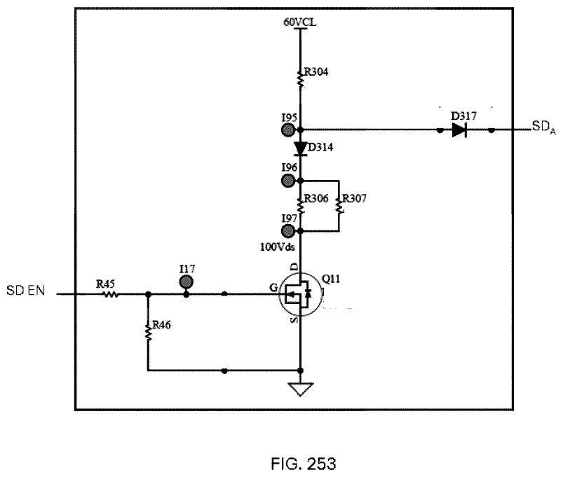

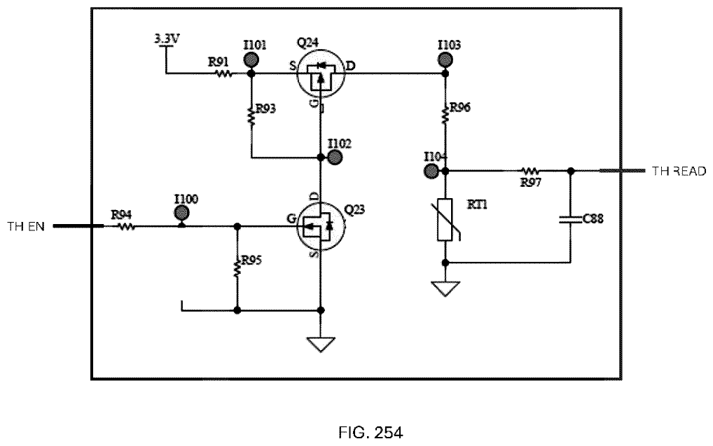

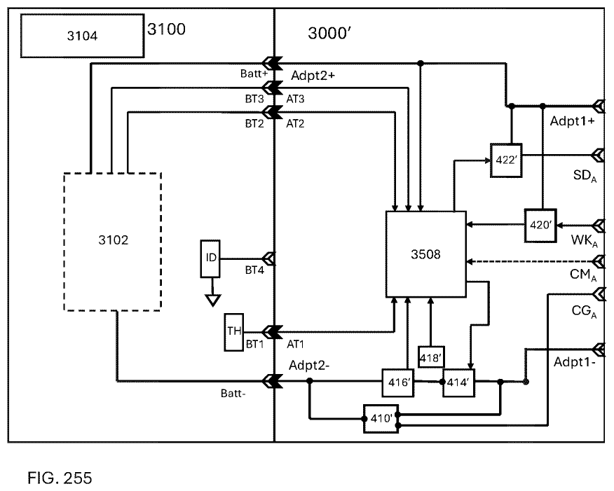

Referring to FIG. 250, there is illustrated a schematic block diagram of an example adaptor 3000′ coupled to an example battery pack 3100. The example battery pack may be a battery pack from a power tool system (a second power tool system) that is not compatible with the power tool 6000 of a first power tool system. In other words, the battery pack 3100 of the second power tool system is not able to interface directly with the power tool 6000 of the first power tool system and requires the adaptor 3000′ in order to provide power to the power tool 6000.

The example battery pack 3100 may include a plurality of battery cells 3102. The plurality of battery cells may include a plurality of strings (or sets) of battery cells A1, A2, A3. Each string of the battery cells may include a string of series connected battery cells. Each string of battery cells may include a string of five battery cells. Each battery cell in each string of battery cells may have a nominal voltage of approximately 3.6 volts to approximately 3.7 volts. Each string of battery cells may have a nominal voltage of approximately 18 volts to approximately 18.5 volts. The plurality of battery cells may include a set of fifteen battery cells connected in series, having a stack voltage. The plurality of battery cells may have a nominal voltage of approximately 54V. The stack voltage may be equal to the nominal voltage of the plurality of battery cells. The stack voltage may be equal to the voltage of the plurality of battery cells at any given time. The nominal voltage of the battery pack 3100 may be equivalent to the operating voltage of the power tool and therefore compatible from a voltage level standpoint.

The battery pack 3100 may also include a set of battery pack terminals. The battery pack 3100 may include a plurality of battery pack terminals. The plurality of battery pack terminals may include a subset of power terminals for transmitting charging and discharging currents and a subset of signal terminals for transmitting communications or data signals.

The subset of power terminals may include a battery pack positive terminal (Batt+) and a battery pack negative terminal (Batt−). The battery pack positive terminal and the battery pack negative terminal may be used for discharging the battery pack along a discharge path when connected to a power tool. The battery pack positive terminal and the battery pack negative terminal may be used for charging the battery pack along a charge path when connected to a power source/battery pack charger.

In the example battery pack 3100, the subset of signal terminals may include a first voltage terminal (BT1), a second voltage terminal (BT2), a third voltage terminal (BT3) and a fourth voltage terminal (BT4). The first voltage terminal may be used to communicate a temperature signal between the battery pack and an adaptor. The temperature signal may be used to indicate shutdown conditions in the battery pack 3100 to the adaptor. The second voltage terminal may be used to communicate a voltage signal representative of a voltage of a subset of the plurality of battery cells to the adaptor. For example, the voltage signal on the second voltage terminal be representative of the voltage of the first four cells in the plurality (stack) of battery cells. The third voltage terminal may be used to communicate a voltage signal representative of a voltage of a subset of the plurality of battery cells to the adaptor. For example, the voltage signal on the third voltage terminal be representative of the voltage of the first ten cells in the plurality (stack) of battery cells. The fourth voltage terminal may be used to communicate a voltage signal representative of an identification circuit of the battery pack 3100.

The battery pack 3100 may also include a pack controller 3104 similar to the primary controller 404 of the battery pack 100′.

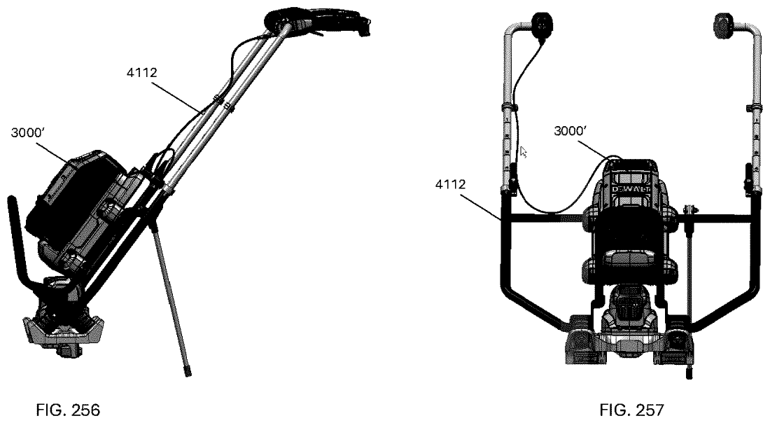

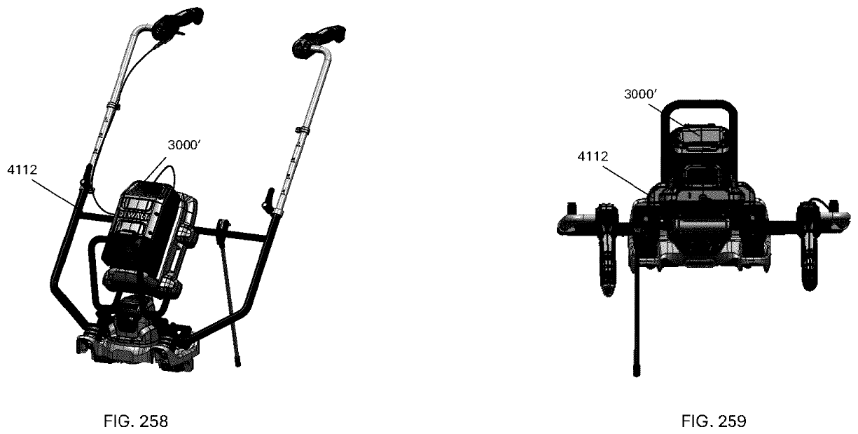

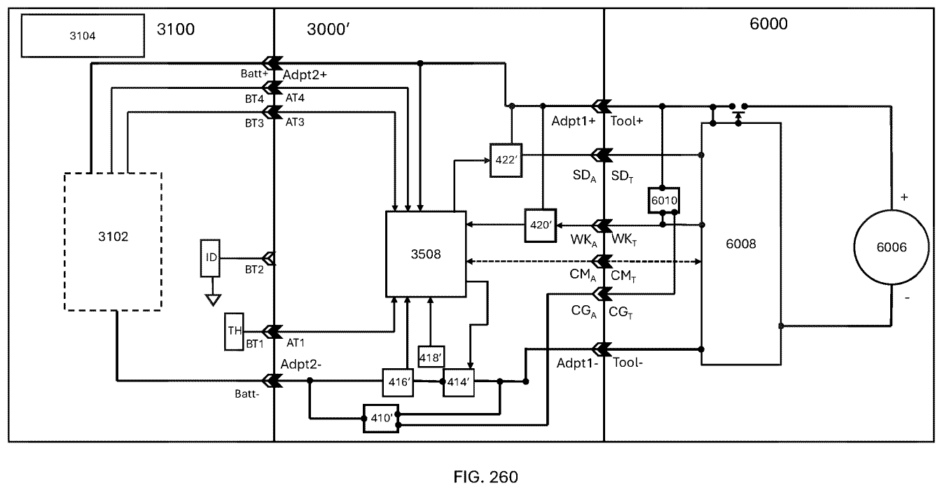

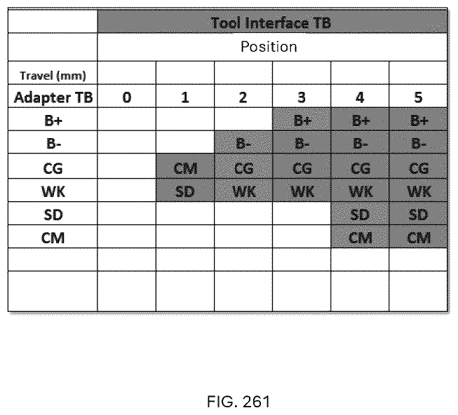

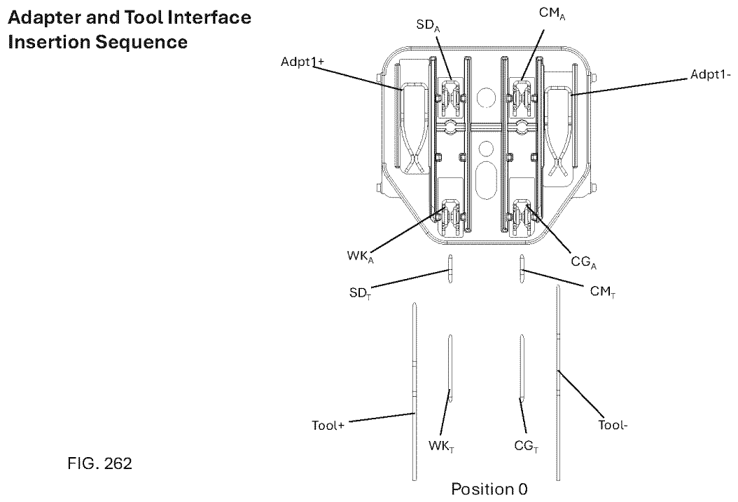

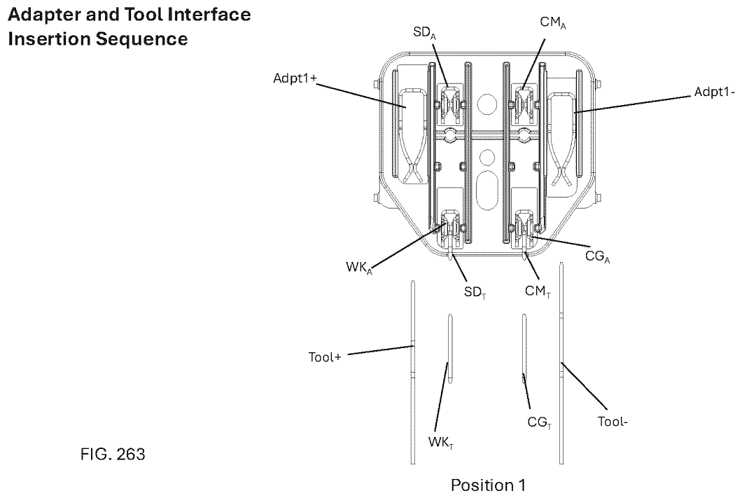

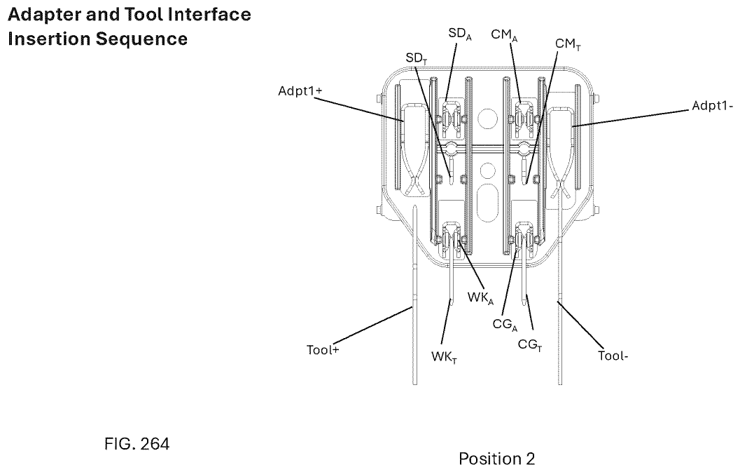

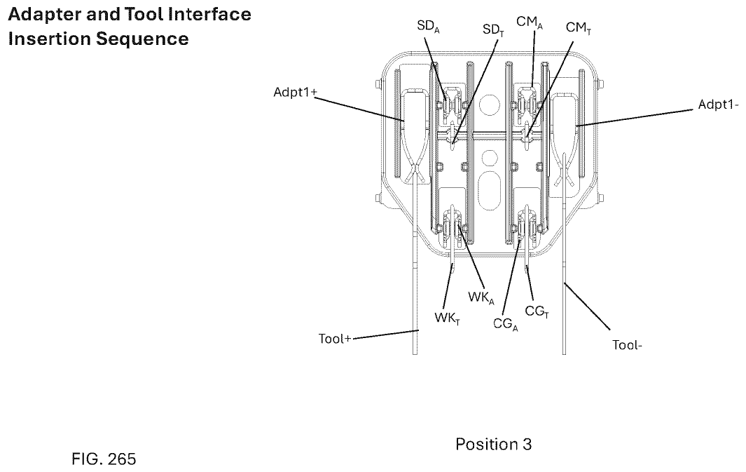

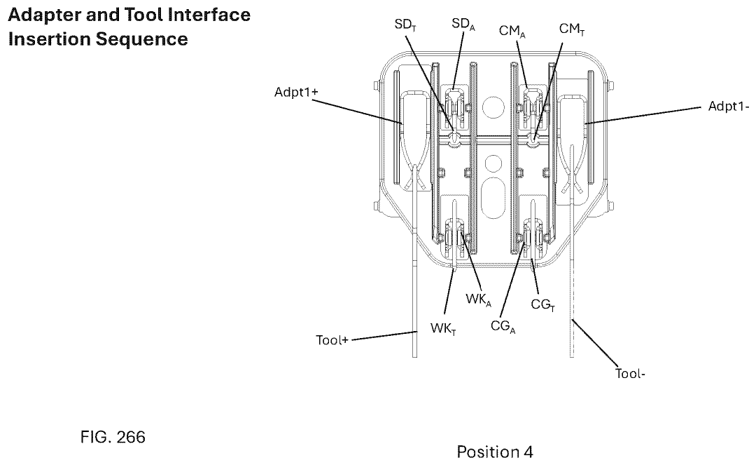

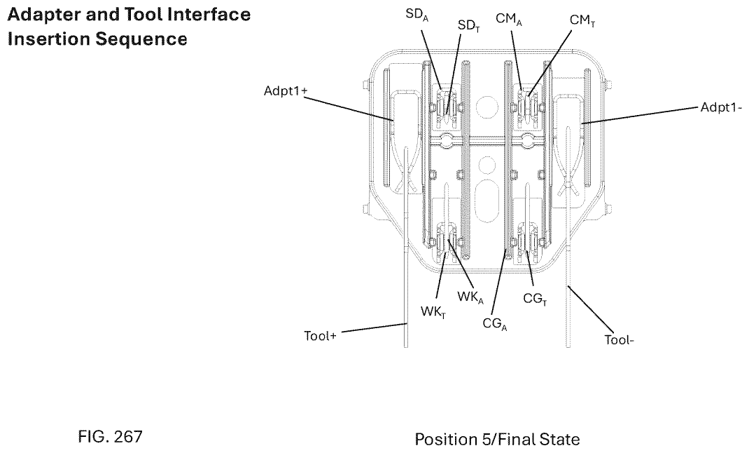

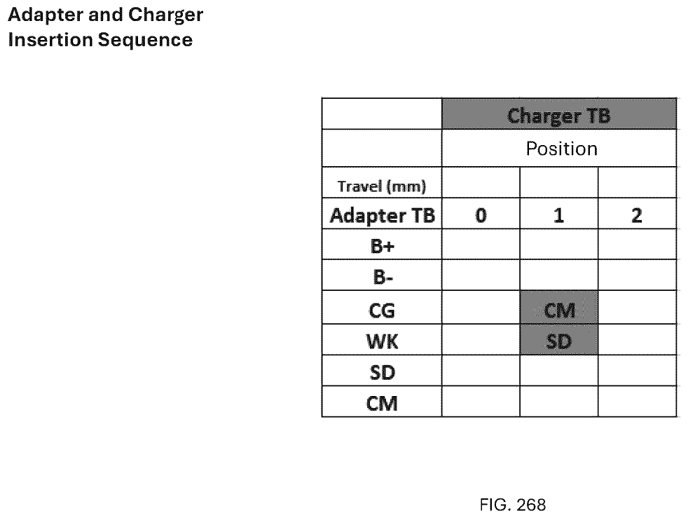

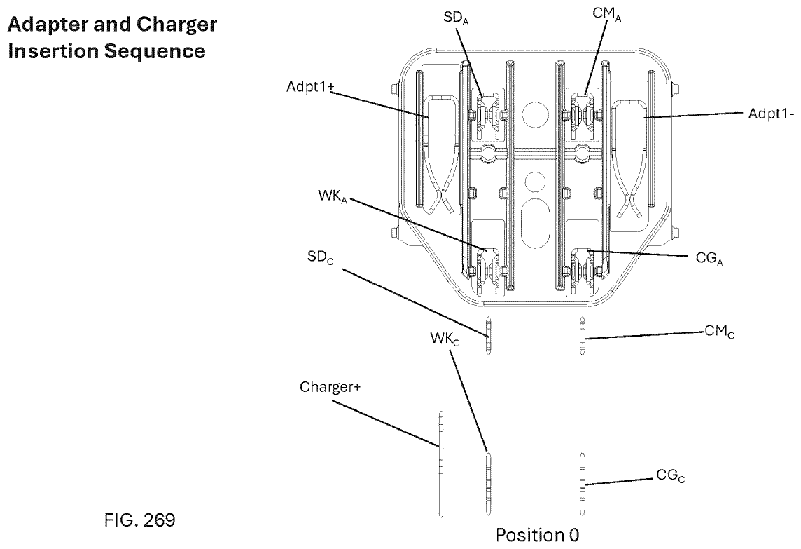

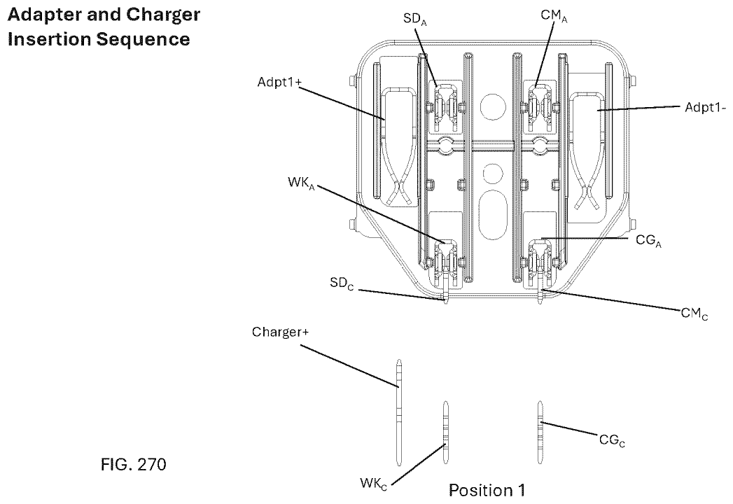

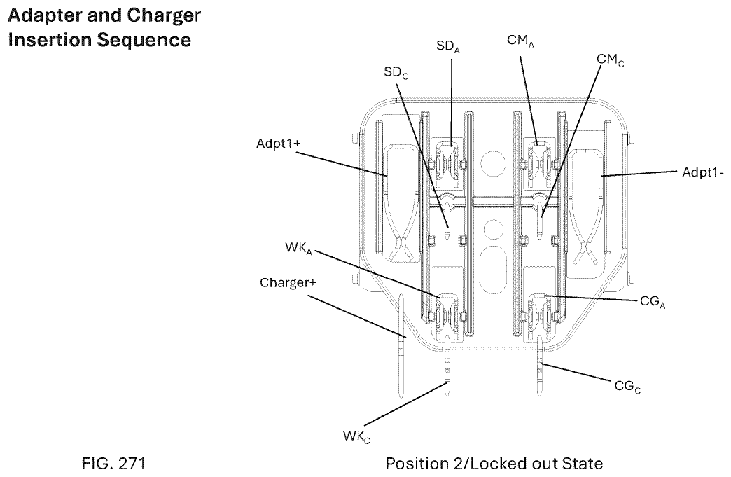

Referring to FIGS. 256-259, there is illustrated an example adaptor 3000′ (including an internally couple battery pack 3100) coupled to a power tool 6000, for example a screed. Referring to FIG. 260, there is illustrated a schematic block diagram of a battery pack 3100, an adaptor 3000′, and a power tool 6000 coupled together.

The battery pack 3100 and the adaptor 3000′ operate in a fashion similar to the battery pack 100′ when coupled with the power tool 6000. For example, when the battery pack 3100 and adaptor 3000′ are coupled with the power tool 6000, the first wake circuit 6010 will send a wake signal to wake circuit 420′ of the adaptor 3000′ and the adaptor controller 3508 will close the adaptor discharge FETs 414′ to enable current to flow from the battery pack through the adaptor and to the power tool.

Furthermore, if the adaptor 3000′ is in a sleep mode (discharge FETs 414′ in an open state), the battery pack 3100 will still provide current through the adaptor 3000′ to the power tool 6000 through the bypass circuit 410′.

Still further, if the adaptor controller 3508 determines, based on information/data collected from the battery pack 3100 through the power terminals and/or the signal terminals, that the battery pack 3100 is experiencing a shutdown event, the adaptor controller 3508 will transmit a shutdown signal to the shutdown circuit 422′ and the shutdown circuit 422′ will present a LOW voltage signal at the SDA terminal and the power tool 6000 will read a LOW voltage signal on the SD_{T} terminal. This will result in the tool controller 6008 turning off the motor and/or opening the discharge switch.

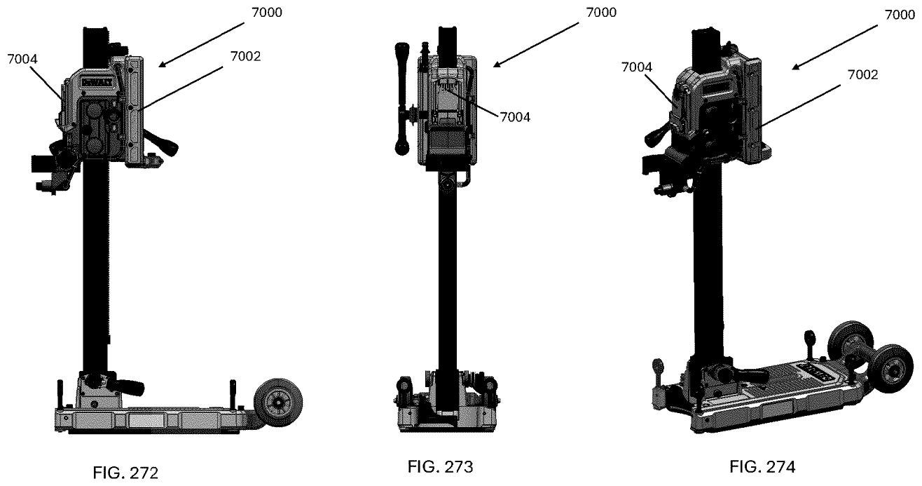

Referring to FIGS. 272-274, there is illustrated another example adaptor 7000. The example adaptor 7000 is configured to enable the battery pack 100′ from the first power tool system to operate with a power tool 8000 from the second power tool system. The power tool 8000 may be, for example, a core drill 8000. In other words, the battery pack 100′ of the first power tool system is not able to interface directly with the power tool 8000 of the second power tool system and requires the adaptor 7000 in order to provide power to the power tool 8000.

In addition to enabling the battery pack 100′ of the first power tool system to operate with the power tool 8000 of the second power tool system, the adaptor 7000 may also provide a mechanical function. For example, the adaptor 7000 may be a stand for a core drill 8000. As illustrated in FIGS. 272-274, the adaptor 7000 may have a first electromechanical interface (A) 7002 and a second electromechanical interface (B) 7004. The first electromechanical interface 7002 may be configured to couple/mate with a corresponding electromechanical interface (A) of the battery pack 100′ of the first power tool system and the second electromechanical interface 7004 may be configured to couple/mate with a corresponding electromechanical interface (B) of the power tool 8000 of the second power tool system.

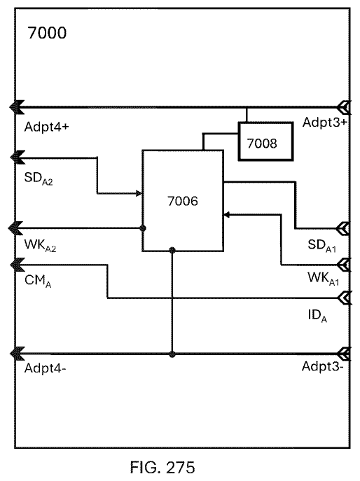

Referring to FIG. 275, the example battery pack adaptor 7000 of the present application may include an example first terminal block for mating with an example low power, high voltage power tool 8000. The first terminal block may include a first plurality of adaptor terminals. The first plurality of adaptor terminals may have a physical configuration and arrangement as illustrated in FIGs. The first terminal block may include a first plastic housing (not shown). The first plastic housing may maintain the physical position of the first plurality of adaptor terminals relative to each other. The first plurality of adaptor terminals may be female type terminals.

The first plurality of adaptor terminals may include a first subset of power terminals for transmitting discharging currents or charging currents and a first subset of signal terminals for transmitting communications or data signals.

In the example adaptor 7000, the first subset of power terminals may include a first adaptor positive terminal (Adpt3+) and a first adaptor negative terminal (Adpt3−). The first adaptor positive terminal and the first adaptor negative terminal may be used for discharging the coupled battery pack 100′ along a discharge path when connected to the power tool 8000. The first adaptor positive terminal and the first adaptor negative terminal may be used for charging the coupled battery pack 100′ along a charge path when connected to a power source/battery pack charger.

In the example adaptor 7000, the first subset of signal terminals may include a first signal terminal (ID_{A}), a second signal terminal (WK_{A1}) and a third signal terminal (SD_{A1}). The first signal terminal may be used to communicate with an identification circuit of the coupled power tool 8000. The second signal terminal may be used to receive a voltage signal indicative of a trigger pull of the coupled power tool 8000. The third signal terminal may be used to transmit a shutdown signal to the coupled power tool 8000.

The example adaptor 7000 may include a second terminal block for mating with an example battery pack of the first power tool system, for example a battery pack 100′. The second terminal block may include a second plurality of adaptor terminals. The second plurality of adaptor terminals may have a physical configuration and arrangement as illustrated in FIGs. The second terminal block may include a second plastic housing (not shown). The second plastic housing may maintain the physical position of the second plurality of adaptor terminals relative to each other. The second plurality of adaptor terminals may be male type terminals.

The second plurality of adaptor terminals may include a second subset of power terminals for transmitting discharging currents or charging currents and a second subset of signal terminals for transmitting communications or data signals.

In the example adaptor 7000, the second subset of power terminals may include a second adaptor positive terminal (Adpt4+) and a second adaptor negative terminal (Adpt4−). The second adaptor positive terminal and the second adaptor negative terminal may be used for discharging the coupled battery pack 100′ along a discharge path when connected to the power tool 8000. The second adaptor positive terminal and the second adaptor negative terminal may be used for charging the coupled battery pack 100′ along a charge path when connected to a power source/battery pack charger.

In the example adaptor 7000, the second subset of signal terminals may include a wake terminal (WK_{A2}), a shutdown terminal (SD_{A2}) and a data communications terminal (CM_{A}). The wake terminal may be used to communicate a wake signal between the adaptor 7000 and the battery pack 100′. The wake signal may be used to put the battery pack 100′ into a “wake” state from a “sleep” state or to put the battery pack 100′ into the “sleep” state from the “wake” state. The shutdown terminal may be used to communicate a shutdown signal between the battery pack 100′ and the adaptor 7000. The shutdown signal may be used to “instruct” the adaptor 7000 to transmit a shutdown signal to the power tool 8000 to stop/cease operations. The data communications terminal may be used to communicate digital data between the battery pack 100′ and the power tool 8000.

The adaptor may also include an adaptor processing circuit 7006. The adaptor processing circuit 7006 may be or referred to as a microcontroller, a microprocessor or another type of integrated circuit. The adaptor processing circuit 7006 may also be or referred to as an adaptor microprocessor or controller or simply a controller.

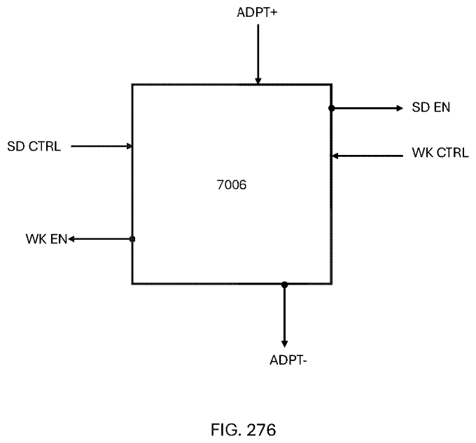

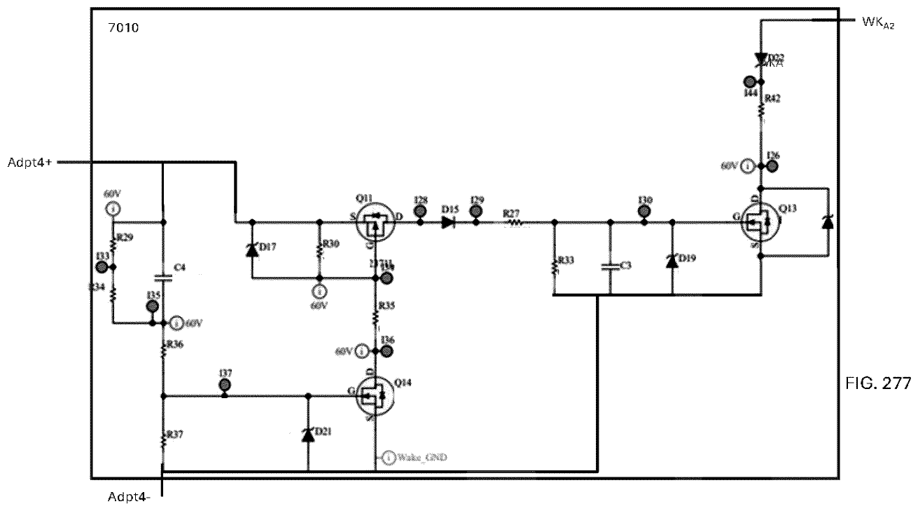

As illustrated in FIG. 276, the adaptor controller 7006 may include a pin/terminal for receiving a power supply voltage signal (ADPT+) from an enable switch 7008. The adaptor controller 7006 may also include a pin/terminal for transmitting a shutdown signal (SD EN) to the power tool 8000. The adaptor controller 7006 may also include a pin/terminal for receiving an input signal (WK CTRL) from the power tool 8000. The adaptor controller 7006 may also include a pin/terminal for connecting the adaptor controller 7006 to the negative terminals ADPT−. The adaptor controller 7006 may also include a pin/terminal for transmitting a control signal (WK EN) to the batter pack 100′. The adaptor controller 7006 may also include a pin/terminal for receiving an input signal (SD CTRL) from the battery pack 100′.

The adaptor 7000 may also include an enable switch 7008. The adaptor enable switch 7010 may be a mechanical switch. The enable switch 7008 may include a first terminal coupled to the Adpt3+ and Adpt4+ terminals and a second terminal coupled to the adaptor controller 7006. The enable switch 7008 may be incorporated into the second mechanical interface 7004 of the adaptor 7000. The enable switch 7008 may cooperate with the mechanical interface of the power tool 8000 of the second power tool system. The enable switch 7008 may be closed when the power tool 8000 is coupled/mated with the adaptor 7000. When the enable switch 7008 is closed, a closed circuit is created between the Adpt4+ terminal and the adaptor controller 7006. When the battery pack 100′ and the power tool 8000 are coupled/mated with the adaptor 7000, a power current will be provided from the battery pack 100′ to the adaptor controller 7006.

The adaptor controller 7006 may include a first wake circuit 7010. The first wake circuit 7010 may be similar to and operate in a similar fashion to the first wake circuit 6010 of the power tool 6000, described above. The first wake circuit 7010 may include a first terminal coupled to the WKA2 terminal of the adaptor 7000, a second terminal coupled to the Adpt+ terminal of the adaptor 7000 and a third terminal coupled to the Adpt− terminal of the adaptor 7000.

The adaptor controller 7008 may include a second wake circuit 7012. The second wake circuit 7012 may be similar to and operate in a similar fashion to the second wake circuit 6016 of the power tool 6000, described above. The second wake circuit 7102

The adaptor 7008 may include a shutdown circuit 7014. The shutdown circuit 7014 may include a first terminal coupled to the SD_{A1} terminal of the adaptor 7000, a second terminal coupled to the SD_{A2} terminal of the adaptor 7000, a third terminal coupled to the Adpt4+ terminal of the adaptor 7000, and a fourth terminal coupled to the Adpt− terminal of the adaptor 7000. The adaptor shutdown circuit 7014 may be similar to and operate in a similar fashion to the battery pack shutdown circuit 422, described above.

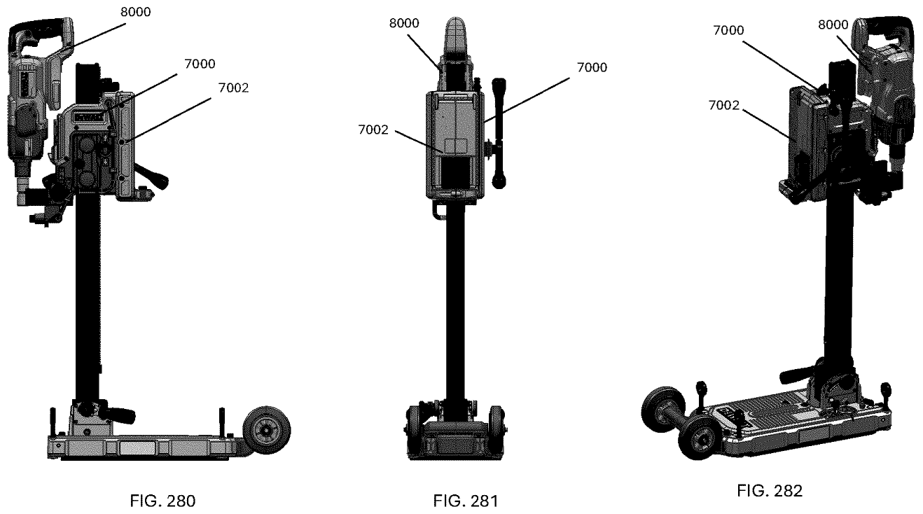

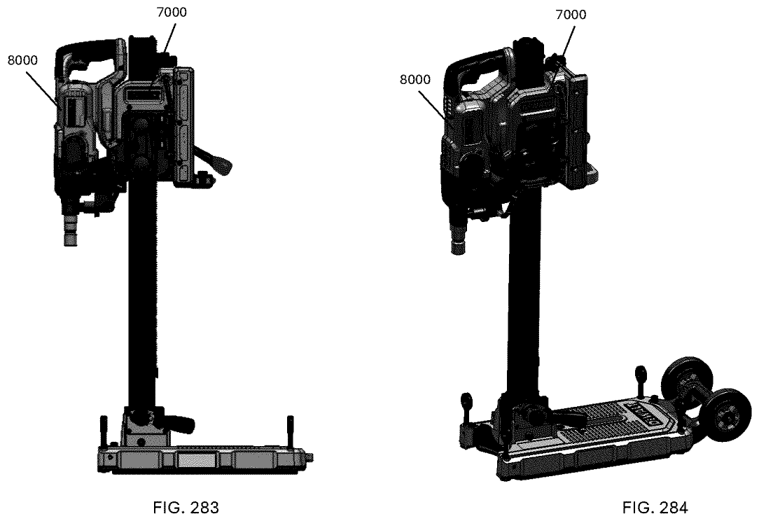

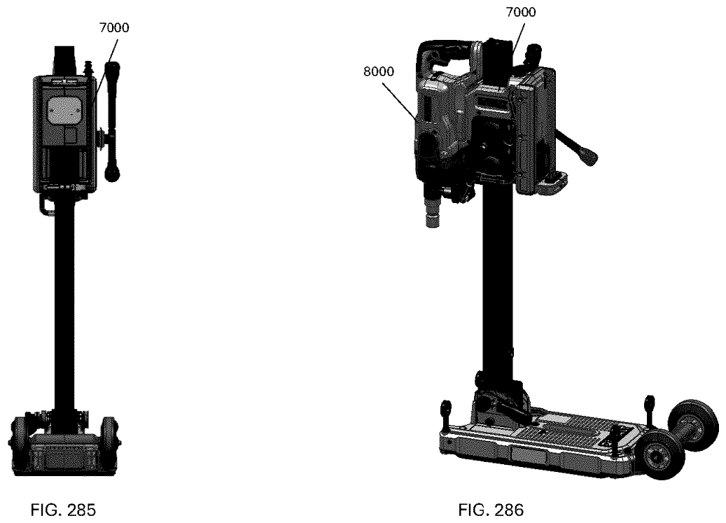

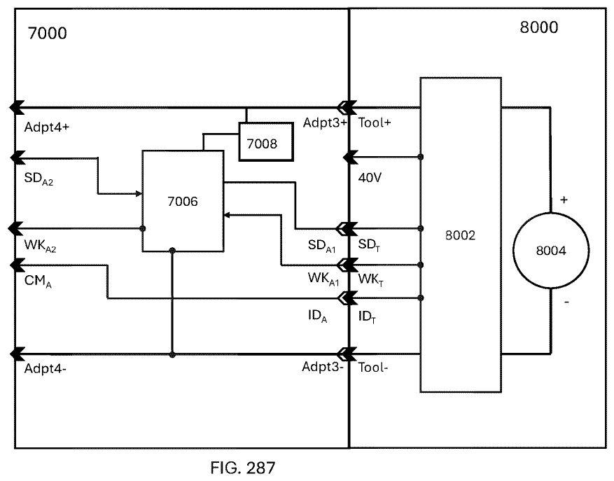

Referring to FIGS. 280-284, there is illustrated an example adaptor 7000 coupled to a power tool 8000, for example a core drill. Referring to FIG. 287, there is illustrated a schematic block diagram of the adaptor 7000 and the power tool 8000 coupled together.

The power tool 8000 may also include a set of power tool terminals. The power tool 8000 may include a plurality of power tool terminals. The plurality of power tool terminals may include a subset of power terminals for transmitting discharging currents and a subset of signal terminals for transmitting communications or data signals.

The subset of power terminals may include a power tool positive terminal (Tool+) and a power tool negative terminal (Tool−). The power tool positive terminal and the power tool negative terminal may be used for discharging a battery pack along a discharge path when connected to the power tool 8000.

In the example power tool 8000, the subset of signal terminals may include a first voltage terminal (ID_{T}), a second voltage terminal (WK_{T}), a third voltage terminal (SD_{T}) and a fourth voltage terminal (40V). The first voltage terminal may be used to communicate an identification signal between the power tool 8000 and the battery pack. The second voltage terminal may be used to communicate a wake control signal from the power tool 8000 to the adaptor 7000. The third voltage terminal may be used to communicate a shutdown enable signal from the adaptor 7000 to the power tool 8000.

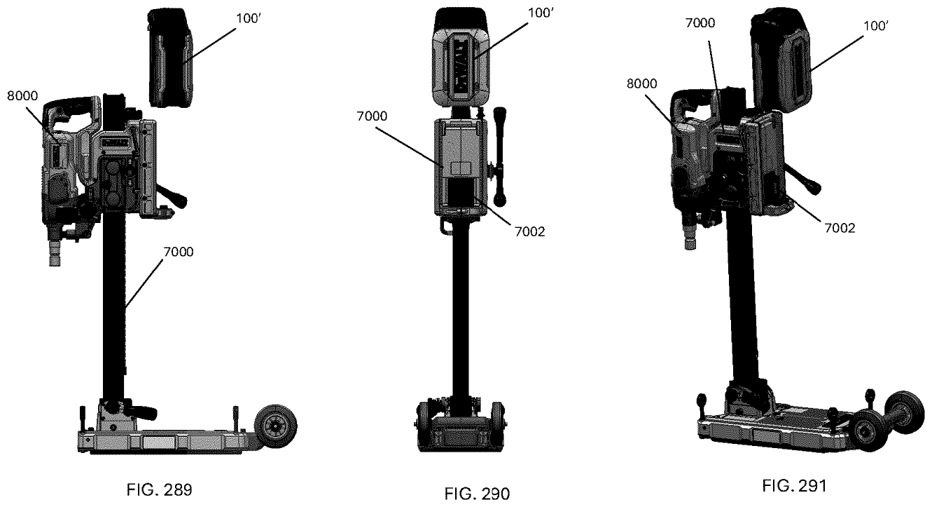

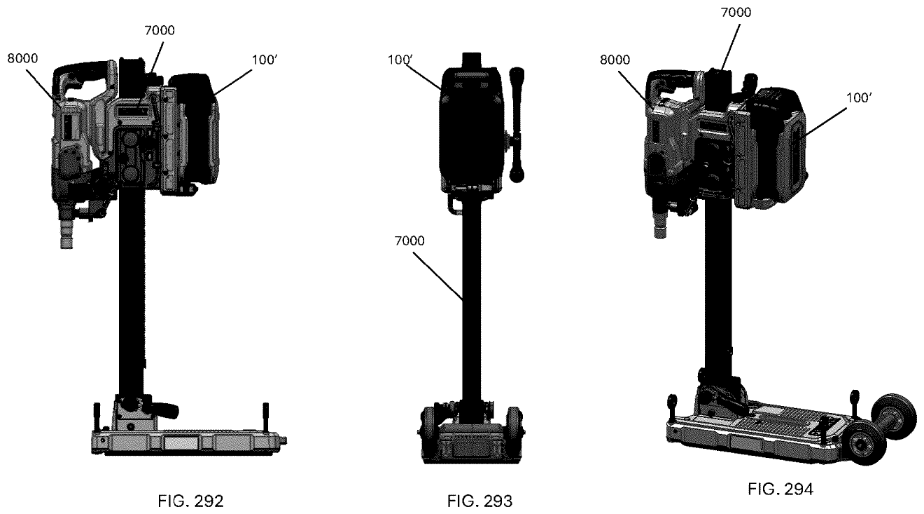

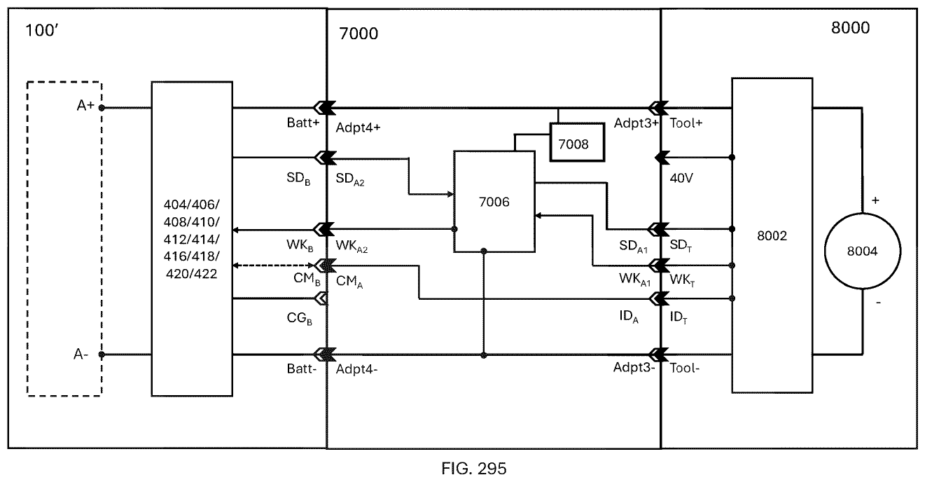

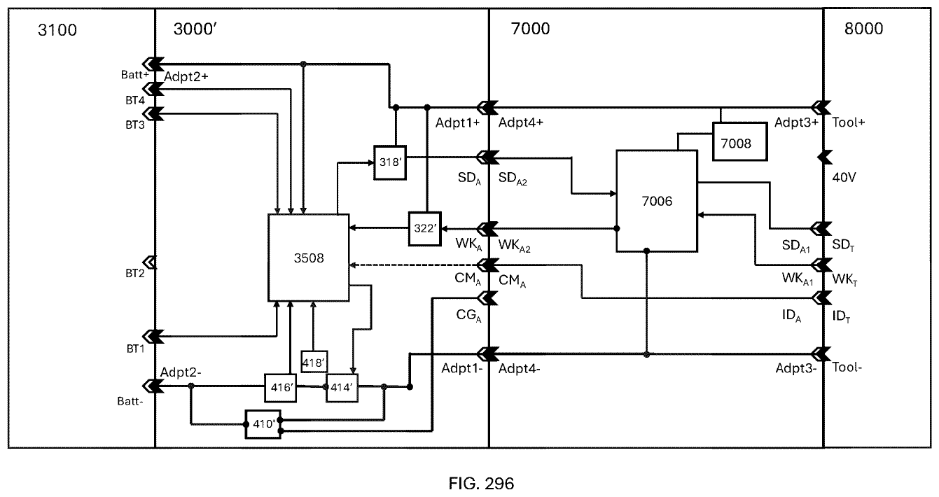

Referring to FIGS. 292-294, there is illustrated an example battery pack 100′ coupled/mated to the adaptor 7000 and the power tool 8000. Referring to FIG. 295, there is illustrated a schematic block diagram of an example an example battery pack 100′ coupled/mated to the adaptor 7000 and the power tool 8000. The example battery pack may be a battery pack from the first power tool system that is not compatible with the power tool 8000 of the second power tool system. In other words, the battery pack 100′ of the first power tool system is not able to interface directly with the power tool 8000 of the second power tool system and requires the adaptor 7000 in order to provide power to the power tool 8000.

The power tool 8000 and the adaptor 7000 operate in a fashion similar to the power tool 6000 when coupled with the battery pack 100′. For example, when the adaptor 7000 and the power tool 8000 are coupled with the battery pack 100′, the first wake circuit 7010 will send a wake signal to wake circuit 420 of the battery pack 100′ and the battery pack controller will close the battery pack discharge FETs 414 to enable current to flow from the battery pack 100′ through the adaptor 7000 and to the power tool 8000.

When the power tool 8000 is coupled/mated to the adaptor 7000 and the battery pack 100′ is coupled/mated to the adaptor 7000, a HIGH voltage signal (60V) will be provided to the first wake circuit 7010 (the Adpt3/Adpt4+ terminals). As such, a HIGH voltage signal will be placed on the gate of the transistor Q14 and the transistor Q14 will close. When the transistor Q14 closes, a LOW voltage signal will be placed on the gate of the Q11 transistor and the transistor Q11 will close. When the transistor Q11 closes a HIGH voltage signal (60V) will be placed on the gage of the transistor Q13 and the transistor Q13 will close. When the transistor Q13 closes, a LOW voltage signal (0V) will be presented at the WK_{A2} terminal. As such, a LOW voltage signal will be presented at the WK_{B} terminal (a change of state of the voltage signal on the WK_{B} terminal). When the battery pack 100′ reads the LOW voltage signal on the WK_{B} terminal, the battery pack 100′ will be placed into the wake state, as described above.

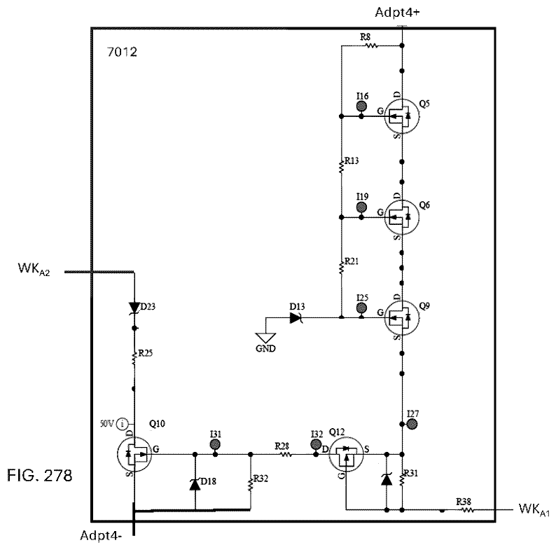

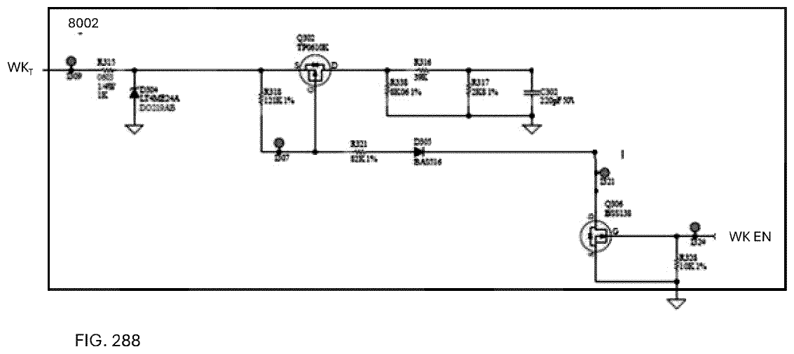

Furthermore, referring to FIGS. 288 and 278, when the adaptor 7000 and the power tool 8000 are coupled with the battery pack 100′, upon a trigger pull event of the power tool 8000, the second wake circuit 7012 will send a wake signal to wake circuit 420 of the battery pack 100′ and the battery pack controller will close the battery pack discharge FETs 414 to enable current to flow from the battery pack 100′ through the adaptor 7000 and to the power tool 8000. For example, the power tool controller 8002 of the power tool will place a HIGH voltage signal (WK EN) on the gate of the transistor Q306 and close the transistor Q306. When transistor Q306 closes, a LOW voltage signal will be placed on the gate of the transistor 302 and the transistor 302 will close. When the transistor 302 closes a LOW voltage signal will be placed on the WK_{T} terminal of the power tool 8000. When the adaptor 7000 reads a LOW voltage signal on the WK_{A1} terminal, a LOW voltage signal will be placed on the gate of the transistor Q12 and the transistor Q12 will close. When the transistor Q12 closes a HIGH voltage signal will be placed on the gate of the transistor Q10 and the transistor Q10 will close. When the transistor Q10 closes a LOW voltage signal will be placed on the WK_{A2} terminal of the adaptor 7000. The LOW voltage signal will be read on the WK_{B} terminal of the battery pack 100′ and the battery pack 100′ will be placed into the wake state, as described above.

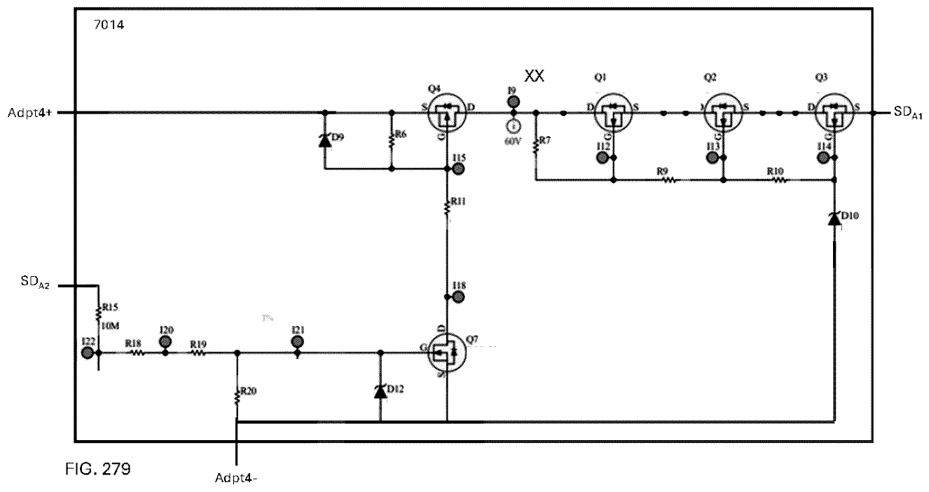

Still further, if the adaptor controller 7006 determines, based on information/data collected from the battery pack 100′ through the power terminals and/or the signal terminals, that the battery pack 100′ is experiencing a shutdown event, the adaptor controller 7006 will transmit a shutdown signal (SD EN) to the power tool 8000 and the power tool controller 8002 of the power tool 8000 will turn off the motor 88804 and/or opening a discharge switch. For example, referring to FIG. 279, as the power tool 8000 from the second power tool system is not configured to read a 60V signal on the SD_{T} terminal, the shutdown circuit 7014 of the adaptor 7000 must first level shift the input voltage from the Adpt+ terminal to a lower voltage. This is the purpose of transistors Q1, Q2, and Q3. In a default state (normal operation, no shutdown event) a HIGH voltage signal (60V) is presented at the SD_{A2} terminal. As such, a HIGH voltage signal is placed on the gate of the transistor Q7 and the transistor Q7 will close. When the transistor Q7 is closed, a LOW voltage signal is placed on the gate of the transistor Q4 and the transistor Q4 will close. As the transistor Q4 is closed a HIGH voltage signal (60V) will be present at node XX. The transistors Q1, Q2, Q3 shift the HIGH voltage signal to a lower HIGH voltage signal that is acceptable by the power tool 8000. When a shutdown event occurs in the battery pack 100′, the battery pack 100′ presents a LOW voltage signal on the WK_{B} terminal, as described above. As a result, the adaptor 7000 reads a LOW voltage signal on the WK_{A2} terminal. A LOW voltage signal is placed on the gate of the transistor Q7 and the transistor Q7 opens. When the transistor Q7 opens a HIGH voltage signal is placed on the gate of the transistor Q4 and the transistor Q4 opens. As a result, a LOW voltage signal is present at node XX and a LOW voltage signal will be present at the SD_{A1} terminal. As a result, the power tool 8000 will read a LOW voltage signal on the SD_{T} terminal and tool controller 8002 will stop providing a discharge current to the motor 8004.

The battery pack 3100 may also include a pack controller 3104 similar to the primary controller 404 of the battery pack 100′.

The first electromechanical interface 7002 of the adaptor 7000 may include the mechanical enable switch 7008.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A battery pack, comprising:
a housing; and
a cell holder subassembly, the cell holder subassembly including a set of battery cell modules.

2. The battery pack of claim 1, wherein the housing includes a first housing portion and a second housing portion together forming an internal cavity and wherein the cell holder subassembly is received in the internal cavity of the housing.

3. The battery pack of claim 2, wherein the cell holder subassembly includes a module holder including a base and two opposing side walls that form an interior storage space that is configured to receive the set of battery cell modules,
wherein the module holder has a longitudinal axis along a length of the module holder and a transverse axis that is perpendicular to the longitudinal axis, the transverse axis being along a width of the module holder, and
wherein the two side walls extend along the longitudinal axis of the module holder.

4. The battery pack of claim 3, wherein the base and the two side walls of the module holder are integrally formed.

5. The battery pack of claim 4, wherein the cell holder subassembly includes two opposing end walls that extend perpendicular to the base and the two side walls and that extend along the transverse axis of the module holder, and
wherein the two end walls are configured to be removably connected to the two side walls.

6. A battery pack, comprising:
a housing forming an internal cavity; and
a shipping subassembly, the shipping subassembly including a handle having a recess forming a cavity, the cavity including an opening to the internal cavity and an actuation component received in the handle cavity.

7. The battery pack of claim 6, wherein the shipping subassembly comprises a plurality of moveable contacts and a contact holding member configured to house the moveable contacts,
wherein the contact holding member is configured to be translated along a longitudinal axis of the battery pack between a first position and a second position;
wherein, when the contact holding member is in the first position, the contacts are configured to engage with contact pads of the battery pack to complete a power path between battery cells of the battery pack and to connect the battery cells of the battery pack together in series, wherein the contact pads of the battery pack are configured to be connected to cell taps of the battery pack, and
wherein, when the contact holding member in the second position, the contacts are configured to be disengaged from the contact pads of the battery pack to break the power path between battery cells of the battery pack and to disconnect the battery cells of the battery pack.

8. The battery pack of claim 7, wherein the contacts comprise leaf spring style contacts.

9. The battery pack of claim 8, wherein the first position is a use position of the battery pack and the second position is a shipping position for transportation of the battery pack.

10. The battery pack of claim 6, wherein the contact holding member comprises:
a body portion configured to be connected with the contacts and configured to retain the contacts in place,
a handle portion having a first cam surface, the handle portion configured to engage with the actuation component, and
connector portions configured to connect the handle portion and the body position.

11. The battery pack of claim 10, wherein the shipping subassembly further comprises:
a shipping subassembly base member,
a contact pad member having a plurality of fixed contact pads, the fixed contact pads insert molded within the shipping subassembly base member such that the fixed contact pads are exposed for contact with the movable contacts.

12. The battery pack of claim 11, wherein the shipping subassembly further comprises:
a shipping subassembly cover member configured to connect with the shipping subassembly base member, and
at least one spring configured to be connected between the contact holding member and the shipping subassembly base member,
wherein the shipping subassembly base member is configured to receive the contact holding member along with the moveable contacts therein.

13. The battery pack of claim 11, wherein the shipping subassembly base member comprises:
grooves configured to receive the connector portions of the contact holding member to allow the contact holding member to translate along the longitudinal axis of the battery pack and with respect to the shipping subassembly base member; and
seal members configured to be positioned adjacent the grooves of the shipping subassembly base member and the connector portions of the contact holding member so as to seal the internal cavity of the battery pack,
wherein the shipping subassembly cover member and shipping subassembly base member are configured to enclose the at least on spring, the seal members, and portions of the contact holding member along with the moveable contacts.

14. The battery pack of claim 13, wherein the at least one spring are configured to bias the contact holding member in a first direction along the longitudinal direction of the battery pack and with respect to the shipping subassembly base member so as to position the contact holding member in the first position.

15. The battery pack of claim 14, wherein the actuation component is configured to engage with the contact holding member to translate the contact holding member from the first position to the second position against the bias of the at least one spring and in an opposing second direction along the longitudinal axis of the battery pack.

16. The battery pack of claim 10, wherein the actuation component comprises:
an actuation component body sized and configured to be received in the cavity of the handle of the shipping subassembly; and
an actuation element having a first end and second end, the actuation element configured to be connected to the actuation component body at the first end and the actuation element comprises a second cam surface at the second end.

17. The battery pack of claim 16, wherein portions of the actuation element are configured to extend into an opening to the internal cavity, when the actuation component body is received in the cavity of the handle of the shipping subassembly, such that the second cam surface at the second end of the actuation element engage with the first cam surface of the handle portion of the contact holding member,
wherein surface interactions between the second cam surface of the actuation element and the first cam surface of the handle portion of the contact holding member cause the contact holding member to translate from the first position to the second position against the bias of the at least one spring and in an opposing second direction along the longitudinal axis of the battery pack.

18. The battery pack of claim 17, wherein the handle of the shipping subassembly is integrally formed in the housing of the battery pack,
wherein the handle is used by a user to carry the battery pack from one location to another location between use.

19. The battery pack of claim 17, further comprises a subassembly support that is configured to support an electronics module subassembly and a terminal block on a top surface thereof and is configured to be connected with the shipping subassembly base member on a bottom surface thereof,
wherein the shipping subassembly base member is connected to the shipping subassembly cover member on a top surface thereof to enclose the at least one spring, the seal members, and the contact holding member along with the moveable contacts between the shipping subassembly base member and the shipping subassembly cover member.

20. A battery pack latching system for latching a battery pack to a device upon mating the battery pack to the device along a mating direction, comprising:
a first component with a first end for user engagement and a second end for rotation about a first rotation axis;
a second component with a first end for engagement with a portion of the device and a second end for rotation about a second rotation axis, the second rotation axis generally parallel to the first rotation axis;
the first component including at least one shoulder between the first end and the second end and the second component including at least one shoulder between the first end and the second end, the first component shoulder positioned to engage the second component shoulder upon rotation of the first component about the first rotation axis forcing the second component to rotate about the second rotation axis.

21. The battery pack latching system of claim 20, wherein the first component includes a user actuation element for user engagement,
wherein the second component includes a latching element configured to engage with the portion of the device,
wherein the first end of the second component includes a latching element latching end,
wherein the second end of the second component includes a latching element rotating end,
wherein the first component shoulder engages the second component shoulder in an area, the latching element rotating end and the latching element latching end are on opposite sides of a plane that is generally perpendicular to the mating direction and passes through the area.

22. The battery pack latching system of claim 20, wherein the first end of the first component includes a user actuation element user end,
wherein the second end of the first component includes a user actuation element rotating end, and
wherein the first component shoulder engages the second component shoulder in an area, the user actuation element rotating end and the user actuation element user end are on opposite sides of a plane that is generally perpendicular to the mating direction and passes through the area.

23. The battery pack latching system of claim 20, wherein the device is a charger.

24. The battery pack latching system of claim 20, wherein the device is a cordless power tool.

25. The battery pack latching system of claim 20, further comprising a spring assembly,
wherein the spring assembly having a first end and a second end, the first end of the spring assembly is configured to be operatively connected to the second component and the second end of the spring assembly is configured to be operatively connected to a housing of the battery pack, and
wherein the spring assembly is configured to bias the second component away from the housing.

26. The battery pack latching system of claim 20, wherein, when the first component shoulder engages the second component shoulder in an area, the second component is forced to rotate about the second rotation axis against the bias of the spring assembly.

27. The battery pack latching system of claim 20, wherein, when the user actuation element is actuated by the user, the first component shoulder engages the second component shoulder upon rotation of the first component about the first rotation axis forcing the second component to rotate about the second rotation axis against the bias of the spring assembly, and
wherein the rotation of the second component about the second rotation axis causes the latching element of the second component to disengage from the portions of the device.
